(19) United States
(12) Patent Application Publication
(10) Pub. No.: US 2019/0101952 A1
(43) Pub. Date: Apr. 4, 2019

(54) PROCESSORS AND METHODS FOR CONFIGURABLE CLOCK GATING IN A SPATIAL ARRAY

(71) Applicant: INTEL CORPORATION, Santa Clara, CA (US)

(72) Inventors: MITCHELL DIAMOND, Santa Clara, CA (US); BENJAMIN KEEN, Santa Clara, CA (US); KERMIN E. FLEMING, JR., Hudson, MA (US)

(21) Appl. No.: 15/721,816

(22) Filed: Sep. 30, 2017

(51) Int. Cl. G06F 1/08; G06F 1/10; G06F 1/32; G06F 9/38; G06F 15/80

(52) U.S. Cl. CPC G06F 1/08; G06F 1/10; G06F 1/3237; G06F 15/8023; G06F 9/384; G06F 9/3802; G06F 9/3869

(57) ABSTRACT

Methods and apparatuses relating to configurable clock gating in spatial arrays are described. In one embodiment, a processor includes processing elements; an interconnect network between the processing elements; and a configuration controller, coupled to a first processing element and a second processing element of the plurality of processing elements and the first processing element having an output coupled to an input of the second processing element, to configure the second processing element to clock gate at least one clocked component of the second processing element, and configure the first processing element to send a reenable signal on the interconnect network to the second processing element to reenable the at least one clocked component of the second processing element when data is to be sent from the first processing element to the second processing element.

### STATEMENT REGARDING FEDERALLY SPONSORED RESEARCH AND DEVELOPMENT

This invention was made with Government support under contract number H98230A-13-D-0124-0202 awarded by the Department of Defense. The Government has certain rights in this invention.

### TECHNICAL FIELD

The disclosure relates generally to electronics, and, more specifically, an embodiment of the disclosure relates to circuitry for configurable clock gating in a spatial array.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1 illustrates an accelerator tile according to embodiments of the disclosure.

FIG. 2 illustrates a hardware processor coupled to a memory according to embodiments of the disclosure.

FIG. 3 illustrates an accelerator tile comprising an array of processing elements according to embodiments of the disclosure.

FIG. 4 illustrates a logical view of clock gating hardware in a processing element according to embodiments of the disclosure.

FIG. 5 illustrates a processing element including a clock gating circuit according to embodiments of the disclosure.

FIG. 6 illustrates a processing element according to embodiments of the disclosure.

FIG. 7 illustrates a flow diagram according to embodiments of the disclosure.

FIG. 8 illustrates a flow diagram according to embodiments of the disclosure.

FIG. 9 illustrates a context switch in a spatial array of processing elements of a processor according to embodiments of the disclosure.

FIGS. 10A-10D illustrate an in-flight configuration for a context switch of a spatial array of processing elements according to embodiments of the disclosure.

FIGS. 11A-11J illustrate illustrates a phased extraction of context for a spatial array of processing elements configured to execute a dataflow graph according to embodiments of the disclosure.

FIG. 12A illustrates an extracted state according to embodiments of the disclosure.

FIG. 12B illustrates a state at the beginning of an extraction according to embodiments of the disclosure.

FIG. 13 illustrates a state machine for a (e.g., configuration) controller according to embodiments of the disclosure.

FIG. 14A illustrates an extraction of context for a spatial array of processing elements according to embodiments of the disclosure.

FIG. 14B illustrates an extraction of context for a spatial array of processing elements according to embodiments of the disclosure.

FIG. 15 illustrates a phased extraction of context for a spatial array of processing elements that includes a (e.g., mezzanine or global) network therebetween according to embodiments of the disclosure.

FIG. 16 illustrates a phased extraction of context for a spatial array of processing elements that includes memory access according to embodiments of the disclosure.

FIG. 17A illustrates an extraction of context for a spatial array of processing elements according to embodiments of the disclosure.

FIG. 17B illustrates an extraction of context for a spatial array of processing elements according to embodiments of the disclosure.

FIG. 18 illustrates a flow diagram according to embodiments of the disclosure.

FIG. 19 illustrates a flow diagram according to embodiments of the disclosure.

FIG. 20A illustrates a program source according to embodiments of the disclosure.

FIG. 20B illustrates a dataflow graph for the program source of FIG. 20A according to embodiments of the disclosure.

FIG. 20C illustrates an accelerator with a plurality of processing elements configured to execute the dataflow graph of FIG. 20B according to embodiments of the disclosure.

FIG. 21 illustrates an example execution of a dataflow graph according to embodiments of the disclosure.

FIG. 22 illustrates a program source according to embodiments of the disclosure.

FIG. 23 illustrates an accelerator tile comprising an array of processing elements according to embodiments of the disclosure.

FIG. 24A illustrates a configurable data path network according to embodiments of the disclosure.

FIG. 24B illustrates a configurable flow control path network according to embodiments of the disclosure.

FIG. 25 illustrates a hardware processor tile comprising an accelerator according to embodiments of the disclosure.

FIG. 26 illustrates a processing element according to embodiments of the disclosure.

FIG. 27 illustrates a request address file (RAF) circuit according to embodiments of the disclosure.

FIG. 28 illustrates a plurality of request address file (RAF) circuits coupled between a plurality of accelerator tiles and a plurality of cache banks according to embodiments of the disclosure.

FIG. 29 illustrates a floating point multiplier partitioned into three regions (the result region, three potential carry regions, and the gated region) according to embodiments of the disclosure.

FIG. 30 illustrates an in-flight configuration of an accelerator with a plurality of processing elements according to embodiments of the disclosure.

FIG. 31 illustrates a snapshot of an in-flight, pipelined extraction according to embodiments of the disclosure.

FIG. 32 illustrates a compilation toolchain for an accelerator according to embodiments of the disclosure.

FIG. 33 illustrates a compiler for an accelerator according to embodiments of the disclosure.

FIG. 34A illustrates sequential assembly code according to embodiments of the disclosure.

FIG. 34B illustrates dataflow assembly code for the sequential assembly code of FIG. 34A according to embodiments of the disclosure.

FIG. 34C illustrates a dataflow graph for the dataflow assembly code of FIG. 34B for an accelerator according to embodiments of the disclosure.

FIG. 35A illustrates C source code according to embodiments of the disclosure.

FIG. 35B illustrates dataflow assembly code for the C source code of FIG. 35A according to embodiments of the disclosure.

FIG. 35C illustrates a dataflow graph for the dataflow assembly code of FIG. 35B for an accelerator according to embodiments of the disclosure.

FIG. 36A illustrates C source code according to embodiments of the disclosure.

FIG. 36B illustrates dataflow assembly code for the C source code of FIG. 36A according to embodiments of the disclosure.

FIG. 36C illustrates a dataflow graph for the dataflow assembly code of FIG. 36B for an accelerator according to embodiments of the disclosure.

FIG. 37A illustrates a flow diagram according to embodiments of the disclosure.

FIG. 37B illustrates a flow diagram according to embodiments of the disclosure.

FIG. 38 illustrates a throughput versus energy per operation graph according to embodiments of the disclosure.

FIG. 39 illustrates an accelerator tile comprising an array of processing elements and a local configuration controller according to embodiments of the disclosure.

FIGS. 40A-40C illustrate a local configuration controller configuring a data path network according to embodiments of the disclosure.

FIG. 41 illustrates a configuration controller according to embodiments of the disclosure.

FIG. 42 illustrates an accelerator tile comprising an array of processing elements, a configuration cache, and a local configuration controller according to embodiments of the disclosure.

FIG. 43 illustrates an accelerator tile comprising an array of processing elements and a configuration and exception handling controller with a reconfiguration circuit according to embodiments of the disclosure.

FIG. 44 illustrates a reconfiguration circuit according to embodiments of the disclosure.

FIG. 45 illustrates an accelerator tile comprising an array of processing elements and a configuration and exception handling controller with a reconfiguration circuit according to embodiments of the disclosure.

FIG. 46 illustrates an accelerator tile comprising an array of processing elements and a mezzanine exception aggregator coupled to a tile-level exception aggregator according to embodiments of the disclosure.

FIG. 47 illustrates a processing element with an exception generator according to embodiments of the disclosure.

FIG. 48 illustrates an accelerator tile comprising an array of processing elements and a local extraction controller according to embodiments of the disclosure.

FIGS. 49A-49C illustrate a local extraction controller configuring a data path network according to embodiments of the disclosure.

FIG. 50 illustrates an extraction controller according to embodiments of the disclosure.

FIG. 51 illustrates a flow diagram according to embodiments of the disclosure.

FIG. 52 illustrates a flow diagram according to embodiments of the disclosure.

FIG. 53A is a block diagram illustrating a generic vector friendly instruction format and class A instruction templates thereof according to embodiments of the disclosure.

FIG. 53B is a block diagram illustrating the generic vector friendly instruction format and class B instruction templates thereof according to embodiments of the disclosure.

FIG. 54A is a block diagram illustrating fields for the generic vector friendly instruction formats in FIGS. 53A and 53B according to embodiments of the disclosure.

FIG. 54B is a block diagram illustrating the fields of the specific vector friendly instruction format in FIG. 54A that make up a full opcode field according to one embodiment of the disclosure.

FIG. 54C is a block diagram illustrating the fields of the specific vector friendly instruction format in FIG. 54A that make up a register index field according to one embodiment of the disclosure.

FIG. 54D is a block diagram illustrating the fields of the specific vector friendly instruction format in FIG. 54A that make up the augmentation operation field 5350 according to one embodiment of the disclosure.

FIG. 55 is a block diagram of a register architecture according to one embodiment of the disclosure

FIG. 56A is a block diagram illustrating both an exemplary in-order pipeline and an exemplary register renaming, out-of-order issue/execution pipeline according to embodiments of the disclosure.

FIG. 56B is a block diagram illustrating both an exemplary embodiment of an in-order architecture core and an exemplary register renaming, out-of-order issue/execution architecture core to be included in a processor according to embodiments of the disclosure.

FIG. 57A is a block diagram of a single processor core, along with its connection to the on-die interconnect network and with its local subset of the Level 2 (L2) cache, according to embodiments of the disclosure.

FIG. 57B is an expanded view of part of the processor core in FIG. 57A according to embodiments of the disclosure.

FIG. 58 is a block diagram of a processor that may have more than one core, may have an integrated memory controller, and may have integrated graphics according to embodiments of the disclosure.

FIG. 59 is a block diagram of a system in accordance with one embodiment of the present disclosure.

FIG. 60 is a block diagram of a more specific exemplary system in accordance with an embodiment of the present disclosure.

FIG. 61, shown is a block diagram of a second more specific exemplary system in accordance with an embodiment of the present disclosure.

FIG. 62, shown is a block diagram of a system on a chip (SoC) in accordance with an embodiment of the present disclosure.

FIG. 63 is a block diagram contrasting the use of a software instruction converter to convert binary instructions in a source instruction set to binary instructions in a target instruction set according to embodiments of the disclosure.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. One non-limiting example of an operation is a blend operation to input a plurality of vectors elements and output a vector with a blended plurality of elements. In certain embodiments, multiple operations are accomplished with the execution of a single instruction.

Exascale performance, e.g., as defined by the Department of Energy, may require system-level floating point performance to exceed 10̂18 floating point operations per second (exaFLOPs) or more within a given (e.g., 20 MW) power budget. Certain embodiments herein are directed to a spatial array of processing elements (e.g., a configurable spatial accelerator (CSA)) that targets high performance computing (HPC), for example, of a processor. Certain embodiments herein of a spatial array of processing elements (e.g., a CSA) target the direct execution of a dataflow graph (or graphs) to yield a computationally dense yet energy-efficient spatial microarchitecture which far exceeds conventional roadmap architectures.

Certain embodiments of spatial architectures (e.g., the spatial arrays disclosed herein) are an energy efficient and high performance way to accelerate user applications. In certain embodiments, a spatial array (e.g., a plurality of processing elements coupled together by a (e.g., circuit switched) (e.g., interconnect) network) is to accelerate an application, for example, to execute some region of a single stream program (e.g., faster than a core of a processor). In certain embodiments, a measure of the effectiveness of a spatial architecture is the speed at which an (e.g., to-be-accelerated) region may be loaded into it, e.g., the longer it takes to load the region, the larger the region is to be to amortize the cost of loading the program. Conversely, where configuration times are short, then smaller program regions may be accelerated, e.g., broadening the applicability of the spatial architecture (e.g., accelerator).

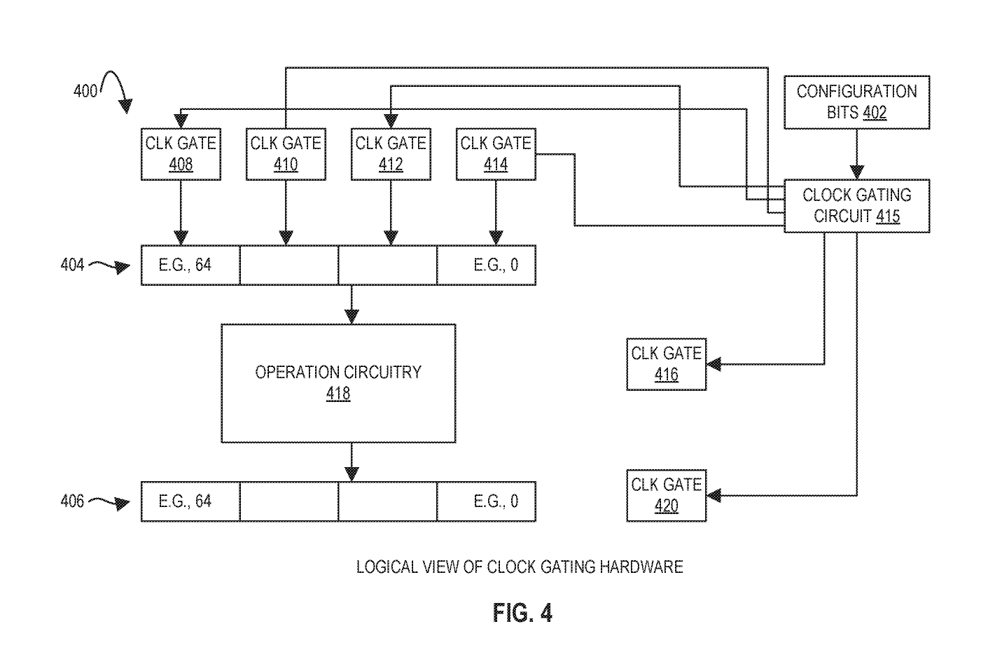

Certain embodiments herein provide for the hardware and techniques for providing clock gating in a spatial array (e.g., spatial fabric), e.g., clock gating in one or more (e.g., each) processing elements of a spatial array. Clock gating may generally refer to shutting off or blocking a clocking signal (e.g., a clock waveform) to a clocked component (e.g., a register or buffer), e.g., turning off the toggling/switching (e.g., and power consumption) caused by the clocking signal. The clocked component may maintain its current state (e.g., maintain any data stored therein), for example, as opposed to turning off the clocked component and losing the data stored therein. The clocked component may be reenabled to turn off the clock gating, e.g., to latch in a (e.g., new) data value into the clocked component. Certain embodiments herein provide for (e.g., coarse grained) programmable clock gating. Certain embodiments herein are directed to spatial architectures (e.g., configurable spatial array (CSA)) that provide energy efficient and high performance acceleration of user applications. In certain embodiments, the parallel nature of the spatial architecture may cause a plurality (e.g., many) processing elements (PEs) to be be executing at the same time such that power (e.g., clocking power) is a main concern across the spatial array. In certain embodiments, the programmatic way a spatial array (e.g., spatial fabric) is configured for a given dataflow graph allows for unique clock gating techniques to be used in the hardware (e.g., along with a software assist). For example, by using the (e.g., prior) knowledge of what is to happen inside the spatial array up front, clock gating may be utilized on a global and/or local basis (e.g., which will change dynamically as an algorithm or dataflow graph progresses). A spatial array (e.g., as an accelerator) may be a (e.g., generic) compute engine until it gets programmed with a specific dataflow graph to execute a given section of code. The PEs and (e.g., interconnect) networks may configured to do a specific task over and over again. By allowing the programmer/compiler/router to incorporate information (e.g., hints) known before execution about the specific operation(s) being called for and/or the specific distance (e.g., length) of path connections in the circuit and/or their physical properties, the PEs may be configured to reduce clock switching (e.g., via clock gating) to decrease the power used. Certain embodiments herein utilize the apriori knowledge of the size of the data being clocked in and out to control the number of bits used and the number of bits clock gated in a clocked component. For example, in one embodiment, clocked components (e.g., data buffers) may have one or more elements (e.g., see the discussion of FIG. 4 below) clock gated, for example, clock gating constants or portions of data buffers that are not to be used in an operation, e.g., clock gating upper or lower half (e.g., 32 bits) of a (e.g., 64 bits) buffer or register (e.g., when the smaller data value is to be used (e.g., 32 bits)) or clock gating the portion or portions an address that does not go past a certain address range to turn off those unused bits.

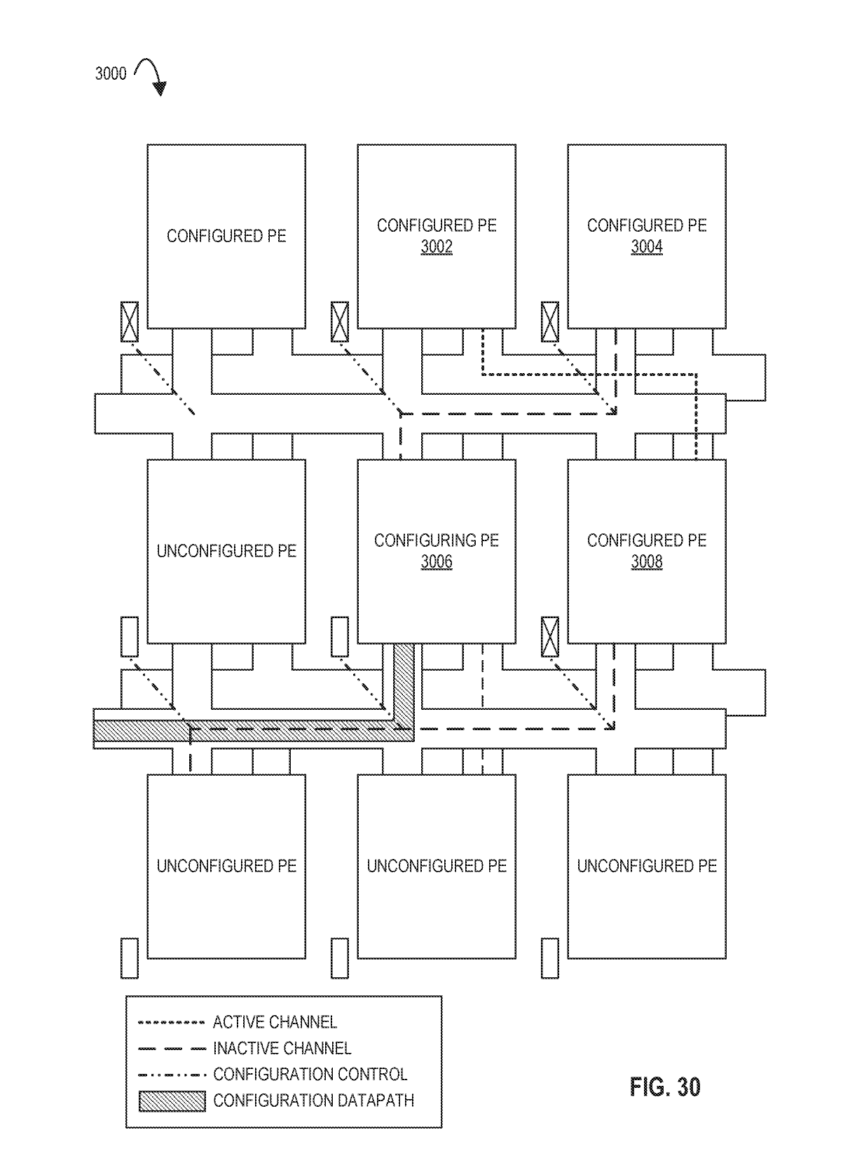

Certain embodiments herein provide for the hardware and techniques for pipelining configuration in a spatial array (e.g., spatial fabric). Certain embodiments herein leverage (e.g., regional) control (e.g., configuration controllers) and (e.g., low level) dataflow semantics of a spatial array (e.g., configurable spatial array (CSA)) to create a pipelined configuration effect which enables prior (e.g., early) configured (e.g., processing) elements of the spatial array to begin (e.g., immediately) operating, for example, before the entire (e.g., section) of the spatial array is configured. Certain embodiments herein may reduce the effective latency of configuration down to tens of nanoseconds. In one embodiment, configuration may be two (e.g., separate) operations: the actual configuration and the (e.g., simultaneous) extraction of a previous configuration (e.g., state thereof) loaded in to the spatial array (e.g., fabric), for example, these operations may occur during a context switch. Certain embodiments herein allow these operations to occur simultaneously within a spatial array. Certain embodiments herein utilize micro-protocol(s) for configuration and extraction, for example, as discussed in reference below to FIGS. 30, 31, and 39-46.

Certain embodiments herein provide the techniques and hardware (e.g., microarchitectural extensions and/or definitions) to permit the pipelining of the configuration and/or extraction operations of a spatial array. Certain embodiments herein utilize one or more controllers to orchestrate a wave front of configuration and extraction regions across a spatial array. Certain embodiments herein utilize a higher-level (e.g., configuration and/or extraction) controller to orchestrate local level controllers achieving a wave front of configuration and extraction regions across a spatial array. In one embodiment, a wave front logically separates the new and old (e.g., program) contexts, for example, enabling the new context to execute immediately. Certain embodiments herein convert what was a serial process (e.g., extraction followed by configuration) into a pipelined process, e.g., reducing latency by an order of magnitude.

Certain embodiments herein reduce the amount of time necessary to configure (and/or extract) a spatial accelerator, e.g., enabling the profitable acceleration of smaller code regions. As a result, the performance of more programs may be improved and improved to a larger degree.

Below also includes a description of the architectural philosophy of embodiments of a spatial array of processing elements (e.g., a CSA) and certain features thereof. As with any revolutionary architecture, programmability may be a risk. To mitigate this issue, embodiments of the CSA architecture have been co-designed with a compilation tool chain, which is also discussed below.

### INTRODUCTION

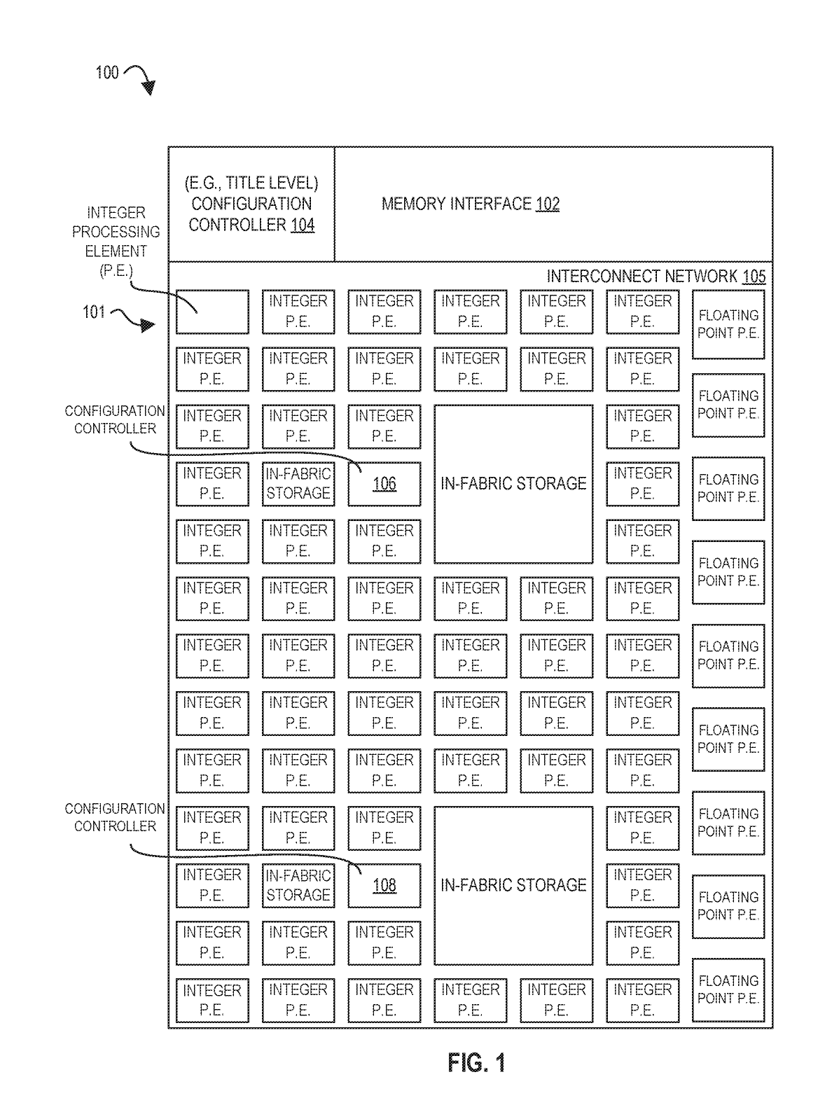

Exascale computing goals may require enormous system-level floating point performance (e.g., 1 ExaFLOPs) within an aggressive power budget (e.g., 20 MW). However, simultaneously improving the performance and energy efficiency of program execution with classical von Neumann architectures has become difficult: out-of-order scheduling, simultaneous multi-threading, complex register files, and other structures provide performance, but at high energy cost. Certain embodiments herein achieve performance and energy requirements simultaneously. Exascale computing power-performance targets may demand both high throughput and low energy consumption per operation. Certain embodiments herein provide this by providing for large numbers of low-complexity, energy-efficient processing (e.g., computational) elements which largely eliminate the control overheads of previous processor designs. Guided by this observation, certain embodiments herein include a spatial array of processing elements, for example, a configurable spatial accelerator (CSA), e.g., comprising an array of processing elements (PEs) connected by a set of light-weight, back-pressured (e.g., communication) networks. One example of a CSA tile is depicted in FIG. 1. Certain embodiments of processing (e.g., compute) elements are dataflow operators, e.g., multiple of a dataflow operator that only processes input data when both (i) the input data has arrived at the dataflow operator and (ii) there is space available for storing the output data, e.g., otherwise no processing is occurring. Certain embodiments (e.g., of an accelerator or CSA) do not utilize a triggered instruction.

Coarse grained spatial architectures, such as an embodiment of the configurable spatial accelerator (CSA) shown in FIG. 1, are the composition of lightweight processing elements (PEs) connected by an interconnect network. Programs, e.g., viewed as control dataflow graphs, may be mapped onto the architecture by configuring the PEs and the network. Generally, PEs may be configured as dataflow operators, e.g., once all input operands arrive at the PE, some operation occurs, and results are forwarded downstream (e.g., to a destination PE(s)) in a pipelined fashion. Dataflow operators may choose to consume incoming data on a per operator basis.

Certain embodiments herein extend the capabilities of a spatial array (e.g., CSA) to include clock gating in the spatial array (e.g., spatial fabric), e.g., clock gating in one or more (e.g., each) processing elements of the spatial array. A spatial array may include one or more of the components or methods discussed below. In HPC systems as an example, power may be one of the major limiting factors in performance and/or design. Certain embodiments herein decrease the clocking power for highly dense processing elements, e.g., using knowledge from the programmer and/or compilers.

FIG. 1 illustrates an accelerator tile 100 embodiment of a spatial array of processing elements according to embodiments of the disclosure. Accelerator tile 100 may be a portion of a larger tile. Accelerator tile 100 executes a dataflow graph or graphs. A dataflow graph may generally refer to an explicitly parallel program description which arises in the compilation of sequential codes. Certain embodiments herein (e.g., CSAs) allow dataflow graphs to be directly configured onto the CSA array, for example, rather than being transformed into sequential instruction streams. Certain embodiments herein allow a first (e.g., type of) dataflow operation to be performed by one or more processing elements (PEs) of the spatial array and, additionally or alternatively, a second (e.g., different, type of) dataflow operation to be performed by one or more of the network communication circuits (e.g., endpoints) of the spatial array.

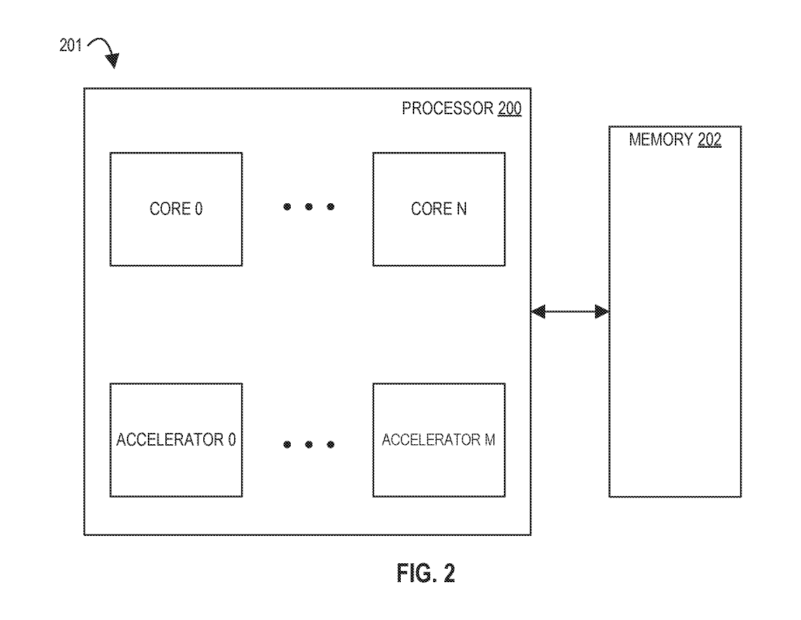

The derivation of a dataflow graph from a sequential compilation flow allows embodiments of a CSA to support familiar programming models and to directly (e.g., without using a table of work) execute existing high performance computing (HPC) code. CSA processing elements (PEs) may be energy efficient. In FIG. 1, memory interface 102 may couple to a memory (e.g., memory 202 in FIG. 2) to allow accelerator tile 100 to access (e.g., load and/store) data to the (e.g., off die) memory. Depicted accelerator tile 100 is a heterogeneous array comprised of several kinds of PEs coupled together via an interconnect network 105. Accelerator tile 100 may include one or more of integer arithmetic PEs, floating point arithmetic PEs, communication circuitry (e.g., network dataflow endpoint circuits), and in-fabric storage, e.g., as part of spatial array of processing elements 101. Dataflow graphs (e.g., compiled dataflow graphs) may be overlaid on the accelerator tile 100 for execution. In one embodiment, for a particular dataflow graph, each PE handles only one or two (e.g., dataflow) operations of the graph. The array of PEs may be heterogeneous, e.g., such that no PE supports the full CSA dataflow architecture and/or one or more PEs are programmed (e.g., customized) to perform only a few, but highly efficient operations. Certain embodiments herein thus yield a processor or accelerator having an array of processing elements that is computationally dense compared to roadmap architectures and yet achieves approximately an order-of-magnitude gain in energy efficiency and performance relative to existing HPC offerings.

Certain embodiments herein provide for performance increases from parallel execution within a (e.g., dense) spatial array of processing elements (e.g., CSA) where each PE utilized may perform its operations simultaneously, e.g., if input data is available. Efficiency increases may result from the efficiency of each PE, e.g., where each PE's operation (e.g., behavior) is fixed once per configuration (e.g., mapping) step and execution occurs on local data arrival at the PE, e.g., without considering other fabric activity. In certain embodiments, a PE is (e.g., each a single) dataflow operator, for example, a dataflow operator that only operates on input data when both (i) the input data has arrived at the dataflow operator and (ii) there is space available for storing the output data, e.g., otherwise no operation is occurring.

Certain embodiments herein include a spatial array of processing elements as an energy-efficient and high-performance way of accelerating user applications. In one embodiment, a spatial array(s) is configured via a serial process in which the latency of the configuration is fully exposed via a global reset. Some of this may stem from the register-transfer level (RTL) semantics of an array (e.g., a field-programmable gate array (FPGA)). A program for executing on an array (e.g., FPGA) may assume a fundamental notion of reset in which every part of the design is expected to be operational coming out of the configuration reset. Certain embodiments herein provide a dataflow-style array in which PEs (e.g., all) conform to a flow-controller micro-protocol. This micro-protocol may create the effect of a distributed initialization. This micro-protocol can allow for a pipelined configuration and extraction mechanism, e.g., with regional (e.g., not the entire array) orchestration. Certain embodiments herein provide for a context switch in a dataflow architecture. Additionally or alternatively, certain embodiments herein provide for clock gating in the spatial array (e.g., spatial fabric), e.g., clock gating in one or more (e.g., each) processing elements of the spatial array

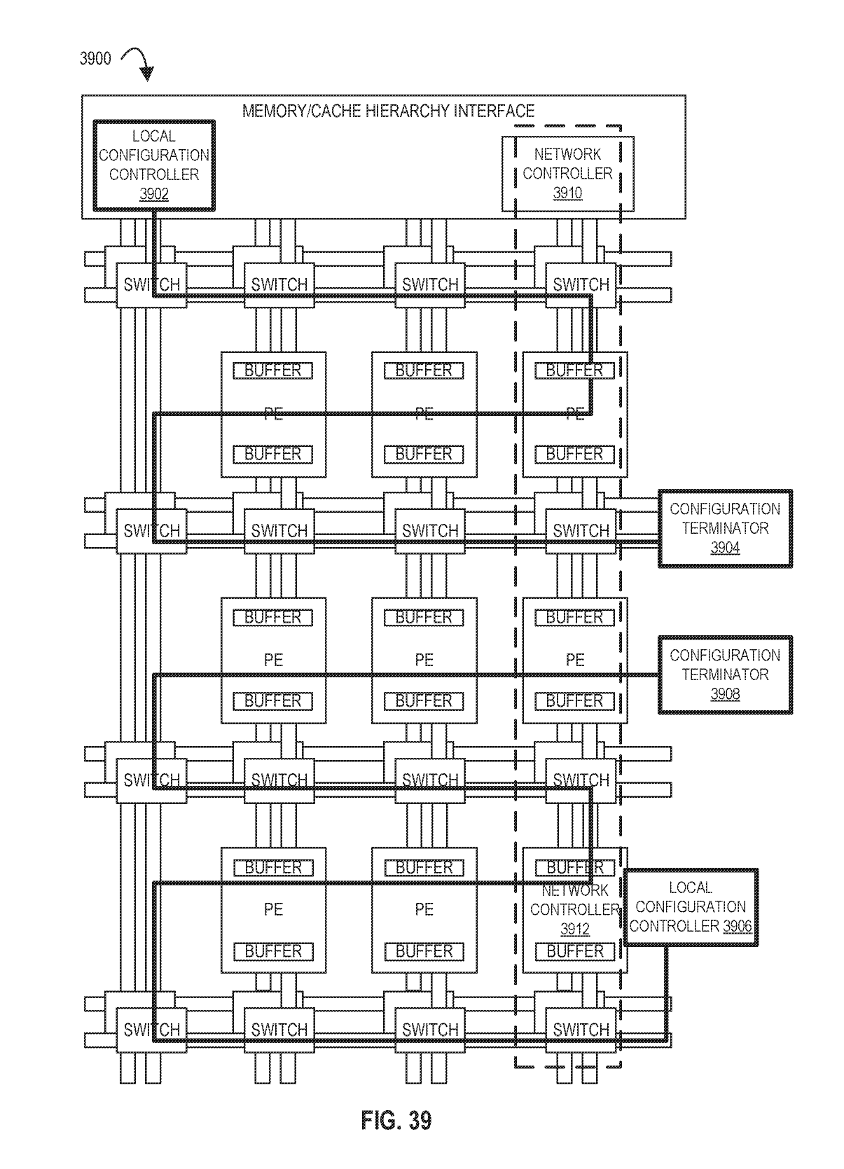

Depicted accelerator tile 100 include a (e.g., tile level) configuration controller 104, e.g., to configure one or more of the processing elements (PEs) and/or the (e.g., interconnect network 105) network between the PEs, e.g., according to an input dataflow graph. Additionally or alternatively, accelerator tile 100 includes one or more (e.g., local) configuration controllers (106, 108). For example, each local configuration controller may configure a (e.g., respective) subset of the processing elements and/or the network (e.g., inputting and/or outputting into that subset of the processing elements). Each local (e.g., configuration) controller may operate independently. In one embodiment, a configuration controller includes the capabilities for setting clock gating (e.g., for certain (or all) of the PEs and/or network between the PEs). In one embodiment, a configuration controller includes the capabilities to set clock gating in a clock gaiting circuit within a PE. In one embodiment, a configuration controller includes the capabilities for extraction, e.g., an extraction controller. In one embodiment, a configuration controller and a separate extraction controller are utilized. In one embodiment, local controllers sit on a network by which they communicate with the upper levels of the control hierarchy, memory, and/or each other, for example, via network in dotted box in FIG. 39.

As shown below, an execution plan for pipelined services may include three steps: configure (e.g., and set clock gating functionalities), buffer, and extraction. Similarly, the control hardware (e.g., controller(s)) may require knowledge and coordination of these three steps. An example control flow is as follows: each local controller may contain a list of those controllers which are physically adjacent to it. A context (e.g., state) transition may begin when a local controller receives a message from each those local controllers that precede it. That local controller may then begin its current operation. When the operation completes, it may transition its context (e.g., state) and send a message to each successor controller. In one embodiment, a local controller follows four states, Run, Extract, Inactive, and Configure. Inactive may be obtained by starting the Configure micro-protocol, for example, which deactivates the PEs, but may not immediately supply the configuration information, e.g., thereby holding the PEs in a deactivated state.

Pipelined runtime services may include coordination between a higher-level (e.g., tile-level) controller and the local controller responsible for configuration. To shorten this communication time and to improve pipeline behavior, certain embodiments herein include a microarchitecture to support the direct forwarding of (e.g., configuration, extraction, and/or completion) commands among the local controllers. This may allow the higher-level controller(s) to overlay a coordinated configuration and extraction graph on top of the local controllers which can be used to dynamically construct the wave front.

Certain embodiments herein provide paradigm-shifting levels of performance and tremendous improvements in energy efficiency across a broad class of existing single-stream and parallel programs, e.g., all while preserving familiar HPC programming models. Certain embodiments herein may target HPC such that floating point energy efficiency is extremely important. Certain embodiments herein not only deliver compelling improvements in performance and reductions in energy, they also deliver these gains to existing HPC programs written in mainstream HPC languages and for mainstream HPC frameworks. Certain embodiments of the architecture herein (e.g., with compilation in mind) provide several extensions in direct support of the control-dataflow internal representations generated by modern compilers. Certain embodiments herein are direct to a CSA dataflow compiler, e.g., which can accept C, C++, and Fortran programming languages, to target a CSA architecture.

FIG. 2 illustrates a hardware processor 200 coupled to (e.g., connected to) a memory 202 according to embodiments of the disclosure. In one embodiment, hardware processor 200 and memory 202 are a computing system 201. In certain embodiments, one or more of accelerators is a CSA according to this disclosure. In certain embodiments, one or more of the cores in a processor are those cores disclosed herein. Hardware processor 200 (e.g., each core thereof) may include a hardware decoder (e.g., decode unit) and a hardware execution unit. Hardware processor 200 may include registers. Note that the figures herein may not depict all data communication couplings (e.g., connections). One of ordinary skill in the art will appreciate that this is to not obscure certain details in the figures. Note that a double headed arrow in the figures may not require two-way communication, for example, it may indicate one-way communication (e.g., to or from that component or device). Any or all combinations of communications paths may be utilized in certain embodiments herein. Depicted hardware processor 200 includes a plurality of cores (O to N, where N may be 1 or more) and hardware accelerators (O to M, where M may be 1 or more) according to embodiments of the disclosure. Hardware processor 200 (e.g., accelerator(s) and/or core(s) thereof) may be coupled to memory 202 (e.g., data storage device). Hardware decoder (e.g., of core) may receive an (e.g., single) instruction (e.g., macro-instruction) and decode the instruction, e.g., into micro-instructions and/or micro-operations. Hardware execution unit (e.g., of core) may execute the decoded instruction (e.g., macro-instruction) to perform an operation or operations.

Section 1 below discusses configurable clock gating in a spatial array. Section 2 below discloses embodiments of CSA architecture. In particular, novel embodiments of integrating memory within the dataflow execution model are disclosed. Section 3 delves into the microarchitectural details of embodiments of a CSA. In one embodiment, the main goal of a CSA is to support compiler produced programs. Section 4 below examines embodiments of a CSA compilation tool chain. The advantages of embodiments of a CSA are compared to other architectures in the execution of compiled codes in Section 5. Finally the performance of embodiments of a CSA microarchitecture is discussed in Section 6, further CSA details are discussed in Section 7, and a summary is provided in Section 8.

### 1. Configurable Clock Gating

In certain embodiments, processing elements (PEs) communicate using dedicated virtual circuits which are formed by statically configuring a (e.g., circuit switched) communications network, for example, as discussed herein. These virtual circuits may be flow controlled and fully back-pressured, e.g., such that a PE will stall if either the source has no data or its destination is full. At runtime, data may flow through the PEs implementing the mapped dataflow graph (e.g., mapped algorithm). For example, data may be streamed in from memory, through the (e.g., fabric area of a) spatial array of processing elements, and then back out to memory.

Such an architecture may achieve remarkable performance efficiency relative to traditional multicore processors: compute, e.g., in the form of PEs, may be simpler and more numerous than cores and communications may be direct, e.g., as opposed to an extension of the memory system. In certain embodiments, a spatial array (e.g., CSA according to any of this disclosure) includes paths through the network from one PE to another that are configurable based on the programming of the dataflow graph (e.g., as discussed further below).

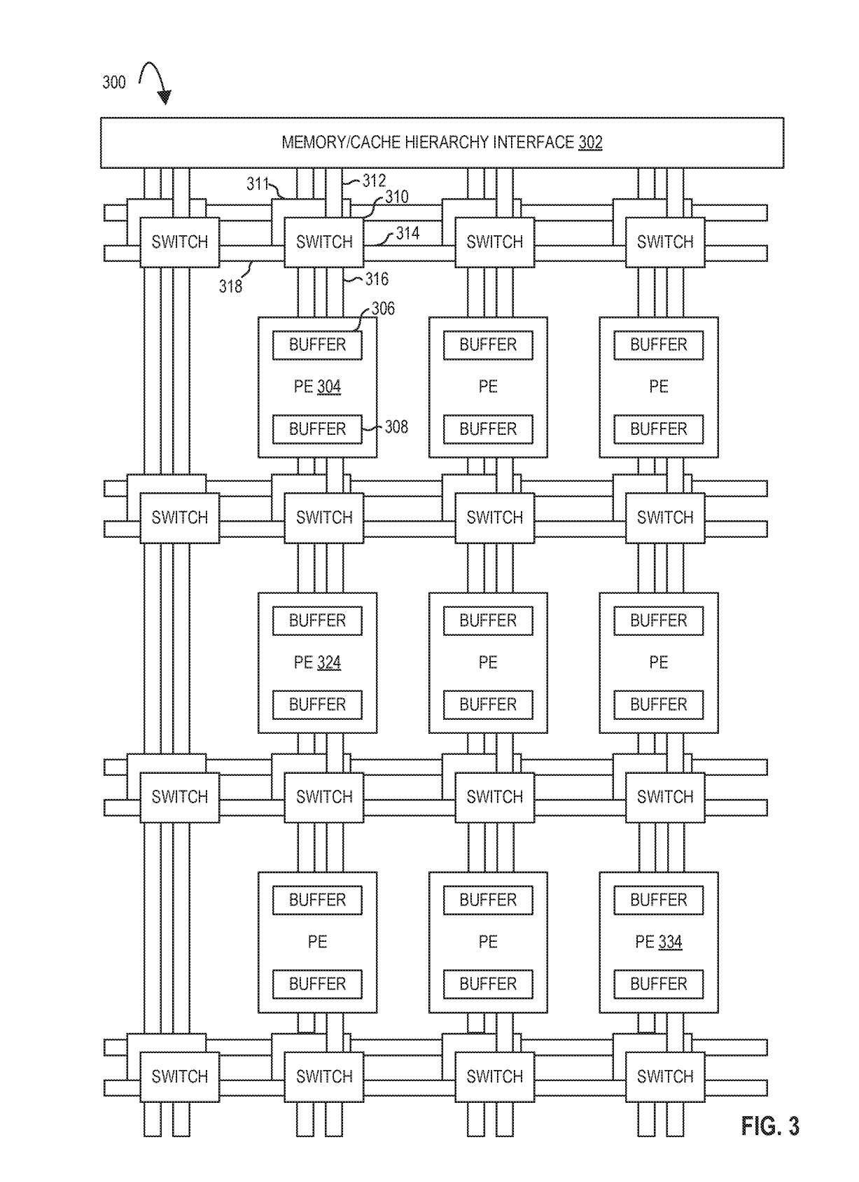

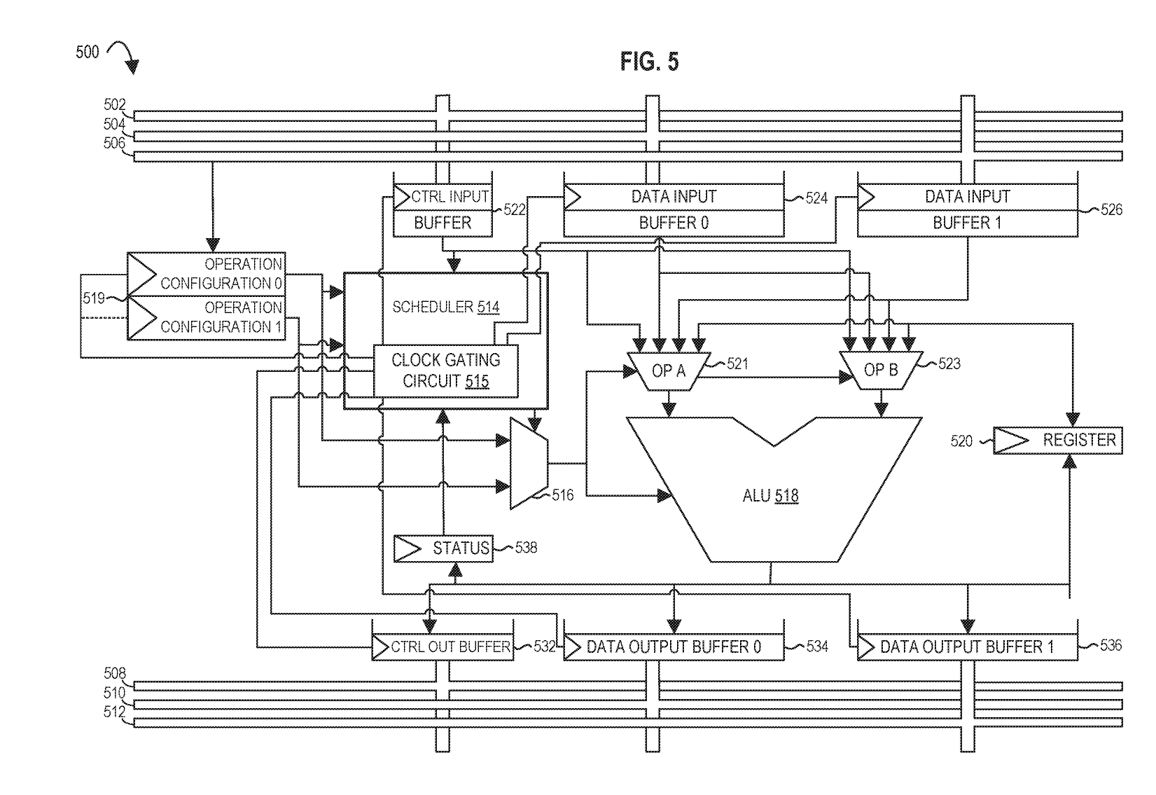

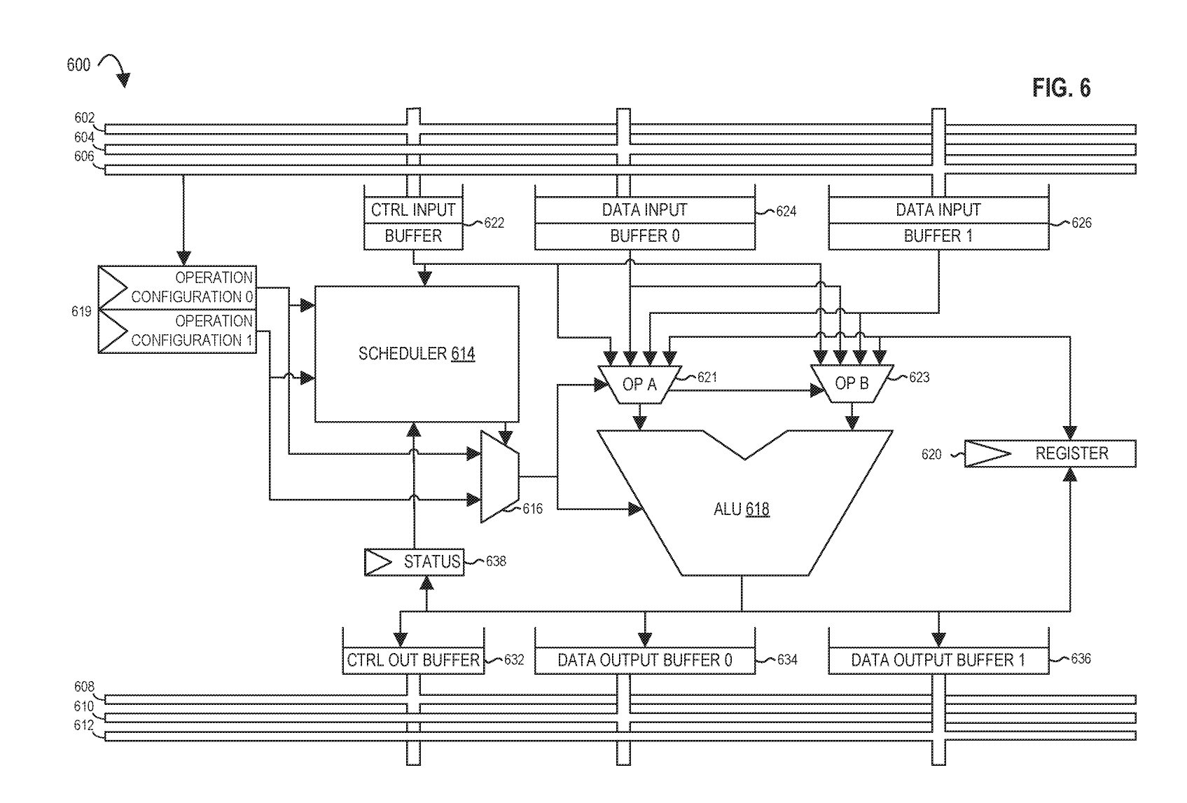

FIG. 3 illustrates an accelerator tile 300 comprising an array of processing elements (PEs) according to embodiments of the disclosure. The interconnect network is depicted as circuit switched, statically configured communications channels. For example, a set of channels coupled together by a switch (e.g., switch 310 in a first network and switch 311 in a second network). The first network and second network may be separate or coupled together. For example, switch 310 may couple one or more of the four data paths (312, 314, 316, 318) together, e.g., as configured to perform an operation according to a dataflow graph. In one embodiment, the number of data paths is any plurality. Processing element (e.g., processing element 304) may be as disclosed herein, for example, as in FIGS. 5, 6, and/or 26. Accelerator tile 300 includes a memory/cache hierarchy interface 302, e.g., to interface the accelerator tile 300 with a memory and/or cache. A data path (e.g., 318) may extend to another tile or terminate, e.g., at the edge of a tile. A processing element (e.g., PE 304) may include an input buffer (e.g., buffer 306) and/or an output buffer (e.g., buffer 308).

Operations may be executed based on the availability of their inputs and the status of the PE. A PE may obtain operands from input channels and write results to output channels, although internal register state may also be used. Certain embodiments herein include a configurable dataflow-friendly PE. FIGS. 5, 6, and 26 show detailed block diagrams of one such PE, e.g., an integer PE. This PE consists of several I/O buffers, an ALU, a storage register, some instruction registers, and a scheduler. Each clock cycle, the scheduler may select an instruction for execution based on the availability of the input and output buffers and the status of the PE. The result of the operation may then be written to either an output buffer or to a (e.g., local to the PE) register. Data written to an output buffer may be transported to a downstream PE for further processing. This style of PE may be extremely energy efficient, for example, rather than reading data from a complex, multi-ported register file, a PE reads the data from a register. Similarly, instructions may be stored directly in a register, rather than in a virtualized instruction cache.

Instruction registers may be set during a special configuration step. During this step, auxiliary control wires and state, in addition to the inter-PE network, may be used to stream in configuration across the several PEs comprising the fabric. As result of parallelism, certain embodiments of such a network may provide for rapid reconfiguration, e.g., a tile sized fabric may be configured in less than about 10 microseconds. FIGS. 5, 6, and 26 represent example configuration of a processing element, e.g., in which all architectural elements are minimally sized. In other embodiments, each of the components of a processing element is independently scaled to produce new PEs. For example, to handle more complicated programs, a larger number of instructions that are executable by a PE may be introduced. A second dimension of configurability is in the function of the PE arithmetic logic unit (ALU). In FIGS. 5, 6, and 26, an integer PE is depicted which may support addition, subtraction, and various logic operations. Other kinds of PEs may be created by substituting different kinds of functional units into the PE. An integer multiplication PE, for example, might have no registers, a single operation, and a single output buffer. Certain embodiments of a PE decompose a fused multiply add (FMA) into separate, but tightly coupled floating multiply and floating add units to improve support for multiply-add-heavy workloads. PEs are discussed further below.

In one embodiment, each PE may perform clock gating to shut off and/or block its clock signal, e.g., and may be reenabled once valid (e.g., input) data is sent to the PE. An embodiment of clock gating may include clock gating one or more (e.g., all or all except a control input buffer) clocked components (e.g., where data is latched in based on the clock signal) of a processing element. An embodiment of clock gating may include clock gating based on specific knowledge of the dataflow graph, e.g., to enable dynamic clock gating. An embodiment of clock gating may include clock gating based on distance between sending and receiving PEs (e.g., PEs on a same die or same tile). In certain embodiments, information about the physical properties and the flow for a dataflow graph is known at configuration time, such that configuration information (e.g., from compiler/router tools) is used to cause the hardware (e.g., a clock gating circuit) to implement clock gating, e.g., in contrast to embodiments where clock gating is derived by the circuit functionality and/or does not have input from the compiler (e.g., or programmer) as to how a program is implemented by the hardware.

FIG. 4 illustrates a logical view of clock gating hardware 400 in a processing element according to embodiments of the disclosure. Clock gating hardware may be components in a processing element (PE), e.g., any processing element disclosed herein. Depicted hardware include an input data storage 404 (e.g., corresponding to data input buffer 524 or data input buffer 526 in FIG. 5 or data input buffer 624 or data input buffer 626), operations circuitry 418 (e.g., which may include one or more clocked registers) (e.g., which may include an ALU, e.g., ALU 518 in FIG. 5 or ALU 618 in FIG. 6) to perform one or more operations on (e.g., all) input data stored in input data storage 404, and provide the resultant of the one or more operations into output data storage 406 (e.g., corresponding to data output buffer 534 or data output buffer 536 in FIG. 5 or data output buffer 634 or data output buffer 636). In one embodiment, a buffer may be a control input or control output buffer.

Input data storage 404 is shown as divided into four elements (e.g., although it may be divided into a single element or any plurality of elements in certain embodiments), and output data storage 406 is shown as divided into the same number of (e.g., four) elements (e.g., although it may be divided into a single element or any plurality of elements in certain embodiments). In one embodiment, the input data storage 404 is divided into a different number of elements than the number of elements that output data storage 406 is divided into. Clock gating hardware 400 includes storage 402 for configuration bit or bits. In certain embodiments, configuration bit or bits are loaded (e.g., into storage 402 in a PE) by a configuration controller (e.g., a configuration controller or controllers as discussed herein). In one embodiment, the configuration bits in configuration bit storage 402 include one bit for all, a subset of, or each of the clocked components, e.g., multiple configuration bits with a single bit thereof corresponding to a particular clocked (e.g., independently clock gated) component or components (e.g., one bit for each element that is independently clock gated in input data storage 404, and one bit for each of the operation circuitry 418 and output data storage 406, e.g., six bits total as one example). In one embodiment, the configuration bits in configuration bit storage 402 is a single bit for all clocked components. Configurations bits may be input into clock gating circuit 415 to clock gate one or more of the clocked components (e.g., any combination of the input data storage 404 (e.g., each element thereof), output data storage 406 (e.g., each element thereof), and operation circuitry 418). Clock gating circuit may shut off or block a clocking signal (e.g., a clock waveform) to a clocked component, e.g., turning off the toggling/switching (e.g., and power consumption) caused by the clocking signal. The clocked component may maintain its current state (e.g., maintain any data stored therein), for example, as opposed to turning off the clocked component and losing the data stored therein. The clocked component may be reenabled to turn off the clock gating, e.g., to latch in a (e.g., new) data value in the clocked component. In certain embodiments, (e.g., each element of) input data storage 404 (e.g., each element thereof) is a clocked component such that a new data value is latched in (e.g., from an input of an interconnect network) in a clock cycle (e.g., on a falling edge and/or rising edge of a clock waveform). Depicted input data storage 404 includes a clock gate (408, 410, 412, 414, respectively) for each element of input data storage 404. In one embodiment, a clock gate controls whether its element in input data storage 404 is updated or clock gated, e.g., controlled via a signal from clock gating circuit 415. In one embodiment, a single clock gate controls the entire input data storage 404. Depicted output data storage 406 includes a shared clock gate 420 for all elements of output data storage 404. In one embodiment, the clock gate 420 controls whether the element(s) in output data storage 406 is updated or clock gated, e.g., controlled via a signal from clock gating circuit 415. In one embodiment, output data storage 406 includes a separate clock gate for each element of output data storage 406. Clock gating circuit may clock gate one or more (e.g., all) of the clocked components according to a dataflow graph input into a spatial array (e.g., having at least one PE) that includes clock gating hardware 400. Clock gating circuit 415 may clock gate the operations circuitry 418 via clock gate 416. Thus, certain clocked components may not be utilized, e.g., based on the configuration information (e.g., in each cycle or each dataflow graph) to configure a dataflow graph into a spatial array (e.g., CSA).

As one example, the following for-loop code (1) walks through memory from address 0 to address N (e.g., one gigabit (1 Gb)) incrementing by 8. This may be a fixed progression through the addresses range for the 64 bits needed to represent 1 Gb. In one embodiment, the address space is 64 bits wide, and thus:

For address=0;address<N;address=address+8 (1)

In certain embodiments of a spatial array, a processing element (e.g., PE 500 in FIG. 5) is used to generate numbers from 1 to N which is then sent (e.g., to another PE) to add 8 to arrive at the correct address. During the for-loop execution, the 64 bits of address may be progressing predictably in incrementing by 8. One or multiple processing elements may thus have their clocked components (e.g., flops) (e.g., input and/or output storage) clock gated to avoid latching in unused data or merely logically low values (e.g., 0s). In one embodiment, a PE performs operations which define the number of bits used in the instruction (e.g., a byte, word, double-word, etc.) and that number may be hardcoded in to largest data width that an operation (e.g., an algorithm) is to use. In the for-loop code (1) above and/or other operations in dataflow graph, a predictable variable use of the width of data being used is known (e.g., prior to execution on the spatial array). During the configuration phase of a spatial array, configuration bits are sent to each PE (e.g., clock gating circuit in that PE) to configuring it for a specific functionality. Configuration bits may be set to inform the PE (e.g., its clock gating circuit) that the flow of data through it matches a specific (e.g., predetermined) pattern, e.g., allowing use of (e.g., different) clock gating for clocked components (for example, different types of components in different PEs, e.g., clock gating the output of a first PE and clock gating the input of another PE connected to the output of the first PE) of a spatial array, e.g., to save power. The configuration bits may be selected for (e.g., unique for each of) a specific operation or operations (e.g., application) of a dataflow graph where generation of patterns is generated to enhance the PE or PEs clock gating over the length of the execution of the dataflow graph (e.g., algorithm thereof).

FIG. 5 illustrates a processing element 500 including a clock gating circuit 515 according to embodiments of the disclosure. Depicted clock gating circuit 515 is disposed in the scheduler 514. In other embodiments, the clock gating circuit is separate from an operation scheduler. Clock gating circuit 515 may include one or more of the depicted control lines to clock gate those clocked components. In one embodiment, clock gating circuit 515 receives a configuration (e.g., in configuration register or storage within clock gating circuit) and performs the clock gating actions based on those configuration bit or bits. In one embodiment, (e.g., clock gating) configuration is sent and/or received on one of (input) networks 502, 504, or 506 or (output) networks 508, 510, or 512. Configuration may be loaded into configuration storage as discussed herein, e.g., by a configuration controller as discussed herein. Status register 538 and/or register 520 may be clock gated in certain embodiments. In one embodiment, a configuration value (e.g., a single bit) it to clock gate all (e.g., data) input and output buffers (e.g., data input buffer 524, data input buffer 526, data output buffer 534, and data output buffer 536) for a first value (e.g., when the configuration value is set to a logical one), and enable all (e.g., data) input and output buffers (e.g., data input buffer 524, data input buffer 526, data output buffer 534, and data output buffer 536) for a second value (e.g., when the configuration value is set to a logical zero). In one embodiment, control input buffer 522 is not clock gated, e.g., so as to receive a control input signal (e.g., from another PE) to reenable one or more (e.g., not necessarily all) of the clocked components that are currently clock gated, e.g., received from (input) networks 502, 504, or 506. In one embodiment, clock gating circuitry is to change which components (e.g., a subset of the clocked components in a PE) are clock gated for each dataflow graph (e.g., a cycle of execution of the dataflow graph). In one embodiment, the configuration bits (e.g., stored in configuration register and/or storage within clock gating circuit 515) include one bit for all, a subset of, or each of the clocked components, e.g., multiple configuration bits with a single bit thereof corresponding to a particular clocked (e.g., independently clock gated) component or components (e.g., one bit for each element that is independently clock gated) (e.g., one respective bit for each of control input buffer 522, control output buffer 532, data input buffer 524, data input buffer 526, data output buffer 534, data output buffer 536, and configuration register 519, e.g., seven bits total as one example). In one embodiment, the configuration bits (e.g., stored in configuration register and/or storage within clock gating circuit 515) include one bit for all of a subset of the clocked components (e.g., any combination of control input buffer 522, control output buffer 532, data input buffer 524, data input buffer 526, data output buffer 534, data output buffer 536, configuration register 519, or other clocked component). In one embodiment, a configuration value includes (e.g., is) a single bit (e.g., stored in configuration register and/or storage within clock gating circuit 515) for the subset of the control input buffer 522, control output buffer 532, data input buffer 524, data input buffer 526, data output buffer 534, and data output buffer 536. In one embodiment, a configuration value includes (e.g., is) a single bit (e.g., stored in configuration register and/or storage within clock gating circuit 515) for the subset of the control input buffer 522 and the control output buffer 532. In one embodiment, a configuration value includes (e.g., is) a single bit (e.g., stored in configuration register and/or storage within clock gating circuit 515) for the subset of data input buffer 524, data input buffer 526, data output buffer 534, and data output buffer 536.

In certain embodiments, the clock gating circuitry includes a state machine to perform one or more of the following:

### Configuration Register Clock Gating

In one embodiment, configuration registers (e.g., configuration register 519 in FIG. 5) are active only during configuration and extraction. Therefore, they may be disabled at other times. Each PE may be equipped with state which tracks these behaviors.

E.g., a state machine in clock gating circuitry may operating according to the following:

Config_clock_enable=!configured∥!extracted;

such that a configuration register is clock gated other than when that configuration register is being configured or when that configuration register is being extracted (e.g., as discussed below).

### Input Buffer Clock Gating

In one embodiment, an (e.g., data) input buffer is clock gated when it is known that the input buffer will not be written in a given time period (e.g., cycle). For example, this may happen when the buffer (e.g., queue) is full, unused, or, in some cases, if no data is expected. The expectation of data may depend on physical distances in the network (e.g., circuit switched network), and use a configuration bit or bits to clock gate or otherwise disable the buffer. X in the following denotes the input buffer, and i denotes the particular slot in that input buffer. In another embodiment, less specific gating may be chosen to simplify implementation.

E.g., a state machine in clock gating circuitry may operating according to the following: Input_buffer_X_i_clock_enable=input_buffer_X_i_is_head && input_X_buffer_used∥(input_X_valid∥!enable_input_X_network_gating)
such that the input buffer is clock gated when the input buffer is full, unused, or if no input data is expected.

### Output Buffer Clock Gating

In one embodiment, an (e.g., data) output buffer is clock gated when it is known that the output buffer will not be used in a given time period (e.g., cycle). This may happen when the buffer is unused, the buffer slot is not the head of the buffer (e.g., queue), or the processing element will not execute in this cycle. Y denotes the output buffer, j denotes the particular slot of the buffer. In another embodiment, less specific gating may be chosen to simplify implementation. E.g., a state machine in clock gating circuitry may operating according to the following: Output_buffer_Y_j_clock_enable=output_buffer_Y_j_is_head && output_Y_buffer_used && PE_executes

such that the output buffer is clock gated when the buffer slot is not the head of the buffer (e.g., queue), or the processing element will not execute in this cycle

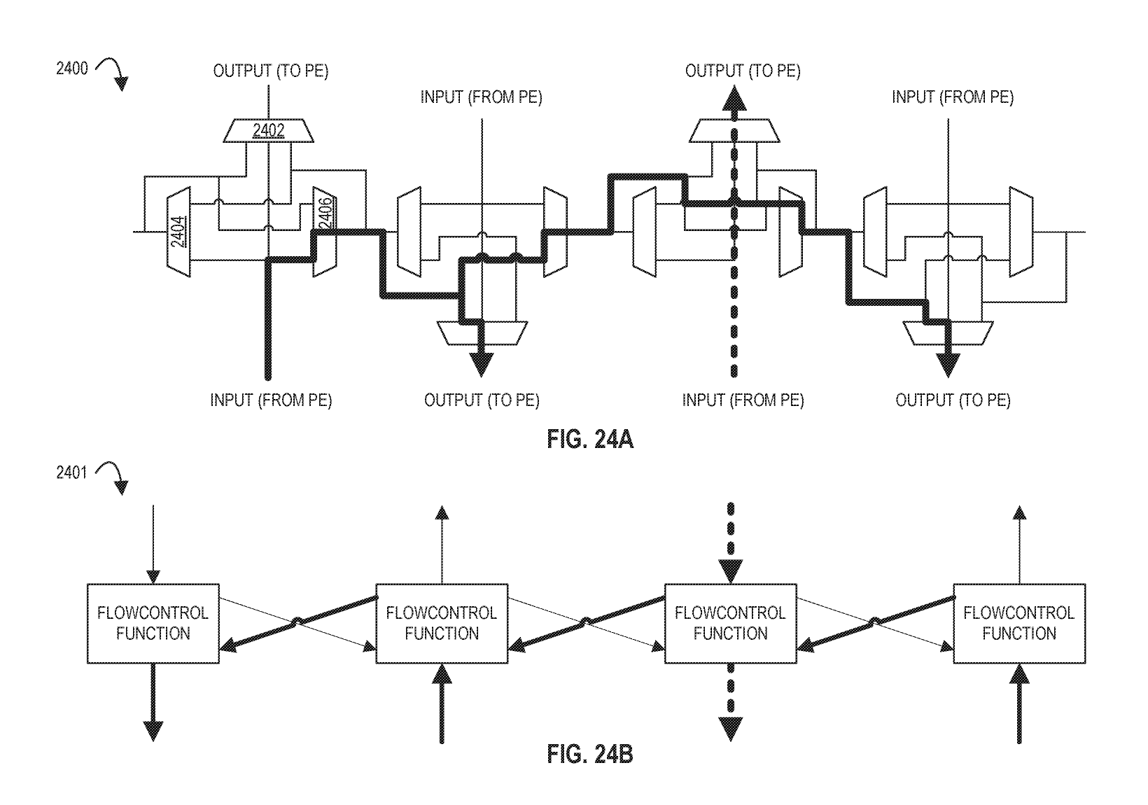

In one embodiment, operation configuration register 519 is loaded during configuration (e.g., mapping) and specifies the particular operation (or operations) this processing (e.g., compute) element is to perform and/or any clock gating that is to be performed. In one embodiment, operation configuration register 519 is clock gated (e.g., when the data therein is not be stored or loaded (e.g., extracted)). Register 520 activity may be controlled by that operation (an output of mux 516, e.g., controlled by the scheduler 514). Scheduler 514 may schedule an operation or operations of processing element 500, for example, when input data and control input arrives. Control input buffer 522 is connected to local network 502 (e.g., and local network 502 may include a data path network as in FIG. 24A and a flow control path network as in FIG. 24B) and is loaded with a value when it arrives (e.g., the network has a data bit(s) and valid bit(s)). Control output buffer 532, data output buffer 534, and/or data output buffer 536 may receive an output of processing element 500, e.g., as controlled by the operation (an output of mux 516). Status register 538 may be loaded whenever the ALU 518 executes (also controlled by output of mux 516). Data in control input buffer 522 and control output buffer 532 may be a single bit. Mux 521 (e.g., operand A) and mux 523 (e.g., operand B) may source inputs. Multiple parallel input buffers (e.g., data input buffer 524 and data input buffer 526) may be utilized. Multiple parallel output buffers (e.g., data output buffer 534 and data output buffer 536) may be utilized.

For example, suppose the operation of this processing (e.g., compute) element is (or includes) what is called a pick in FIG. 14B. The processing element 500 then is to select data from either data input buffer 524 or data input buffer 526, e.g., to go to data output buffer 534 (e.g., default) or data output buffer 536. The control bit in 522 may thus indicate a 0 if selecting from data input buffer 524 or a 1 if selecting from data input buffer 526.

For example, suppose the operation of this processing (e.g., compute) element is (or includes) what is called a switch in FIG. 14B. The processing element 500 is to output data to data output buffer 534 or data output buffer 536, e.g., from data input buffer 524 (e.g., default) or data input buffer 526. The control bit in 522 may thus indicate a 0 if outputting to data output buffer 534 or a 1 if outputting to data output buffer 536.

Multiple networks (e.g., interconnects) may be connected to a processing element, e.g., (input) networks 502, 504, 506 and (output) networks 508, 510, 512. The connections may be switches, e.g., as discussed in reference to FIGS. 24A and 24B. In one embodiment, each network includes two sub-networks (or two channels on the network), e.g., one for the data path network in FIG. 24A and one for the flow control (e.g., backpressure) path network in FIG. 24B. As one example, local network 502 (e.g., set up as a control interconnect) is depicted as being switched (e.g., connected) to control input buffer 522. In this embodiment, a data path (e.g., network as in FIG. 24A) may carry the control input value (e.g., bit or bits) (e.g., a control token) and the flow control path (e.g., network) may carry the backpressure signal (e.g., backpressure or no-backpressure token) from control input buffer 522, e.g., to indicate to the upstream producer (e.g., PE) that a new control input value is not to be loaded into (e.g., sent to) control input buffer 522 until the backpressure signal indicates there is room in the control input buffer 522 for the new control input value (e.g., from a control output buffer of the upstream producer). In one embodiment, the new control input value may not enter control input buffer 522 until both (i) the upstream producer receives the “space available” backpressure signal from “control input” buffer 522 and (ii) the new control input value is sent from the upstream producer, e.g., and this may stall the processing element 500 until that happens (and space in the target, output buffer(s) is available).

Data input buffer 524 and data input buffer 526 may perform similarly, e.g., local network 504 (e.g., set up as a data (as opposed to control) interconnect) is depicted as being switched (e.g., connected) to data input buffer 524. In this embodiment, a data path (e.g., network as in FIG. 24A) may carry the data input value (e.g., bit or bits) (e.g., a dataflow token) and the flow control path (e.g., network) may carry the backpressure signal (e.g., backpressure or no-backpressure token) from data input buffer 524, e.g., to indicate to the upstream producer (e.g., PE) that a new data input value is not to be loaded into (e.g., sent to) data input buffer 524 until the backpressure signal indicates there is room in the data input buffer 524 for the new data input value (e.g., from a data output buffer of the upstream producer). In one embodiment, the new data input value may not enter data input buffer 524 until both (i) the upstream producer receives the “space available” backpressure signal from “data input” buffer 524 and (ii) the new data input value is sent from the upstream producer, e.g., and this may stall the processing element 500 until that happens (and space in the target, output buffer(s) is available). A control output value and/or data output value may be stalled in their respective output buffers (e.g., 532, 534, 536) until a backpressure signal indicates there is available space in the input buffer for the downstream processing element(s).

A processing element 500 may be stalled from execution until its operands (e.g., a control input value and its corresponding data input value or values) are received and/or until there is room in the output buffer(s) of the processing element 500 for the data that is to be produced by the execution of the operation on those operands. Clock gating circuit 515 may stall one or more of the clocked components during the stall of execution.

FIG. 6 illustrates a processing element 600 according to embodiments of the disclosure. In one embodiment, operation configuration register 619 is loaded during configuration (e.g., mapping) and specifies the particular operation (or operations) this processing (e.g., compute) element is to perform. Register 620 activity may be controlled by that operation (an output of mux 616, e.g., controlled by the scheduler 614). Scheduler 614 may schedule an operation or operations of processing element 600, for example, when input data and control input arrives. Control input buffer 622 is connected to local network 602 (e.g., and local network 602 may include a data path network as in FIG. 24A and a flow control path network as in FIG. 24B) and is loaded with a value when it arrives (e.g., the network has a data bit(s) and valid bit(s)). Control output buffer 632, data output buffer 634, and/or data output buffer 636 may receive an output of processing element 600, e.g., as controlled by the operation (an output of mux 616). Status register 638 may be loaded whenever the ALU 618 executes (also controlled by output of mux 616). Data in control input buffer 622 and control output buffer 632 may be a single bit. Mux 621 (e.g., operand A) and mux 623 (e.g., operand B) may source inputs.

For example, suppose the operation of this processing (e.g., compute) element is (or includes) what is called a pick in FIG. 14B. The processing element 600 then is to select data from either data input buffer 624 or data input buffer 626, e.g., to go to data output buffer 634 (e.g., default) or data output buffer 636. The control bit in 622 may thus indicate a 0 if selecting from data input buffer 624 or a 1 if selecting from data input buffer 626.

For example, suppose the operation of this processing (e.g., compute) element is (or includes) what is called a switch in FIG. 14B. The processing element 600 is to output data to data output buffer 634 or data output buffer 636, e.g., from data input buffer 624 (e.g., default) or data input buffer 626. The control bit in 622 may thus indicate a 0 if outputting to data output buffer 634 or a 1 if outputting to data output buffer 636.

Multiple networks (e.g., interconnects) may be connected to a processing element, e.g., (input) networks 602, 604, 606 and (output) networks 608, 610, 612. The connections may be switches, e.g., as discussed in reference to FIGS. 24A and 24B. In one embodiment, each network includes two sub-networks (or two channels on the network), e.g., one for the data path network in FIG. 24A and one for the flow control (e.g., backpressure) path network in FIG. 24B. As one example, local network 602 (e.g., set up as a control interconnect) is depicted as being switched (e.g., connected) to control input buffer 622. In this embodiment, a data path (e.g., network as in FIG. 24A) may carry the control input value (e.g., bit or bits) (e.g., a control token) and the flow control path (e.g., network) may carry the backpressure signal (e.g., backpressure or no-backpressure token) from control input buffer 622, e.g., to indicate to the upstream producer (e.g., PE) that a new control input value is not to be loaded into (e.g., sent to) control input buffer 622 until the backpressure signal indicates there is room in the control input buffer 622 for the new control input value (e.g., from a control output buffer of the upstream producer). In one embodiment, the new control input value may not enter control input buffer 622 until both (i) the upstream producer receives the “space available” backpressure signal from “control input” buffer 622 and (ii) the new control input value is sent from the upstream producer, e.g., and this may stall the processing element 600 until that happens (and space in the target, output buffer(s) is available).

Data input buffer 624 and data input buffer 626 may perform similarly, e.g., local network 604 (e.g., set up as a data (as opposed to control) interconnect) is depicted as being switched (e.g., connected) to data input buffer 624. In this embodiment, a data path (e.g., network as in FIG. 24A) may carry the data input value (e.g., bit or bits) (e.g., a dataflow token) and the flow control path (e.g., network) may carry the backpressure signal (e.g., backpressure or no-backpressure token) from data input buffer 624, e.g., to indicate to the upstream producer (e.g., PE) that a new data input value is not to be loaded into (e.g., sent to) data input buffer 624 until the backpressure signal indicates there is room in the data input buffer 624 for the new data input value (e.g., from a data output buffer of the upstream producer). In one embodiment, the new data input value may not enter data input buffer 624 until both (i) the upstream producer receives the “space available” backpressure signal from “data input” buffer 624 and (ii) the new data input value is sent from the upstream producer, e.g., and this may stall the processing element 600 until that happens (and space in the target, output buffer(s) is available). A control output value and/or data output value may be stalled in their respective output buffers (e.g., 632, 634, 636) until a backpressure signal indicates there is available space in the input buffer for the downstream processing element(s).

A processing element 600 may be stalled from execution until its operands (e.g., a control input value and its corresponding data input value or values) are received and/or until there is room in the output buffer(s) of the processing element 600 for the data that is to be produced by the execution of the operation on those operands.

Certain embodiments herein allow for dynamic clock gating based on the dataflow graph to be executed.

Referring to FIGS. 3-6 together, certain embodiments herein allow for clock gating based on the distance between a producer PE and its consuming PE or PEs. In FIG. 3, processing element 304 may produce an output (e.g., stored in output buffer 308), and that may be coupled to inputs or one or more of processing element 324 (e.g., the output data to initially be stored in its input buffer, e.g., and then consumed by PE 324) and processing element 334 (e.g., the output data to initially be stored in its input buffer, e.g., and then consumed by PE 324). In one embodiment, one or more of (input) networks 502, 504, 506 are coupled to one or more of (output) networks 508, 510, 512, e.g., to send data and/or reenable signals from an output to an input.

In one embodiment, all (for example, data, e.g., but not control) input and output PE buffers are clock gated until something is valid to receive or send. In one embodiment, data (for example, a reenable control signal) from PE 304 may make it to PE 324 in a given time (e.g., within a clock signal) to trigger a circuit (e.g., clock gating circuit 415 in FIG. 4 or clock gating circuit 515 in FIG. 5) to reenable a clock gated component (e.g., input buffer) to then received transmitted data, and, for example, where the distance from PE 304 to PE 334 is too long to capture the valid signal and reenable the clock gated buffers (e.g., their clocks) (e.g., where PE 304 and PE 324 are adjacent to each other). For example, a sending and/or receiving PE may include one or more (e.g., all) of the components in FIG. 4 or FIG. 5. In one embodiment, a sending PE includes one or more (e.g., all) of the components of FIG. 4, 5, or 6. In one embodiment, PE 324 is PE 500 from FIG. 5, and the configuration received by clock gating circuit 515 causes the data input buffer or buffers (524, 526) to be clock gated until a reenable control signal is received in control input buffer 522 from PE 304. In one embodiment, PE 304 is as in FIG. 5 or 6, and the PE 304 is to send output data (e.g., from one or more of data output buffers (534, 536) in FIG. 5 or from one or more of data output buffers (634, 636) in FIG. 6) (e.g., the data being sent on a circuit-switched interconnect network that is currently coupling PE 304 and PE 324) concurrently with a reenable signal (e.g., from control output buffer 532 in FIG. 5 or from control output buffer 632 in FIG. 6), e.g., the data and the corresponding reenable signal sent from PE 304 and received (and latched) into PE 324 in the same time period (e.g., a same clock cycle) (e.g., single clock cycle or single subset of a clock cycle). In one embodiment, all of the input buffers (e.g., data input buffer or buffers (524, 526)) are reenabled or otherwise turned on via receipt of the reenable signal by clock gating circuit 515. In one embodiment, a bit or bits (e.g., in configuration register 519 and/or clock gating circuit 515), of configuration are set in a sending PE to cause that PE to (e.g., simultaneously) send the (e.g., payload) data and the corresponding reenable signal to a receiving PE. In one embodiment, a bit or bits (e.g., in configuration register 519 and/or clock gating circuit 515) of configuration are set in a receiving PE to cause that PE to switch the indicated components (e.g., all data input buffers) from being clock gated to reenabled (e.g., to receive the data) when the reenable signal is received in the control input buffer 522. In one embodiment, the receiving PE is clock gated (e.g., the indicated components (e.g., input buffer) are clock gated) previously, e.g., by the sending PE instead sending a clocking mode value (e.g., zero) to the control input buffer of the receiving PE. In one embodiment, the configuration of the PEs to send and receive in this clock gating mode are set during the same configuration process. In certain embodiments, configuration bits are sent (e.g., by a configuration controller) to the PEs to allow the programmer to enable clock gating for PE 324 using the incoming reenable (e.g., valid) bit, but not for PE 334. In one embodiment, receiving PE 334 has a (e.g., the shortest) distance on the interconnect network that is greater than a threshold distance between PE 304 of PE 334, e.g., a threshold distance to communicate (e.g., send data from PE 304 and receive it within PE 334) within a same time period (e.g., a same clock cycle). In one embodiment, e.g., based on exceeding that threshold distance, configuration bit or bits are sent to PE 334 to disable the clock gating functions (e.g., disable clock gating circuit in that PE). This may allow the programmer to enable clock gating in a fine grain way. In one embodiment, a PE defaults to disabling the clock gating functions (e.g., disabling the clock gating circuit in that PE). In certain embodiments, the distances between PEs that are to be coupled together (e.g., as producer and consumer) are re-evaluated for every new dataflow graph based on the placement and routing, e.g., saving clocking power. In one embodiment, a receiving PE uses the reenable signal (e.g., bit set to high or low) to start up the clocks to capture the incoming data. In another embodiment, knowledge of a prior execution of a same dataflow graph is used to determine which components may be clock gated (e.g., owing to not updating or using those components in that cycle) for another execution of that dataflow graph. Different clock gating (e.g., different in a cycle) may be used on the input and the output buffers of a PE.

A spatial array (e.g., CSA) (e.g., a PE of a spatial array), processor, or system may include any of the disclosure herein, for example, one or more PEs according to any of the architecture disclosed herein.

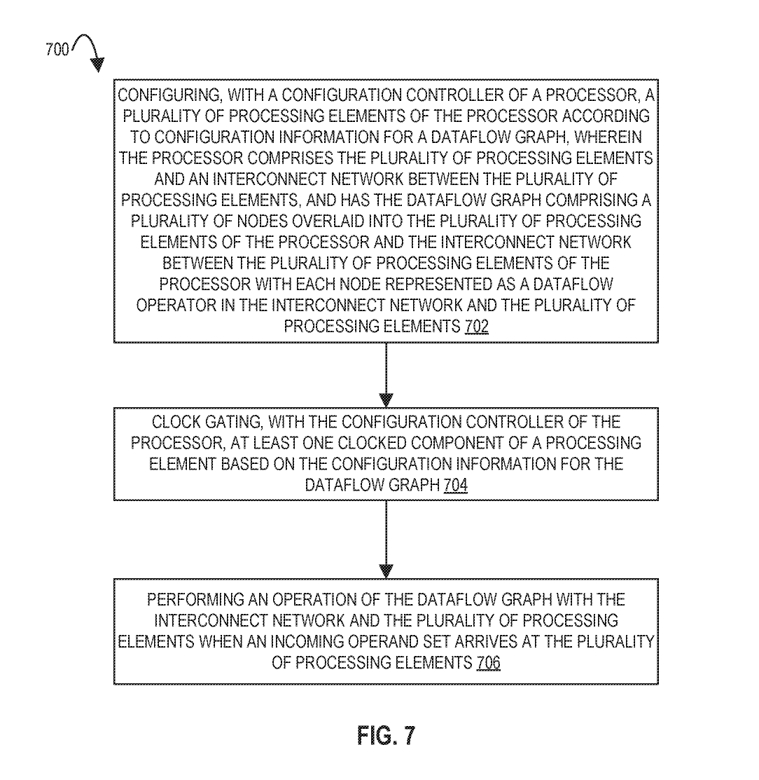

FIG. 7 illustrates a flow diagram 700 according to embodiments of the disclosure. Depicted flow 700 includes configuring, with a configuration controller of a processor, a plurality of processing elements of the processor according to configuration information for a dataflow graph, wherein the processor comprises the plurality of processing elements and an interconnect network between the plurality of processing elements, and has the dataflow graph comprising a plurality of nodes overlaid into the plurality of processing elements of the processor and the interconnect network between the plurality of processing elements of the processor with each node represented as a dataflow operator in the interconnect network and the plurality of processing elements 702; clock gating, with the configuration controller of the processor, at least one clocked component of a processing element based on the configuration information for the dataflow graph 704; and performing an operation of the dataflow graph with the interconnect network and the plurality of processing elements when an incoming operand set arrives at the plurality of processing elements 706.

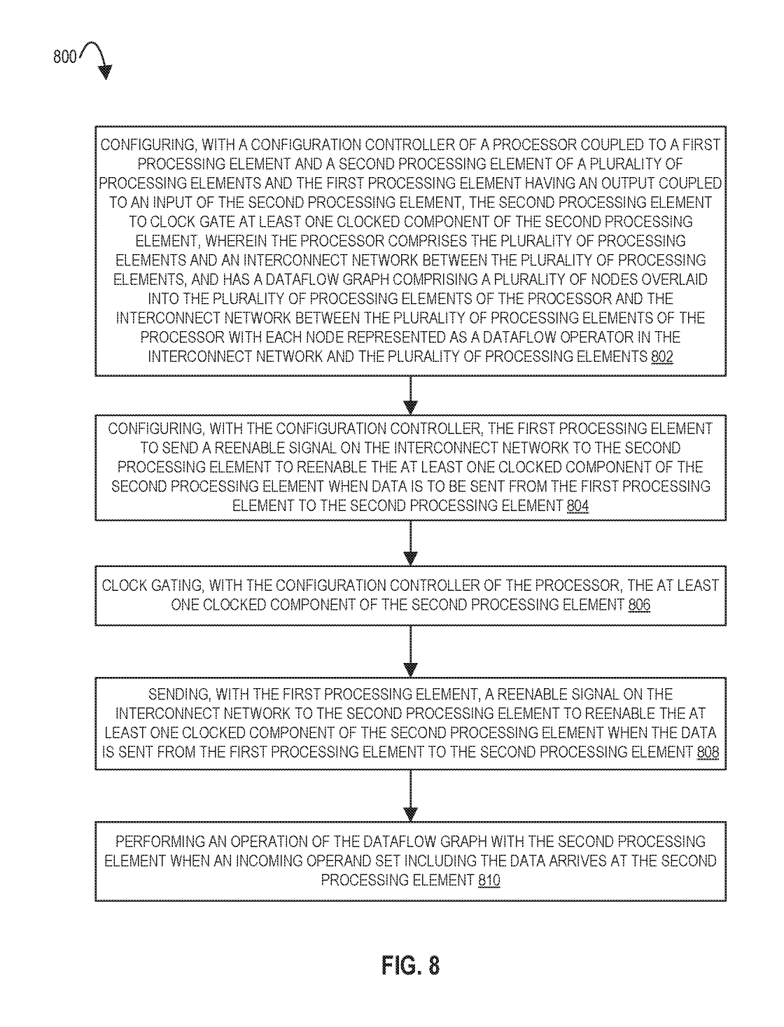

FIG. 8 illustrates a flow diagram 800 according to embodiments of the disclosure. Depicted flow 800 includes configuring, with a configuration controller of a processor coupled to a first processing element and a second processing element of a plurality of processing elements and the first processing element having an output coupled to an input of the second processing element, the second processing element to clock gate at least one clocked component of the second processing element, wherein the processor comprises the plurality of processing elements and an interconnect network between the plurality of processing elements, and has a dataflow graph comprising a plurality of nodes overlaid into the plurality of processing elements of the processor and the interconnect network between the plurality of processing elements of the processor with each node represented as a dataflow operator in the interconnect network and the plurality of processing elements 802; configuring, with the configuration controller, the first processing element to send a reenable signal on the interconnect network to the second processing element to reenable the at least one clocked component of the second processing element when data is to be sent from the first processing element to the second processing element 804; clock gating, with the configuration controller of the processor, the at least one clocked component of the second processing element 806; sending, with the first processing element, a reenable signal on the interconnect network to the second processing element to reenable the at least one clocked component of the second processing element when the data is sent from the first processing element to the second processing element 808; and performing an operation of the dataflow graph with the second processing element when an incoming operand set including the data arrives at the second processing element 810.

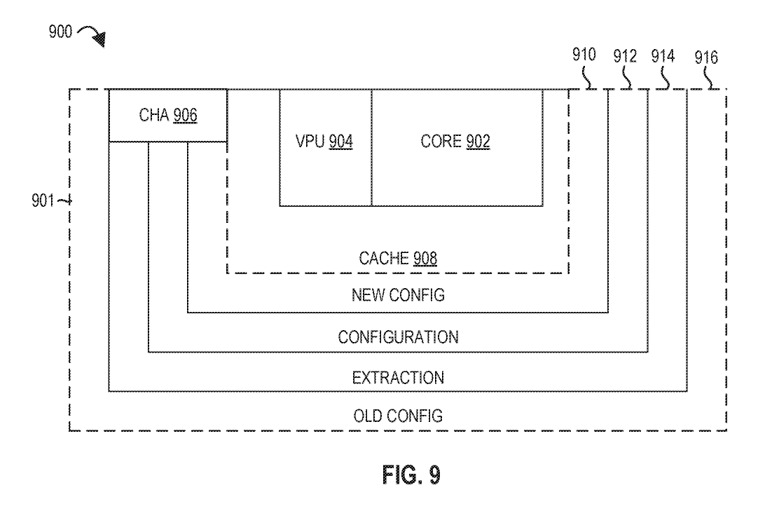

FIG. 9 illustrates a context switch in a spatial array 901 of processing elements of a processor 900 according to embodiments of the disclosure. Spatial array 901 is depicted as being an accelerator coupled to processor core 902 and/or vector processing unit (VPU) 904, for example, for the accelerator to perform tasks instead of the core and/or VPU. Depicted processor 900 includes a cache home agent 906, for example, to serve as the local coherence and cache controller (e.g., caching agent) and/or also serves as the global coherence and memory controller interface (e.g., home agent).

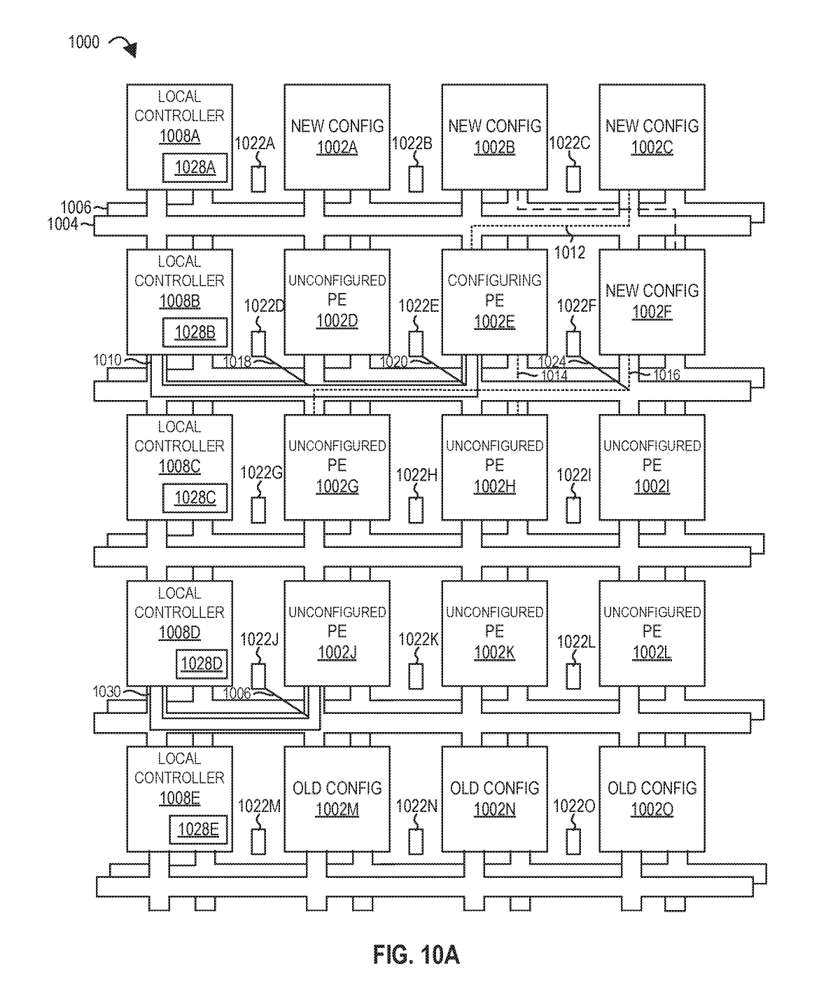

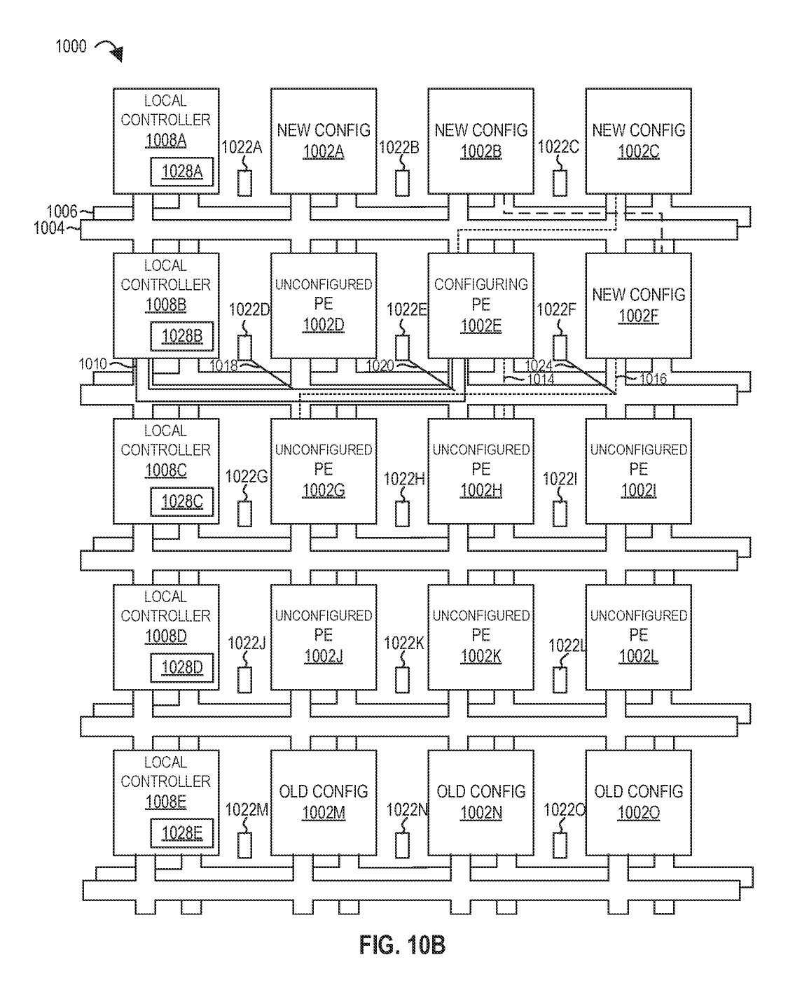

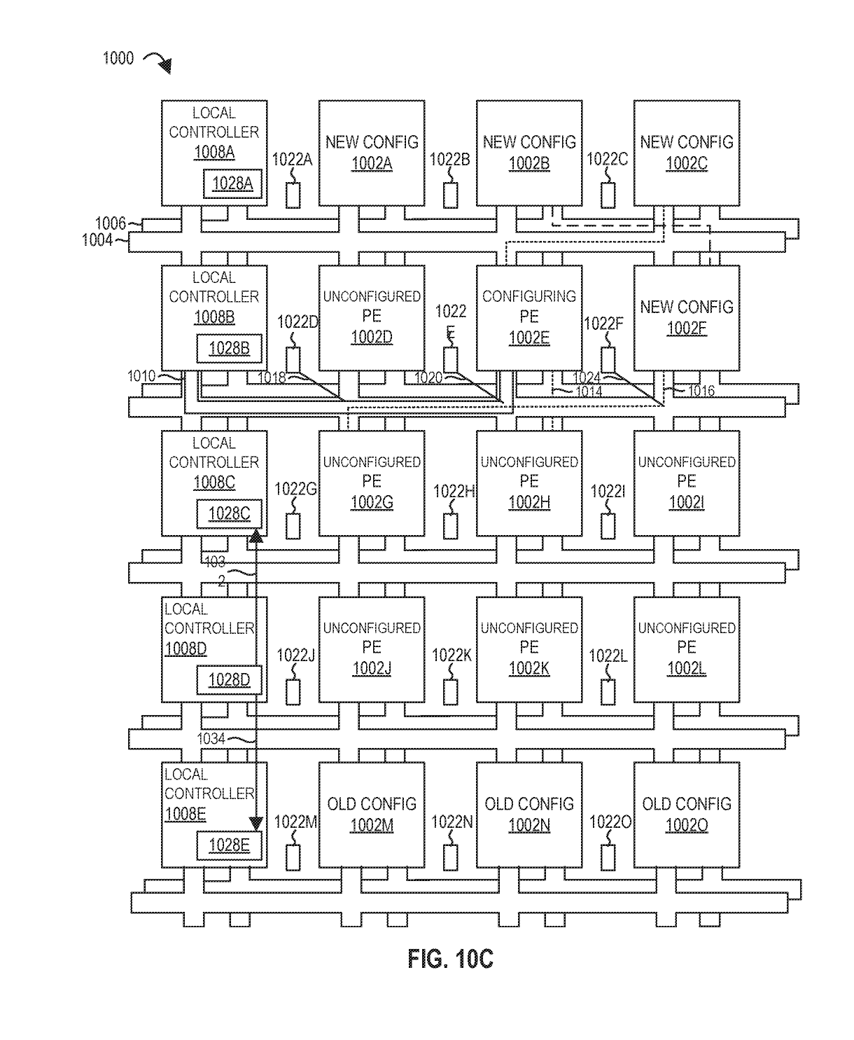

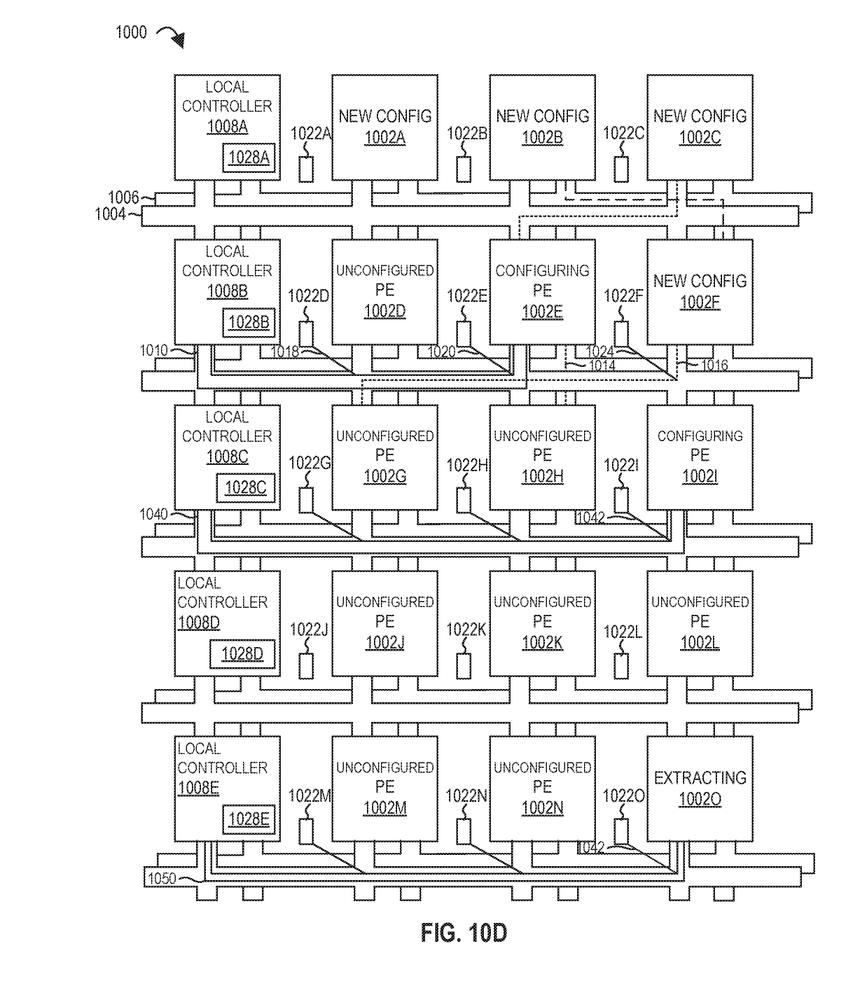

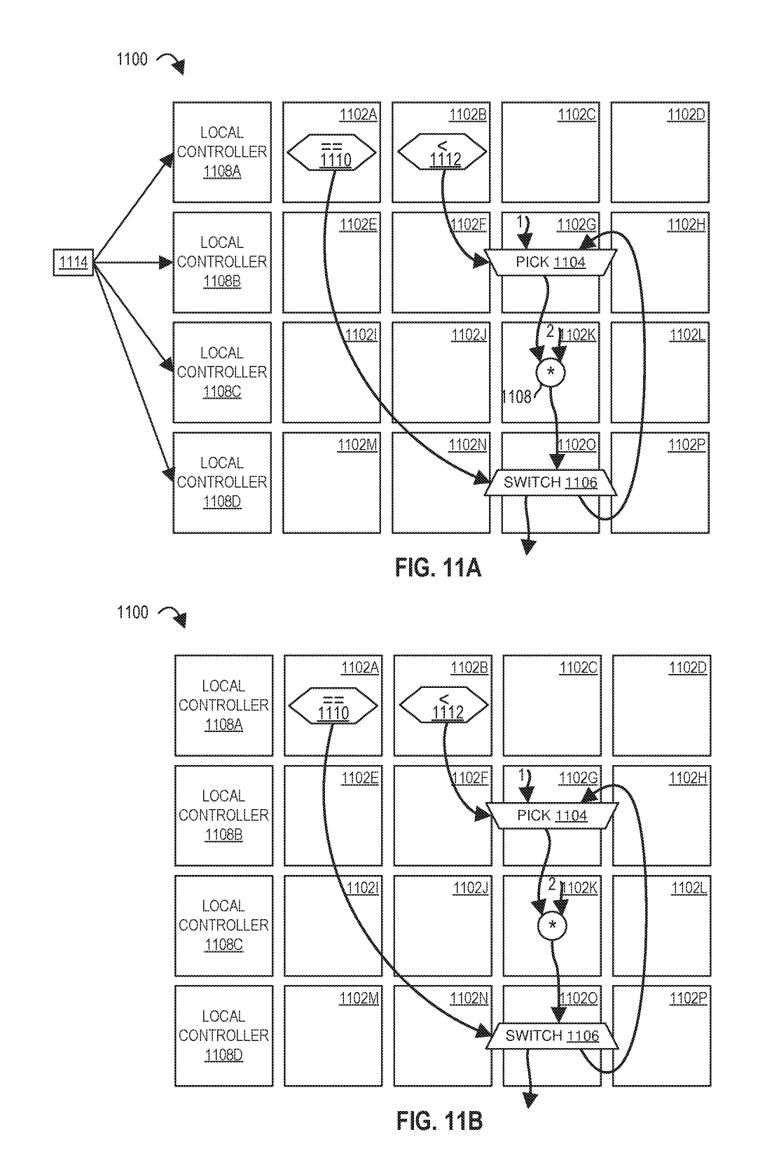

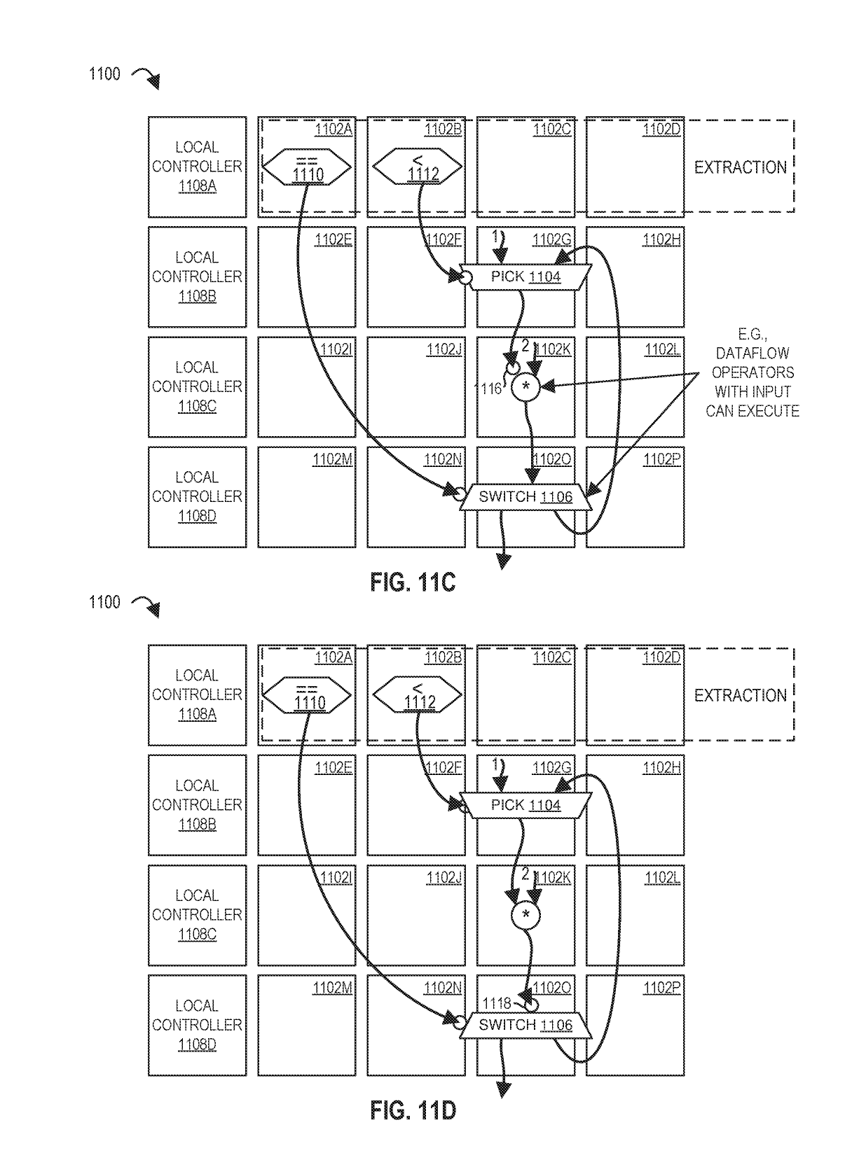

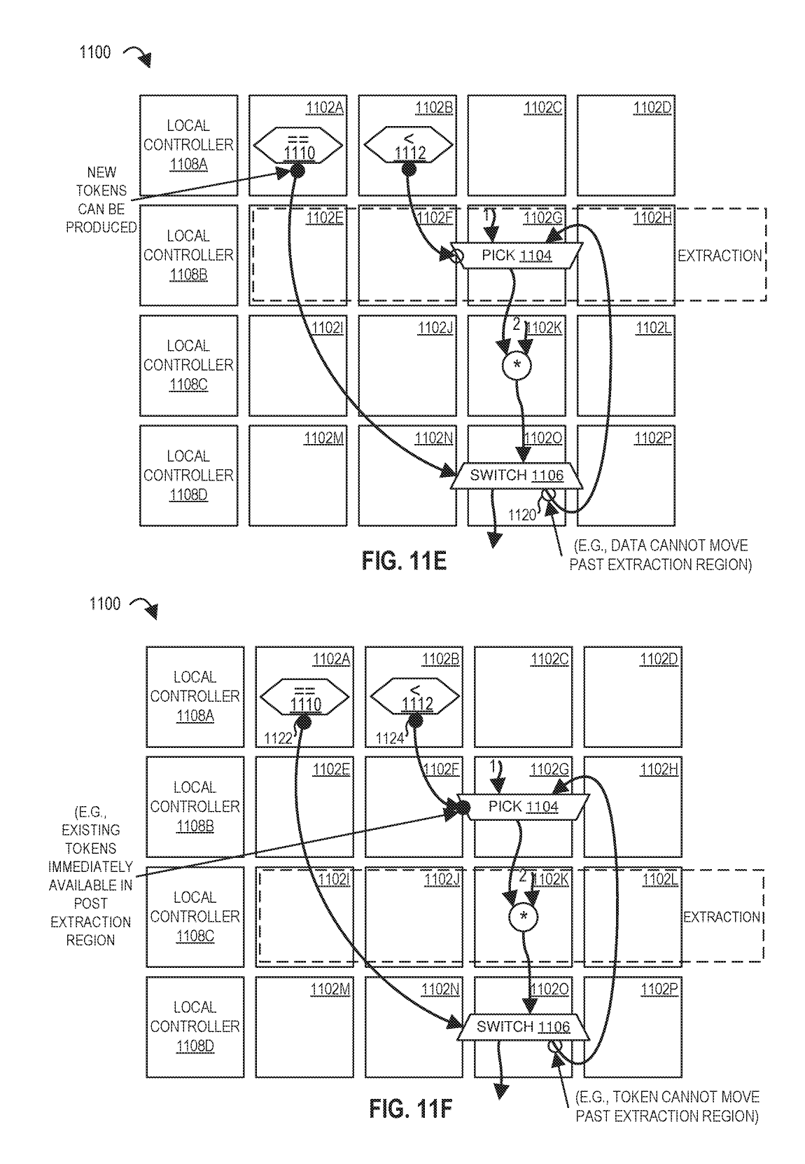

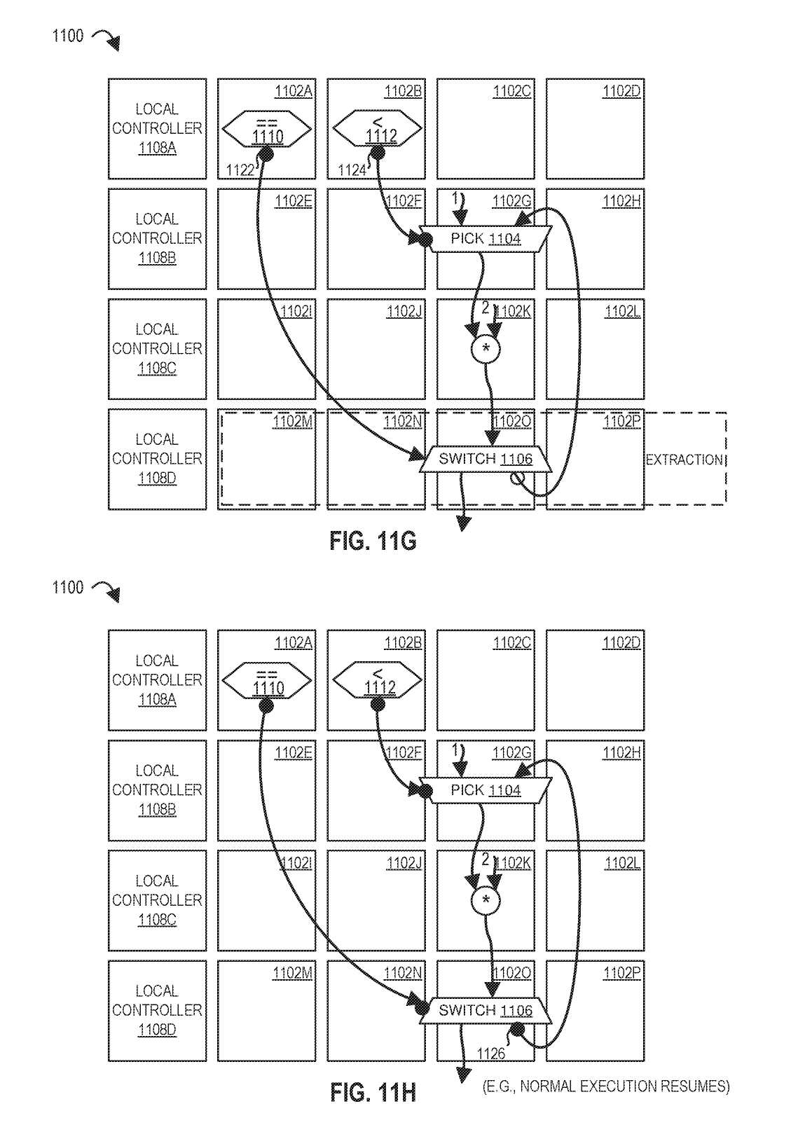

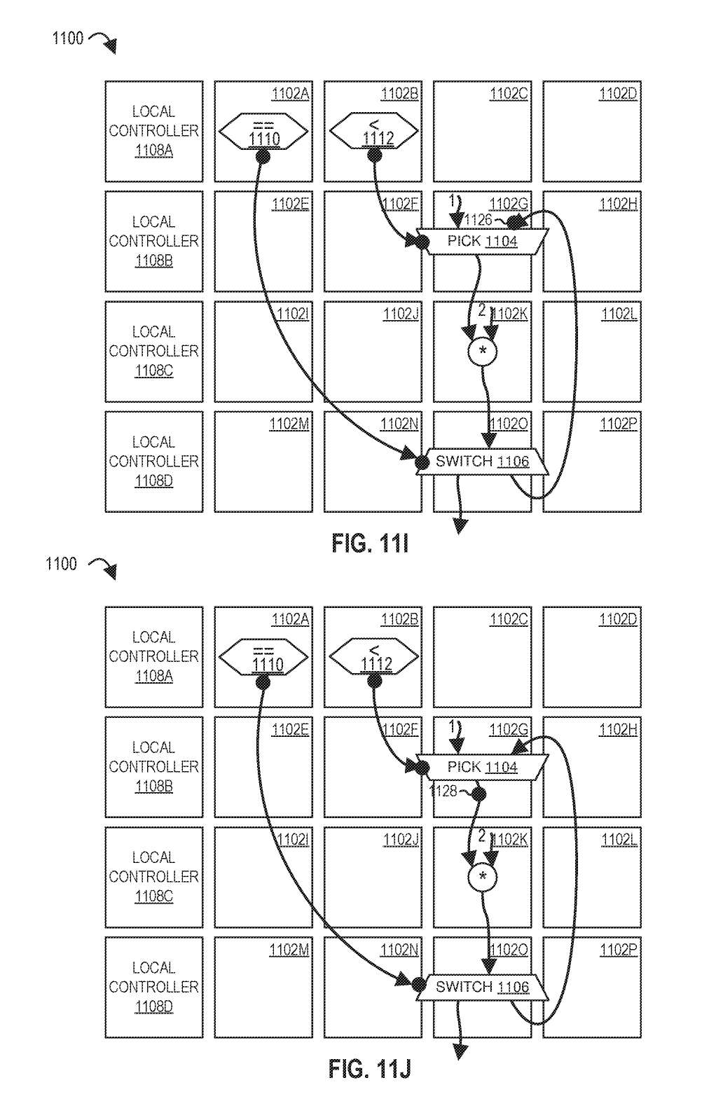

Spatial array 901 may be any of the spatial arrays discussed herein, e.g., in FIGS. 10A-10D or FIGS. 11A-11J. Particularly, FIG. 9 provides a conceptual view of a context switch in a spatial array. A (e.g., centralized) control orchestrates a wave front radiating out, e.g., from the cache (e.g. L2 cache 908). The new configuration 910 region and old configuration 916 region may be simultaneously active, e.g., processing data. FIG. 9 illustrates the idea that through coordination of the spatial array 901 (e.g., fabric), the spatial array may achieve pipelined, wave front oriented runtime services. In FIG. 9, a coordinated implementation of a context switch is shown. Here, an extraction 914 region (e.g., that is saving the state of a first spatial context) is active simultaneously with a configuration 912 region (e.g., the loading of a second (new or prior), different context into the spatial array). In this embodiment, both the new and old configuration may be simultaneously active, e.g., to limit the degradation of the spatial array throughput caused by runtime operations. In one embodiment in order to achieve pipelined configuration and extraction, the main property to guarantee is that the new configuration 912 (e.g., configuring region) and the old extraction 914 (e.g., extracting region) do not communicate. To achieve this guarantee, certain embodiments herein leverage the architectural property of a spatial array in regards to communication, for example, PEs following a full/empty (e.g., backpressure) micro-protocol that can be manipulated in the micro architecture to prevent communications. An example of this mechanism is shown in FIGS. 10A-10D. Certain embodiments herein provide for a coordination mechanism (e.g., controller) of the spatial array to ensure that the new and old regions do not communicate, e.g., to ensure program correctness.

FIGS. 10A-10D illustrate an in-flight configuration for a context switch (e.g., configuration and extraction) of a spatial array 1000 of processing elements (1002A-1002O) according to embodiments of the disclosure. In one embodiment, spatial array is an accelerator of a processor (e.g., with a core). Once configured, PEs may execute subject to dataflow constraints. However, channels involving unconfigured PEs may be disabled by the microarchitecture, e.g., preventing any undefined operations from occurring. These properties allow embodiments herein to initialize and execute in a distributed fashion, e.g., with no centralized execution control whatsoever. From an unconfigured state, configuration may occur completely in parallel, e.g., in perhaps as few as 200 nanoseconds. However, due to the distributed initialization of embodiments of a spatial array (e.g., CSA), PEs may become active, for example, sending requests to memory, e.g., well before the entire fabric is configured. Extraction may proceed in much the same way as configuration. The local network (e.g., 1004 or 1006) may be conformed (e.g., circuits thereof switched) to extract data from one target at a time, and state bits used to achieve distributed coordination. A spatial array (e.g., CSA) may orchestrate extraction to be nondestructive, that is, at the completion of extraction, each extractable target has returned to its starting state. In this implementation, all state in the target may be circulated to an egress register tied to the local network in a scan-like fashion. Although in-place extraction may be achieved by introducing new paths at the register-transfer level (RTL), or using existing lines to provide the same functionalities with lower overhead. Like configuration, hierarchical extraction is achieved in parallel.

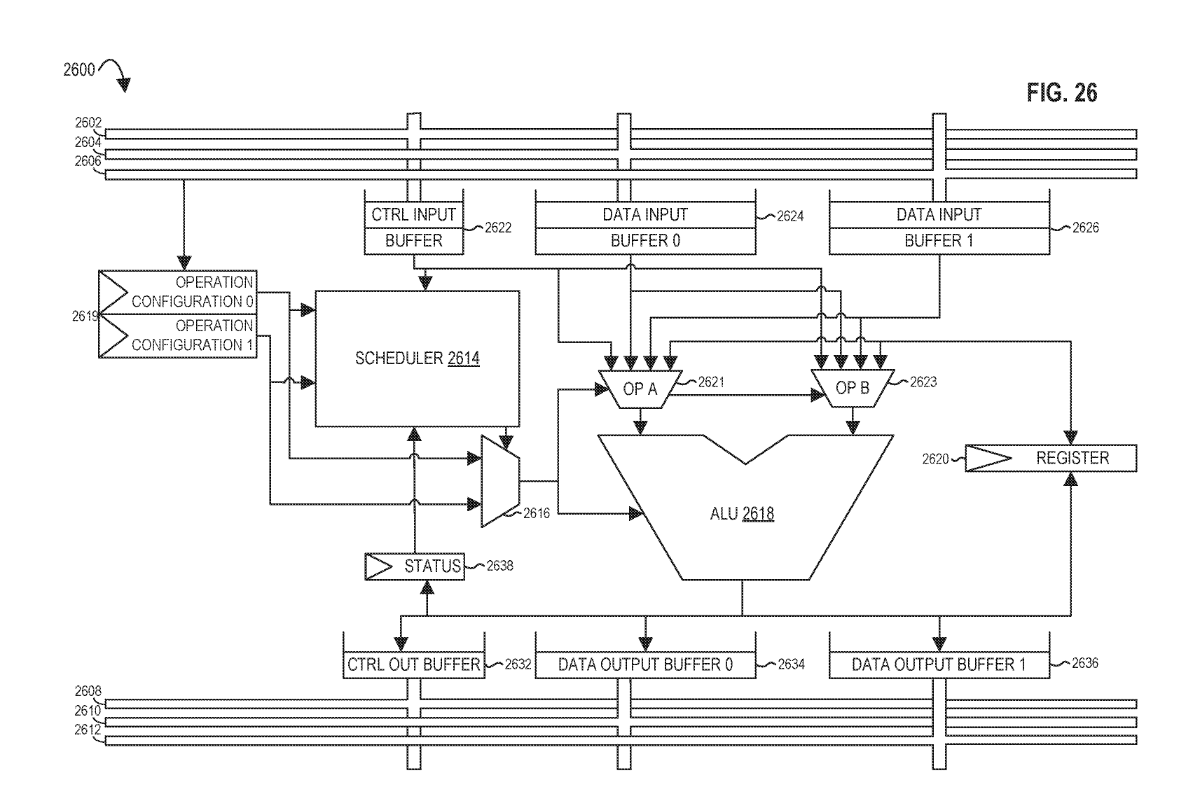

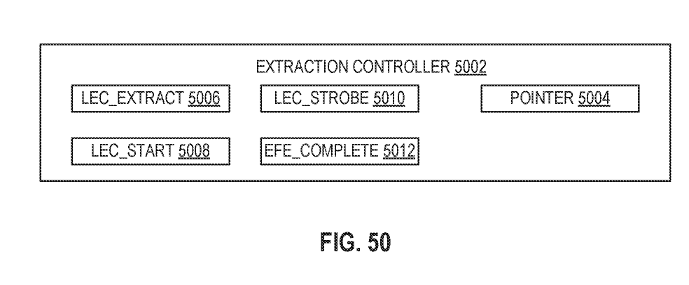

In FIG. 10A, a plurality of local (e.g., configuration) controllers (1008A-1008E) are included, e.g., connected to the network (e.g., local network 1004 or 1006). In one embodiment, a local (e.g., configuration) controller is to control configuration and/or extraction. A local controller may be further controlled by a higher-level controller, e.g., controller 104 in FIG. 1. A (e.g., configuration) controller may manage the configuration and/or extraction of a subset of processing elements. Local (e.g., configuration) controller 1008A may manage (e.g., cause) the configuration and/or extraction of a processing elements 1002A-1002C. Local (e.g., configuration) controller 1008B may manage (e.g., cause) the configuration and/or extraction of a processing elements 1002D-1002O. Local (e.g., configuration) controller 1008C may manage (e.g., cause) the configuration and/or extraction of a processing elements 1002G-1002I. Local (e.g., configuration) controller 1008D may manage (e.g., cause) the configuration and/or extraction of a processing elements 1002J-1002L. Local (e.g., configuration) controller 1008E may manage (e.g., cause) the configuration and/or extraction of a processing elements 1002M-1002O. Although each subset of managed processing elements (e.g., 1002A-1002C) are shown on a same row as its local (e.g., configuration) controller (e.g., 1008A), other orientations are possible. Although three processing elements (e.g., 1002A-1002C) are shown as having a single, local (e.g., configuration) controller (e.g., 1008A), a (e.g., local) controller may be utilized for one processing element or any plurality of processing elements. A processing element may be as disclosed herein, for example, in FIG. 26. A processing element may be configured, e.g., by writing to a configuration register. A local (e.g., configuration) controller may be a configuration controller (e.g., as in FIG. 41) and/or an extraction controller (e.g., as in FIG. 50). A processing element's state (e.g., configuration information) may include the data in any (input or output) queues or buffers, backpressure data (e.g., signals), operation configuration and/or any other data. State may include information stored in any register(s) of the processing element. State may include where (e.g., from one or more PEs or memory) to source (input) data from for a PE and where to send (output) data to, e.g., which PE or PEs or memory. State may include the (e.g., switch settings) for a data path network and/or a flow control (e.g., backpressure) path network, see. e.g., FIGS. 24A-24B. State may include data related to memory accesses, e.g., including addresses and returned data.

In the depicted embodiment, each processing element may be in the indicated status, e.g., already configured with a particular configuration, actively configuring (e.g., loading and enabling a configuration to execute), unconfigured, actively unconfiguring, or extracting a configuration (e.g., state). A configuration in a spatial array (e.g., processing element(s)) may be for a same dataflow graph, for example, with one or more processing elements not reconfigured. For example, the one or more processing elements may perform a same operation but with different input source(s) and/or output destination(s), e.g., values, for each configuration. A configuration may be for a different dataflow graph, e.g., with one or more processing elements reconfigured to perform a different operation. A configuration may be where (e.g., a subset of) processing elements are configured (e.g., programmed) such that each node of a dataflow graph is represented in a spatial array (e.g., with the processing elements as dataflow operators).

In FIG. 10A, local controller 1008A may have previously received a command (e.g., from a higher-level controller) to apply a new configuration to the subset of processing elements (1002A-1002C) it is coupled to, and which is already fully applied (e.g., loaded) in FIG. 10A. Local controller 1008B may have received a command (e.g., from a higher-level controller) to apply a new configuration to the subset of processing elements (1002D-1002F) it is coupled to. In FIG. 10A, processing element 1002D is unconfigured, processing element 1002E is being actively configured (e.g., with new configuration), and processing element 1002F is already configured with the new configuration. Local controller 1008B may send configuration information (e.g., data) 1010 (e.g., including the state, etc.) to processing element 1002E to cause the configuration of processing element 1002E accordingly. Line 1020 schematically illustrates configuration control sent from the configuration storage 1022E to network (e.g., 1004 and/or 1006) to achieve the desired configuration data path(s). Configuration control signal data on line 1020 may come from local controller 1008B.

Configuration storage (1022A-10220) schematically illustrates the configuration and extraction control data (signals) (e.g., in contrast to the configuration and extraction data payload itself) that sets the circuit-switches in the network. In one embodiment, a configuration storage is a register in a local (e.g., configuration and/or extraction) controller. Lines (1018, 1020, 1024) schematically illustrate configuration control sent from the configuration storage (1022D-1022F) to network (e.g., 1004 and/or 1006) to achieve the desired configuration data path(s). The line from processing element 1002B to processing element 1002F may represent an active channel in the network (1004 and/or 1006) that is set (e.g., a circuit switched network's switches set to allow that data path) to couple an output (e.g., a buffer thereof) of processing element 1002B to an input of processing element 1002F (e.g., a buffer thereof). This channel may be set according to the new configuration. Dotted lines (1012, 1014, 1016) may indicate inactive channels of the network, e.g., to be active when both the input and output processing element(s) are configured accordingly.

Local (e.g., configuration) controller 1008D is depicted as sending and/or receiving un-configuration (e.g., extraction) data 1030 (e.g., including the state, etc.) with processing element 1002J to cause the un-configuration (e.g., extraction of state) of processing element 1002J accordingly. Line 1026 schematically illustrates un-configuration (e.g., extraction) control sent from the configuration (e.g., un-configuration) storage 1022J to network (e.g., 1004 and/or 1006) to achieve the desired un-configuration data path(s). Un-configuration (e.g., extraction) control signal data on line 1026 may come from local controller 1008D.

Local controllers (1008A-1008E) may each include storage 1028A-1028E (e.g., register(s)) to store information that describes the coordination between the local controllers, e.g., what operation (e.g., active with new config, active with old config, unconfigured, unconfiguring (extracting), or configuring) that each controller is doing.

Turning to FIG. 10B, processing element 1002J that was unconfiguring in FIG. 10A is now unconfigured, for example, the state data for that context is now saved, e.g., in any storage discussed herein. Processing element 1002J is then unconfigured, e.g., it can assert backpressure to any upstream processing elements, etc. to not allow data to be input into processing element 1002J. In one embodiment, when the state data is saved for processing element 1002J (e.g., as managed by the local controller 1008D), the path for sending and/or receiving un-configuration (e.g., extraction) data 1030 in FIG. 10A may be disabled, for example, by clearing the data in configuration (e.g., un-configuration) storage 1022J.

Turning to FIG. 10C, upon completion of the unconfiguring (e.g., un-configuration operation) of processing element 100J (and processing element 1002K and processing element 1002L), local controller 1009D may send (completion) messages (1032, 1034) to adjacent controllers (1008C and 1008E, respectively). In one embodiment such a message (e.g., completion of extraction), may cause one or more of the adjacent sets of processing elements to being their next operations.

Turning now to FIG. 10D, receipt of completion (e.g., un-configuration) message 1032 by local controller 1008C, may trigger local controller 1008C to begin its next operation, e.g., indicated in FIG. 10D as being configuration of processing element 1002I, e.g., with configuration information (e.g., data) 1040 (e.g., including the state, etc.) sent along path (e.g., in network 1004 and/or 1006) to processing element 1002I to cause the configuration of processing element 1002I (e.g., and processing element 1002G and processing element 1002H) accordingly. In one embodiment, configuration (e.g., extraction) control is sent from the configuration storage (1022G-1022I) to network (e.g., 1004 and/or 1006) to achieve the desired configuration data path. Configuration control signal 1042 data may come from local controller 1008C.

Additionally or alternatively, receipt of completion (e.g., un-configuration) message 1034 by local controller 1008E, may trigger local controller 1008E to begin its next operation, e.g., indicated in FIG. 10D as being the start of the un-configuration (e.g., extraction) of processing element 1002O, e.g., with un-configuration (e.g., extraction) data 1050 (e.g., including the state, etc.) sent and/or received along path (e.g., in network 1004 and/or 1006) with processing element 1002O to cause the un-configuration (e.g., extraction) of processing element 1002O (e.g., and processing element 1002M and processing element 1002N) accordingly. In one embodiment, un-configuration (e.g., extraction) control is sent from the configuration (e.g., un-configuration) storage 10220 to network (e.g., 1004 and/or 1006) to achieve the desired un-configuration data path(s). Un-configuration (e.g., extraction) control signal 1052 data may come from local controller 1008D. Note that the term old as used in reference to these figures may refer to an existing configuration. Note that the term new as used in reference to these figures may refer to a previous configuration, but that is replacing the configuration that is currently in a PE or that is configured into an un-configured PE.

In one embodiment, a network (e.g., a circuit-switched network) includes multiple channels (e.g., as shown in FIGS. 10A-10D). Channel semantics (e.g., the dotted and sold lines overlaid into the network in FIGS. 10A-10D) may enable a natural activation of a pipeline, e.g., where unconfigured PEs clamp control values and/or as PEs are configured they begin to compute. A spatial array may thus become active in very few cycles, for example, in about 10 s of nanoseconds (e.g., in contrast to the cycle-level semantics of a FPGA where backpressure is not implicit and entire design (FPGA) must be configured, as an analogue of ‘coming out of reset’).

Although the above discussion of FIGS. 10A-10D is in reference to a plurality of local controllers, in another embodiment, a single (e.g., configuration) controller may achieve the above.

FIGS. 10A-10D further illustrate a communications microprotocol during extraction, e.g., via the manipulation of full/empty (e.g., backpressure) bits in the communications microprotocol to prevent data flow at a fine grain during runtime service events.

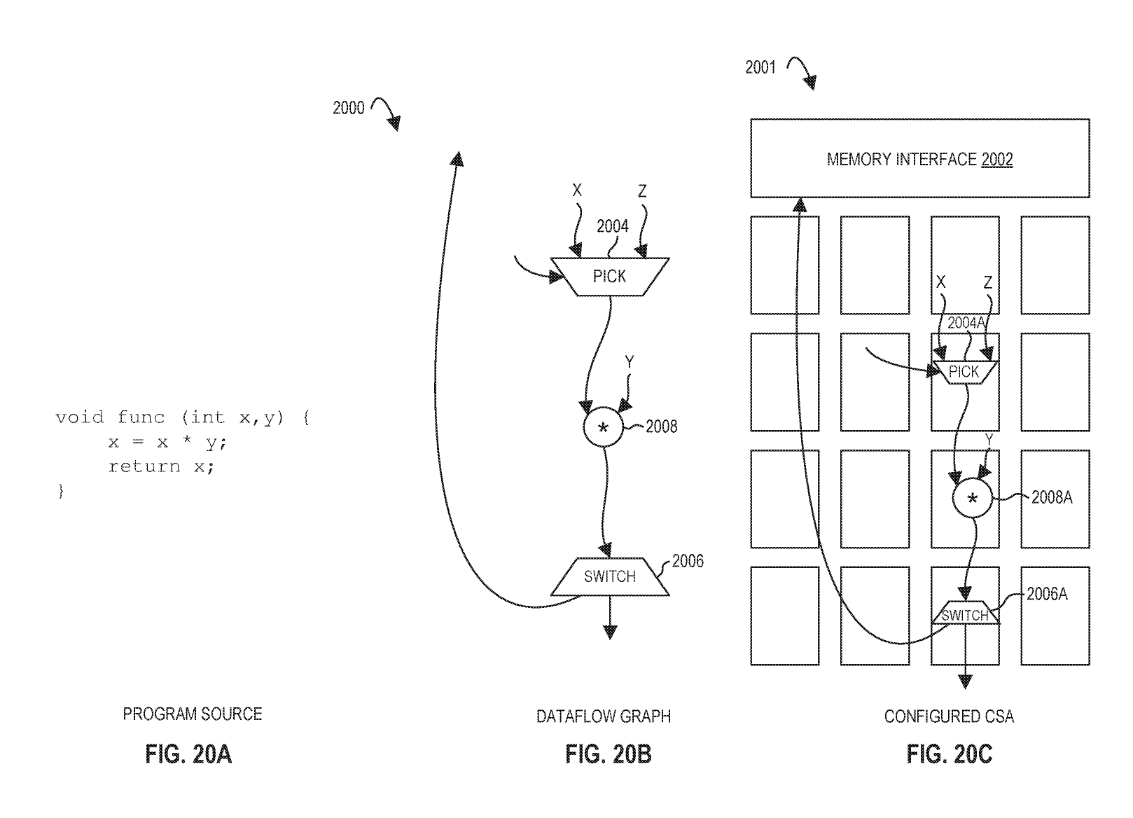

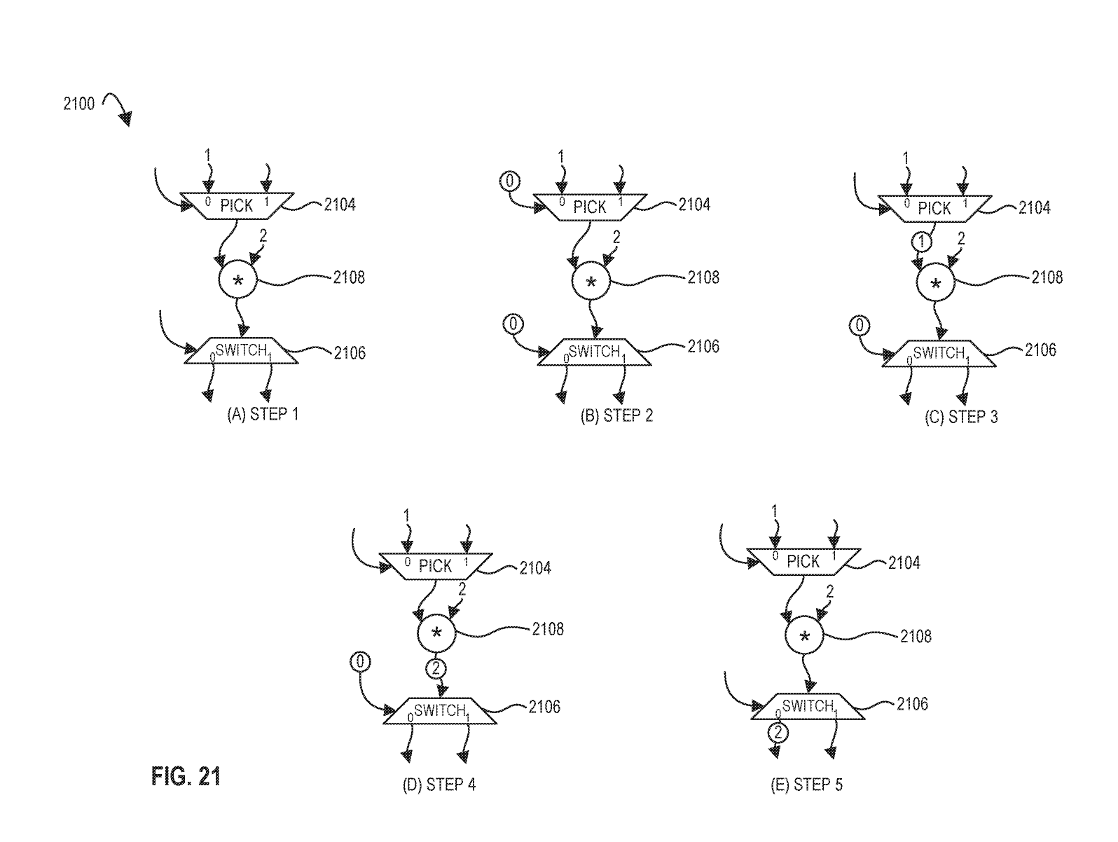

FIGS. 11A-11J illustrate illustrates a phased extraction of a (e.g., first) context for a spatial array 1100 of processing elements (1102A-1102P) configured to execute a dataflow graph according to embodiments of the disclosure. In FIG. 11A-11J, single dataflow graph is depicted as overlaid into the spatial array 1100 of processing elements (1102A-1102P) (e.g., and overlaid into the (e.g., interconnect) network(s) therebetween), for example, such that each node of the dataflow graph is represented as a dataflow operator in the spatial array of processing elements. In one embodiment, one or more of the processing elements in the spatial array of processing elements is to access memory through memory interface (e.g., memory interface 2002 in FIG. 20C). In one embodiment, pick node of a dataflow graph thus corresponds (e.g., is represented by) to pick operator 1104, switch node of a dataflow graph thus corresponds (e.g., is represented by) to switch operator 1106, multiplier node of dataflow graph thus corresponds (e.g., is represented by) to multiplier operator 1108, “equal to” node of dataflow graph thus corresponds (e.g., is represented by) to equal check operator 1110, and less-than node of dataflow graph thus corresponds (e.g., is represented by) to less-than operator 1112. Another processing element and/or a flow control path network may provide the control signals (e.g., control tokens) to the pick operator 1104 and switch operator 1106 to perform the operations. In one embodiment, spatial array 1100 of processing elements is configured (to execute the dataflow graph) before execution begins. In one embodiment, compiler performs the conversion from program and/or dataflow graph to the configuration in FIG. 11A. In one embodiment, the input of the dataflow graph nodes into the spatial array of processing elements logically embeds the dataflow graph into the array of processing elements, e.g., as discussed further below, such that the input/output paths are configured to produce the desired result. See, e.g., the discussion below for FIGS. 20A-20C.

In FIGS. 11A-11J, spatial array 1100 is depicted as having local (e.g., configuration and/or extraction) controllers 1108A-1108D). A (e.g., configuration) controller may manage the configuration and/or extraction of a subset of processing elements. Local (e.g., configuration) controller 1108A may manage (e.g., cause) the configuration and/or extraction of a processing elements 1102A-1002D. Local (e.g., configuration) controller 1108B may manage (e.g., cause) the configuration and/or extraction of a processing elements 1102E-1102H. Local (e.g., configuration) controller 1108C may manage (e.g., cause) the configuration and/or extraction of a processing elements 1102I-1102L. Local (e.g., configuration) controller 1108D may manage (e.g., cause) the configuration and/or extraction of a processing elements 1102M-1102P. A local controller may be further controlled by a higher-level controller, e.g., controller 1114.

In FIG. 11A, local controllers receive their signals from (tile) controller 1114, e.g., for a configuration (e.g., according to a first context). These signals (e.g., commands) control the behavior of the local controllers to configure their respective subset of processing elements. An extraction of the current operating state (e.g., the operands, etc.) may be desired, for example, on a context switch from a first context to a second, different context. The constants 1 and 2 in processing elements 1102G and 1102K, respectively, may be utilized as inputs, but this disclosure is not so limited.

In FIG. 11B, the local (e.g., configuration and/or extraction) controllers 1108A-1108D have completed their configuration (e.g., according to a first context) and may now operate, e.g., when input data and/or output data space (e.g., no backpressure is asserted) is available. Next, assume a request is made to extract the context that is currently in FIG. 11B. This extraction may be performed in phases, e.g., from top to bottom (in program/operation flow).

In FIG. 11C, the extraction of the context of the (e.g., configured and/or unconfigured) processing elements (1102A-1102D) is begun, e.g., by the local controller 1108A. For example, any input data, output data and respective backpressure signals is extracted from configured processing elements 1102A and 1102B (and saved). The remaining processing elements (1102E-1102P, e.g., only 1102G, 1102K, and 1102O) may continue to operate, e.g., assuming they have input data and/or output data space (e.g., no backpressure is asserted). In FIG. 11C, processing element 1102G has performed as the pick operator 1104 and has output data 1116. Hollow circles in these figures may represent input data value and/or output data space (e.g., no backpressure is asserted) according to a first context and solid circles in these figures may represent input data value and/or output data space (e.g., no backpressure is asserted) according to a first context.

In FIG. 11D, the extraction of the context of processing elements (1102A-1102D) is still occurring and output data 1116 has been consumed by processing element 1102K performing as the multiplier operator 1108, and has output data 1118.

In FIG. 11E, the extraction of the context of processing elements (1102A-1102D) is complete and output data 1118 has been consumed by processing element 1102O performing as the switch operator 1106, and has output data 1118. The context of the (e.g., configured and/or unconfigured) next subset of processing elements (1102E-1102H) is begun, e.g., by the local controller 1108B. For example, any input data, output data and respective backpressure signals is extracted from configured processing element 1102G (and saved). The remaining processing elements (1102I-1102P, e.g., only 1102K, and 1102O) may continue to operate, e.g., assuming they have input data and/or output data space (e.g., no backpressure is asserted). In certain embodiments, data may not move past an extraction region, e.g., here, the extraction region is processing elements (1102E-1102H). Thus output data 1120 is stalled (e.g., it was to go to processing element 1102G as the pick operator 1104) in embodiments where an extracting region is to not accept new data (e.g., that region of processing elements asserts its backpressure signal). In one embodiment, new data may be produced for regions above (e.g., in program flow order) the extraction region, e.g., by processing element 1102A as equal check operator 1110 and/or by processing element 1102B as less-than operator 1112.

In FIG. 11F, the extraction of the context of processing elements (1102E-1102H) is complete. The context of the (e.g., configured and/or unconfigured) next subset of processing elements (1102I-1102L) is begun, e.g., by the local controller 1108C. For example, any input data, output data and respective backpressure signals is extracted from configured processing element 1102K (and saved). The remaining processing elements (1102M-1102P, e.g., only 1102O) may continue to operate, e.g., assuming they have input data and/or output data space (e.g., no backpressure is asserted). In certain embodiments, data may not move past an extraction region, e.g., here, the extraction region is processing elements (1102I-1102L). Thus output data 1120 is stalled (e.g., it was to go to processing element 1102G as the pick operator 1104) in embodiments where an extracting region (and any region (logically) above) is to not accept new data (e.g., that region of processing elements asserts its backpressure signal to prevent data from traversing that region). In one embodiment, new data may be produced for regions above (e.g., in program flow order) the extraction region, e.g., with the output data 1122 from processing element 1102A as equal check operator 1110 stalled from going to processing element 1102O (e.g., across the extraction region) and/or with the output data 1124 from processing element 1102B as less-than operator 1112 not being stalled from going to processing element 1102G (e.g., not crossing the (in-process) extraction region).

In FIG. 11G, the extraction of the context of processing elements (1102I-1102L) is complete. The context of the (e.g., configured and/or unconfigured) next subset of processing elements (1102M-1102P) is begun, e.g., by the local controller 1108D. For example, any input data, output data (stalled output data 1120) and respective backpressure signals is extracted from configured processing element 1102O (and saved). There are no further downstream processing elements here to have their context saved (e.g., this is the end of this portion of the dataflow graph), so the extraction is almost complete. The above processing elements (1102A-1102L, e.g., only 1102A, 1102B, 1102G, and 1102K) may continue to operate, e.g., assuming they have input data and/or output data space (e.g., no backpressure is asserted). In certain embodiments, data may not move past an extraction region, e.g., here, the extraction region is processing elements (1102M-1102P). Thus output data from processing element 1102G is stalled (e.g., it is waiting for data from processing element 1102O to proceed) in embodiments where an extracting region (and any region (logically) above) is to not accept new data (e.g., that region of processing elements asserts its backpressure signal to prevent data from traversing that region). In one embodiment, new data may be produced for regions above (e.g., in program flow order) the extraction region, e.g., with the output data 1122 from processing element 1102G as pick operator 1104 stalled with the output data from processing element 1102O as switch operator 1106, but not being stalled from crossing the (in-process) extraction region.

In FIG. 11H, the local (e.g., configuration and/or extraction) controllers 1108A-1108D have completed their extraction of a first context (and configuration for a second context) and may now operate, e.g., when input data and/or output data space (e.g., no backpressure is asserted) is available. For example, after extraction, the spatial array 1100 (e.g., the dataflow graph loaded therein) may be reused for a different set of (input) operands, e.g., as a second context. In FIG. 11H, a data output 1126 (e.g., from a previous operation on context two) may be available (e.g., configured into spatial array 1100), and thus flow up to processing element 1102G as pick operator 1104 as show in FIG. 11I.

In FIG. 11J, processing element 1102G as pick operator 1104 may have all of its operands and no backpressure signals, and thus produce output data 1128.

In one embodiment, to accesses a local controller, a higher-level controller may have access to the address for the local controllers it is managing. A local controller may have access to (e.g., calculate) the address for the processing elements it is managing. The address for a PE may be sent in by the higher-level (e.g., regional) controller, e.g., which has knowledge of memory formats for spatial array context.

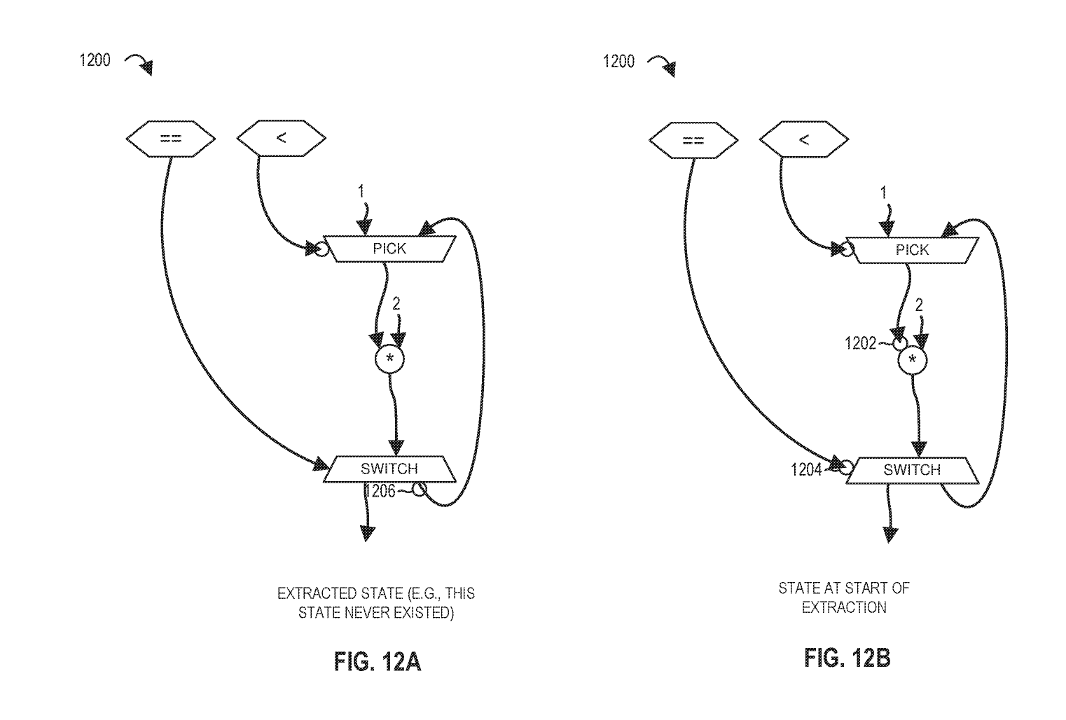

FIG. 12A illustrates an extracted state 1200 according to embodiments of the disclosure. FIG. 12B illustrates a state 1200 at the beginning of an extraction according to embodiments of the disclosure. FIGS. 12A and 12B illustrate that when an extraction is phased, the extraction may take the form of the dataflow graph shown in FIG. 12A (e.g., with the input and output data from that saved state indicated as hollow circles), although that state in its exact form never existed at one point in time. Thus, it may be said that the phased extraction output in FIG. 12A captures the legal view (e.g., state) of the spatial array (e.g., dataflow graph represented in the spatial array) while FIG. 12B illustrates the state at the start of a phased extraction that include multiple phases (e.g., multiple phases of a single portion of a dataflow graph). The state in FIG. 12A may be several steps ahead of the initial state (when the extraction first began), for example, as several more operations have executed, e.g., consuming input data 1202 and 1204, and producing output data 1206.

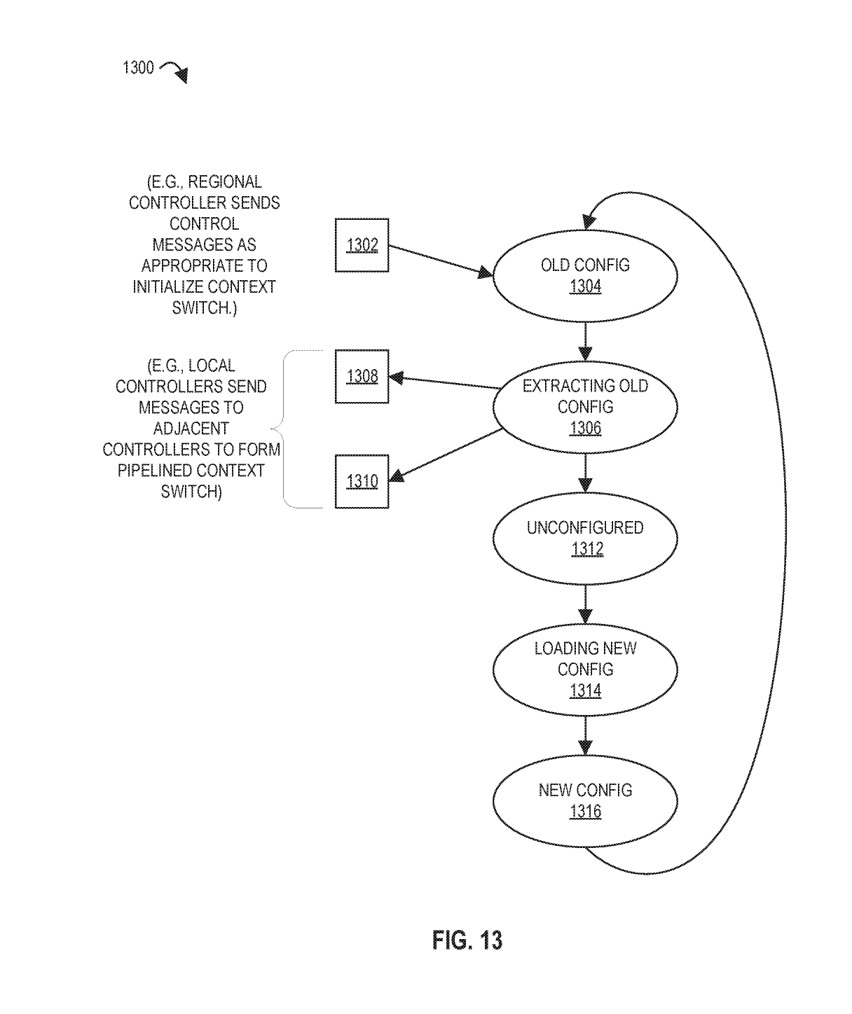

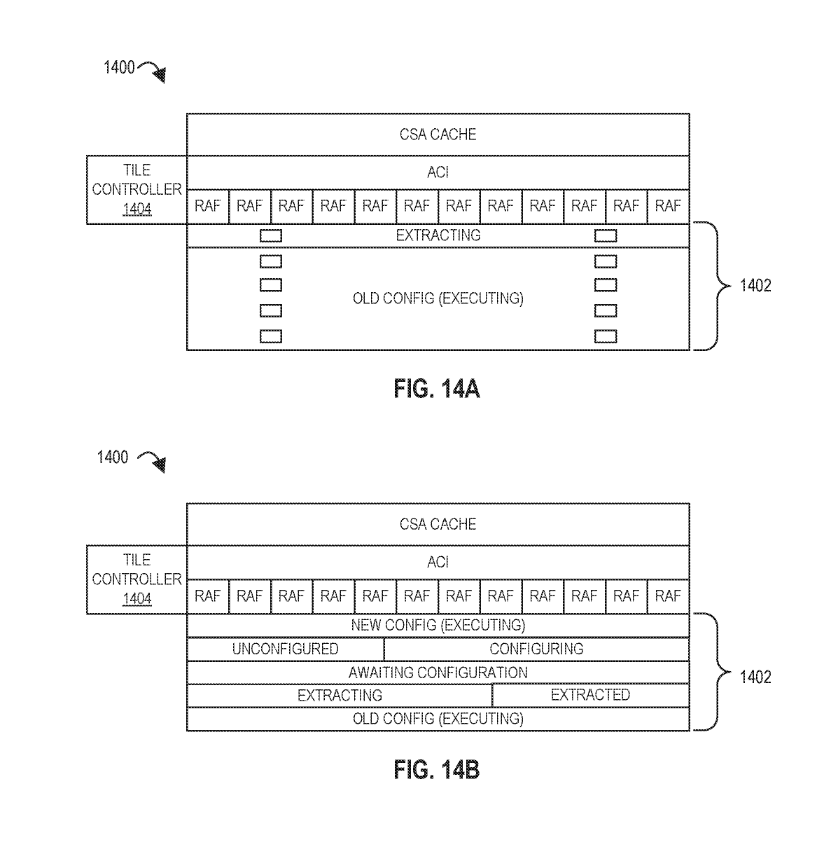

FIG. 13 illustrates a state machine 1300 for a (e.g., configuration) controller according to embodiments of the disclosure. A controller may include a hardware state machine, e.g., in each local (e.g., configuration) controller. State machine may be a Mealy machine or a Moore machine. State 1302 may be where a (e.g., higher-level) controller sends a control message to initiate a context switch, e.g., for a previously configured PE or PEs of another (e.g., local) controller. Previously configured PE or PEs may operate (e.g., when input data operands and output space is available) according to a first (e.g., old) context (e.g., of a dataflow graph) in state 1304, e.g., until the data is all consumed. State 1306 may then be entered, e.g., based on the requested context switch, and the context (e.g., old configuration) of the previously configured PE or PEs may begin to be extracted. On completion of the extraction, e.g., after state 1306 or on entry into state 1312, the local (e.g., configuration) controller may send a message to adjacent controllers to form a pipelined context switch. In one embodiment, the local (e.g., configuration) controller sends a message to the next local (e.g., configuration) controller or controllers (e.g., 2, 3, 4, 5, etc. controllers) as an indication that they may start to extract the first context for their subset of processing element(s). Additionally or alternatively, the local (e.g., configuration) controller sends a message to the previous local (e.g., configuration) controller or controllers (e.g., 2, 3, 4, 5, etc. controllers) as an indication that they may start to configure (e.g., load) a second (e.g., new) context into their subset of processing element(s). In state 1312, the most recently extracted processing elements may then be held in an unconfigured state. In state 1314, those unconfigured processing elements may start to configure (e.g., load) a second context into their subset of processing element(s), for example, on receipt of a message from a next local (e.g., configuration) controller or controllers (e.g., 2, 3, 4, 5, etc. controllers) that their extraction of the first state is complete. In state 1316, that new state (e.g., configuration) may execute on the configured processing element(s), and then return to state 1304, e.g., when a (e.g., higher-level) controller sends a control message to initiate another context switch. In one embodiment, a context may be from different dataflow graph(s) or (e.g., different parts) of the same dataflow graph.

FIG. 14A illustrates an extraction of context for a spatial array 1402 of processing elements according to embodiments of the disclosure. Spatial array 1402 is illustrated schematically to show an initial configuration message forming a spatial array wide (e.g., fabric wide) barrier (e.g., extraction region), which sweeps through the entire spatial array (e.g., fabric), for example, under the control and direction of the higher-level (e.g., tile level) controller 1404. Controller 1404 may orchestrate local controllers to coordinate this pipeline. ACI network and RAF may be as discussed herein. Although FIG. 14A illustrates one phase ordering here, other topologies are possible.

FIG. 14B illustrates an extraction of context for a spatial array 1402 of processing elements according to embodiments of the disclosure. Spatial array 1402 is illustrated schematically to show a spatial array wide (e.g., fabric wide) barrier (e.g., extraction region in “awaiting configuration”), which sweeps through the entire spatial array (e.g., fabric), for example, under the control and direction of the higher-level (e.g., tile level) controller 1404. Controller 1404 may orchestrate local controllers to coordinate this pipeline. In one embodiment, the states of the spatial array 1402 in FIG. 14B correspond to those in FIGS. 4A-4D. ACI network and RAF may be as discussed herein. Although FIG. 14B illustrates one phase ordering here, other topologies are possible.

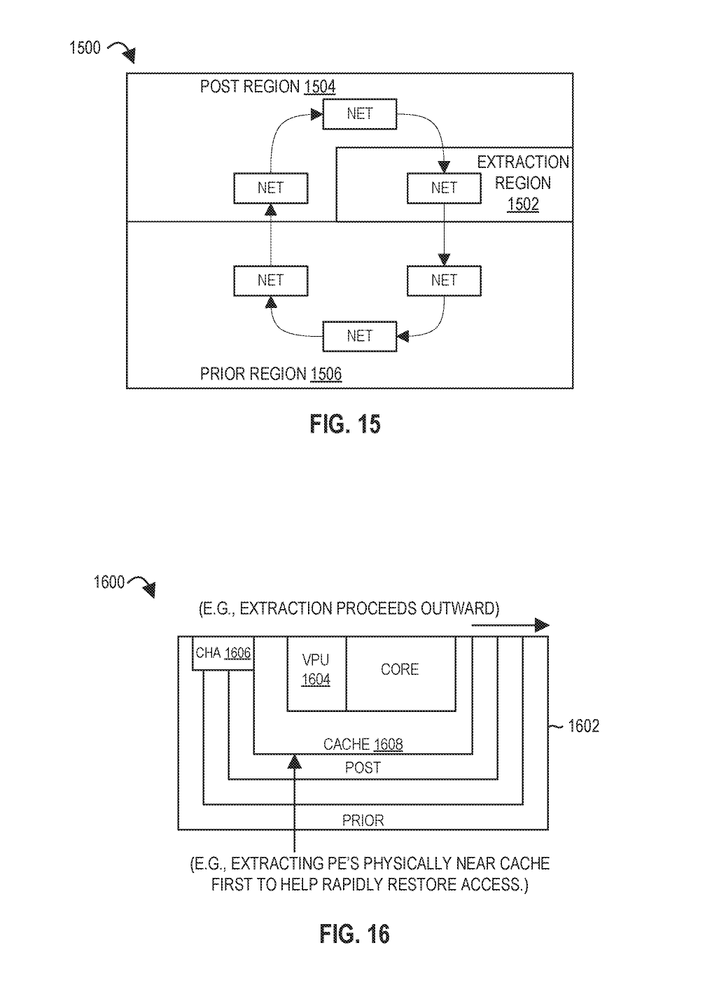

FIG. 15 illustrates a phased extraction of context for a spatial array of processing elements that includes a (e.g., mezzanine or global) network therebetween according to embodiments of the disclosure. Network may be any network discussed herein. FIG. 15 includes a block diagram illustration of an extraction region 1502, POST (extraction) region 1504 and PRIOR (to extraction) region 1506 that include network message that cross these regions.

Messages in networks may cross phase boundary (e.g., extraction region). In one embodiment, the hardware (e.g., a network controller as discussed herein) records a state of network tokens. In one embodiment, network controller may inject POST (e.g., extraction region) transition message on each channel and to not release PRIOR (e.g., extraction region) message until receive a POST message. Network controller may record its state when POST messages received for all active channels. In one embodiment, early consumption of messages is legal, but state is retained. Matching messages (e.g., message from the same context) may be forwarded, for example, PRIOR may consume PRIOR messages and POST may consume POST messages. Mismatch may mean that the data is from the wrong epoch and needs to wait. PRIOR messages may be promoted. PRIOR endpoints may wait for extraction. PRIOR messages may wait for POST transition.

FIG. 16 illustrates a phased extraction of context for a spatial array 1600 of processing elements 1602 that includes memory access according to embodiments of the disclosure. Communications through memory may be utilized in some embodiments. In the depicted embodiment, only the processing elements in the POST region (e.g., after the extraction region) touches memory (e.g., cache), e.g., mitigated by extracting near-memory (e.g., near a Request address file (RAF) circuits, which may be as described herein) PEs first to re-enable them quickly. In one embodiment, a spatial array (e.g., controller) is to treat a PRIOR region of PEs and a POST region of PEs as conflicting channel groups, e.g., roll back on conflict detection between the two regions to PRIOR's snapshot. Ion one embodiment, spatial array (e.g., controller) is to keep old and new values alive in cache, e.g., allow each epoch to access its value. In one embodiment, extracting for processing elements physically near the cache (e.g., L2 cache in FIG. 16) may help rapidly restore access, e.g., where extraction proceeds (e.g., radiates) outward in the embodiment in FIG. 16. Spatial array 1600 may be coupled to a vector processing unit 1604 and/or a processor core 1610.

Handling Memory Operations: it may be the case that a context has memory operations outstanding during the period of an extraction. In this case, the cache interface (e.g., CHA) will reserve the resources already allocated to the outstanding requests, e.g., slots in a re-order buffer, until those requests are completed by the memory system. At that point the requests may be written into the in-memory representation of the evicted process and the allocated resources returned to the memory interface for use by the newly configured context. In one embodiment, while requests are outstanding, the associated resources are not used by the new context.

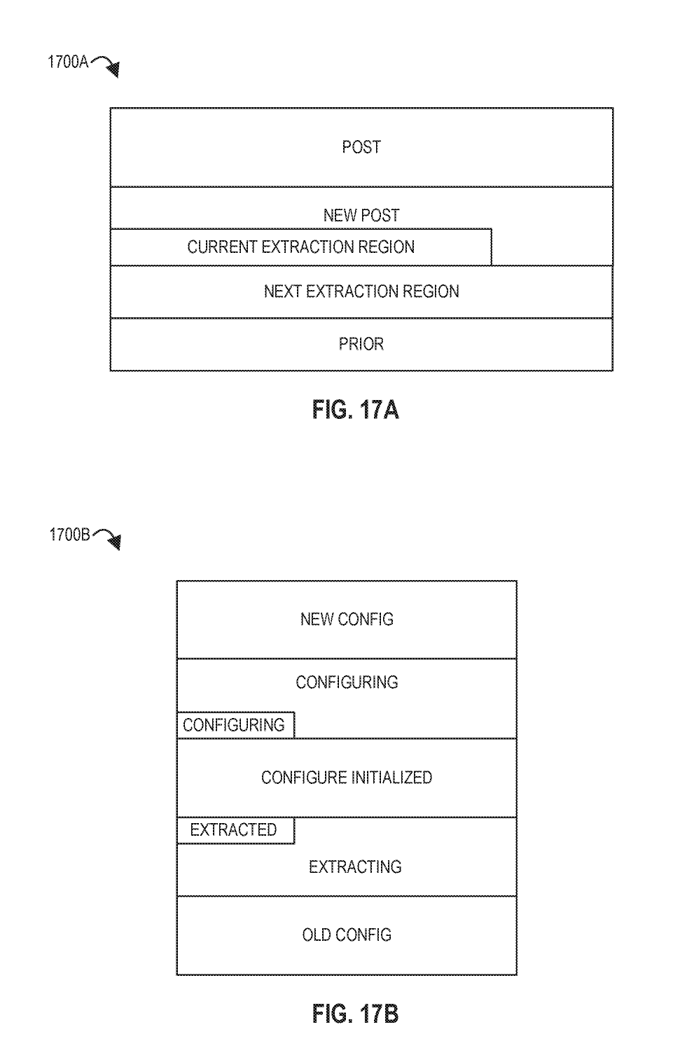

FIG. 17A illustrates an extraction of context for a spatial array 1700A of processing elements according to embodiments of the disclosure. In one embodiment, a second (e.g., next) extraction region may be maintained (e.g., where no data may cross the region) to prevent inter-epoch communications, e.g., in addition to a currently extracting region. In one embodiment, phased extraction may be achieved with no modifications to processing element(s), for example, where a local network is disabled during extraction (e.g., via backpressure signals). This may provide an impassable barrier (e.g., owing to the backpressure signals being active). A double layering of extraction may ensure PEs in the first layer do not interfere with PRIOR region as they transition to POST, e.g., as in FIG. 17A. In certain embodiments, careful, high-level orchestration and coordination is utilized, e.g., for the function of regional and/or global extraction controllers. POST may refer to the new configuration region that is configured with the new configuration (e.g., context). PRIOR may refer to the prior configuration region that is configured with the prior configuration (e.g., context).

FIG. 17B illustrates an extraction of context for a spatial array 1700B of processing elements according to embodiments of the disclosure. FIG. 17B depicts a detailed time slice of a pipelined context switch. Five regions are depicted in FIG. 17B: the executing contexts, the currently extracting region, the currently configuring region, and a buffer region between.

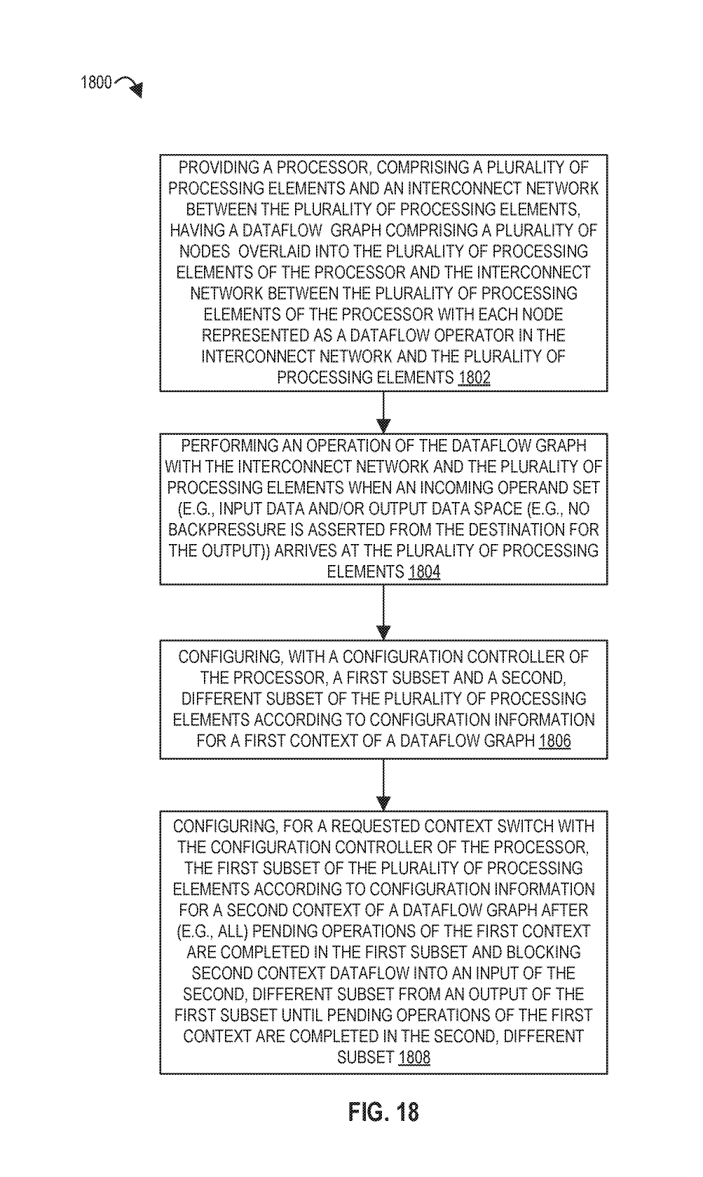

FIG. 18 illustrates a flow diagram 1800 according to embodiments of the disclosure. Depicted flow 1800 includes providing a processor, comprising a plurality of processing elements and an interconnect network between the plurality of processing elements, having a dataflow graph comprising a plurality of nodes overlaid into the plurality of processing elements of the processor and the interconnect network between the plurality of processing elements of the processor with each node represented as a dataflow operator in the interconnect network and the plurality of processing elements 1802; performing an operation of the dataflow graph with the interconnect network and the plurality of processing elements when an incoming operand set (e.g., input data and/or output data space (e.g., no backpressure is asserted from the destination for the output)) arrives at the plurality of processing elements 1804; configuring, with a configuration controller of the processor, a first subset and a second, different subset of the plurality of processing elements according to configuration information for a first context of a dataflow graph 1806; and configuring, for a requested context switch with the configuration controller of the processor, the first subset of the plurality of processing elements according to configuration information for a second context of a dataflow graph after (e.g., all) pending operations of the first context are completed in the first subset and blocking second context dataflow into an input of the second, different subset from an output of the first subset until pending operations of the first context are completed in the second, different subset 1808.

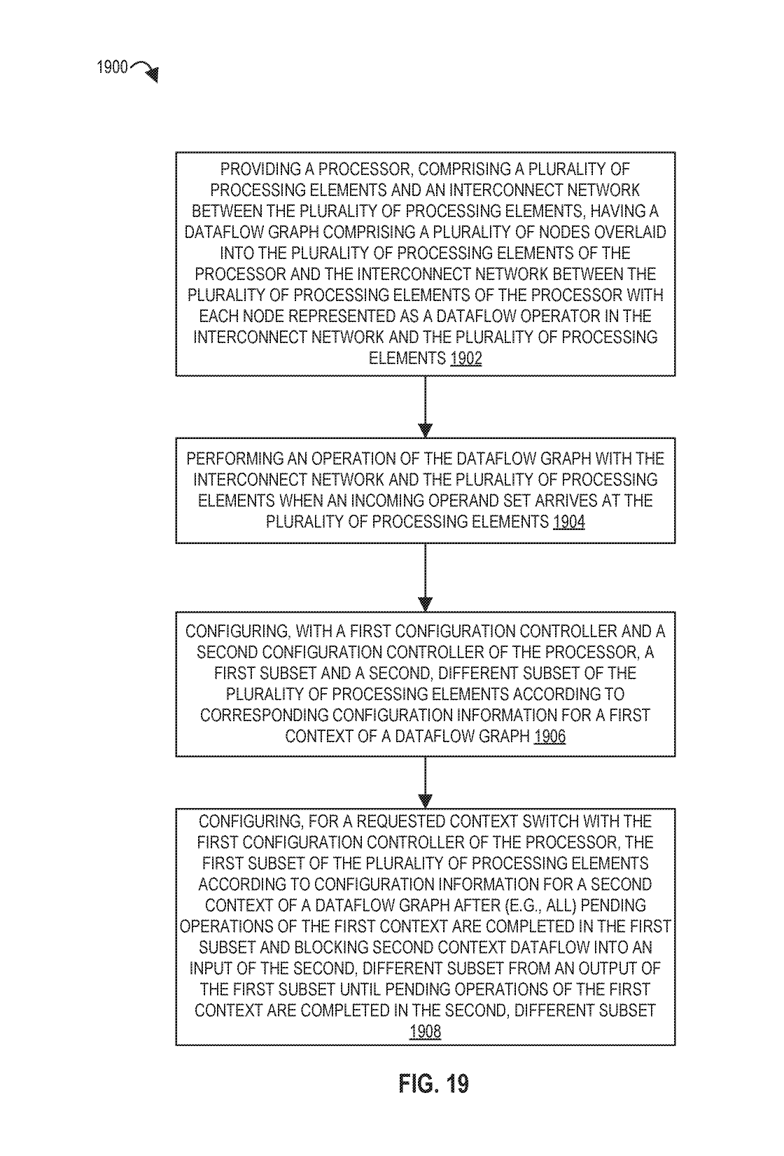

FIG. 19 illustrates a flow diagram according to embodiments of the disclosure. Depicted flow 1900 includes providing a processor, comprising a plurality of processing elements and an interconnect network between the plurality of processing elements, having a dataflow graph comprising a plurality of nodes overlaid into the plurality of processing elements of the processor and the interconnect network between the plurality of processing elements of the processor with each node represented as a dataflow operator in the interconnect network and the plurality of processing elements 1902; performing an operation of the dataflow graph with the interconnect network and the plurality of processing elements when an incoming operand set arrives at the plurality of processing elements 1904; configuring, with a first configuration controller and a second configuration controller of the processor, a first subset and a second, different subset of the plurality of processing elements according to corresponding configuration information for a first context of a dataflow graph 1906; and configuring, for a requested context switch with the first configuration controller of the processor, the first subset of the plurality of processing elements according to configuration information for a second context of a dataflow graph after (e.g., all) pending operations of the first context are completed in the first subset and blocking second context dataflow into an input of the second, different subset from an output of the first subset until pending operations of the first context are completed in the second, different subset 1908.

### 2. CSA Architecture

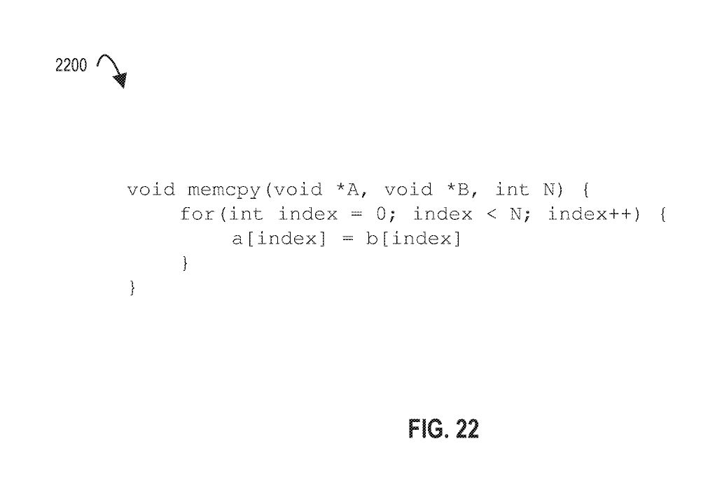

The goal of certain embodiments of a CSA is to rapidly and efficiently execute programs, e.g., programs produced by compilers. Certain embodiments of the CSA architecture provide programming abstractions that support the needs of compiler technologies and programming paradigms. Embodiments of the CSA execute dataflow graphs, e.g., a program manifestation that closely resembles the compiler's own internal representation (IR) of compiled programs. In this model, a program is represented as a dataflow graph comprised of nodes (e.g., vertices) drawn from a set of architecturally-defined dataflow operators (e.g., that encompass both computation and control operations) and edges which represent the transfer of data between dataflow operators. Execution may proceed by injecting dataflow tokens (e.g., that are or represent data values) into the dataflow graph. Tokens may flow between and be transformed at each node (e.g., vertex), for example, forming a complete computation. A sample dataflow graph and its derivation from high-level source code is shown in FIGS. 20A-20C, and FIG. 22 shows an example of the execution of a dataflow graph.

Embodiments of the CSA are configured for dataflow graph execution by providing exactly those dataflow-graph-execution supports required by compilers. In one embodiment, the CSA is an accelerator (e.g., an accelerator in FIG. 2) and it does not seek to provide some of the necessary but infrequently used mechanisms available on general purpose processing cores (e.g., a core in FIG. 2), such as system calls. Therefore, in this embodiment, the CSA can execute many codes, but not all codes. In exchange, the CSA gains significant performance and energy advantages. To enable the acceleration of code written in commonly used sequential languages, embodiments herein also introduce several novel architectural features to assist the compiler. One particular novelty is CSA's treatment of memory, a subject which has been ignored or poorly addressed previously. Embodiments of the CSA are also unique in the use of dataflow operators, e.g., as opposed to lookup tables (LUTs), as their fundamental architectural interface.

Turning back to embodiments of the CSA, dataflow operators are discussed next.

### 2.1 Dataflow Operators

The key architectural interface of embodiments of the accelerator (e.g., CSA) is the dataflow operator, e.g., as a direct representation of a node in a dataflow graph. From an operational perspective, dataflow operators behave in a streaming or data-driven fashion. Dataflow operators may execute as soon as their incoming operands become available. CSA dataflow execution may depend (e.g., only) on highly localized status, for example, resulting in a highly scalable architecture with a distributed, asynchronous execution model. Dataflow operators may include arithmetic dataflow operators, for example, one or more of floating point addition and multiplication, integer addition, subtraction, and multiplication, various forms of comparison, logical operators, and shift. However, embodiments of the CSA may also include a rich set of control operators which assist in the management of dataflow tokens in the program graph. Examples of these include a “pick” operator, e.g., which multiplexes two or more logical input channels into a single output channel, and a “switch” operator, e.g., which operates as a channel demultiplexor (e.g., outputting a single channel from two or more logical input channels). These operators may enable a compiler to implement control paradigms such as conditional expressions. Certain embodiments of a CSA may include a limited dataflow operator set (e.g., to relatively small number of operations) to yield dense and energy efficient PE microarchitectures. Certain embodiments may include dataflow operators for complex operations that are common in HPC code. The CSA dataflow operator architecture is highly amenable to deployment-specific extensions. For example, more complex mathematical dataflow operators, e.g., trigonometry functions, may be included in certain embodiments to accelerate certain mathematics-intensive HPC workloads. Similarly, a neural-network tuned extension may include dataflow operators for vectorized, low precision arithmetic.

FIG. 20A illustrates a program source according to embodiments of the disclosure. Program source code includes a multiplication function (func). FIG. 20B illustrates a dataflow graph 2000 for the program source of FIG. 20A according to embodiments of the disclosure. Dataflow graph 2000 includes a pick node 2004, switch node 2006, and multiplication node 2008. A buffer may optionally be included along one or more of the communication paths. Depicted dataflow graph 2000 may perform an operation of selecting input X with pick node 2004, multiplying X by Y (e.g., multiplication node 2008), and then outputting the result from the left output of the switch node 2006. FIG. 20C illustrates an accelerator (e.g., CSA) with a plurality of processing elements 2001 configured to execute the dataflow graph of FIG. 20B according to embodiments of the disclosure. More particularly, the dataflow graph 2000 is overlaid into the array of processing elements 2001 (e.g., and the (e.g., interconnect) network(s) therebetween), for example, such that each node of the dataflow graph 2000 is represented as a dataflow operator in the array of processing elements 2001. For example, certain dataflow operations may be achieved with a processing element and/or certain dataflow operations may be achieved with a communications network (e.g., a network dataflow endpoint circuit thereof). For example, a Pick, PickSingleLeg, PickAny, Switch, and/or SwitchAny operation may be achieved with one or more components of a communications network (e.g., a network dataflow endpoint circuit thereof), e.g., in contrast to a processing element.

In one embodiment, one or more of the processing elements in the array of processing elements 2001 is to access memory through memory interface 2002. In one embodiment, pick node 2004 of dataflow graph 2000 thus corresponds (e.g., is represented by) to pick operator 2004A, switch node 2006 of dataflow graph 2000 thus corresponds (e.g., is represented by) to switch operator 2006A, and multiplier node 2008 of dataflow graph 2000 thus corresponds (e.g., is represented by) to multiplier operator 2008A. Another processing element and/or a flow control path network may provide the control signals (e.g., control tokens) to the pick operator 2004A and switch operator 2006A to perform the operation in FIG. 20A. In one embodiment, array of processing elements 2001 is configured to execute the dataflow graph 2000 of FIG. 20B before execution begins. In one embodiment, compiler performs the conversion from FIG. 20A-20B. In one embodiment, the input of the dataflow graph nodes into the array of processing elements logically embeds the dataflow graph into the array of processing elements, e.g., as discussed further below, such that the input/output paths are configured to produce the desired result.

### 2.2 Latency Insensitive Channels

Communications arcs are the second major component of the dataflow graph. Certain embodiments of a CSA describes these arcs as latency insensitive channels, for example, in-order, back-pressured (e.g., not producing or sending output until there is a place to store the output), point-to-point communications channels. As with dataflow operators, latency insensitive channels are fundamentally asynchronous, giving the freedom to compose many types of networks to implement the channels of a particular graph. Latency insensitive channels may have arbitrarily long latencies and still faithfully implement the CSA architecture. However, in certain embodiments there is strong incentive in terms of performance and energy to make latencies as small as possible. Section 3.2 herein discloses a network microarchitecture in which dataflow graph channels are implemented in a pipelined fashion with no more than one cycle of latency. Embodiments of latency-insensitive channels provide a critical abstraction layer which may be leveraged with the CSA architecture to provide a number of runtime services to the applications programmer. For example, a CSA may leverage latency-insensitive channels in the implementation of the CSA configuration (the loading of a program onto the CSA array).

FIG. 21 illustrates an example execution of a dataflow graph 2100 according to embodiments of the disclosure. At step 1, input values (e.g., 1 for X in FIG. 20B and 2 for Y in FIG. 20B) may be loaded in dataflow graph 2100 to perform a 1*2 multiplication operation. One or more of the data input values may be static (e.g., constant) in the operation (e.g., 1 for X and 2 for Y in reference to FIG. 20B) or updated during the operation. At step 2, a processing element (e.g., on a flow control path network) or other circuit outputs a zero to control input (e.g., mux control signal) of pick node 2104 (e.g., to source a one from port “0” to its output) and outputs a zero to control input (e.g., mux control signal) of switch node 2106 (e.g., to provide its input out of port “0” to a destination (e.g., a downstream processing element). At step 3, the data value of 1 is output from pick node 2104 (e.g., and consumes its control signal “0” at the pick node 2104) to multiplier node 2108 to be multiplied with the data value of 2 at step 4. At step 4, the output of multiplier node 2108 arrives at switch node 2106, e.g., which causes switch node 2106 to consume a control signal “0” to output the value of 2 from port “0” of switch node 2106 at step 5. The operation is then complete. A CSA may thus be programmed accordingly such that a corresponding dataflow operator for each node performs the operations in FIG. 21. Although execution is serialized in this example, in principle all dataflow operations may execute in parallel. Steps are used in FIG. 21 to differentiate dataflow execution from any physical microarchitectural manifestation. In one embodiment a downstream processing element is to send a signal (or not send a ready signal) (for example, on a flow control path network) to the switch 2106 to stall the output from the switch 2106, e.g., until the downstream processing element is ready (e.g., has storage room) for the output.

### 2.3 Memory

Dataflow architectures generally focus on communication and data manipulation with less attention paid to state. However, enabling real software, especially programs written in legacy sequential languages, requires significant attention to interfacing with memory. Certain embodiments of a CSA use architectural memory operations as their primary interface to (e.g., large) stateful storage. From the perspective of the dataflow graph, memory operations are similar to other dataflow operations, except that they have the side effect of updating a shared store. In particular, memory operations of certain embodiments herein have the same semantics as every other dataflow operator, for example, they “execute” when their operands, e.g., an address, are available and, after some latency, a response is produced. Certain embodiments herein explicitly decouple the operand input and result output such that memory operators are naturally pipelined and have the potential to produce many simultaneous outstanding requests, e.g., making them exceptionally well suited to the latency and bandwidth characteristics of a memory subsystem. Embodiments of a CSA provide basic memory operations such as load, which takes an address channel and populates a response channel with the values corresponding to the addresses, and a store. Embodiments of a CSA may also provide more advanced operations such as in-memory atomics and consistency operators. These operations may have similar semantics to their von Neumann counterparts. Embodiments of a CSA may accelerate existing programs described using sequential languages such as C and Fortran. A consequence of supporting these language models is addressing program memory order, e.g., the serial ordering of memory operations typically prescribed by these languages.

FIG. 22 illustrates a program source (e.g., C code) 2200 according to embodiments of the disclosure. According to the memory semantics of the C programming language, memory copy (memcpy) should be serialized. However, memcpy may be parallelized with an embodiment of the CSA if arrays A and B are known to be disjoint. FIG. 22 further illustrates the problem of program order. In general, compilers cannot prove that array A is different from array B, e.g., either for the same value of index or different values of index across loop bodies. This is known as pointer or memory aliasing. Since compilers are to generate statically correct code, they are usually forced to serialize memory accesses. Typically, compilers targeting sequential von Neumann architectures use instruction ordering as a natural means of enforcing program order. However, embodiments of the CSA have no notion of instruction or instruction-based program ordering as defined by a program counter. In certain embodiments, incoming dependency tokens, e.g., which contain no architecturally visible information, are like all other dataflow tokens and memory operations may not execute until they have received a dependency token. In certain embodiments, memory operations produce an outgoing dependency token once their operation is visible to all logically subsequent, dependent memory operations. In certain embodiments, dependency tokens are similar to other dataflow tokens in a dataflow graph. For example, since memory operations occur in conditional contexts, dependency tokens may also be manipulated using control operators described in Section 2.1, e.g., like any other tokens. Dependency tokens may have the effect of serializing memory accesses, e.g., providing the compiler a means of architecturally defining the order of memory accesses.

### 2.4 Runtime Services

A primary architectural considerations of embodiments of the CSA involve the actual execution of user-level programs, but it may also be desirable to provide several support mechanisms which underpin this execution. Chief among these are configuration (in which a dataflow graph is loaded into the CSA), extraction (in which the state of an executing graph is moved to memory), and exceptions (in which mathematical, soft, and other types of errors in the fabric are detected and handled, possibly by an external entity). Section 3.6 below discusses the properties of a latency-insensitive dataflow architecture of an embodiment of a CSA to yield efficient, largely pipelined implementations of these functions. Conceptually, configuration may load the state of a dataflow graph into the interconnect (and/or communications network (e.g., a network dataflow endpoint circuit thereof)) and processing elements (e.g., fabric), e.g., generally from memory. During this step, all structures in the CSA may be loaded with a new dataflow graph and any dataflow tokens live in that graph, for example, as a consequence of a context switch. The latency-insensitive semantics of a CSA may permit a distributed, asynchronous initialization of the fabric, e.g., as soon as PEs are configured, they may begin execution immediately. Unconfigured PEs may backpressure their channels until they are configured, e.g., preventing communications between configured and unconfigured elements. The CSA configuration may be partitioned into privileged and user-level state. Such a two-level partitioning may enable primary configuration of the fabric to occur without invoking the operating system. During one embodiment of extraction, a logical view of the dataflow graph is captured and committed into memory, e.g., including all live control and dataflow tokens and state in the graph.

Extraction may also play a role in providing reliability guarantees through the creation of fabric checkpoints. Exceptions in a CSA may generally be caused by the same events that cause exceptions in processors, such as illegal operator arguments or reliability, availability, and serviceability (RAS) events. In certain embodiments, exceptions are detected at the level of dataflow operators, for example, checking argument values or through modular arithmetic schemes. Upon detecting an exception, a dataflow operator (e.g., circuit) may halt and emit an exception message, e.g., which contains both an operation identifier and some details of the nature of the problem that has occurred. In one embodiment, the dataflow operator will remain halted until it has been reconfigured. The exception message may then be communicated to an associated processor (e.g., core) for service, e.g., which may include extracting the graph for software analysis.

### 2.5 Tile-Level Architecture

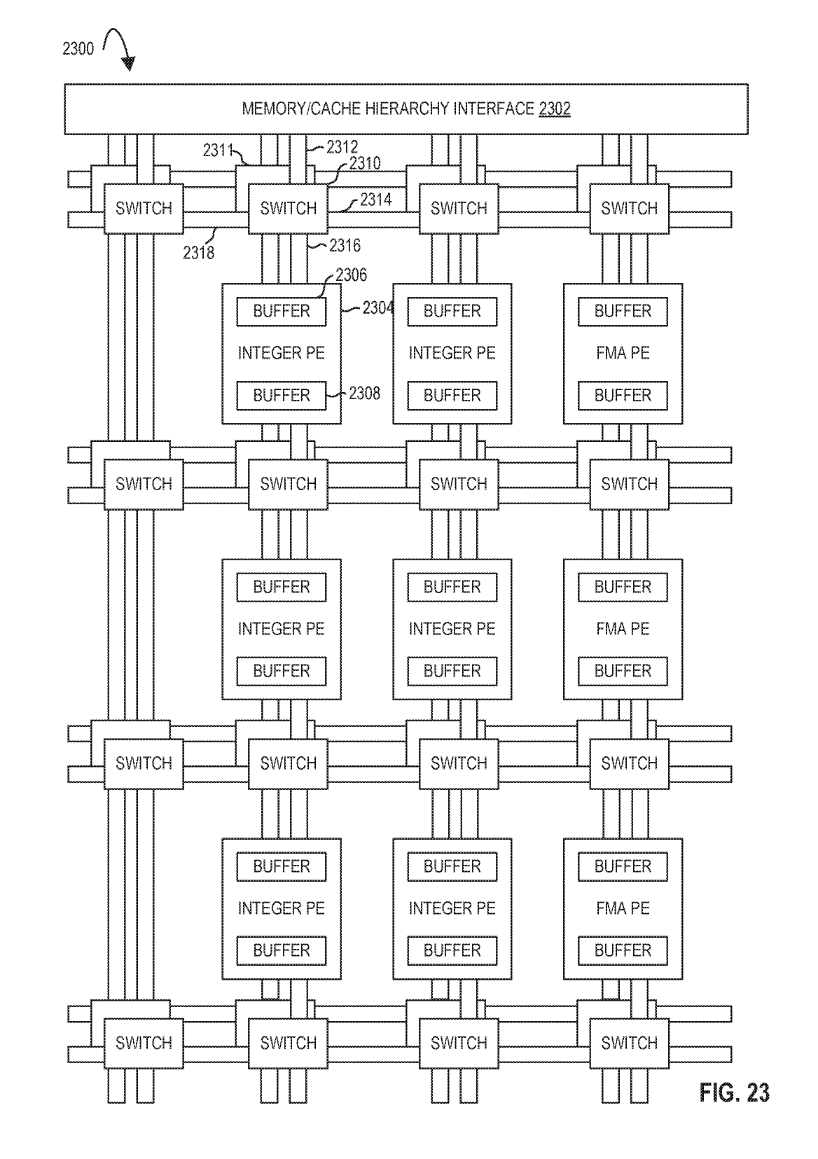

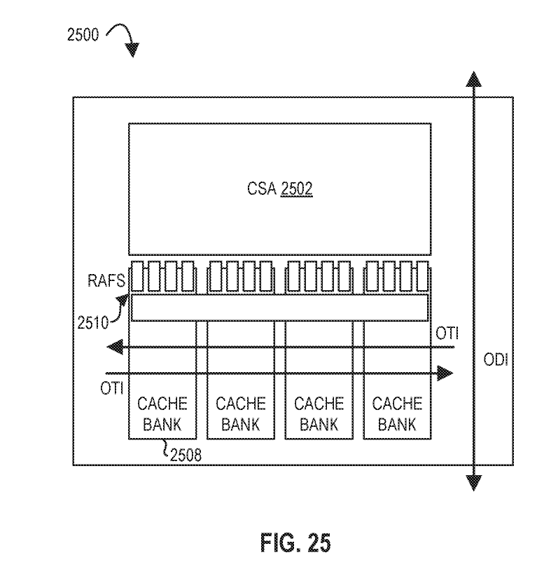

Embodiments of the CSA computer architectures (e.g., targeting HPC and datacenter uses) are tiled. FIGS. 23 and 25 show tile-level deployments of a CSA. FIG. 25 shows a full-tile implementation of a CSA, e.g., which may be an accelerator of a processor with a core. A main advantage of this architecture is may be reduced design risk, e.g., such that the CSA and core are completely decoupled in manufacturing. In addition to allowing better component reuse, this may allow the design of components like the CSA Cache to consider only the CSA, e.g., rather than needing to incorporate the stricter latency requirements of the core. Finally, separate tiles may allow for the integration of CSA with small or large cores. One embodiment of the CSA captures most vector-parallel workloads such that most vector-style workloads run directly on the CSA, but in certain embodiments vector-style instructions in the core may be included, e.g., to support legacy binaries.

### 3. Microarchitecture

In one embodiment, the goal of the CSA microarchitecture is to provide a high quality implementation of each dataflow operator specified by the CSA architecture. Embodiments of the CSA microarchitecture provide that each processing element (and/or communications network (e.g., a network dataflow endpoint circuit thereof)) of the microarchitecture corresponds to approximately one node (e.g., entity) in the architectural dataflow graph. In one embodiment, a node in the dataflow graph is distributed in multiple network dataflow endpoint circuits. In certain embodiments, this results in microarchitectural elements that are not only compact, resulting in a dense computation array, but also energy efficient, for example, where processing elements (PEs) are both simple and largely unmultiplexed, e.g., executing a single dataflow operator for a configuration (e.g., programming) of the CSA. To further reduce energy and implementation area, a CSA may include a configurable, heterogeneous fabric style in which each PE thereof implements only a subset of dataflow operators (e.g., with a separate subset of dataflow operators implemented with network dataflow endpoint circuit(s)). Peripheral and support subsystems, such as the CSA cache, may be provisioned to support the distributed parallelism incumbent in the main CSA processing fabric itself. Implementation of CSA microarchitectures may utilize dataflow and latency-insensitive communications abstractions present in the architecture. In certain embodiments, there is (e.g., substantially) a one-to-one correspondence between nodes in the compiler generated graph and the dataflow operators (e.g., dataflow operator compute elements) in a CSA.

Below is a discussion of an example CSA, followed by a more detailed discussion of the microarchitecture. Certain embodiments herein provide a CSA that allows for easy compilation, e.g., in contrast to an existing FPGA compilers that handle a small subset of a programming language (e.g., C or C++) and require many hours to compile even small programs.

Certain embodiments of a CSA architecture admits of heterogeneous coarse-grained operations, like double precision floating point. Programs may be expressed in fewer coarse grained operations, e.g., such that the disclosed compiler runs faster than traditional spatial compilers. Certain embodiments include a fabric with new processing elements to support sequential concepts like program ordered memory accesses. Certain embodiments implement hardware to support coarse-grained dataflow-style communication channels. This communication model is abstract, and very close to the control-dataflow representation used by the compiler. Certain embodiments herein include a network implementation that supports single-cycle latency communications, e.g., utilizing (e.g., small) PEs which support single control-dataflow operations. In certain embodiments, not only does this improve energy efficiency and performance, it simplifies compilation because the compiler makes a one-to-one mapping between high-level dataflow constructs and the fabric. Certain embodiments herein thus simplify the task of compiling existing (e.g., C, C++, or Fortran) programs to a CSA (e.g., fabric).

Energy efficiency may be a first order concern in modern computer systems. Certain embodiments herein provide a new schema of energy-efficient spatial architectures. In certain embodiments, these architectures form a fabric with a unique composition of a heterogeneous mix of small, energy-efficient, data-flow oriented processing elements (PEs) (and/or a packet switched communications network (e.g., a network dataflow endpoint circuit thereof)) with a lightweight circuit switched communications network (e.g., interconnect), e.g., with hardened support for flow control. Due to the energy advantages of each, the combination of these components may form a spatial accelerator (e.g., as part of a computer) suitable for executing compiler-generated parallel programs in an extremely energy efficient manner. Since this fabric is heterogeneous, certain embodiments may be customized for different application domains by introducing new domain-specific PEs. For example, a fabric for high-performance computing might include some customization for double-precision, fused multiply-add, while a fabric targeting deep neural networks might include low-precision floating point operations.

An embodiment of a spatial architecture schema, e.g., as exemplified in FIG. 23, is the composition of light-weight processing elements (PE) connected by an inter-PE network. Generally, PEs may comprise dataflow operators, e.g., where once (e.g., all) input operands arrive at the dataflow operator, some operation (e.g., micro-instruction or set of micro-instructions) is executed, and the results are forwarded to downstream operators. Control, scheduling, and data storage may therefore be distributed amongst the PEs, e.g., removing the overhead of the centralized structures that dominate classical processors.

Programs may be converted to dataflow graphs that are mapped onto the architecture by configuring PEs and the network to express the control-dataflow graph of the program. Communication channels may be flow-controlled and fully back-pressured, e.g., such that PEs will stall if either source communication channels have no data or destination communication channels are full. In one embodiment, at runtime, data flow through the PEs and channels that have been configured to implement the operation (e.g., an accelerated algorithm). For example, data may be streamed in from memory, through the fabric, and then back out to memory.

Embodiments of such an architecture may achieve remarkable performance efficiency relative to traditional multicore processors: compute (e.g., in the form of PEs) may be simpler, more energy efficient, and more plentiful than in larger cores, and communications may be direct and mostly short-haul, e.g., as opposed to occurring over a wide, full-chip network as in typical multicore processors. Moreover, because embodiments of the architecture are extremely parallel, a number of powerful circuit and device level optimizations are possible without seriously impacting throughput, e.g., low leakage devices and low operating voltage. These lower-level optimizations may enable even greater performance advantages relative to traditional cores. The combination of efficiency at the architectural, circuit, and device levels yields of these embodiments are compelling. Embodiments of this architecture may enable larger active areas as transistor density continues to increase.

Embodiments herein offer a unique combination of dataflow support and circuit switching to enable the fabric to be smaller, more energy-efficient, and provide higher aggregate performance as compared to previous architectures. FPGAs are generally tuned towards fine-grained bit manipulation, whereas embodiments herein are tuned toward the double-precision floating point operations found in HPC applications. Certain embodiments herein may include a FPGA in addition to a CSA according to this disclosure.

Certain embodiments herein combine a light-weight network with energy efficient dataflow processing elements (and/or communications network (e.g., a network dataflow endpoint circuit thereof)) to form a high-throughput, low-latency, energy-efficient HPC fabric. This low-latency network may enable the building of processing elements (and/or communications network (e.g., a network dataflow endpoint circuit thereof)) with fewer functionalities, for example, only one or two instructions and perhaps one architecturally visible register, since it is efficient to gang multiple PEs together to form a complete program.

Relative to a processor core, CSA embodiments herein may provide for more computational density and energy efficiency. For example, when PEs are very small (e.g., compared to a core), the CSA may perform many more operations and have much more computational parallelism than a core, e.g., perhaps as many as 16 times the number of FMAs as a vector processing unit (VPU). To utilize all of these computational elements, the energy per operation is very low in certain embodiments.

The energy advantages our embodiments of this dataflow architecture are many. Parallelism is explicit in dataflow graphs and embodiments of the CSA architecture spend no or minimal energy to extract it, e.g., unlike out-of-order processors which must re-discover parallelism each time an instruction is executed. Since each PE is responsible for a single operation in one embodiment, the register files and ports counts may be small, e.g., often only one, and therefore use less energy than their counterparts in core. Certain CSAs include many PEs, each of which holds live program values, giving the aggregate effect of a huge register file in a traditional architecture, which dramatically reduces memory accesses. In embodiments where the memory is multi-ported and distributed, a CSA may sustain many more outstanding memory requests and utilize more bandwidth than a core. These advantages may combine to yield an energy level per watt that is only a small percentage over the cost of the bare arithmetic circuitry. For example, in the case of an integer multiply, a CSA may consume no more than 25% more energy than the underlying multiplication circuit. Relative to one embodiment of a core, an integer operation in that CSA fabric consumes less than 1/30th of the energy per integer operation.

From a programming perspective, the application-specific malleability of embodiments of the CSA architecture yields significant advantages over a vector processing unit (VPU). In traditional, inflexible architectures, the number of functional units, like floating divide or the various transcendental mathematical functions, must be chosen at design time based on some expected use case. In embodiments of the CSA architecture, such functions may be configured (e.g., by a user and not a manufacturer) into the fabric based on the requirement of each application. Application throughput may thereby be further increased. Simultaneously, the compute density of embodiments of the CSA improves by avoiding hardening such functions, and instead provision more instances of primitive functions like floating multiplication. These advantages may be significant in HPC workloads, some of which spend 75% of floating execution time in transcendental functions.

Certain embodiments of the CSA represents a significant advance as a dataflow-oriented spatial architectures, e.g., the PEs of this disclosure may be smaller, but also more energy-efficient. These improvements may directly result from the combination of dataflow-oriented PEs with a lightweight, circuit switched interconnect, for example, which has single-cycle latency, e.g., in contrast to a packet switched network (e.g., with, at a minimum, a 300% higher latency). Certain embodiments of PEs support 32-bit or 64-bit operation. Certain embodiments herein permit the introduction of new application-specific PEs, for example, for machine learning or security, and not merely a homogeneous combination. Certain embodiments herein combine lightweight dataflow-oriented processing elements with a lightweight, low-latency network to form an energy efficient computational fabric.

In order for certain spatial architectures to be successful, programmers are to configure them with relatively little effort, e.g., while obtaining significant power and performance superiority over sequential cores. Certain embodiments herein provide for a CSA (e.g., spatial fabric) that is easily programmed (e.g., by a compiler), power efficient, and highly parallel. Certain embodiments herein provide for a (e.g., interconnect) network that achieves these three goals. From a programmability perspective, certain embodiments of the network provide flow controlled channels, e.g., which correspond to the control-dataflow graph (CDFG) model of execution used in compilers. Certain network embodiments utilize dedicated, circuit switched links, such that program performance is easier to reason about, both by a human and a compiler, because performance is predictable. Certain network embodiments offer both high bandwidth and low latency. Certain network embodiments (e.g., static, circuit switching) provides a latency of 0 to 1 cycle (e.g., depending on the transmission distance.) Certain network embodiments provide for a high bandwidth by laying out several networks in parallel, e.g., and in low-level metals. Certain network embodiments communicate in low-level metals and over short distances, and thus are very power efficient.

Certain embodiments of networks include architectural support for flow control. For example, in spatial accelerators composed of small processing elements (PEs), communications latency and bandwidth may be critical to overall program performance. Certain embodiments herein provide for a light-weight, circuit switched network which facilitates communication between PEs in spatial processing arrays, such as the spatial array shown in FIG. 23, and the micro-architectural control features necessary to support this network. Certain embodiments of a network enable the construction of point-to-point, flow controlled communications channels which support the communications of the dataflow oriented processing elements (PEs). In addition to point-to-point communications, certain networks herein also support multicast communications. Communications channels may be formed by statically configuring the network to from virtual circuits between PEs. Circuit switching techniques herein may decrease communications latency and commensurately minimize network buffering, e.g., resulting in both high performance and high energy efficiency. In certain embodiments of a network, inter-PE latency may be as low as a zero cycles, meaning that the downstream PE may operate on data in the cycle after it is produced. To obtain even higher bandwidth, and to admit more programs, multiple networks may be laid out in parallel, e.g., as shown in FIG. 23.

Spatial architectures, such as the one shown in FIG. 23, may be the composition of lightweight processing elements connected by an inter-PE network (and/or communications network (e.g., a network dataflow endpoint circuit thereof)). Programs, viewed as dataflow graphs, may be mapped onto the architecture by configuring PEs and the network. Generally, PEs may be configured as dataflow operators, and once (e.g., all) input operands arrive at the PE, some operation may then occur, and the result are forwarded to the desired downstream PEs. PEs may communicate over dedicated virtual circuits which are formed by statically configuring a circuit switched communications network. These virtual circuits may be flow controlled and fully back-pressured, e.g., such that PEs will stall if either the source has no data or the destination is full. At runtime, data may flow through the PEs implementing the mapped algorithm. For example, data may be streamed in from memory, through the fabric, and then back out to memory. Embodiments of this architecture may achieve remarkable performance efficiency relative to traditional multicore processors: for example, where compute, in the form of PEs, is simpler and more numerous than larger cores and communication are direct, e.g., as opposed to an extension of the memory system.

FIG. 23 illustrates an accelerator tile 2300 comprising an array of processing elements (PEs) according to embodiments of the disclosure. The interconnect network is depicted as circuit switched, statically configured communications channels. For example, a set of channels coupled together by a switch (e.g., switch 2310 in a first network and switch 2311 in a second network). The first network and second network may be separate or coupled together. For example, switch 2310 may couple one or more of the four data paths (2312, 2314, 2316, 2318) together, e.g., as configured to perform an operation according to a dataflow graph. In one embodiment, the number of data paths is any plurality. Processing element (e.g., processing element 2304) may be as disclosed herein, for example, as in FIG. 26. Accelerator tile 2300 includes a memory/cache hierarchy interface 2302, e.g., to interface the accelerator tile 2300 with a memory and/or cache. A data path (e.g., 2318) may extend to another tile or terminate, e.g., at the edge of a tile. A processing element may include an input buffer (e.g., buffer 2306) and an output buffer (e.g., buffer 2308).

Operations may be executed based on the availability of their inputs and the status of the PE. A PE may obtain operands from input channels and write results to output channels, although internal register state may also be used. Certain embodiments herein include a configurable dataflow-friendly PE. FIG. 26 shows a detailed block diagram of one such PE: the integer PE. This PE consists of several I/O buffers, an ALU, a storage register, some instruction registers, and a scheduler. Each cycle, the scheduler may select an instruction for execution based on the availability of the input and output buffers and the status of the PE. The result of the operation may then be written to either an output buffer or to a (e.g., local to the PE) register. Data written to an output buffer may be transported to a downstream PE for further processing. This style of PE may be extremely energy efficient, for example, rather than reading data from a complex, multi-ported register file, a PE reads the data from a register. Similarly, instructions may be stored directly in a register, rather than in a virtualized instruction cache.

Instruction registers may be set during a special configuration step. During this step, auxiliary control wires and state, in addition to the inter-PE network, may be used to stream in configuration across the several PEs comprising the fabric. As result of parallelism, certain embodiments of such a network may provide for rapid reconfiguration, e.g., a tile sized fabric may be configured in less than about 10 microseconds.

FIG. 26 represents one example configuration of a processing element, e.g., in which all architectural elements are minimally sized. In other embodiments, each of the components of a processing element is independently scaled to produce new PEs. For example, to handle more complicated programs, a larger number of instructions that are executable by a PE may be introduced. A second dimension of configurability is in the function of the PE arithmetic logic unit (ALU). In FIG. 26, an integer PE is depicted which may support addition, subtraction, and various logic operations. Other kinds of PEs may be created by substituting different kinds of functional units into the PE. An integer multiplication PE, for example, might have no registers, a single instruction, and a single output buffer. Certain embodiments of a PE decompose a fused multiply add (FMA) into separate, but tightly coupled floating multiply and floating add units to improve support for multiply-add-heavy workloads. PEs are discussed further below.

FIG. 24A illustrates a configurable data path network 2400 (e.g., of network one or network two discussed in reference to FIG. 23) according to embodiments of the disclosure. Network 2400 includes a plurality of multiplexers (e.g., multiplexers 2402, 2404, 2406) that may be configured (e.g., via their respective control signals) to connect one or more data paths (e.g., from PEs) together. FIG. 24B illustrates a configurable flow control path network 2401 (e.g., network one or network two discussed in reference to FIG. 23) according to embodiments of the disclosure. A network may be a light-weight PE-to-PE network. Certain embodiments of a network may be thought of as a set of composable primitives for the construction of distributed, point-to-point data channels. FIG. 24A shows a network that has two channels enabled, the bold black line and the dotted black line. The bold black line channel is multicast, e.g., a single input is sent to two outputs. Note that channels may cross at some points within a single network, even though dedicated circuit switched paths are formed between channel endpoints. Furthermore, this crossing may not introduce a structural hazard between the two channels, so that each operates independently and at full bandwidth.

Implementing distributed data channels may include two paths, illustrated in FIGS. 24A-24B. The forward, or data path, carries data from a producer to a consumer. Multiplexors may be configured to steer data and valid bits from the producer to the consumer, e.g., as in FIG. 24A. In the case of multicast, the data will be steered to multiple consumer endpoints. The second portion of this embodiment of a network is the flow control or backpressure path, which flows in reverse of the forward data path, e.g., as in FIG. 24B. Consumer endpoints may assert when they are ready to accept new data. These signals may then be steered back to the producer using configurable logical conjunctions, labelled as (e.g., backflow) flowcontrol function in FIG. 24B. In one embodiment, each flowcontrol function circuit may be a plurality of switches (e.g., muxes), for example, similar to FIG. 24A. The flow control path may handle returning control data from consumer to producer. Conjunctions may enable multicast, e.g., where each consumer is ready to receive data before the producer assumes that it has been received. In one embodiment, a PE is a PE that has a dataflow operator as its architectural interface. Additionally or alternatively, in one embodiment a PE may be any kind of PE (e.g., in the fabric), for example, but not limited to, a PE that has an instruction pointer, triggered instruction, or state machine based architectural interface.

The network may be statically configured, e.g., in addition to PEs being statically configured. During the configuration step, configuration bits may be set at each network component. These bits control, for example, the mux selections and flow control functions. A network may comprise a plurality of networks, e.g., a data path network and a flow control path network. A network or plurality of networks may utilize paths of different widths (e.g., a first width, and a narrower or wider width). In one embodiment, a data path network has a wider (e.g., bit transport) width than the width of a flow control path network. In one embodiment, each of a first network and a second network includes their own data path network and flow control path network, e.g., data path network A and flow control path network A and wider data path network B and flow control path network B.

Certain embodiments of a network are bufferless, and data is to move between producer and consumer in a single cycle. Certain embodiments of a network are also boundless, that is, the network spans the entire fabric. In one embodiment, one PE is to communicate with any other PE in a single cycle. In one embodiment, to improve routing bandwidth, several networks may be laid out in parallel between rows of PEs.

Relative to FPGAs, certain embodiments of networks herein have three advantages: area, frequency, and program expression. Certain embodiments of networks herein operate at a coarse grain, e.g., which reduces the number configuration bits, and thereby the area of the network. Certain embodiments of networks also obtain area reduction by implementing flow control logic directly in circuitry (e.g., silicon). Certain embodiments of hardened network implementations also enjoys a frequency advantage over FPGA. Because of an area and frequency advantage, a power advantage may exist where a lower voltage is used at throughput parity. Finally, certain embodiments of networks provide better high-level semantics than FPGA wires, especially with respect to variable timing, and thus those certain embodiments are more easily targeted by compilers. Certain embodiments of networks herein may be thought of as a set of composable primitives for the construction of distributed, point-to-point data channels.

In certain embodiments, a multicast source may not assert its data valid unless it receives a ready signal from each sink. Therefore, an extra conjunction and control bit may be utilized in the multicast case.

Like certain PEs, the network may be statically configured. During this step, configuration bits are set at each network component. These bits control, for example, the mux selection and flow control function. The forward path of our network requires some bits to swing its muxes. In the example shown in FIG. 24A, four bits per hop are required: the east and west muxes utilize one bit each, while the southbound mux utilize two bits. In this embodiment, four bits may be utilized for the data path, but 7 bits may be utilized for the flow control function (e.g., in the flow control path network). Other embodiments may utilize more bits, for example, if a CSA further utilizes a north-south direction. The flow control function may utilize a control bit for each direction from which flow control can come. This may enables the setting of the sensitivity of the flow control function statically. The table 1 below summarizes the Boolean algebraic implementation of the flow control function for the network in FIG. 24B, with configuration bits capitalized. In this example, seven bits are utilized.

TABLE 1
Flow Implementation

| | |
|---|---|
| readyToEast | (EAST_WEST_SENSITIVE + readyFromWest) * |
| | (EAST_SOUTH_SENSITIVE + readyFromSouth) |
| readyToWest | (WEST_EAST_SENSITIVE + readyFromEast) * |
| | (WEST_SOUTH_SENSITIVE + readyFromSouth) |
| readyToNorth | (NORTH_WEST_SENSITIVE + readyFromWest) * |
| | (NORTH_EAST_SENSITIVE + readyFromEast) * |
| | (NORTH_SOUTH_SENSITIVE + readyFromSouth) |

For the third flow control box from the left in FIG. 24B, EAST_WEST_SENSITIVE and NORTH_SOUTH_SENSITIVE are depicted as set to implement the flow control for the bold line and dotted line channels, respectively.

FIG. 25 illustrates a hardware processor tile 2500 comprising an accelerator 2502 according to embodiments of the disclosure. Accelerator 2502 may be a CSA according to this disclosure. Tile 2500 includes a plurality of cache banks (e.g., cache bank 2508). Request address file (RAF) circuits 2510 may be included, e.g., as discussed below in Section 3.2. ODI may refer to an On Die Interconnect, e.g., an interconnect stretching across an entire die connecting up all the tiles. OTI may refer to an On Tile Interconnect, for example, stretching across a tile, e.g., connecting cache banks on the tile together.

### 3.1 Processing Elements

In certain embodiments, a CSA includes an array of heterogeneous PEs, in which the fabric is composed of several types of PEs each of which implement only a subset of the dataflow operators. By way of example, FIG. 26 shows a provisional implementation of a PE capable of implementing a broad set of the integer and control operations. Other PEs, including those supporting floating point addition, floating point multiplication, buffering, and certain control operations may have a similar implementation style, e.g., with the appropriate (dataflow operator) circuitry substituted for the ALU. PEs (e.g., dataflow operators) of a CSA may be configured (e.g., programmed) before the beginning of execution to implement a particular dataflow operation from among the set that the PE supports. A configuration may include one or two control words which specify an opcode controlling the ALU, steer the various multiplexors within the PE, and actuate dataflow into and out of the PE channels. Dataflow operators may be implemented by microcoding these configurations bits. The depicted integer PE 2600 in FIG. 26 is organized as a single-stage logical pipeline flowing from top to bottom. Data enters PE 2600 from one of set of local networks, where it is registered in an input buffer for subsequent operation. Each PE may support a number of wide, data-oriented and narrow, control-oriented channels. The number of provisioned channels may vary based on PE functionality, but one embodiment of an integer-oriented PE has 2 wide and 1-2 narrow input and output channels. Although the integer PE is implemented as a single-cycle pipeline, other pipelining choices may be utilized. For example, multiplication PEs may have multiple pipeline stages.

PE execution may proceed in a dataflow style. Based on the configuration microcode, the scheduler may examine the status of the PE ingress and egress buffers, and, when all the inputs for the configured operation have arrived and the egress buffer of the operation is available, orchestrates the actual execution of the operation by a dataflow operator (e.g., on the ALU). The resulting value may be placed in the configured egress buffer. Transfers between the egress buffer of one PE and the ingress buffer of another PE may occur asynchronously as buffering becomes available. In certain embodiments, PEs are provisioned such that at least one dataflow operation completes per cycle. Section 2 discussed dataflow operator encompassing primitive operations, such as add, xor, or pick. Certain embodiments may provide advantages in energy, area, performance, and latency. In one embodiment, with an extension to a PE control path, more fused combinations may be enabled. In one embodiment, the width of the processing elements is 64 bits, e.g., for the heavy utilization of double-precision floating point computation in HPC and to support 64-bit memory addressing.

### 3.2 Communications Networks

Embodiments of the CSA microarchitecture provide a hierarchy of networks which together provide an implementation of the architectural abstraction of latency-insensitive channels across multiple communications scales. The lowest level of CSA communications hierarchy may be the local network. The local network may be statically circuit switched, e.g., using configuration registers to swing multiplexor(s) in the local network data-path to form fixed electrical paths between communicating PEs. In one embodiment, the configuration of the local network is set once per dataflow graph, e.g., at the same time as the PE configuration. In one embodiment, static, circuit switching optimizes for energy, e.g., where a large majority (perhaps greater than 95%) of CSA communications traffic will cross the local network. A program may include terms which are used in multiple expressions. To optimize for this case, embodiments herein provide for hardware support for multicast within the local network. Several local networks may be ganged together to form routing channels, e.g., which are interspersed (as a grid) between rows and columns of PEs. As an optimization, several local networks may be included to carry control tokens. In comparison to a FPGA interconnect, a CSA local network may be routed at the granularity of the data-path, and another difference may be a CSA's treatment of control. One embodiment of a CSA local network is explicitly flow controlled (e.g., back-pressured). For example, for each forward data-path and multiplexor set, a CSA is to provide a backward-flowing flow control path that is physically paired with the forward data-path. The combination of the two microarchitectural paths may provide a low-latency, low-energy, low-area, point-to-point implementation of the latency-insensitive channel abstraction. In one embodiment, a CSA's flow control lines are not visible to the user program, but they may be manipulated by the architecture in service of the user program. For example, the exception handling mechanisms described in Section 2.2 may be achieved by pulling flow control lines to a “not present” state upon the detection of an exceptional condition. This action may not only gracefully stalls those parts of the pipeline which are involved in the offending computation, but may also preserve the machine state leading up the exception, e.g., for diagnostic analysis. The second network layer, e.g., the mezzanine network, may be a shared, packet switched network. Mezzanine network may include a plurality of distributed network controllers, network dataflow endpoint circuits. The mezzanine network (e.g., the network schematically indicated by the dotted box in FIG. 39) may provide more general, long range communications, e.g., at the cost of latency, bandwidth, and energy. In some programs, most communications may occur on the local network, and thus mezzanine network provisioning will be considerably reduced in comparison, for example, each PE may connects to multiple local networks, but the CSA will provision only one mezzanine endpoint per logical neighborhood of PEs. Since the mezzanine is effectively a shared network, each mezzanine network may carry multiple logically independent channels, e.g., and be provisioned with multiple virtual channels. In one embodiment, the main function of the mezzanine network is to provide wide-range communications in-between PEs and between PEs and memory. In addition to this capability, the mezzanine may also include network dataflow endpoint circuit(s), for example, to perform certain dataflow operations. In addition to this capability, the mezzanine may also operate as a runtime support network, e.g., by which various services may access the complete fabric in a user-program-transparent manner. In this capacity, the mezzanine endpoint may function as a controller for its local neighborhood, for example, during CSA configuration. To form channels spanning a CSA tile, three subchannels and two local network channels (which carry traffic to and from a single channel in the mezzanine network) may be utilized. In one embodiment, one mezzanine channel is utilized, e.g., one mezzanine and two local=3 total network hops.

The composability of channels across network layers may be extended to higher level network layers at the inter-tile, inter-die, and fabric granularities.

FIG. 26 illustrates a processing element 2600 according to embodiments of the disclosure. In one embodiment, operation configuration register 2619 is loaded during configuration (e.g., mapping) and specifies the particular operation (or operations) this processing (e.g., compute) element is to perform. Register 2620 activity may be controlled by that operation (an output of mux 2616, e.g., controlled by the scheduler 2614). Scheduler 2614 may schedule an operation or operations of processing element 2600, for example, when input data and control input arrives. Control input buffer 2622 is connected to local network 2602 (e.g., and local network 2602 may include a data path network as in FIG. 24A and a flow control path network as in FIG. 24B) and is loaded with a value when it arrives (e.g., the network has a data bit(s) and valid bit(s)). Control output buffer 2632, data output buffer 2634, and/or data output buffer 2636 may receive an output of processing element 2600, e.g., as controlled by the operation (an output of mux 2616). Status register 2638 may be loaded whenever the ALU 2618 executes (also controlled by output of mux 2616). Data in control input buffer 2622 and control output buffer 2632 may be a single bit. Mux 2621 (e.g., operand A) and mux 2623 (e.g., operand B) may source inputs.

For example, suppose the operation of this processing (e.g., compute) element is (or includes) what is called a pick in FIG. 14B. The processing element 2600 then is to select data from either data input buffer 2624 or data input buffer 2626, e.g., to go to data output buffer 2634 (e.g., default) or data output buffer 2636. The control bit in 2622 may thus indicate a 0 if selecting from data input buffer 2624 or a 1 if selecting from data input buffer 2626.

For example, suppose the operation of this processing (e.g., compute) element is (or includes) what is called a switch in FIG. 14B. The processing element 2600 is to output data to data output buffer 2634 or data output buffer 2636, e.g., from data input buffer 2624 (e.g., default) or data input buffer 2626. The control bit in 2622 may thus indicate a 0 if outputting to data output buffer 2634 or a 1 if outputting to data output buffer 2636.

Multiple networks (e.g., interconnects) may be connected to a processing element, e.g., (input) networks 2602, 2604, 2606 and (output) networks 2608, 2610, 2612. The connections may be switches, e.g., as discussed in reference to FIGS. 24A and 24B. In one embodiment, each network includes two sub-networks (or two channels on the network), e.g., one for the data path network in FIG. 24A and one for the flow control (e.g., backpressure) path network in FIG. 24B. As one example, local network 2602 (e.g., set up as a control interconnect) is depicted as being switched (e.g., connected) to control input buffer 2622. In this embodiment, a data path (e.g., network as in FIG. 24A) may carry the control input value (e.g., bit or bits) (e.g., a control token) and the flow control path (e.g., network) may carry the backpressure signal (e.g., backpressure or no-backpressure token) from control input buffer 2622, e.g., to indicate to the upstream producer (e.g., PE) that a new control input value is not to be loaded into (e.g., sent to) control input buffer 2622 until the backpressure signal indicates there is room in the control input buffer 2622 for the new control input value (e.g., from a control output buffer of the upstream producer). In one embodiment, the new control input value may not enter control input buffer 2622 until both (i) the upstream producer receives the “space available” backpressure signal from “control input” buffer 2622 and (ii) the new control input value is sent from the upstream producer, e.g., and this may stall the processing element 2600 until that happens (and space in the target, output buffer(s) is available).

Data input buffer 2624 and data input buffer 2626 may perform similarly, e.g., local network 2604 (e.g., set up as a data (as opposed to control) interconnect) is depicted as being switched (e.g., connected) to data input buffer 2624. In this embodiment, a data path (e.g., network as in FIG. 24A) may carry the data input value (e.g., bit or bits) (e.g., a dataflow token) and the flow control path (e.g., network) may carry the backpressure signal (e.g., backpressure or no-backpressure token) from data input buffer 2624, e.g., to indicate to the upstream producer (e.g., PE) that a new data input value is not to be loaded into (e.g., sent to) data input buffer 2624 until the backpressure signal indicates there is room in the data input buffer 2624 for the new data input value (e.g., from a data output buffer of the upstream producer). In one embodiment, the new data input value may not enter data input buffer 2624 until both (i) the upstream producer receives the “space available” backpressure signal from “data input” buffer 2624 and (ii) the new data input value is sent from the upstream producer, e.g., and this may stall the processing element 2600 until that happens (and space in the target, output buffer(s) is available). A control output value and/or data output value may be stalled in their respective output buffers (e.g., 2632, 2634, 2636) until a backpressure signal indicates there is available space in the input buffer for the downstream processing element(s).

A processing element 2600 may be stalled from execution until its operands (e.g., a control input value and its corresponding data input value or values) are received and/or until there is room in the output buffer(s) of the processing element 2600 for the data that is to be produced by the execution of the operation on those operands.

### 3.3 Memory Interface

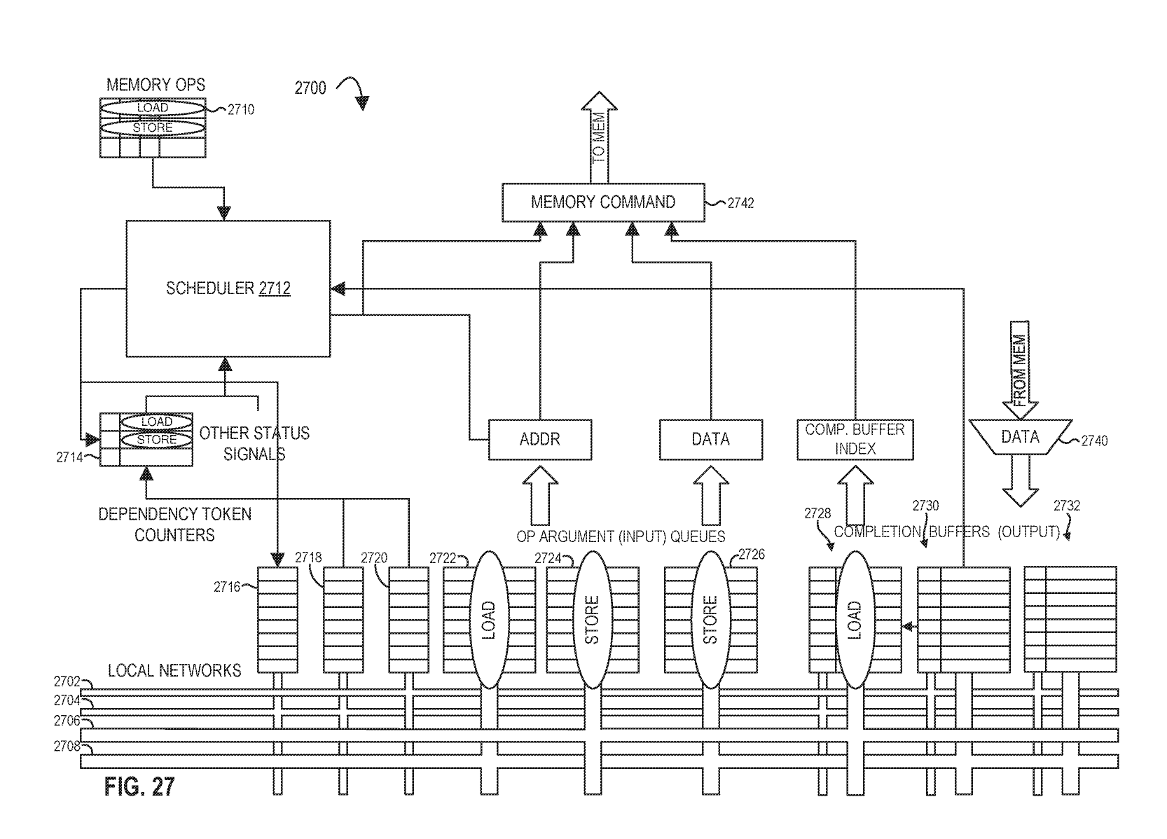

The request address file (RAF) circuit, a simplified version of which is shown in FIG. 27, may be responsible for executing memory operations and serves as an intermediary between the CSA fabric and the memory hierarchy. As such, the main microarchitectural task of the RAF may be to rationalize the out-of-order memory subsystem with the in-order semantics of CSA fabric. In this capacity, the RAF circuit may be provisioned with completion buffers, e.g., queue-like structures that re-order memory responses and return them to the fabric in the request order. The second major functionality of the RAF circuit may be to provide support in the form of address translation and a page walker. Incoming virtual addresses may be translated to physical addresses using a channel-associative translation lookaside buffer (TLB). To provide ample memory bandwidth, each CSA tile may include multiple RAF circuits. Like the various PEs of the fabric, the RAF circuits may operate in a dataflow-style by checking for the availability of input arguments and output buffering, if required, before selecting a memory operation to execute. Unlike some PEs, however, the RAF circuit is multiplexed among several co-located memory operations. A multiplexed RAF circuit may be used to minimize the area overhead of its various subcomponents, e.g., to share the Accelerator Cache Interface (ACI) port (described in more detail in Section 3.4), shared virtual memory (SVM) support hardware, mezzanine network interface, and other hardware management facilities. However, there are some program characteristics that may also motivate this choice. In one embodiment, a (e.g., valid) dataflow graph is to poll memory in a shared virtual memory system. Memory-latency-bound programs, like graph traversals, may utilize many separate memory operations to saturate memory bandwidth due to memory-dependent control flow. Although each RAF may be multiplexed, a CSA may include multiple (e.g., between 8 and 32) RAFs at a tile granularity to ensure adequate cache bandwidth. RAFs may communicate with the rest of the fabric via both the local network and the mezzanine network. Where RAFs are multiplexed, each RAF may be provisioned with several ports into the local network. These ports may serve as a minimum-latency, highly-deterministic path to memory for use by latency-sensitive or high-bandwidth memory operations. In addition, a RAF may be provisioned with a mezzanine network endpoint, e.g., which provides memory access to runtime services and distant user-level memory accessors.

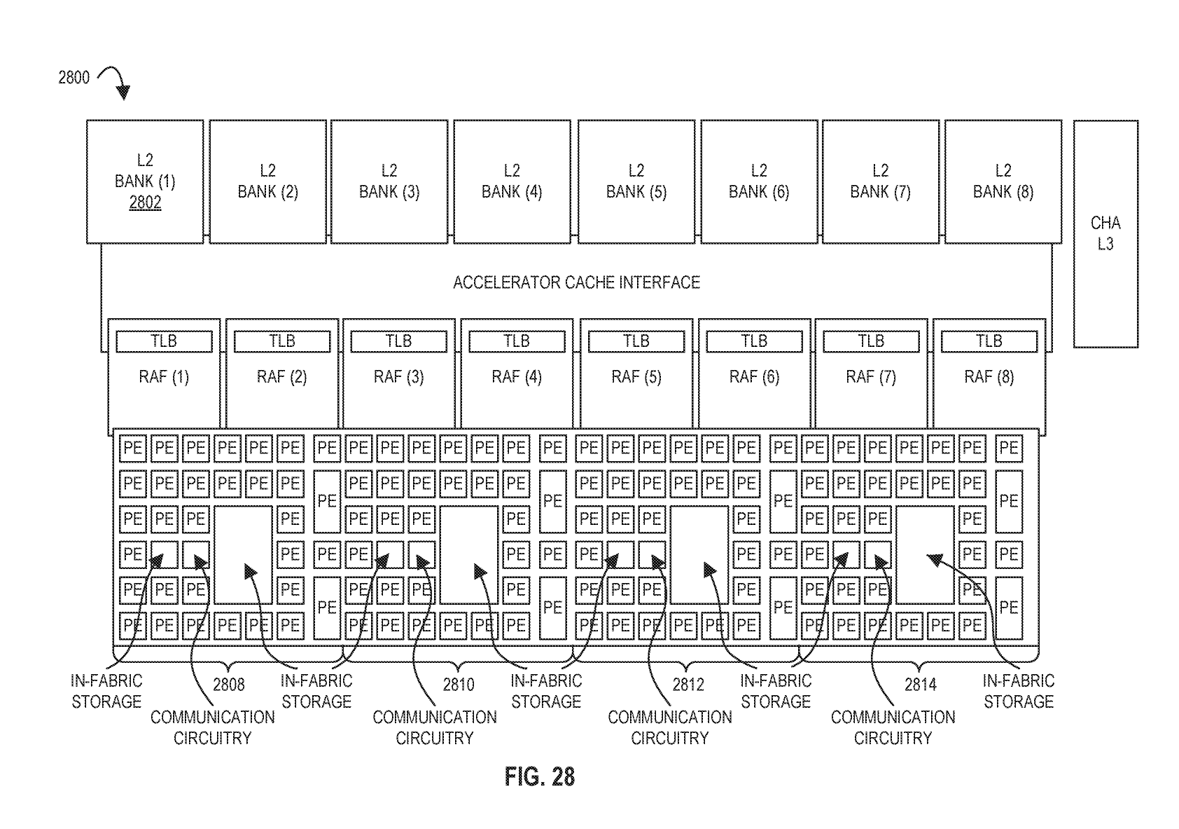

FIG. 27 illustrates a request address file (RAF) circuit 2700 according to embodiments of the disclosure. In one embodiment, at configuration time, the memory load and store operations that were in a dataflow graph are specified in registers 2710. The arcs to those memory operations in the dataflow graphs may then be connected to the input queues 2722, 2724, and 2726. The arcs from those memory operations are thus to leave completion buffers 2728, 2730, or 2732. Dependency tokens (which may be single bits) arrive into queues 2718 and 2720. Dependency tokens are to leave from queue 2716. Dependency token counter 2714 may be a compact representation of a queue and track a number of dependency tokens used for any given input queue. If the dependency token counters 2714 saturate, no additional dependency tokens may be generated for new memory operations. Accordingly, a memory ordering circuit (e.g., a RAF in FIG. 28) may stall scheduling new memory operations until the dependency token counters 2714 becomes unsaturated.

As an example for a load, an address arrives into queue 2722 which the scheduler 2712 matches up with a load in 2710. A completion buffer slot for this load is assigned in the order the address arrived. Assuming this particular load in the graph has no dependencies specified, the address and completion buffer slot are sent off to the memory system by the scheduler (e.g., via memory command 2742). When the result returns to mux 2740 (shown schematically), it is stored into the completion buffer slot it specifies (e.g., as it carried the target slot all along though the memory system). The completion buffer sends results back into local network (e.g., local network 2702, 2704, 2706, or 2708) in the order the addresses arrived.

Stores may be similar except both address and data have to arrive before any operation is sent off to the memory system.

### 3.4 Cache

Dataflow graphs may be capable of generating a profusion of (e.g., word granularity) requests in parallel. Thus, certain embodiments of the CSA provide a cache subsystem with sufficient bandwidth to service the CSA. A heavily banked cache microarchitecture, e.g., as shown in FIG. 28 may be utilized. FIG. 28 illustrates a circuit 2800 with a plurality of request address file (RAF) circuits (e.g., RAF circuit (1)) coupled between a plurality of accelerator tiles (2808, 2810, 2812, 2814) and a plurality of cache banks (e.g., cache bank 2802) according to embodiments of the disclosure. In one embodiment, the number of RAFs and cache banks may be in a ratio of either 1:1 or 1:2. Cache banks may contain full cache lines (e.g., as opposed to sharing by word), with each line having exactly one home in the cache. Cache lines may be mapped to cache banks via a pseudo-random function. The CSA may adopts the SVM model to integrate with other tiled architectures. Certain embodiments include an Accelerator Cache Interconnect (ACI) network connecting the RAFs to the cache banks. This network may carry address and data between the RAFs and the cache. The topology of the ACI may be a cascaded crossbar, e.g., as a compromise between latency and implementation complexity.

### 3.5 Floating Point Support

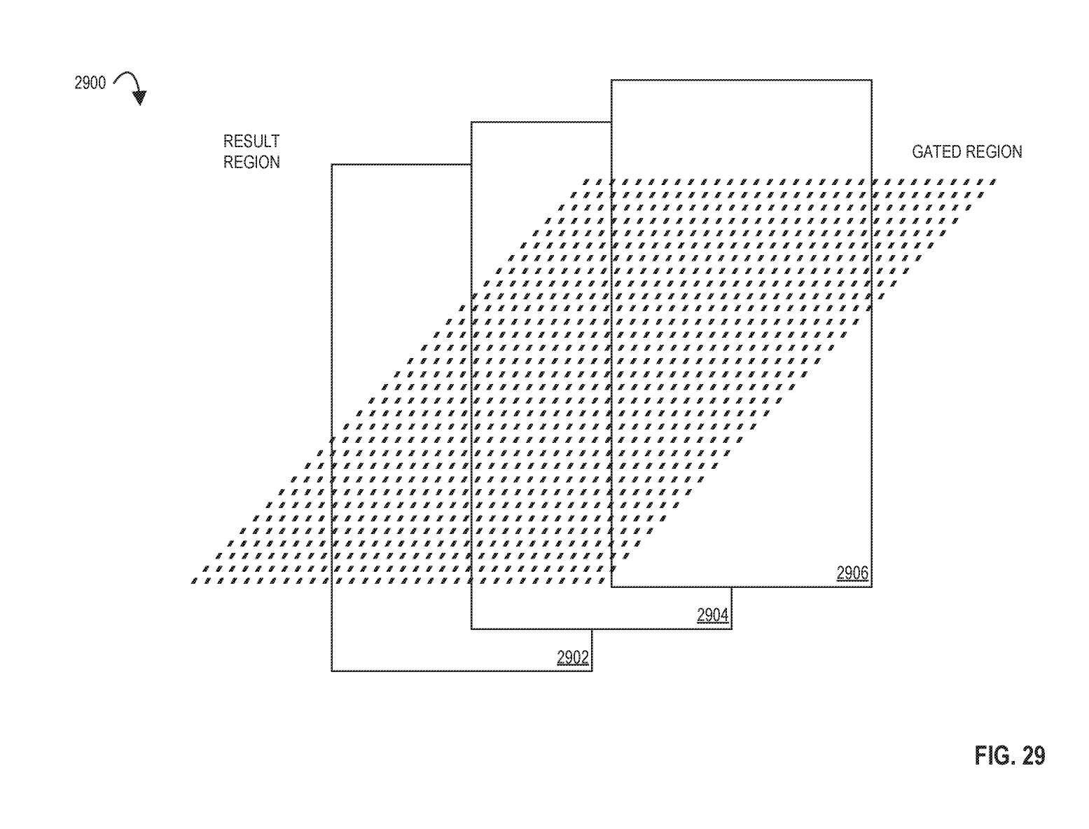

Certain HPC applications are characterized by their need for significant floating point bandwidth. To meet this need, embodiments of a CSA may be provisioned with multiple (e.g., between 128 and 256 each) of floating add and multiplication PEs, e.g., depending on tile configuration. A CSA may provide a few other extended precision modes, e.g., to simplify math library implementation. CSA floating point PEs may support both single and double precision, but lower precision PEs may support machine learning workloads. A CSA may provide an order of magnitude more floating point performance than a processor core. In one embodiment, in addition to increasing floating point bandwidth, in order to power all of the floating point units, the energy consumed in floating point operations is reduced. For example, to reduce energy, a CSA may selectively gate the low-order bits of the floating point multiplier array. In examining the behavior of floating point arithmetic, the low order bits of the multiplication array may often not influence the final, rounded product. FIG. 29 illustrates a floating point multiplier 2900 partitioned into three regions (the result region, three potential carry regions (2902, 2904, 2906), and the gated region) according to embodiments of the disclosure. In certain embodiments, the carry region is likely to influence the result region and the gated region is unlikely to influence the result region. Considering a gated region of g bits, the maximum carry may be:

$${carry}_{g} \leq \frac{1}{{2}^{g}} {\sum }_{1}^{g} i {2}^{i - 1} \leq {\sum }_{1}^{g} \frac{i}{{2}^{g}} - {\sum }_{1}^{g} \frac{1}{{2}^{g}} + 1 \leq g - 1$$

Given this maximum carry, if the result of the carry region is less than 2^{c}−g, where the carry region is c bits wide, then the gated region may be ignored since it does not influence the result region. Increasing g means that it is more likely the gated region will be needed, while increasing c means that, under random assumption, the gated region will be unused and may be disabled to avoid energy consumption. In embodiments of a CSA floating multiplication PE, a two stage pipelined approach is utilized in which first the carry region is determined and then the gated region is determined if it is found to influence the result. If more information about the context of the multiplication is known, a CSA more aggressively tune the size of the gated region. In FMA, the multiplication result may be added to an accumulator, which is often much larger than either of the multiplicands. In this case, the addend exponent may be observed in advance of multiplication and the CSDA may adjust the gated region accordingly. One embodiment of the CSA includes a scheme in which a context value, which bounds the minimum result of a computation, is provided to related multipliers, in order to select minimum energy gating configurations.

### 3.6 Runtime Services

In certain embodiment, a CSA includes a heterogeneous and distributed fabric, and consequently, runtime service implementations are to accommodate several kinds of PEs in a parallel and distributed fashion. Although runtime services in a CSA may be critical, they may be infrequent relative to user-level computation. Certain implementations, therefore, focus on overlaying services on hardware resources. To meet these goals, CSA runtime services may be cast as a hierarchy, e.g., with each layer corresponding to a CSA network. At the tile level, a single external-facing controller may accepts or sends service commands to an associated core with the CSA tile. A tile-level controller may serve to coordinate regional controllers at the RAFs, e.g., using the ACI network. In turn, regional controllers may coordinate local controllers at certain mezzanine network stops (e.g., network dataflow endpoint circuits). At the lowest level, service specific micro-protocols may execute over the local network, e.g., during a special mode controlled through the mezzanine controllers. The micro-protocols may permit each PE (e.g., PE class by type) to interact with the runtime service according to its own needs. Parallelism is thus implicit in this hierarchical organization, and operations at the lowest levels may occur simultaneously. This parallelism may enables the configuration of a CSA tile in between hundreds of nanoseconds to a few microseconds, e.g., depending on the configuration size and its location in the memory hierarchy. Embodiments of the CSA thus leverage properties of dataflow graphs to improve implementation of each runtime service. One key observation is that runtime services may need only to preserve a legal logical view of the dataflow graph, e.g., a state that can be produced through some ordering of dataflow operator executions. Services may generally not need to guarantee a temporal view of the dataflow graph, e.g., the state of a dataflow graph in a CSA at a specific point in time. This may permit the CSA to conduct most runtime services in a distributed, pipelined, and parallel fashion, e.g., provided that the service is orchestrated to preserve the logical view of the dataflow graph. The local configuration micro-protocol may be a packet-based protocol overlaid on the local network. Configuration targets may be organized into a configuration chain, e.g., which is fixed in the microarchitecture. Fabric (e.g., PE) targets may be configured one at a time, e.g., using a single extra register per target to achieve distributed coordination. To start configuration, a controller may drive an out-of-band signal which places all fabric targets in its neighborhood into an unconfigured, paused state and swings multiplexors in the local network to a pre-defined conformation. As the fabric (e.g., PE) targets are configured, that is they completely receive their configuration packet, they may set their configuration microprotocol registers, notifying the immediately succeeding target (e.g., PE) that it may proceed to configure using the subsequent packet. There is no limitation to the size of a configuration packet, and packets may have dynamically variable length. For example, PEs configuring constant operands may have a configuration packet that is lengthened to include the constant field (e.g., X and Y in FIGS. 20B-20C). FIG. 30 illustrates an in-flight configuration of an accelerator 3000 with a plurality of processing elements (e.g., PEs 3002, 3004, 3006, 3008) according to embodiments of the disclosure. Once configured, PEs may execute subject to dataflow constraints. However, channels involving unconfigured PEs may be disabled by the microarchitecture, e.g., preventing any undefined operations from occurring. These properties allow embodiments of a CSA to initialize and execute in a distributed fashion with no centralized control whatsoever. From an unconfigured state, configuration may occur completely in parallel, e.g., in perhaps as few as 200 nanoseconds. However, due to the distributed initialization of embodiments of a CSA, PEs may become active, for example sending requests to memory, well before the entire fabric is configured. Extraction may proceed in much the same way as configuration. The local network may be conformed to extract data from one target at a time, and state bits used to achieve distributed coordination. A CSA may orchestrate extraction to be non-destructive, that is, at the completion of extraction each extractable target has returned to its starting state. In this implementation, all state in the target may be circulated to an egress register tied to the local network in a scan-like fashion. Although in-place extraction may be achieved by introducing new paths at the register-transfer level (RTL), or using existing lines to provide the same functionalities with lower overhead. Like configuration, hierarchical extraction is achieved in parallel.

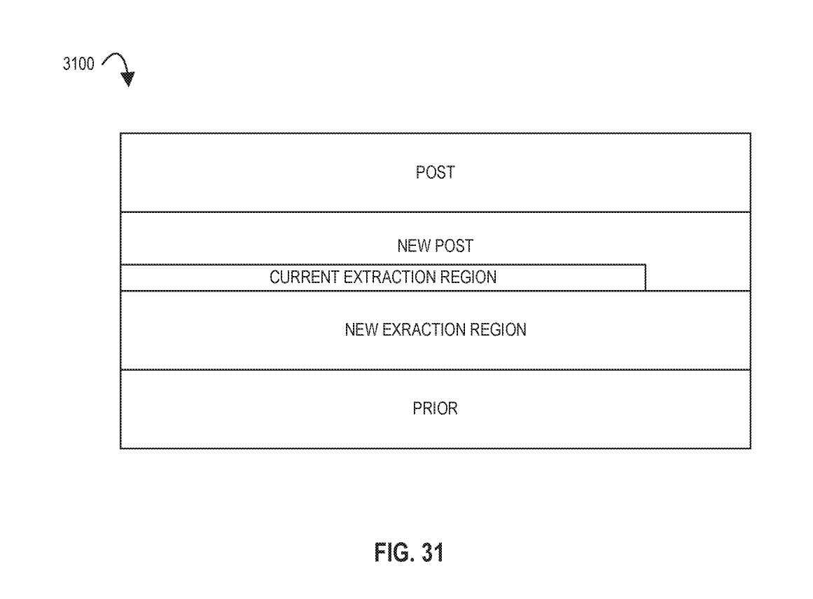

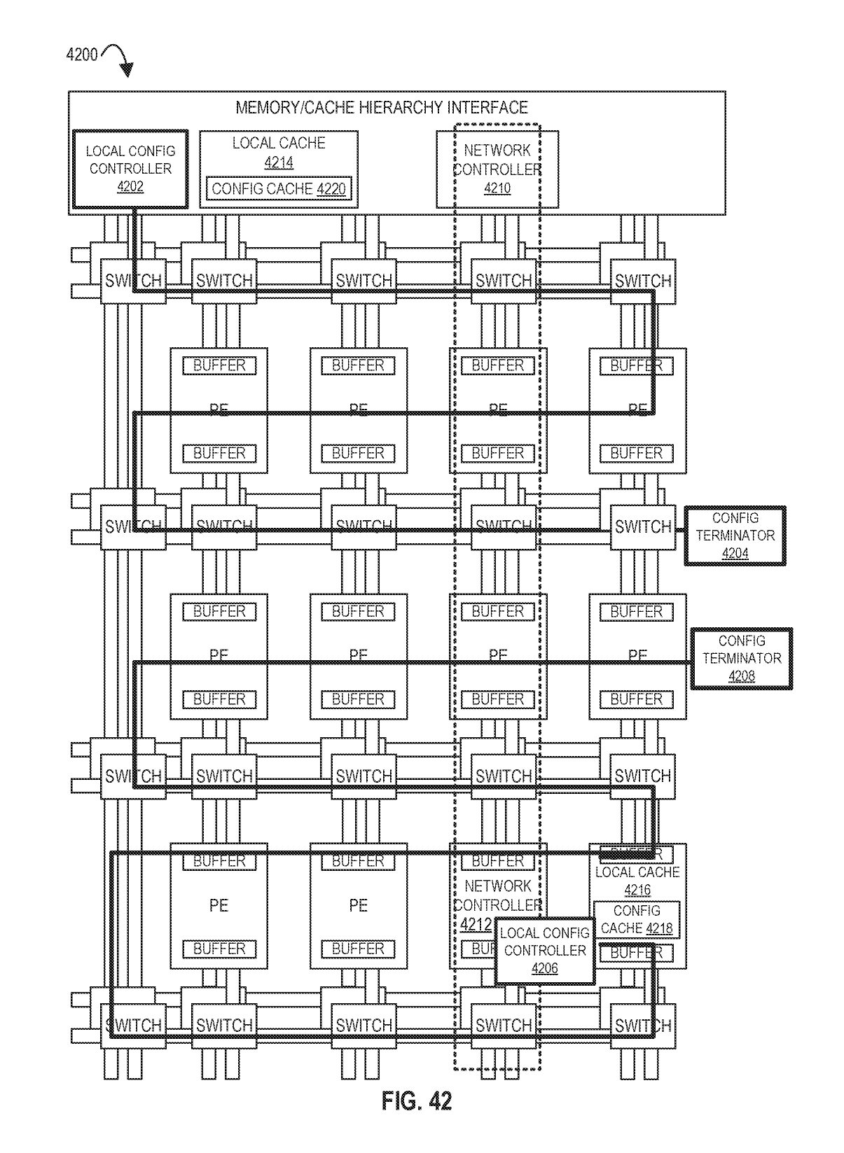

FIG. 31 illustrates a snapshot 3100 of an in-flight, pipelined extraction according to embodiments of the disclosure. In some use cases of extraction, such as checkpointing, latency may not be a concern so long as fabric throughput is maintained. In these cases, extraction may be orchestrated in a pipelined fashion. This arrangement, shown in FIG. 31, permits most of the fabric to continue executing, while a narrow region is disabled for extraction. Configuration and extraction may be coordinated and composed to achieve a pipelined context switch. Exceptions may differ qualitatively from configuration and extraction in that, rather than occurring at a specified time, they arise anywhere in the fabric at any point during runtime. Thus, in one embodiment, the exception micro-protocol may not be overlaid on the local network, which is occupied by the user program at runtime, and utilizes its own network. However, by nature, exceptions are rare and insensitive to latency and bandwidth. Thus certain embodiments of CSA utilize a packet switched network to carry exceptions to the local mezzanine stop, e.g., where they are forwarded up the service hierarchy (e.g., as in FIG. 42). Packets in the local exception network may be extremely small. In many cases, a PE identification (ID) of only two to eight bits suffices as a complete packet, e.g., since the CSA may create a unique exception identifier as the packet traverses the exception service hierarchy. Such a scheme may be desirable because it also reduces the area overhead of producing exceptions at each PE.

### 4. Compilation

The ability to compile programs written in high-level languages onto a CSA may be essential for industry adoption. This section gives a high-level overview of compilation strategies for embodiments of a CSA. First is a proposal for a CSA software framework that illustrates the desired properties of an ideal production-quality toolchain. Next, a prototype compiler framework is discussed. A “control-to-dataflow conversion” is then discussed, e.g., to converts ordinary sequential control-flow code into CSA dataflow assembly code.

### 4.1 Example Production Framework

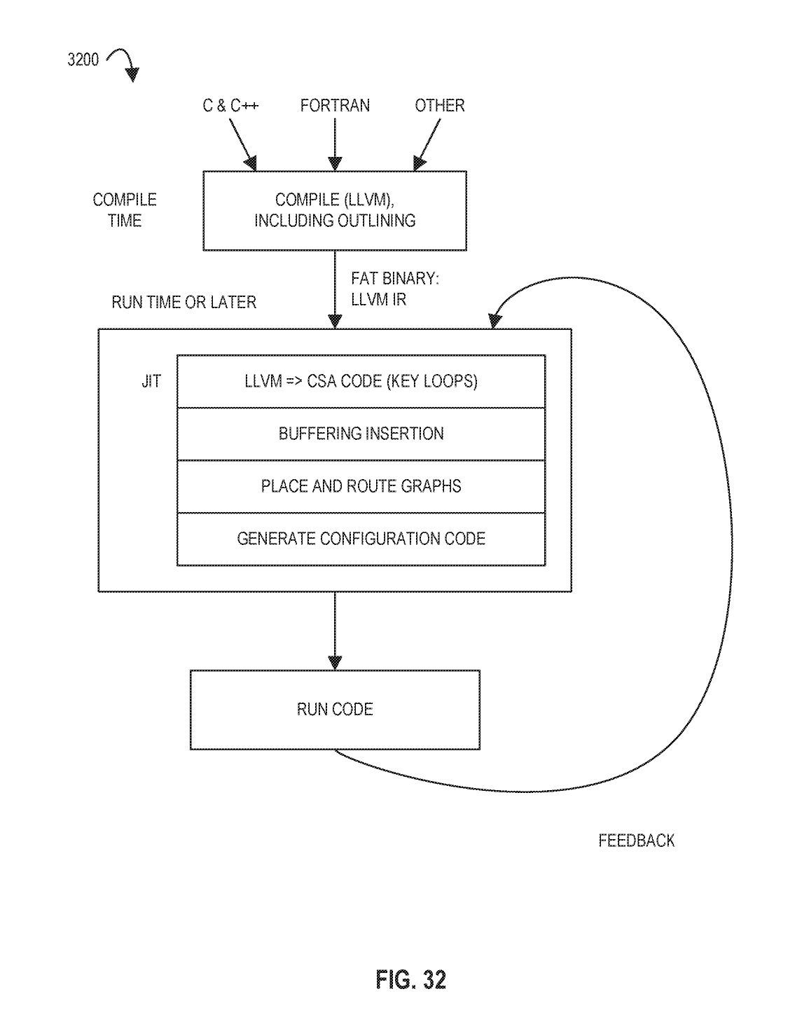

FIG. 32 illustrates a compilation toolchain 3200 for an accelerator according to embodiments of the disclosure. This toolchain compiles high-level languages (such as C, C++, and Fortran) into a combination of host code (LLVM) intermediate representation (IR) for the specific regions to be accelerated. The CSA-specific portion of this compilation toolchain takes LLVM IR as its input, optimizes and compiles this IR into a CSA assembly, e.g., adding appropriate buffering on latency-insensitive channels for performance. It then places and routes the CSA assembly on the hardware fabric, and configures the PEs and network for execution. In one embodiment, the toolchain supports the CSA-specific compilation as a just-in-time (JIT), incorporating potential runtime feedback from actual executions. One of the key design characteristics of the framework is compilation of (LLVM) IR for the CSA, rather than using a higher-level language as input. While a program written in a high-level programming language designed specifically for the CSA might achieve maximal performance and/or energy efficiency, the adoption of new high-level languages or programming frameworks may be slow and limited in practice because of the difficulty of converting existing code bases. Using (LLVM) IR as input enables a wide range of existing programs to potentially execute on a CSA, e.g., without the need to create a new language or significantly modify the front-end of new languages that want to run on the CSA.

### 4.2 Prototype Compiler

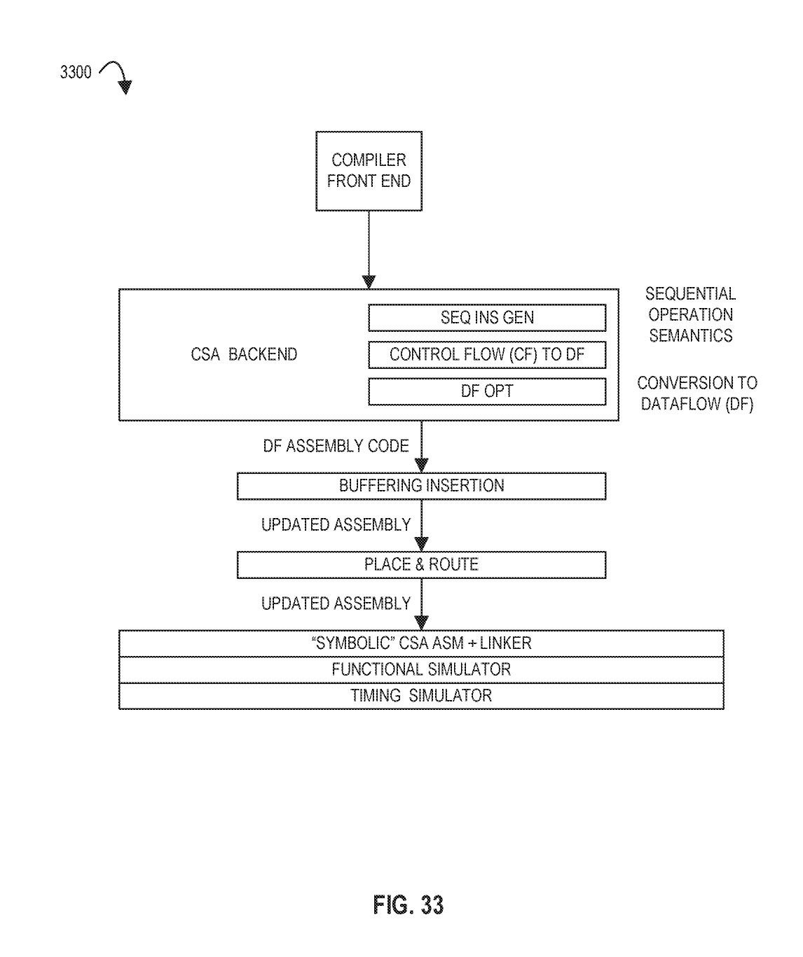

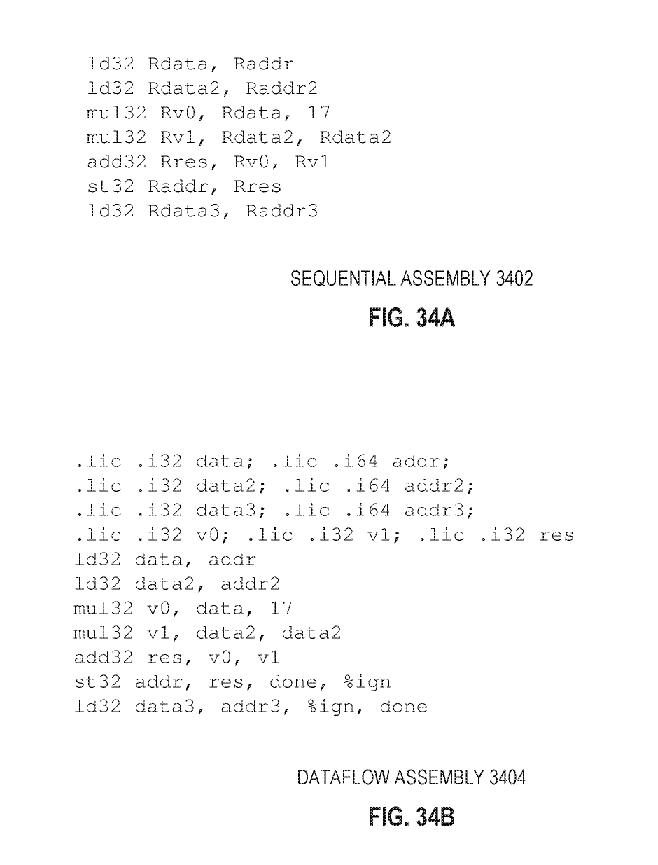

FIG. 33 illustrates a compiler 3300 for an accelerator according to embodiments of the disclosure. Compiler 3300 initially focuses on ahead-of-time compilation of C and C++ through the (e.g., Clang) front-end. To compile (LLVM) IR, the compiler implements a CSA back-end target within LLVM with three main stages. First, the CSA back-end lowers LLVM IR into a target-specific machine instructions for the sequential unit, which implements most CSA operations combined with a traditional RISC-like control-flow architecture (e.g., with branches and a program counter). The sequential unit in the toolchain may serve as a useful aid for both compiler and application developers, since it enables an incremental transformation of a program from control flow (CF) to dataflow (DF), e.g., converting one section of code at a time from control-flow to dataflow and validating program correctness. The sequential unit may also provide a model for handling code that does not fit in the spatial array. Next, the compiler converts these control-flow instructions into dataflow operators (e.g., code) for the CSA. This phase is described later in Section 4.3. Then, the CSA back-end may run its own optimization passes on the dataflow instructions. Finally, the compiler may dump the instructions in a CSA assembly format. This assembly format is taken as input to late-stage tools which place and route the dataflow instructions on the actual CSA hardware.

### 4.3 Control to Dataflow Conversion

A key portion of the compiler may be implemented in the control-to-dataflow conversion pass, or dataflow conversion pass for short. This pass takes in a function represented in control flow form, e.g., a control-flow graph (CFG) with sequential machine instructions operating on virtual registers, and converts it into a dataflow function that is conceptually a graph of dataflow operations (instructions) connected by latency-insensitive channels (LICs). This section gives a high-level description of this pass, describing how it conceptually deals with memory operations, branches, and loops in certain embodiments.

### Straight-Line Code

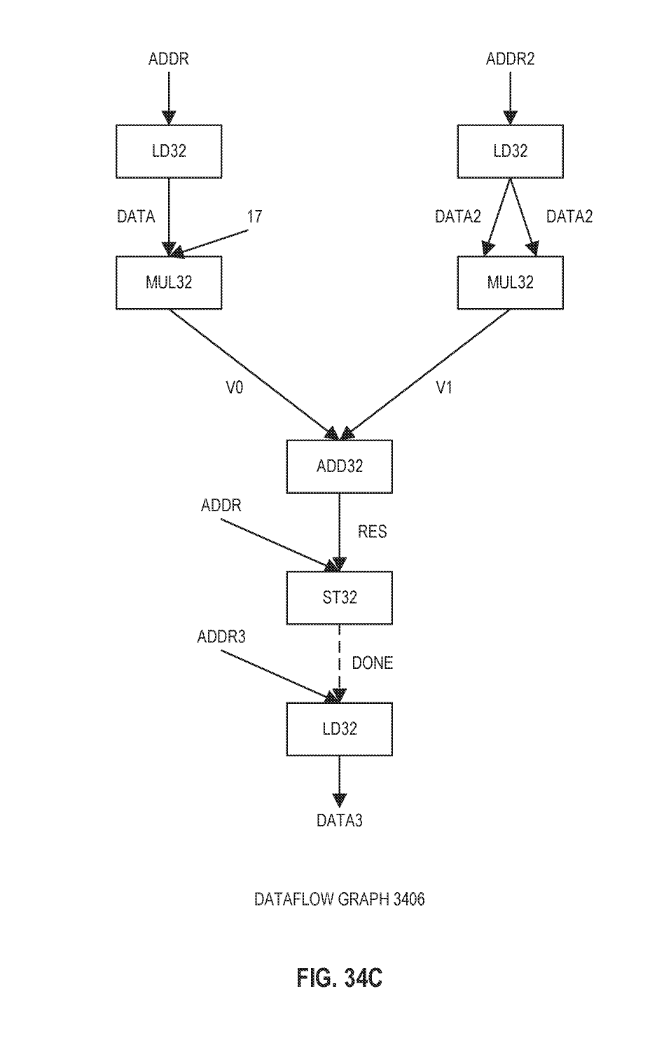

FIG. 34A illustrates sequential assembly code 3402 according to embodiments of the disclosure. FIG. 34B illustrates dataflow assembly code 3404 for the sequential assembly code 3402 of FIG. 34A according to embodiments of the disclosure. FIG. 34C illustrates a dataflow graph 3406 for the dataflow assembly code 3404 of FIG. 34B for an accelerator according to embodiments of the disclosure.

First, consider the simple case of converting straight-line sequential code to dataflow. The dataflow conversion pass may convert a basic block of sequential code, such as the code shown in FIG. 34A into CSA assembly code, shown in FIG. 34B. Conceptually, the CSA assembly in FIG. 34B represents the dataflow graph shown in FIG. 34C. In this example, each sequential instruction is translated into a matching CSA assembly. The .lic statements (e.g., for data) declare latency-insensitive channels which correspond to the virtual registers in the sequential code (e.g., Rdata). In practice, the input to the dataflow conversion pass may be in numbered virtual registers. For clarity, however, this section uses descriptive register names. Note that load and store operations are supported in the CSA architecture in this embodiment, allowing for many more programs to run than an architecture supporting only pure dataflow. Since the sequential code input to the compiler is in SSA (singlestatic assignment) form, for a simple basic block, the control-to-dataflow pass may convert each virtual register definition into the production of a single value on a latency-insensitive channel. The SSA form allows multiple uses of a single definition of a virtual register, such as in Rdata2). To support this model, the CSA assembly code supports multiple uses of the same LIC (e.g., data2), with the simulator implicitly creating the necessary copies of the LICs. One key difference between sequential code and dataflow code is in the treatment of memory operations. The code in FIG. 34A is conceptually serial, which means that the load32 (ld32) of addr3 should appear to happen after the st32 of addr, in case that addr and addr3 addresses overlap.

### Branches

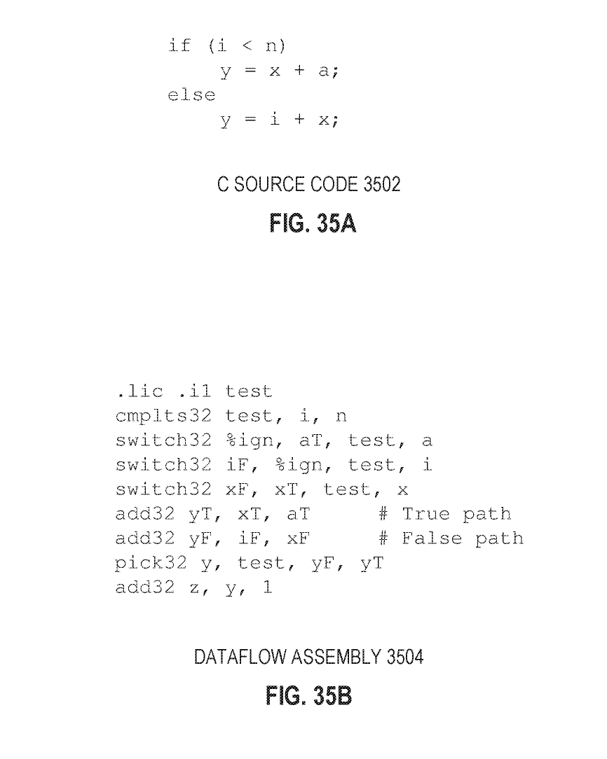

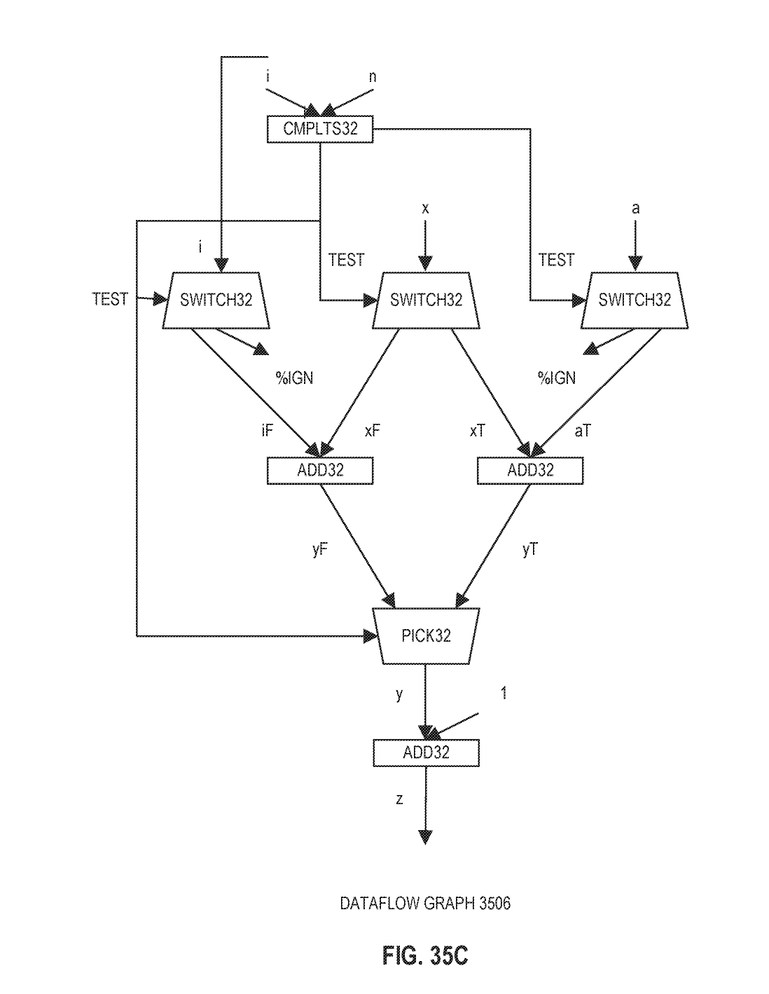

To convert programs with multiple basic blocks and conditionals to dataflow, the compiler generates special dataflow operators to replace the branches. More specifically, the compiler uses switch operators to steer outgoing data at the end of a basic block in the original CFG, and pick operators to select values from the appropriate incoming channel at the beginning of a basic block. As a concrete example, consider the code and corresponding dataflow graph in FIGS. 35A-35C, which conditionally computes a value of y based on several inputs: a i, x, and n. After computing the branch condition test, the dataflow code uses a switch operator (e.g., see FIGS. 20B-20C) steers the value in channel x to channel xF if test is 0, or channel xT if test is 1. Similarly, a pick operator (e.g., see FIGS. 20B-20C) is used to send channel yF to y if test is 0, or send channel yT to y if test is 1. In this example, it turns out that even though the value of a is only used in the true branch of the conditional, the CSA is to include a switch operator which steers it to channel aT when test is 1, and consumes (eats) the value when test is 0. This latter case is expressed by setting the false output of the switch to % ign. It may not be correct to simply connect channel a directly to the true path, because in the cases where execution actually takes the false path, this value of “a” will be left over in the graph, leading to incorrect value of A for the next execution of the function. This example highlights the property of control equivalence, a key property in embodiments of correct dataflow conversion.

Control Equivalence:

Consider a single-entry-single-exit control flow graph G with two basic blocks A and B. A and B are control-equivalent if all complete control flow paths through G visit A and B the same number of times.

LIC Replacement:

In a control flow graph G, suppose an operation in basic block A defines a virtual register x, and an operation in basic block B that uses x. Then a correct control-to-dataflow transformation can replace x with a latency-insensitive channel only if A and B are control equivalent. The control-equivalence relation partitions the basic blocks of a CFG into strong control-dependence regions. FIG. 35A illustrates C source code 3502 according to embodiments of the disclosure. FIG. 35B illustrates dataflow assembly code 3504 for the C source code 3502 of FIG. 35A according to embodiments of the disclosure. FIG. 35C illustrates a dataflow graph 3506 for the dataflow assembly code 3504 of FIG. 35B for an accelerator according to embodiments of the disclosure. In the example in FIGS. 35A-35C, the basic block before and after the conditionals are control-equivalent to each other, but the basic blocks in the true and false paths are each in their own control dependence region. One correct algorithm for converting a CFG to dataflow is to have the compiler insert (1) switches to compensate for the mismatch in execution frequency for any values that flow between basic blocks which are not control equivalent, and (2) picks at the beginning of basic blocks to choose correctly from any incoming values to a basic block. Generating the appropriate control signals for these picks and switches may be the key part of dataflow conversion.

### Loops

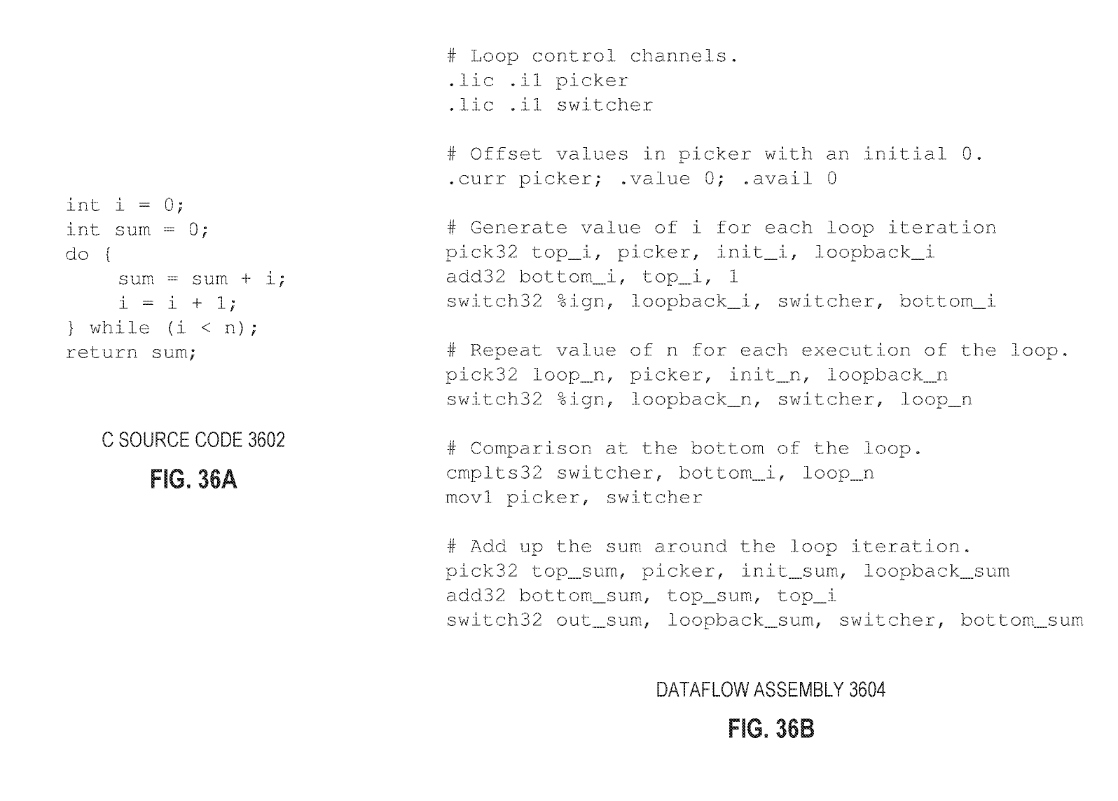

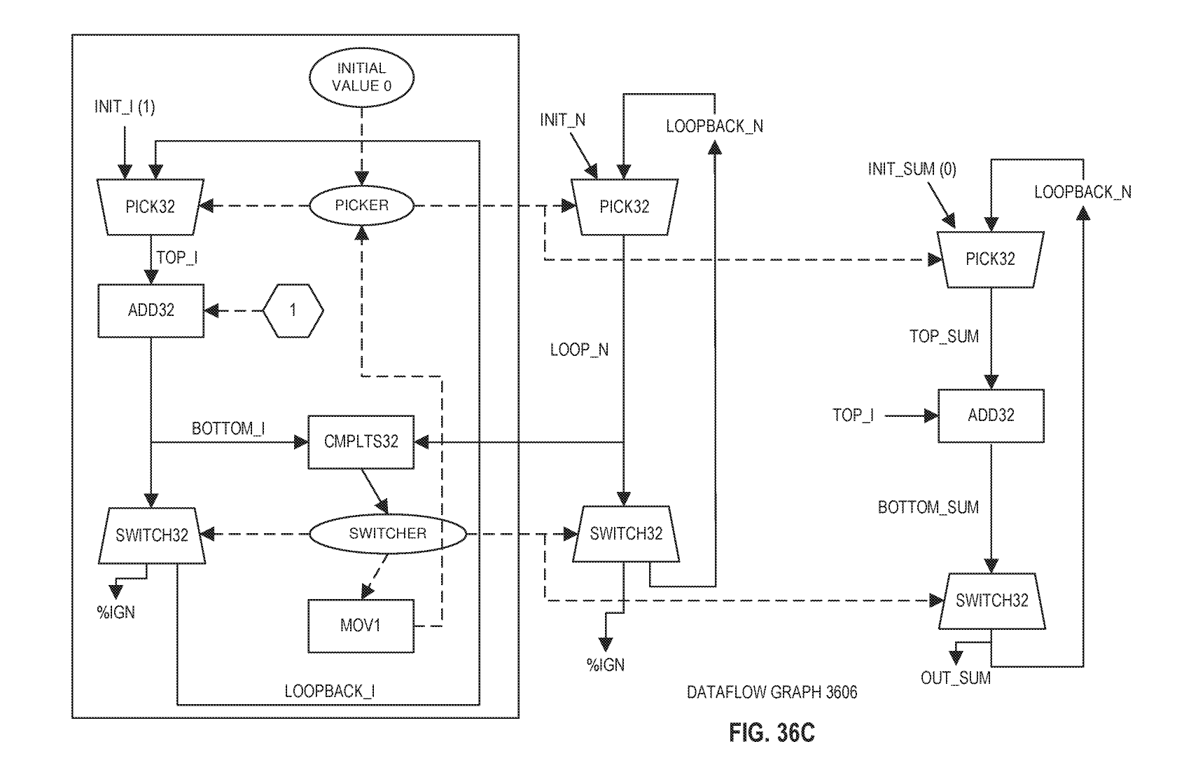

Another important class of CFGs in dataflow conversion are CFGs for single-entry-single-exit loops, a common form of loop generated in (LLVM) IR. These loops may be almost acyclic, except for a single back edge from the end of the loop back to a loop header block. The dataflow conversion pass may use same high-level strategy to convert loops as for branches, e.g., it inserts switches at the end of the loop to direct values out of the loop (either out the loop exit or around the back-edge to the beginning of the loop), and inserts picks at the beginning of the loop to choose between initial values entering the loop and values coming through the back edge. FIG. 36A illustrates C source code 3602 according to embodiments of the disclosure. FIG. 36B illustrates dataflow assembly code 3604 for the C source code 3602 of FIG. 36A according to embodiments of the disclosure. FIG. 36C illustrates a dataflow graph 3606 for the dataflow assembly code 3604 of FIG. 36B for an accelerator according to embodiments of the disclosure. FIGS. 36A-36C shows C and CSA assembly code for an example do-while loop that adds up values of a loop induction variable i, as well as the corresponding dataflow graph. For each variable that conceptually cycles around the loop (i and sum), this graph has a corresponding pick/switch pair that controls the flow of these values. Note that this example also uses a pick/switch pair to cycle the value of n around the loop, even though n is loop-invariant. This repetition of n enables conversion of n's virtual register into a LIC, since it matches the execution frequencies between a conceptual definition of n outside the loop and the one or more uses of n inside the loop. In general, for a correct dataflow conversion, registers that are live-in into a loop are to be repeated once for each iteration inside the loop body when the register is converted into a LIC. Similarly, registers that are updated inside a loop and are live-out from the loop are to be consumed, e.g., with a single final value sent out of the loop. Loops introduce a wrinkle into the dataflow conversion process, namely that the control for a pick at the top of the loop and the switch for the bottom of the loop are offset. For example, if the loop in FIG. 35A executes three iterations and exits, the control to picker should be 0, 1, 1, while the control to switcher should be 1, 1, 0. This control is implemented by starting the picker channel with an initial extra 0 when the function begins on cycle 0 (which is specified in the assembly by the directives .value 0 and .avail 0), and then copying the output switcher into picker. Note that the last 0 in switcher restores a final 0 into picker, ensuring that the final state of the dataflow graph matches its initial state.

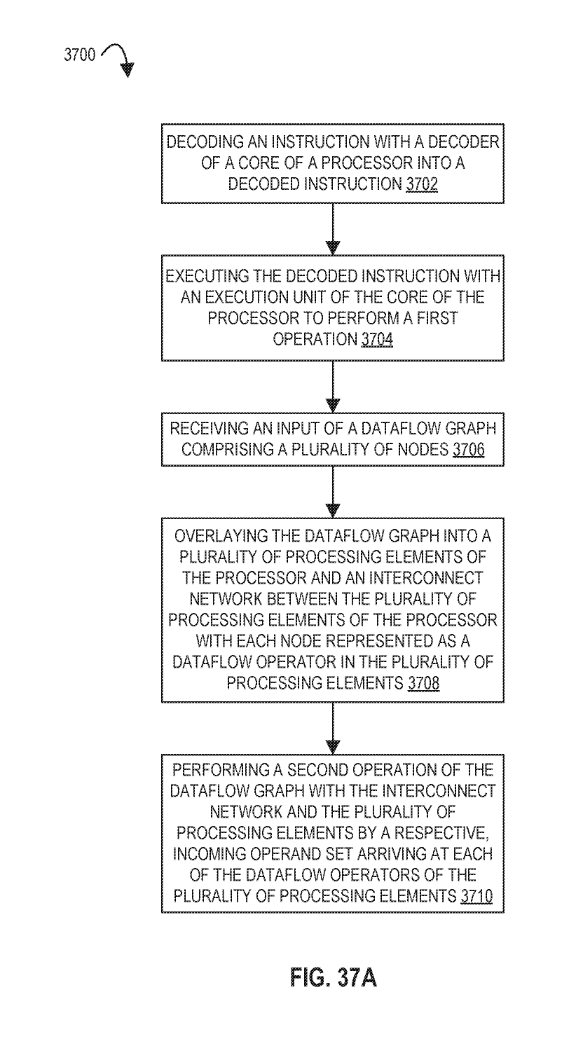

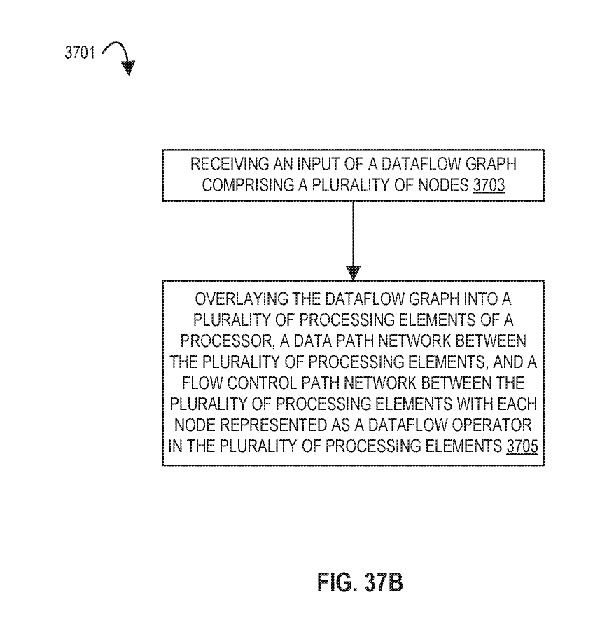

FIG. 37A illustrates a flow diagram 3700 according to embodiments of the disclosure. Depicted flow 3700 includes decoding an instruction with a decoder of a core of a processor into a decoded instruction 3702; executing the decoded instruction with an execution unit of the core of the processor to perform a first operation 3704; receiving an input of a dataflow graph comprising a plurality of nodes 3706; overlaying the dataflow graph into a plurality of processing elements of the processor and an interconnect network between the plurality of processing elements of the processor with each node represented as a dataflow operator in the plurality of processing elements 3708; and performing a second operation of the dataflow graph with the interconnect network and the plurality of processing elements by a respective, incoming operand set arriving at each of the dataflow operators of the plurality of processing elements 3710.

FIG. 37B illustrates a flow diagram 3701 according to embodiments of the disclosure. Depicted flow 3701 includes receiving an input of a dataflow graph comprising a plurality of nodes 3703; and overlaying the dataflow graph into a plurality of processing elements of a processor, a data path network between the plurality of processing elements, and a flow control path network between the plurality of processing elements with each node represented as a dataflow operator in the plurality of processing elements 3705.

In one embodiment, the core writes a command into a memory queue and a CSA (e.g., the plurality of processing elements) monitors the memory queue and begins executing when the command is read. In one embodiment, the core executes a first part of a program and a CSA (e.g., the plurality of processing elements) executes a second part of the program. In one embodiment, the core does other work while the CSA is executing its operations.

### 5. CSA Advantages

In certain embodiments, the CSA architecture and microarchitecture provides profound energy, performance, and usability advantages over roadmap processor architectures and FPGAs. In this section, these architectures are compared to embodiments of the CSA and highlights the superiority of CSA in accelerating parallel dataflow graphs relative to each.

### 5.1 Processors

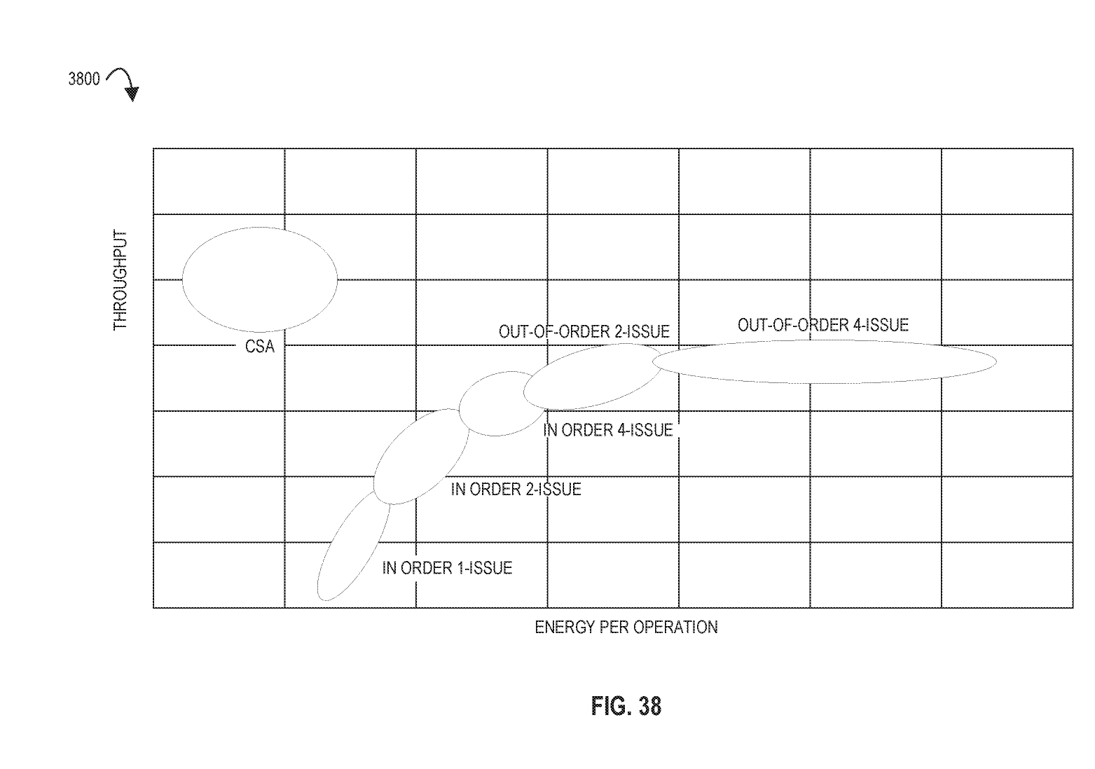

FIG. 38 illustrates a throughput versus energy per operation graph 3800 according to embodiments of the disclosure. As shown in FIG. 38, small cores are generally more energy efficient than large cores, and, in some workloads, this advantage may be translated to absolute performance through higher core counts. The CSA microarchitecture follows these observations to their conclusion and removes (e.g., most) energy-hungry control structures associated with von Neumann architectures, including most of the instruction-side microarchitecture. By removing these overheads and implementing simple, single operation PEs, embodiments of a CSA obtains a dense, efficient spatial array. Unlike small cores, which are usually quite serial, a CSA may gang its PEs together, e.g., via the circuit switched local network, to form explicitly parallel aggregate dataflow graphs. The result is performance in not only parallel applications, but also serial applications as well. Unlike cores, which may pay dearly for performance in terms area and energy, a CSA is already parallel in its native execution model. In certain embodiments, a CSA neither requires speculation to increase performance nor does it need to repeatedly re-extract parallelism from a sequential program representation, thereby avoiding two of the main energy taxes in von Neumann architectures. Most structures in embodiments of a CSA are distributed, small, and energy efficient, as opposed to the centralized, bulky, energy hungry structures found in cores. Consider the case of registers in the CSA: each PE may have a few (e.g., 10 or less) storage registers. Taken individually, these registers may be more efficient that traditional register files. In aggregate, these registers may provide the effect of a large, in-fabric register file. As a result, embodiments of a CSA avoids most of stack spills and fills incurred by classical architectures, while using much less energy per state access. Of course, applications may still access memory. In embodiments of a CSA, memory access request and response are architecturally decoupled, enabling workloads to sustain many more outstanding memory accesses per unit of area and energy. This property yields substantially higher performance for cache-bound workloads and reduces the area and energy needed to saturate main memory in memory-bound workloads. Embodiments of a CSA expose new forms of energy efficiency which are unique to non-von Neumann architectures. One consequence of executing a single operation (e.g., instruction) at a (e.g., most) PEs is reduced operand entropy. In the case of an increment operation, each execution may result in a handful of circuit-level toggles and little energy consumption, a case examined in detail in Section 6.2. In contrast, von Neumann architectures are multiplexed, resulting in large numbers of bit transitions. The asynchronous style of embodiments of a CSA also enables microarchitectural optimizations, such as the floating point optimizations described in Section 3.5 that are difficult to realize in tightly scheduled core pipelines. Because PEs may be relatively simple and their behavior in a particular dataflow graph be statically known, clock gating and power gating techniques may be applied more effectively than in coarser architectures. The graph-execution style, small size, and malleability of embodiments of CSA PEs and the network together enable the expression many kinds of parallelism: instruction, data, pipeline, vector, memory, thread, and task parallelism may all be implemented. For example, in embodiments of a CSA, one application may use arithmetic units to provide a high degree of address bandwidth, while another application may use those same units for computation. In many cases, multiple kinds of parallelism may be combined to achieve even more performance. Many key HPC operations may be both replicated and pipelined, resulting in orders-of-magnitude performance gains. In contrast, von Neumann-style cores typically optimize for one style of parallelism, carefully chosen by the architects, resulting in a failure to capture all important application kernels. Just as embodiments of a CSA expose and facilitates many forms of parallelism, it does not mandate a particular form of parallelism, or, worse, a particular subroutine be present in an application in order to benefit from the CSA. Many applications, including single-stream applications, may obtain both performance and energy benefits from embodiments of a CSA, e.g., even when compiled without modification. This reverses the long trend of requiring significant programmer effort to obtain a substantial performance gain in singlestream applications. Indeed, in some applications, embodiments of a CSA obtain more performance from functionally equivalent, but less “modern” codes than from their convoluted, contemporary cousins which have been tortured to target vector instructions.

### 5.2 Comparison of CSA Embodiments and FGPAs

The choice of dataflow operators as the fundamental architecture of embodiments of a CSA differentiates those CSAs from a FGPA, and particularly the CSA is as superior accelerator for HPC dataflow graphs arising from traditional programming languages. Dataflow operators are fundamentally asynchronous. This enables embodiments of a CSA not only to have great freedom of implementation in the microarchitecture, but it also enables them to simply and succinctly accommodate abstract architectural concepts. For example, embodiments of a CSA naturally accommodate many memory microarchitectures, which are essentially asynchronous, with a simple load-store interface. One need only examine an FPGA DRAM controller to appreciate the difference in complexity. Embodiments of a CSA also leverage asynchrony to provide faster and more-fully-featured runtime services like configuration and extraction, which are believed to be four to six orders of magnitude faster than an FPGA. By narrowing the architectural interface, embodiments of a CSA provide control over most timing paths at the microarchitectural level. This allows embodiments of a CSA to operate at a much higher frequency than the more general control mechanism offered in a FPGA. Similarly, clock and reset, which may be architecturally fundamental to FPGAs, are microarchitectural in the CSA, e.g., obviating the need to support them as programmable entities. Dataflow operators may be, for the most part, coarse-grained. By only dealing in coarse operators, embodiments of a CSA improve both the density of the fabric and its energy consumption: CSA executes operations directly rather than emulating them with look-up tables. A second consequence of coarseness is a simplification of the place and route problem. CSA dataflow graphs are many orders of magnitude smaller than FPGA net-lists and place and route time are commensurately reduced in embodiments of a CSA. The significant differences between embodiments of a CSA and a FPGA make the CSA superior as an accelerator, e.g., for dataflow graphs arising from traditional programming languages.

### 6. Evaluation

The CSA is a novel computer architecture with the potential to provide enormous performance and energy advantages relative to roadmap processors. Consider the case of computing a single strided address for walking across an array. This case may be important in HPC applications, e.g., which spend significant integer effort in computing address offsets. In address computation, and especially strided address computation, one argument is constant and the other varies only slightly per computation. Thus, only a handful of bits per cycle toggle in the majority of cases. Indeed, it may be shown, using a derivation similar to the bound on floating point carry bits described in Section 3.5, that less than two bits of input toggle per computation in average for a stride calculation, reducing energy by 50% over a random toggle distribution. Were a time-multiplexed approach used, much of this energy savings may be lost. In one embodiment, the CSA achieves approximately 3× energy efficiency over a core while delivering an 8x performance gain. The parallelism gains achieved by embodiments of a CSA may result in reduced program run times, yielding a proportionate, substantial reduction in leakage energy. At the PE level, embodiments of a CSA are extremely energy efficient. A second important question for the CSA is whether the CSA consumes a reasonable amount of energy at the tile level. Since embodiments of a CSA are capable of exercising every floating point PE in the fabric at every cycle, it serves as a reasonable upper bound for energy and power consumption, e.g., such that most of the energy goes into floating point multiply and add.

### 7. Further CSA Details

This section discusses further details for configuration and exception handling.

### 7.1 Microarchitecture for Configuring a CSA

This section discloses examples of how to configure a CSA (e.g., fabric), how to achieve this configuration quickly, and how to minimize the resource overhead of configuration. Configuring the fabric quickly may be of preeminent importance in accelerating small portions of a larger algorithm, and consequently in broadening the applicability of a CSA. The section further discloses features that allow embodiments of a CSA to be programmed with configurations of different length.

Embodiments of a CSA (e.g., fabric) may differ from traditional cores in that they make use of a configuration step in which (e.g., large) parts of the fabric are loaded with program configuration in advance of program execution. An advantage of static configuration may be that very little energy is spent at runtime on the configuration, e.g., as opposed to sequential cores which spend energy fetching configuration information (an instruction) nearly every cycle. The previous disadvantage of configuration is that it was a coarse-grained step with a potentially large latency, which places an under-bound on the size of program that can be accelerated in the fabric due to the cost of context switching. This disclosure describes a scalable microarchitecture for rapidly configuring a spatial array in a distributed fashion, e.g., that avoids the previous disadvantages.

As discussed above, a CSA may include light-weight processing elements connected by an inter-PE network. Programs, viewed as control-dataflow graphs, are then mapped onto the architecture by configuring the configurable fabric elements (CFEs), for example PEs and the interconnect (fabric) networks. Generally, PEs may be configured as dataflow operators and once all input operands arrive at the PE, some operation occurs, and the results are forwarded to another PE or PEs for consumption or output. PEs may communicate over dedicated virtual circuits which are formed by statically configuring the circuit switched communications network. These virtual circuits may be flow controlled and fully back-pressured, e.g., such that PEs will stall if either the source has no data or destination is full. At runtime, data may flow through the PEs implementing the mapped algorithm. For example, data may be streamed in from memory, through the fabric, and then back out to memory. Such a spatial architecture may achieve remarkable performance efficiency relative to traditional multicore processors: compute, in the form of PEs, may be simpler and more numerous than larger cores and communications may be direct, as opposed to an extension of the memory system.

Embodiments of a CSA may not utilize (e.g., software controlled) packet switching, e.g., packet switching that requires significant software assistance to realize, which slows configuration. Embodiments of a CSA include out-of-band signaling in the network (e.g., of only 2-3 bits, depending on the feature set supported) and a fixed configuration topology to avoid the need for significant software support.

One key difference between embodiments of a CSA and the approach used in FPGAs is that a CSA approach may use a wide data word, is distributed, and includes mechanisms to fetch program data directly from memory. Embodiments of a CSA may not utilize JTAG-style single bit communications in the interest of area efficiency, e.g., as that may require milliseconds to completely configure a large FPGA fabric.

Embodiments of a CSA include a distributed configuration protocol and microarchitecture to support this protocol. Initially, configuration state may reside in memory. Multiple (e.g., distributed) local configuration controllers (boxes) (LCCs) may stream portions of the overall program into their local region of the spatial fabric, e.g., using a combination of a small set of control signals and the fabric-provided network. State elements may be used at each CFE to form configuration chains, e.g., allowing individual CFEs to self-program without global addressing.

Embodiments of a CSA include specific hardware support for the formation of configuration chains, e.g., not software establishing these chains dynamically at the cost of increasing configuration time. Embodiments of a CSA are not purely packet switched and do include extra out-of-band control wires (e.g., control is not sent through the data path requiring extra cycles to strobe this information and reserialize this information). Embodiments of a CSA decreases configuration latency by fixing the configuration ordering and by providing explicit out-of-band control (e.g., by at least a factor of two), while not significantly increasing network complexity.

Embodiments of a CSA do not use a serial mechanism for configuration in which data is streamed bit by bit into the fabric using a JTAG-like protocol. Embodiments of a CSA utilize a coarse-grained fabric approach. In certain embodiments, adding a few control wires or state elements to a 64 or 32-bit-oriented CSA fabric has a lower cost relative to adding those same control mechanisms to a 4 or 6 bit fabric.

FIG. 39 illustrates an accelerator tile 3900 comprising an array of processing elements (PE) and a local configuration controller (3902, 3906) according to embodiments of the disclosure. Each PE, each network controller (e.g., network dataflow endpoint circuit), and each switch may be a configurable fabric elements (CFEs), e.g., which are configured (e.g., programmed) by embodiments of the CSA architecture.

Embodiments of a CSA include hardware that provides for efficient, distributed, low-latency configuration of a heterogeneous spatial fabric. This may be achieved according to four techniques. First, a hardware entity, the local configuration controller (LCC) is utilized, for example, as in FIGS. 39-41. An LCC may fetch a stream of configuration information from (e.g., virtual) memory. Second, a configuration data path may be included, e.g., that is as wide as the native width of the PE fabric and which may be overlaid on top of the PE fabric. Third, new control signals may be received into the PE fabric which orchestrate the configuration process. Fourth, state elements may be located (e.g., in a register) at each configurable endpoint which track the status of adjacent CFEs, allowing each CFE to unambiguously self-configure without extra control signals. These four microarchitectural features may allow a CSA to configure chains of its CFEs. To obtain low configuration latency, the configuration may be partitioned by building many LCCs and CFE chains. At configuration time, these may operate independently to load the fabric in parallel, e.g., dramatically reducing latency. As a result of these combinations, fabrics configured using embodiments of a CSA architecture, may be completely configured (e.g., in hundreds of nanoseconds). In the following, the detailed the operation of the various components of embodiments of a CSA configuration network are disclosed.

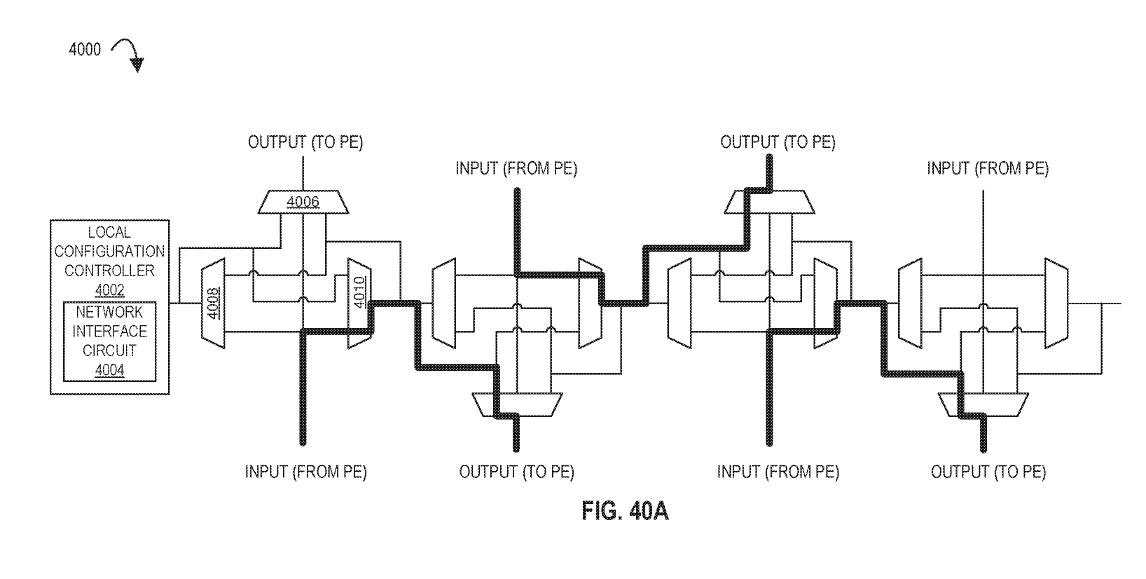

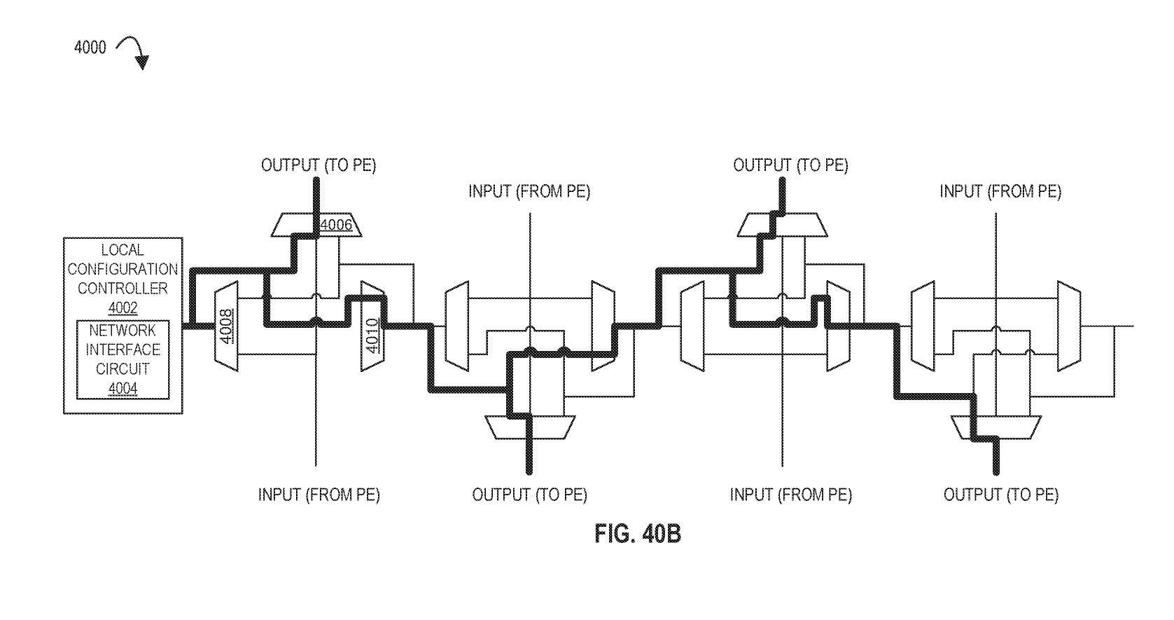

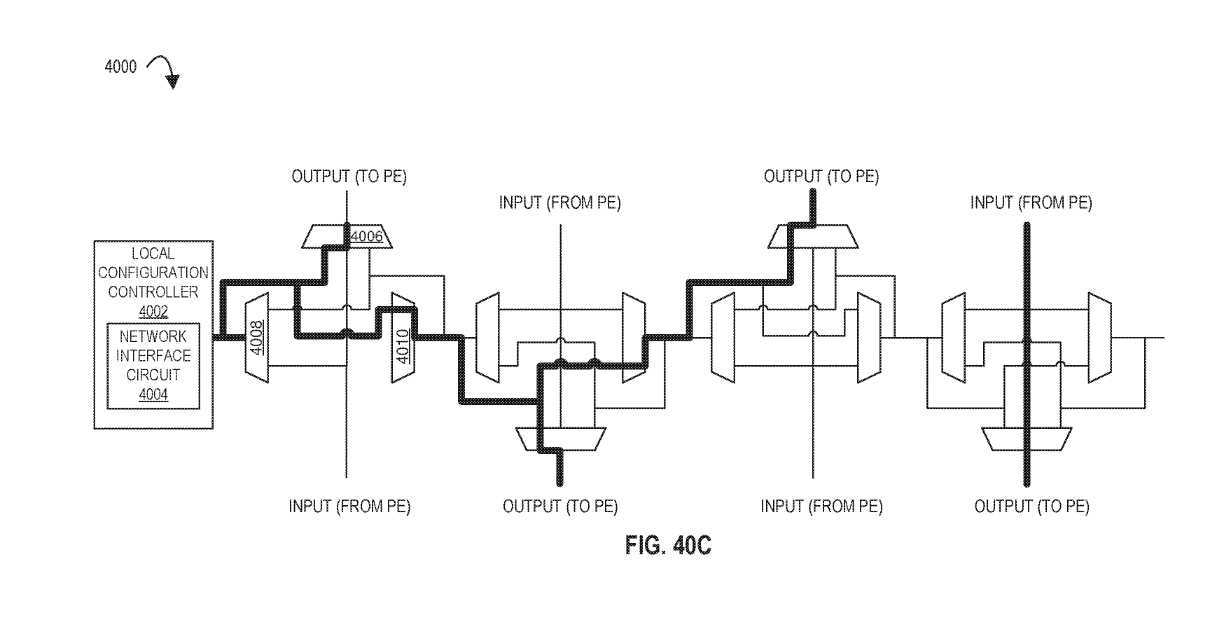

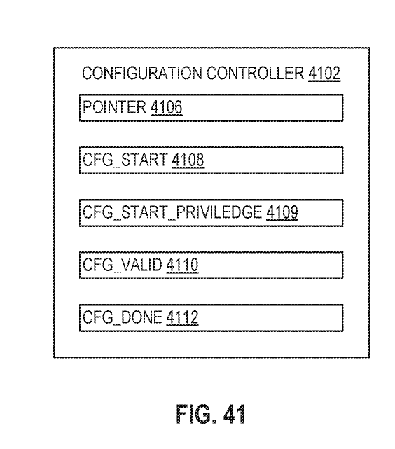

FIGS. 40A-40C illustrate a local configuration controller 4002 configuring a data path network according to embodiments of the disclosure. Depicted network includes a plurality of multiplexers (e.g., multiplexers 4006, 4008, 4010) that may be configured (e.g., via their respective control signals) to connect one or more data paths (e.g., from PEs) together. FIG. 40A illustrates the network 4000 (e.g., fabric) configured (e.g., set) for some previous operation or program. FIG. 40B illustrates the local configuration controller 4002 (e.g., including a network interface circuit 4004 to send and/or receive signals) strobing a configuration signal and the local network is set to a default configuration (e.g., as depicted) that allows the LCC to send configuration data to all configurable fabric elements (CFEs), e.g., muxes. FIG. 40C illustrates the LCC strobing configuration information across the network, configuring CFEs in a predetermined (e.g., silicon-defined) sequence. In one embodiment, when CFEs are configured they may begin operation immediately. In another embodiments, the CFEs wait to begin operation until the fabric has been completely configured (e.g., as signaled by configuration terminator (e.g., configuration terminator 4204 and configuration terminator 4208 in FIG. 42) for each local configuration controller). In one embodiment, the LCC obtains control over the network fabric by sending a special message, or driving a signal. It then strobes configuration data (e.g., over a period of many cycles) to the CFEs in the fabric. In these figures, the multiplexor networks are analogues of the “Switch” shown in certain Figures (e.g., FIG. 23).

### Local Configuration Controller

FIG. 41 illustrates a (e.g., local) configuration controller 4102 according to embodiments of the disclosure. A local configuration controller (LCC) may be the hardware entity which is responsible for loading the local portions (e.g., in a subset of a tile or otherwise) of the fabric program, interpreting these program portions, and then loading these program portions into the fabric by driving the appropriate protocol on the various configuration wires. In this capacity, the LCC may be a special-purpose, sequential microcontroller.

LCC operation may begin when it receives a pointer to a code segment. Depending on the LCB microarchitecture, this pointer (e.g., stored in pointer register 4106) may come either over a network (e.g., from within the CSA (fabric) itself) or through a memory system access to the LCC. When it receives such a pointer, the LCC optionally drains relevant state from its portion of the fabric for context storage, and then proceeds to immediately reconfigure the portion of the fabric for which it is responsible. The program loaded by the LCC may be a combination of configuration data for the fabric and control commands for the LCC, e.g., which are lightly encoded. As the LCC streams in the program portion, it may interprets the program as a command stream and perform the appropriate encoded action to configure (e.g., load) the fabric.

Two different microarchitectures for the LCC are shown in FIG. 39, e.g., with one or both being utilized in a CSA. The first places the LCC 3902 at the memory interface. In this case, the LCC may make direct requests to the memory system to load data. In the second case the LCC 3906 is placed on a memory network, in which it may make requests to the memory only indirectly. In both cases, the logical operation of the LCB is unchanged. In one embodiment, an LCCs is informed of the program to load, for example, by a set of (e.g., OS-visible) control-status-registers which will be used to inform individual LCCs of new program pointers, etc.

### Extra Out-of-Band Control Channels (e.g., Wires)

In certain embodiments, configuration relies on 2-8 extra, out-of-band control channels to improve configuration speed, as defined below. For example, configuration controller 4102 may include the following control channels, e.g., CFG_START control channel 4108, CFG_START_PRIVILEDGE control channel 4109, CFG_VALID control channel 4110, and CFG_DONE control channel 4112, with examples of each discussed in Table 2 below.

TABLE 2
Control Channels

| | |
|---|---|
| CFG_START | Asserted at beginning of configuration. |
| | Sets configuration state at each CFE |
| | and sets the configuration bus. |
| CFG_START_PRIVILEDGE | Asserted at beginning of configuration. |
| | Indicates the enablement of |
| | privilege configuration. |
| CFG_VALID | Denotes validity of values on |
| | configuration bus. |
| CFG_DONE | Optional. Denotes completion of the |
| | configuration of a particular CFE. |
| | This allows configuration to be |
| | short circuited in case a CFE does not |
| | require additional configuration. |

Generally, the handling of configuration information may be left to the implementer of a particular CFE. For example, a selectable function CFE may have a provision for setting registers using an existing data path, while a fixed function CFE might simply set a configuration register.

Due to long wire delays when programming a large set of CFEs, the CFG_VALID signal may be treated as a clock/latch enable for CFE components. Since this signal is used as a clock, in one embodiment the duty cycle of the line is at most 50%. As a result, configuration throughput is approximately halved. Optionally, a second CFG_VALID signal may be added to enable continuous programming.

In one embodiment, only CFG_START is strictly communicated on an independent coupling (e.g., wire), for example, CFG_VALID and CFG_DONE may be overlaid on top of other network couplings.

### Reuse of Network Resources

To reduce the overhead of configuration, certain embodiments of a CSA make use of existing network infrastructure to communicate configuration data. A LCC may make use of both a chip-level memory hierarchy and a fabric-level communications networks to move data from storage into the fabric. As a result, in certain embodiments of a CSA, the configuration infrastructure adds no more than 2% to the overall fabric area and power.

Reuse of network resources in certain embodiments of a CSA may cause a network to have some hardware support for a configuration mechanism. Circuit switched networks of embodiments of a CSA cause an LCC to set their multiplexors in a specific way for configuration when the ‘CFG_START’ signal is asserted. Packet switched networks do not require extension, although LCC endpoints (e.g., configuration terminators) use a specific address in the packet switched network. Network reuse is optional, and some embodiments may find dedicated configuration buses to be more convenient.

### Per CFE State

Each CFE may maintain a bit denoting whether or not it has been configured (see, e.g., FIG. 30). This bit may be de-asserted when the configuration start signal is driven, and then asserted once the particular CFE has been configured. In one configuration protocol, CFEs are arranged to form chains with the CFE configuration state bit determining the topology of the chain. A CFE may read the configuration state bit of the immediately adjacent CFE. If this adjacent CFE is configured and the current CFE is not configured, the CFE may determine that any current configuration data is targeted at the current CFE. When the ‘CFG_DONE’ signal is asserted, the CFE may set its configuration bit, e.g., enabling upstream CFEs to configure. As a base case to the configuration process, a configuration terminator (e.g., configuration terminator 3904 for LCC 3902 or configuration terminator 3908 for LCC 3906 in FIG. 39) which asserts that it is configured may be included at the end of a chain.

Internal to the CFE, this bit may be used to drive flow control ready signals. For example, when the configuration bit is de-asserted, network control signals may automatically be clamped to a values that prevent data from flowing, while, within PEs, no operations or other actions will be scheduled.

Dealing with High-Delay Configuration Paths

One embodiment of an LCC may drive a signal over a long distance, e.g., through many multiplexors and with many loads. Thus, it may be difficult for a signal to arrive at a distant CFE within a short clock cycle. In certain embodiments, configuration signals are at some division (e.g., fraction of) of the main (e.g., CSA) clock frequency to ensure digital timing discipline at configuration. Clock division may be utilized in an out-of-band signaling protocol, and does not require any modification of the main clock tree.

### Ensuring Consistent Fabric Behavior During Configuration

Since certain configuration schemes are distributed and have non-deterministic timing due to program and memory effects, different portions of the fabric may be configured at different times. As a result, certain embodiments of a CSA provide mechanisms to prevent inconsistent operation among configured and unconfigured CFEs. Generally, consistency is viewed as a property required of and maintained by CFEs themselves, e.g., using the internal CFE state. For example, when a CFE is in an unconfigured state, it may claim that its input buffers are full, and that its output is invalid. When configured, these values will be set to the true state of the buffers. As enough of the fabric comes out of configuration, these techniques may permit it to begin operation. This has the effect of further reducing context switching latency, e.g., if long-latency memory requests are issued early.

### Variable-Width Configuration

Different CFEs may have different configuration word widths. For smaller CFE configuration words, implementers may balance delay by equitably assigning CFE configuration loads across the network wires. To balance loading on network wires, one option is to assign configuration bits to different portions of network wires to limit the net delay on any one wire. Wide data words may be handled by using serialization/deserialization techniques. These decisions may be taken on a per-fabric basis to optimize the behavior of a specific CSA (e.g., fabric). Network controller (e.g., one or more of network controller 3910 and network controller 3912 may communicate with each domain (e.g., subset) of the CSA (e.g., fabric), for example, to send configuration information to one or more LCCs. Network controller may be part of a communications network (e.g., separate from circuit switched network). Network controller may include a network dataflow endpoint circuit.

### 7.2 Microarchitecture for Low Latency Configuration of a CSA and for Timely Fetching of Configuration Data for a CSA

Embodiments of a CSA may be an energy-efficient and high-performance means of accelerating user applications. When considering whether a program (e.g., a dataflow graph thereof) may be successfully accelerated by an accelerator, both the time to configure the accelerator and the time to run the program may be considered. If the run time is short, then the configuration time may play a large role in determining successful acceleration. Therefore, to maximize the domain of accelerable programs, in some embodiments the configuration time is made as short as possible. One or more configuration caches may be includes in a CSA, e.g., such that the high bandwidth, low-latency store enables rapid reconfiguration. Next is a description of several embodiments of a configuration cache.

In one embodiment, during configuration, the configuration hardware (e.g., LCC) optionally accesses the configuration cache to obtain new configuration information. The configuration cache may operate either as a traditional address based cache, or in an OS managed mode, in which configurations are stored in the local address space and addressed by reference to that address space. If configuration state is located in the cache, then no requests to the backing store are to be made in certain embodiments. In certain embodiments, this configuration cache is separate from any (e.g., lower level) shared cache in the memory hierarchy.

FIG. 42 illustrates an accelerator tile 4200 comprising an array of processing elements, a configuration cache (e.g., 4218 or 4220), and a local configuration controller (e.g., 4202 or 4206) according to embodiments of the disclosure. In one embodiment, configuration cache 4214 is co-located with local configuration controller 4202. In one embodiment, configuration cache 4218 is located in the configuration domain of local configuration controller 4206, e.g., with a first domain ending at configuration terminator 4204 and a second domain ending at configuration terminator 4208). A configuration cache may allow a local configuration controller may refer to the configuration cache during configuration, e.g., in the hope of obtaining configuration state with lower latency than a reference to memory. A configuration cache (storage) may either be dedicated or may be accessed as a configuration mode of an in-fabric storage element, e.g., local cache 4216.

### Caching Modes

1. Demand Caching—In this mode, the configuration cache operates as a true cache. The configuration controller issues address-based requests, which are checked against tags in the cache. Misses are loaded into the cache and then may be re-referenced during future reprogramming.
2. In-Fabric Storage (Scratchpad) Caching—In this mode the configuration cache receives a reference to a configuration sequence in its own, small address space, rather than the larger address space of the host. This may improve memory density since the portion of cache used to store tags may instead be used to store configuration.

In certain embodiments, a configuration cache may have the configuration data pre-loaded into it, e.g., either by external direction or internal direction. This may allow reduction in the latency to load programs. Certain embodiments herein provide for an interface to a configuration cache which permits the loading of new configuration state into the cache, e.g., even if a configuration is running in the fabric already. The initiation of this load may occur from either an internal or external source. Embodiments of a pre-loading mechanism further reduce latency by removing the latency of cache loading from the configuration path.

### Pre Fetching Modes

1. Explicit Prefetching—A configuration path is augmented with a new command, ConfigurationCachePrefetch. Instead of programming the fabric, this command simply cause a load of the relevant program configuration into a configuration cache, without programming the fabric. Since this mechanism piggybacks on the existing configuration infrastructure, it is exposed both within the fabric and externally, e.g., to cores and other entities accessing the memory space.
2. Implicit prefetching—A global configuration controller may maintain a prefetch predictor, and use this to initiate the explicit prefetching to a configuration cache, e.g., in an automated fashion.

### 7.3 Hardware for Rapid Reconfiguration of a CSA in Response to an Exception

Certain embodiments of a CSA (e.g., a spatial fabric) include large amounts of instruction and configuration state, e.g., which is largely static during the operation of the CSA. Thus, the configuration state may be vulnerable to soft errors. Rapid and error-free recovery of these soft errors may be critical to the long-term reliability and performance of spatial systems.

Certain embodiments herein provide for a rapid configuration recovery loop, e.g., in which configuration errors are detected and portions of the fabric immediately reconfigured. Certain embodiments herein include a configuration controller, e.g., with reliability, availability, and serviceability (RAS) reprogramming features. Certain embodiments of CSA include circuitry for high-speed configuration, error reporting, and parity checking within the spatial fabric. Using a combination of these three features, and optionally, a configuration cache, a configuration/exception handling circuit may recover from soft errors in configuration. When detected, soft errors may be conveyed to a configuration cache which initiates an immediate reconfiguration of (e.g., that portion of) the fabric. Certain embodiments provide for a dedicated reconfiguration circuit, e.g., which is faster than any solution that would be indirectly implemented in the fabric. In certain embodiments, co-located exception and configuration circuit cooperates to reload the fabric on configuration error detection.

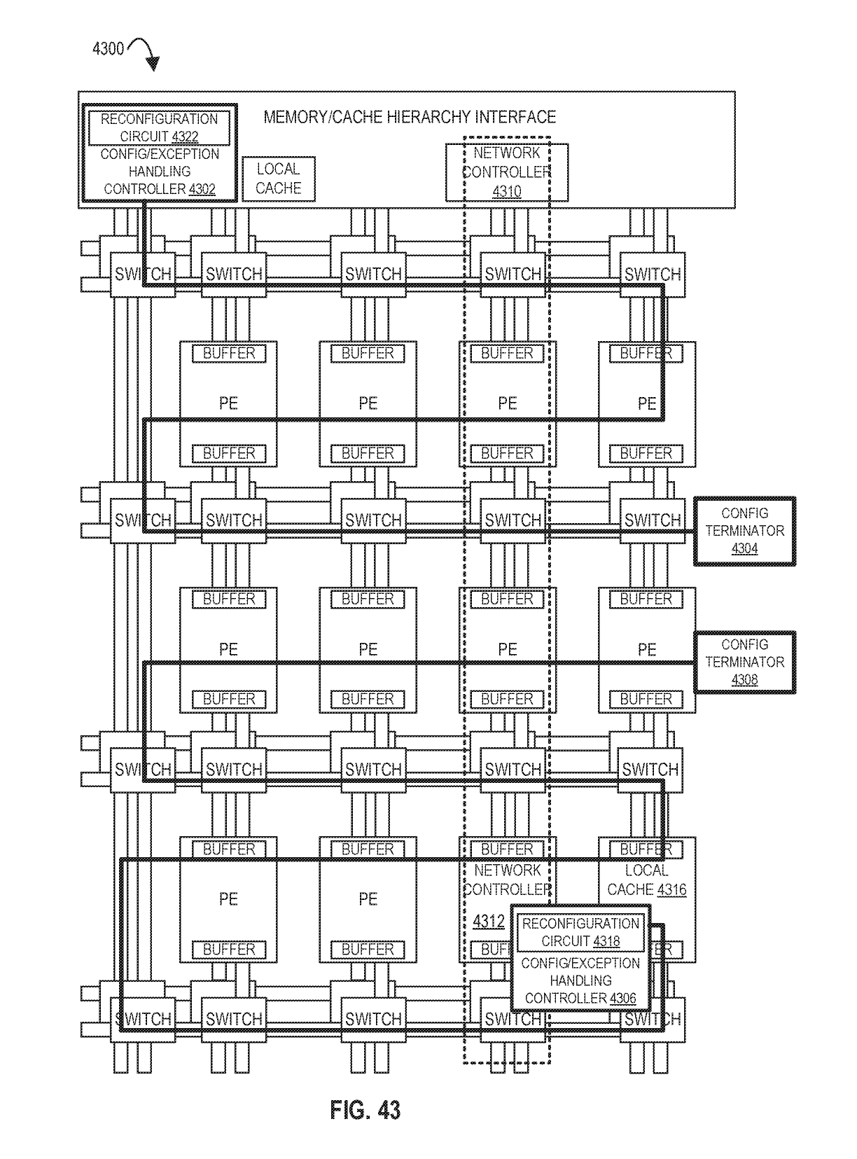

FIG. 43 illustrates an accelerator tile 4300 comprising an array of processing elements and a configuration and exception handling controller (4302, 4306) with a reconfiguration circuit (4318, 4322) according to embodiments of the disclosure. In one embodiment, when a PE detects a configuration error through its local RAS features, it sends a (e.g., configuration error or reconfiguration error) message by its exception generator to the configuration and exception handling controller (e.g., 4302 or 4306). On receipt of this message, the configuration and exception handling controller (e.g., 4302 or 4306) initiates the co-located reconfiguration circuit (e.g., 4318 or 4322, respectively) to reload configuration state. The configuration microarchitecture proceeds and reloads (e.g., only) configurations state, and in certain embodiments, only the configuration state for the PE reporting the RAS error. Upon completion of reconfiguration, the fabric may resume normal operation. To decrease latency, the configuration state used by the configuration and exception handling controller (e.g., 4302 or 4306) may be sourced from a configuration cache. As a base case to the configuration or reconfiguration process, a configuration terminator (e.g., configuration terminator 4304 for configuration and exception handling controller 4302 or configuration terminator 4308 for configuration and exception handling controller 4306) in FIG. 43) which asserts that it is configured (or reconfigures) may be included at the end of a chain.

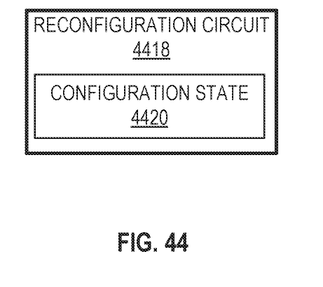

FIG. 44 illustrates a reconfiguration circuit 4418 according to embodiments of the disclosure. Reconfiguration circuit 4418 includes a configuration state register 4420 to store the configuration state (or a pointer thereto).

### 7.4 Hardware for Fabric-Initiated Reconfiguration of a CSA

Some portions of an application targeting a CSA (e.g., spatial array) may be run infrequently or may be mutually exclusive with other parts of the program. To save area, to improve performance, and/or reduce power, it may be useful to time multiplex portions of the spatial fabric among several different parts of the program dataflow graph. Certain embodiments herein include an interface by which a CSA (e.g., via the spatial program) may request that part of the fabric be reprogrammed. This may enable the CSA to dynamically change itself according to dynamic control flow. Certain embodiments herein allow for fabric initiated reconfiguration (e.g., reprogramming). Certain embodiments herein provide for a set of interfaces for triggering configuration from within the fabric. In some embodiments, a PE issues a reconfiguration request based on some decision in the program dataflow graph. This request may travel a network to our new configuration interface, where it triggers reconfiguration. Once reconfiguration is completed, a message may optionally be returned notifying of the completion. Certain embodiments of a CSA thus provide for a program (e.g., dataflow graph) directed reconfiguration capability.

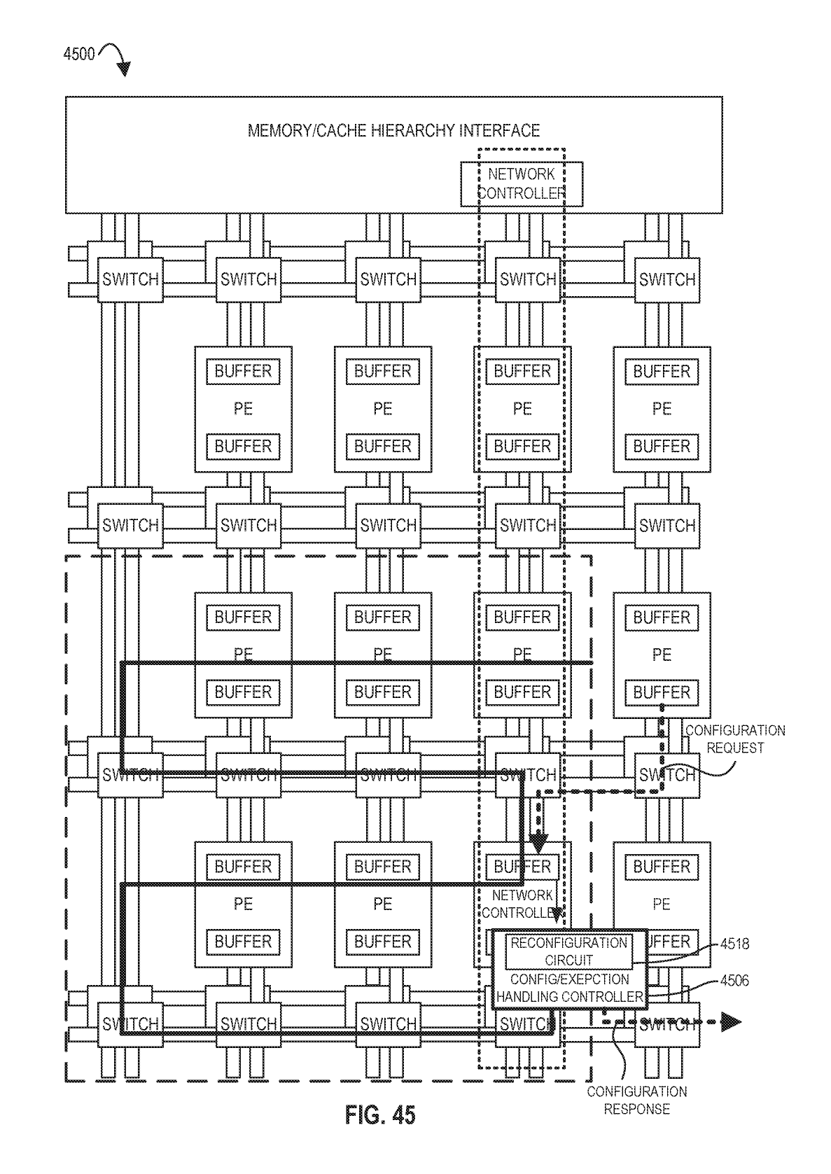

FIG. 45 illustrates an accelerator tile 4500 comprising an array of processing elements and a configuration and exception handling controller 4506 with a reconfiguration circuit 4518 according to embodiments of the disclosure. Here, a portion of the fabric issues a request for (re)configuration to a configuration domain, e.g., of configuration and exception handling controller 4506 and/or reconfiguration circuit 4518. The domain (re)configures itself, and when the request has been satisfied, the configuration and exception handling controller 4506 and/or reconfiguration circuit 4518 issues a response to the fabric, to notify the fabric that (re)configuration is complete. In one embodiment, configuration and exception handling controller 4506 and/or reconfiguration circuit 4518 disables communication during the time that (re)configuration is ongoing, so the program has no consistency issues during operation.

### Configuration Modes

Configure-by-address—In this mode, the fabric makes a direct request to load configuration data from a particular address.

Configure-by-reference—In this mode the fabric makes a request to load a new configuration, e.g., by a pre-determined reference ID. This may simplify the determination of the code to load, since the location of the code has been abstracted.

### Configuring Multiple Domains

A CSA may include a higher level configuration controller to support a multicast mechanism to cast (e.g., via network indicated by the dotted box) configuration requests to multiple (e.g., distributed or local) configuration controllers. This may enable a single configuration request to be replicated across larger portions of the fabric, e.g., triggering a broad reconfiguration.

### 7.5 Exception Aggregators

Certain embodiments of a CSA may also experience an exception (e.g., exceptional condition), for example, floating point underflow. When these conditions occur, a special handlers may be invoked to either correct the program or to terminate it. Certain embodiments herein provide for a system-level architecture for handling exceptions in spatial fabrics. Since certain spatial fabrics emphasize area efficiency, embodiments herein minimize total area while providing a general exception mechanism. Certain embodiments herein provides a low area means of signaling exceptional conditions occurring in within a CSA (e.g., a spatial array). Certain embodiments herein provide an interface and signaling protocol for conveying such exceptions, as well as a PE-level exception semantics. Certain embodiments herein are dedicated exception handling capabilities, e.g., and do not require explicit handling by the programmer.

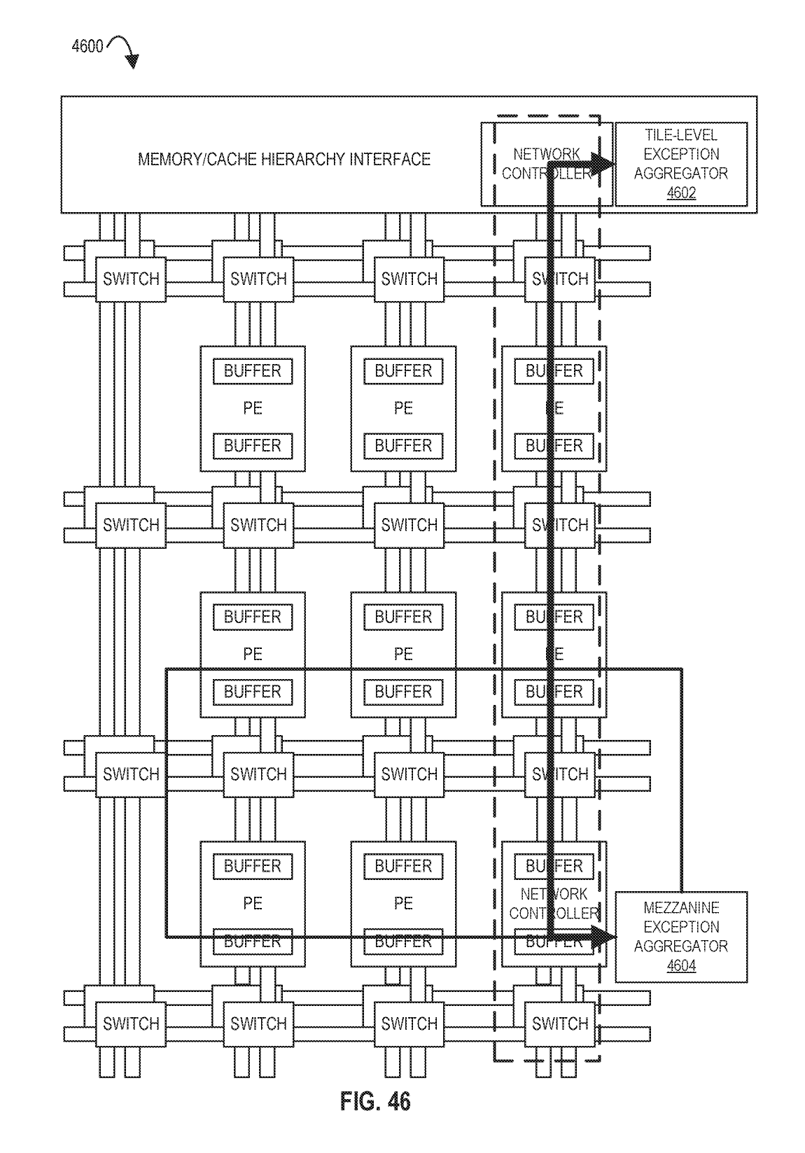

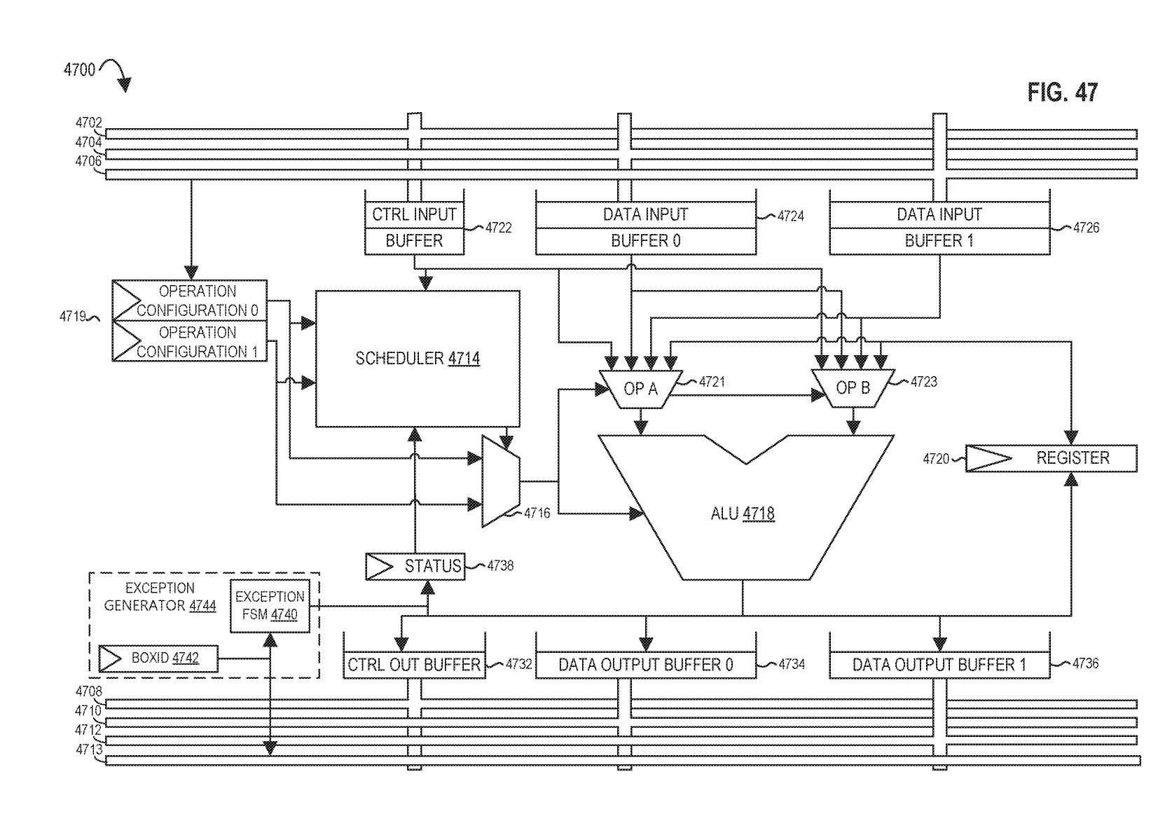

One embodiments of a CSA exception architecture consists of four portions, e.g., shown in FIGS. 46-47. These portions may be arranged in a hierarchy, in which exceptions flow from the producer, and eventually up to the tile-level exception aggregator (e.g., handler), which may rendezvous with an exception servicer, e.g., of a core. The four portions may be:

1. PE Exception Generator

2. Local Exception Network

3. Mezzanine Exception Aggregator

4. Tile-Level Exception Aggregator

FIG. 46 illustrates an accelerator tile 4600 comprising an array of processing elements and a mezzanine exception aggregator 4602 coupled to a tile-level exception aggregator 4604 according to embodiments of the disclosure. FIG. 47 illustrates a processing element 4700 with an exception generator 4744 according to embodiments of the disclosure.

### PE Exception Generator

Processing element 4700 may include processing element 2600 from FIG. 26, for example, with similar numbers being similar components, e.g., local network 2602 and local network 4702. Additional network 4713 (e.g., channel) may be an exception network. A PE may implement an interface to an exception network (e.g., exception network 4713 (e.g., channel) on FIG. 47). For example, FIG. 47 shows the microarchitecture of such an interface, wherein the PE has an exception generator 4744 (e.g., initiate an exception finite state machine (FSM) 4740 to strobe an exception packet (e.g., BOXID 4742) out on to the exception network. BOXID 4742 may be a unique identifier for an exception producing entity (e.g., a PE or box) within a local exception network. When an exception is detected, exception generator 4744 senses the exception network and strobes out the BOXID when the network is found to be free. Exceptions may be caused by many conditions, for example, but not limited to, arithmetic error, failed ECC check on state, etc. however, it may also be that an exception dataflow operation is introduced, with the idea of support constructs like breakpoints.

The initiation of the exception may either occur explicitly, by the execution of a programmer supplied instruction, or implicitly when a hardened error condition (e.g., a floating point underflow) is detected. Upon an exception, the PE 4700 may enter a waiting state, in which it waits to be serviced by the eventual exception handler, e.g., external to the PE 4700. The contents of the exception packet depend on the implementation of the particular PE, as described below.

### Local Exception Network

A (e.g., local) exception network steers exception packets from PE 4700 to the mezzanine exception network. Exception network (e.g., 4713) may be a serial, packet switched network consisting of a (e.g., single) control wire and one or more data wires, e.g., organized in a ring or tree topology, e.g., for a subset of PEs. Each PE may have a (e.g., ring) stop in the (e.g., local) exception network, e.g., where it can arbitrate to inject messages into the exception network.

PE endpoints needing to inject an exception packet may observe their local exception network egress point. If the control signal indicates busy, the PE is to wait to commence inject its packet. If the network is not busy, that is, the downstream stop has no packet to forward, then the PE will proceed commence injection.

Network packets may be of variable or fixed length. Each packet may begin with a fixed length header field identifying the source PE of the packet. This may be followed by a variable number of PE-specific field containing information, for example, including error codes, data values, or other useful status information.

### Mezzanine Exception Aggregator

The mezzanine exception aggregator 4604 is responsible for assembling local exception network into larger packets and sending them to the tile-level exception aggregator 4602. The mezzanine exception aggregator 4604 may pre-pend the local exception packet with its own unique ID, e.g., ensuring that exception messages are unambiguous. The mezzanine exception aggregator 4604 may interface to a special exception-only virtual channel in the mezzanine network, e.g., ensuring the deadlock-freedom of exceptions.

The mezzanine exception aggregator 4604 may also be able to directly service certain classes of exception. For example, a configuration request from the fabric may be served out of the mezzanine network using caches local to the mezzanine network stop.

### Tile-Level Exception Aggregator

The final stage of the exception system is the tile-level exception aggregator 4602. The tile-level exception aggregator 4602 is responsible for collecting exceptions from the various mezzanine-level exception aggregators (e.g., 4604) and forwarding them to the appropriate servicing hardware (e.g., core). As such, the tile-level exception aggregator 4602 may include some internal tables and controller to associate particular messages with handler routines. These tables may be indexed either directly or with a small state machine in order to steer particular exceptions.

Like the mezzanine exception aggregator, the tile-level exception aggregator may service some exception requests. For example, it may initiate the reprogramming of a large portion of the PE fabric in response to a specific exception.

### 7.6 Extraction Controllers

Certain embodiments of a CSA include an extraction controller(s) to extract data from the fabric. The below discusses embodiments of how to achieve this extraction quickly and how to minimize the resource overhead of data extraction. Data extraction may be utilized for such critical tasks as exception handling and context switching. Certain embodiments herein extract data from a heterogeneous spatial fabric by introducing features that allow extractable fabric elements (EFEs) (for example, PEs, network controllers, and/or switches) with variable and dynamically variable amounts of state to be extracted.

Embodiments of a CSA include a distributed data extraction protocol and microarchitecture to support this protocol. Certain embodiments of a CSA include multiple local extraction controllers (LECs) which stream program data out of their local region of the spatial fabric using a combination of a (e.g., small) set of control signals and the fabric-provided network. State elements may be used at each extractable fabric element (EFE) to form extraction chains, e.g., allowing individual EFEs to self-extract without global addressing.

Embodiments of a CSA do not use a local network to extract program data. Embodiments of a CSA include specific hardware support (e.g., an extraction controller) for the formation of extraction chains, for example, and do not rely on software to establish these chains dynamically, e.g., at the cost of increasing extraction time. Embodiments of a CSA are not purely packet switched and do include extra out-of-band control wires (e.g., control is not sent through the data path requiring extra cycles to strobe and reserialize this information). Embodiments of a CSA decrease extraction latency by fixing the extraction ordering and by providing explicit out-of-band control (e.g., by at least a factor of two), while not significantly increasing network complexity.

Embodiments of a CSA do not use a serial mechanism for data extraction, in which data is streamed bit by bit from the fabric using a JTAG-like protocol. Embodiments of a CSA utilize a coarse-grained fabric approach. In certain embodiments, adding a few control wires or state elements to a 64 or 32-bit-oriented CSA fabric has a lower cost relative to adding those same control mechanisms to a 4 or 6 bit fabric.

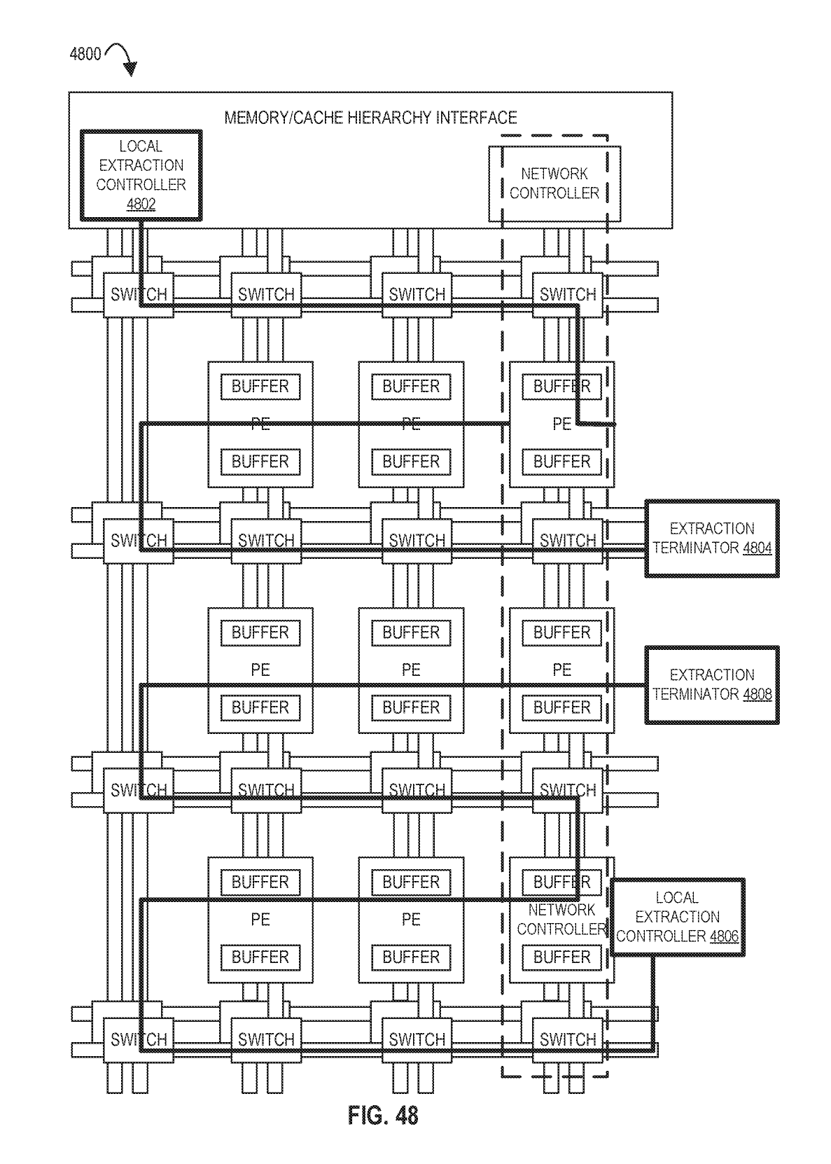

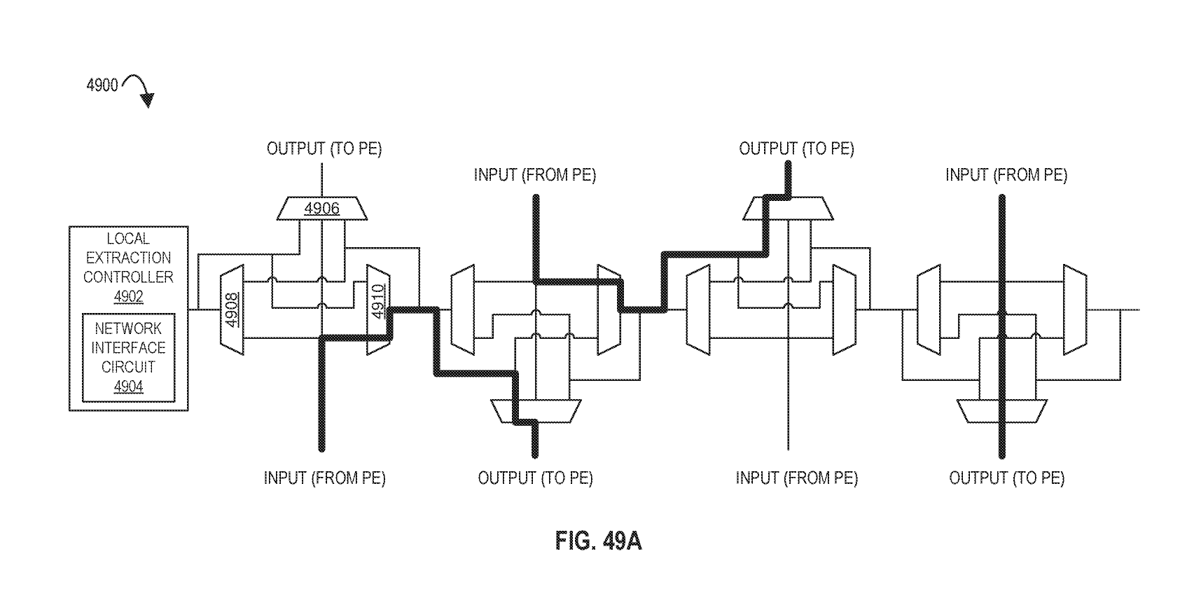

FIG. 48 illustrates an accelerator tile 4800 comprising an array of processing elements and a local extraction controller (4802, 4806) according to embodiments of the disclosure. Each PE, each network controller, and each switch may be an extractable fabric elements (EFEs), e.g., which are configured (e.g., programmed) by embodiments of the CSA architecture.

Embodiments of a CSA include hardware that provides for efficient, distributed, low-latency extraction from a heterogeneous spatial fabric. This may be achieved according to four techniques. First, a hardware entity, the local extraction controller (LEC) is utilized, for example, as in FIGS. 48-50. A LEC may accept commands from a host (for example, a processor core), e.g., extracting a stream of data from the spatial array, and writing this data back to virtual memory for inspection by the host. Second, an extraction data path may be included, e.g., that is as wide as the native width of the PE fabric and which may be overlaid on top of the PE fabric. Third, new control signals may be received into the PE fabric which orchestrate the extraction process. Fourth, state elements may be located (e.g., in a register) at each configurable endpoint which track the status of adjacent EFEs, allowing each EFE to unambiguously export its state without extra control signals. These four microarchitectural features may allow a CSA to extract data from chains of EFEs. To obtain low data extraction latency, certain embodiments may partition the extraction problem by including multiple (e.g., many) LECs and EFE chains in the fabric. At extraction time, these chains may operate independently to extract data from the fabric in parallel, e.g., dramatically reducing latency. As a result of these combinations, a CSA may perform a complete state dump (e.g., in hundreds of nanoseconds).

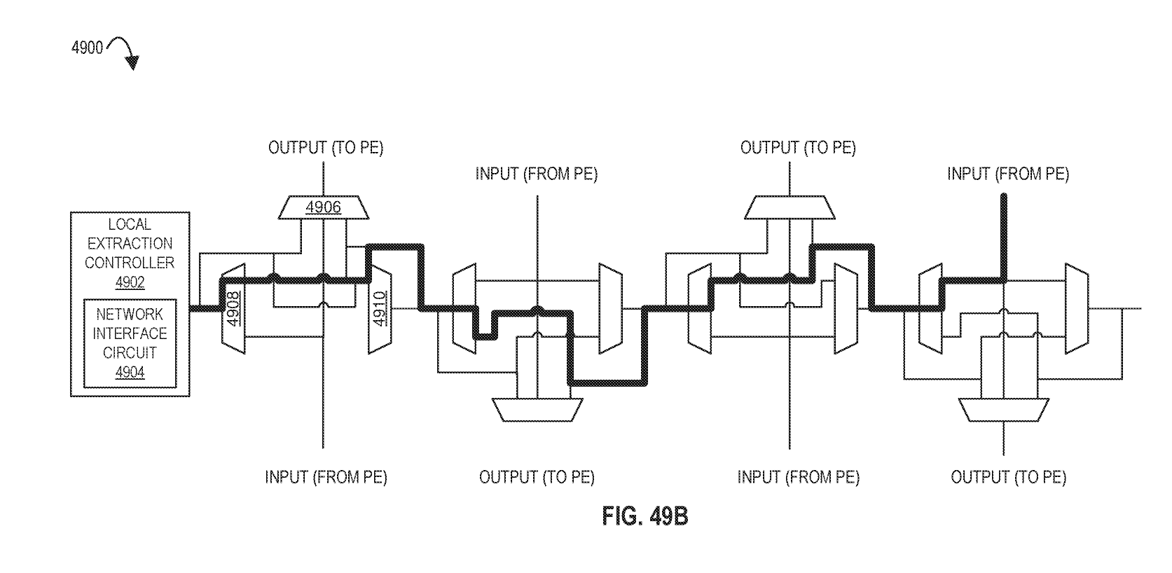

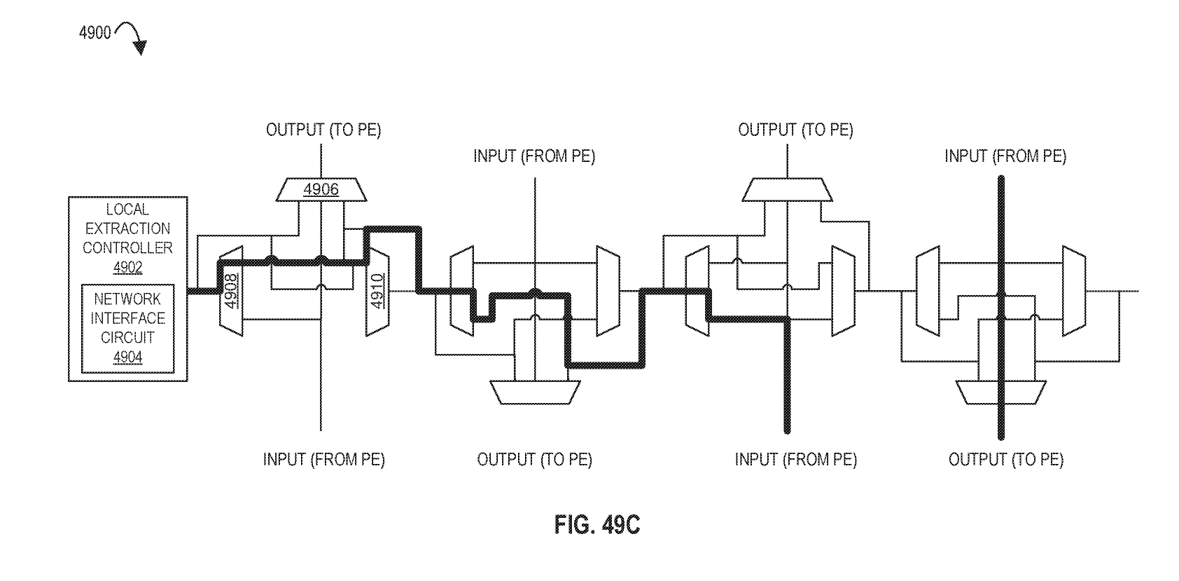

FIGS. 49A-49C illustrate a local extraction controller 4902 configuring a data path network according to embodiments of the disclosure. Depicted network includes a plurality of multiplexers (e.g., multiplexers 4906, 4908, 4910) that may be configured (e.g., via their respective control signals) to connect one or more data paths (e.g., from PEs) together. FIG. 49A illustrates the network 4900 (e.g., fabric) configured (e.g., set) for some previous operation or program. FIG. 49B illustrates the local extraction controller 4902 (e.g., including a network interface circuit 4904 to send and/or receive signals) strobing an extraction signal and all PEs controlled by the LEC enter into extraction mode. The last PE in the extraction chain (or an extraction terminator) may master the extraction channels (e.g., bus) and being sending data according to either (1) signals from the LEC or (2) internally produced signals (e.g., from a PE). Once completed, a PE may set its completion flag, e.g., enabling the next PE to extract its data. FIG. 49C illustrates the most distant PE has completed the extraction process and as a result it has set its extraction state bit or bits, e.g., which swing the muxes into the adjacent network to enable the next PE to begin the extraction process. The extracted PE may resume normal operation. In some embodiments, the PE may remain disabled until other action is taken. In these figures, the multiplexor networks are analogues of the “Switch” shown in certain Figures (e.g., FIG. 23).

The following sections describe the operation of the various components of embodiments of an extraction network.

### Local Extraction Controller

FIG. 50 illustrates an extraction controller 5002 according to embodiments of the disclosure. A local extraction controller (LEC) may be the hardware entity which is responsible for accepting extraction commands, coordinating the extraction process with the EFEs, and/or storing extracted data, e.g., to virtual memory. In this capacity, the LEC may be a special-purpose, sequential microcontroller.

LEC operation may begin when it receives a pointer to a buffer (e.g., in virtual memory) where fabric state will be written, and, optionally, a command controlling how much of the fabric will be extracted. Depending on the LEC microarchitecture, this pointer (e.g., stored in pointer register 5004) may come either over a network or through a memory system access to the LEC. When it receives such a pointer (e.g., command), the LEC proceeds to extract state from the portion of the fabric for which it is responsible. The LEC may stream this extracted data out of the fabric into the buffer provided by the external caller.

Two different microarchitectures for the LEC are shown in FIG. 48. The first places the LEC 4802 at the memory interface. In this case, the LEC may make direct requests to the memory system to write extracted data. In the second case the LEC 4806 is placed on a memory network, in which it may make requests to the memory only indirectly. In both cases, the logical operation of the LEC may be unchanged. In one embodiment, LECs are informed of the desire to extract data from the fabric, for example, by a set of (e.g., OS-visible) control-status-registers which will be used to inform individual LECs of new commands.

### Extra Out-of-Band Control Channels (e.g., Wires)

In certain embodiments, extraction relies on 2-8 extra, out-of-band signals to improve configuration speed, as defined below. Signals driven by the LEC may be labelled LEC. Signals driven by the EFE (e.g., PE) may be labelled EFE. Configuration controller 5002 may include the following control channels, e.g., LEC_EXTRACT control channel 5006, LEC_START control channel 5008, LEC_STROBE control channel 5010, and EFE_COMPLETE control channel 5012, with examples of each discussed in Table 3 below.

TABLE 3
Extraction Channels

| | |
|---|---|
| LEC_EXTRACT | Optional signal asserted by the LEC during |
| | extraction process. Lowering this signal causes |
| | normal operation to resume. |
| LEC_START | Signal denoting start of extraction, allowing setup of |
| | local EFE state |
| LEC_STROBE | Optional strobe signal for controlling extraction |
| | related state machines at EFEs. EFEs may |
| | generate this signal internally in some |
| | implementations. |
| EFE_COMPLETE | Optional signal strobed when EFE has completed |
| | dumping state. This helps LEC identify the |
| | completion of individual EFE dumps. |

Generally, the handling of extraction may be left to the implementer of a particular EFE. For example, selectable function EFE may have a provision for dumping registers using an existing data path, while a fixed function EFE might simply have a multiplexor.

Due to long wire delays when programming a large set of EFEs, the LEC_STROBE signal may be treated as a clock/latch enable for EFE components. Since this signal is used as a clock, in one embodiment the duty cycle of the line is at most 50%. As a result, extraction throughput is approximately halved. Optionally, a second LEC_STROBE signal may be added to enable continuous extraction.

In one embodiment, only LEC_START is strictly communicated on an independent coupling (e.g., wire), for example, other control channels may be overlayed on existing network (e.g., wires).

### Reuse of Network Resources

To reduce the overhead of data extraction, certain embodiments of a CSA make use of existing network infrastructure to communicate extraction data. A LEC may make use of both a chip-level memory hierarchy and a fabric-level communications networks to move data from the fabric into storage. As a result, in certain embodiments of a CSA, the extraction infrastructure adds no more than 2% to the overall fabric area and power.

Reuse of network resources in certain embodiments of a CSA may cause a network to have some hardware support for an extraction protocol. Circuit switched networks require of certain embodiments of a CSA cause a LEC to set their multiplexors in a specific way for configuration when the ‘TEC_START’ signal is asserted. Packet switched networks do not require extension, although LEC endpoints (e.g., extraction terminators) use a specific address in the packet switched network. Network reuse is optional, and some embodiments may find dedicated configuration buses to be more convenient.

### Per EFE State

Each EFE may maintain a bit denoting whether or not it has exported its state. This bit may de-asserted when the extraction start signal is driven, and then asserted once the particular EFE finished extraction. In one extraction protocol, EFEs are arranged to form chains with the EFE extraction state bit determining the topology of the chain. A EFE may read the extraction state bit of the immediately adjacent EFE. If this adjacent EFE has its extraction bit set and the current EFE does not, the EFE may determine that it owns the extraction bus. When an EFE dumps its last data value, it may drives the ‘EFE_DONE’ signal and sets its extraction bit, e.g., enabling upstream EFEs to configure for extraction. The network adjacent to the EFE may observe this signal and also adjust its state to handle the transition. As a base case to the extraction process, an extraction terminator (e.g., extraction terminator 4804 for LEC 4802 or extraction terminator 4808 for LEC 4806 in FIG. 39) which asserts that extraction is complete may be included at the end of a chain.

Internal to the EFE, this bit may be used to drive flow control ready signals. For example, when the extraction bit is de-asserted, network control signals may automatically be clamped to a values that prevent data from flowing, while, within PEs, no operations or actions will be scheduled.

Dealing with High-Delay Paths

One embodiment of a LEC may drive a signal over a long distance, e.g., through many multiplexors and with many loads. Thus, it may be difficult for a signal to arrive at a distant EFE within a short clock cycle. In certain embodiments, extraction signals are at some division (e.g., fraction of) of the main (e.g., CSA) clock frequency to ensure digital timing discipline at extraction. Clock division may be utilized in an out-of-band signaling protocol, and does not require any modification of the main clock tree.

### Ensuring Consistent Fabric Behavior During Extraction

Since certain extraction scheme are distributed and have non-deterministic timing due to program and memory effects, different members of the fabric may be under extraction at different times. While LEC_EXTRACT is driven, all network flow control signals may be driven logically low, e.g., thus freezing the operation of a particular segment of the fabric.

An extraction process may be non-destructive. Therefore a set of PEs may be considered operational once extraction has completed. An extension to an extraction protocol may allow PEs to optionally be disabled post extraction. Alternatively, beginning configuration during the extraction process will have similar effect in embodiments.

### Single PE Extraction

In some cases, it may be expedient to extract a single PE. In this case, an optional address signal may be driven as part of the commencement of the extraction process. This may enable the PE targeted for extraction to be directly enabled. Once this PE has been extracted, the extraction process may cease with the lowering of the LEC_EXTRACT signal. In this way, a single PE may be selectively extracted, e.g., by the local extraction controller.

### Handling Extraction Backpressure

In an embodiment where the LEC writes extracted data to memory (for example, for post-processing, e.g., in software), it may be subject to limited memory bandwidth. In the case that the LEC exhausts its buffering capacity, or expects that it will exhaust its buffering capacity, it may stops strobing the LEC_STROBE signal until the buffering issue has resolved.

Note that in certain figures (e.g., FIGS. 39, 42, 43, 45, 46, and 48) communications are shown schematically. In certain embodiments, those communications may occur over the (e.g., interconnect) network.

### 7.7 Flow Diagrams

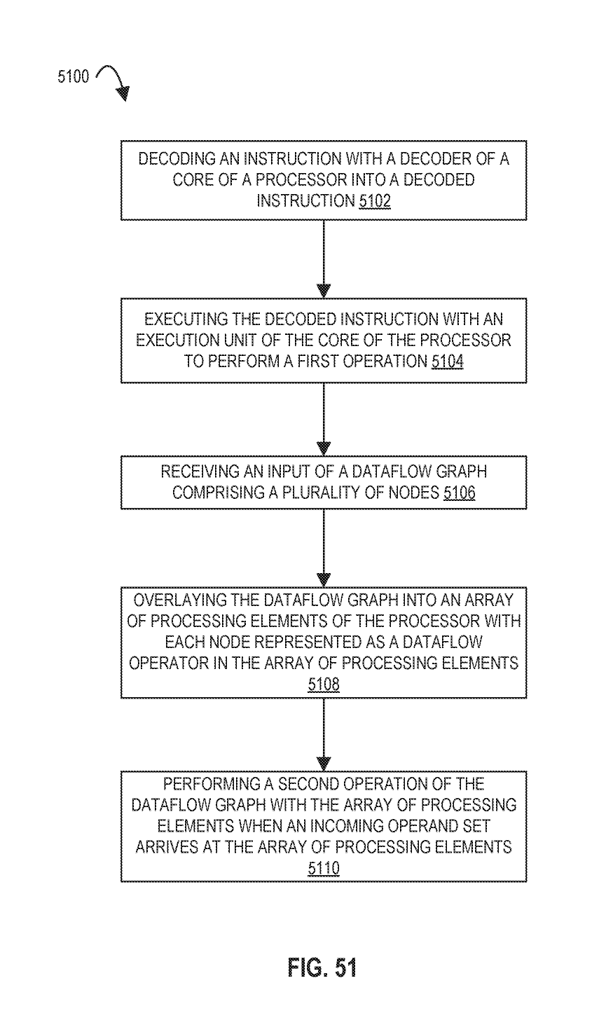

FIG. 51 illustrates a flow diagram 5100 according to embodiments of the disclosure. Depicted flow 5100 includes decoding an instruction with a decoder of a core of a processor into a decoded instruction 5102; executing the decoded instruction with an execution unit of the core of the processor to perform a first operation 5104; receiving an input of a dataflow graph comprising a plurality of nodes 5106; overlaying the dataflow graph into an array of processing elements of the processor with each node represented as a dataflow operator in the array of processing elements 5108; and performing a second operation of the dataflow graph with the array of processing elements when an incoming operand set arrives at the array of processing elements 5110.

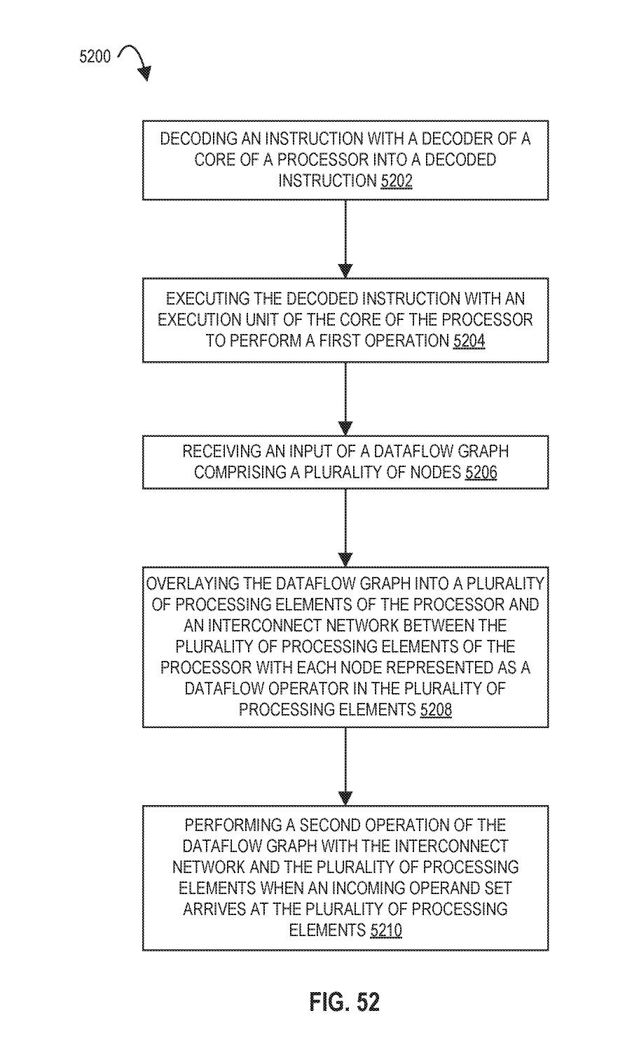

FIG. 52 illustrates a flow diagram 5200 according to embodiments of the disclosure. Depicted flow 5200 includes decoding an instruction with a decoder of a core of a processor into a decoded instruction 5202; executing the decoded instruction with an execution unit of the core of the processor to perform a first operation 5204; receiving an input of a dataflow graph comprising a plurality of nodes 5206; overlaying the dataflow graph into a plurality of processing elements of the processor and an interconnect network between the plurality of processing elements of the processor with each node represented as a dataflow operator in the plurality of processing elements 5208; and performing a second operation of the dataflow graph with the interconnect network and the plurality of processing elements when an incoming operand set arrives at the plurality of processing elements 5210.

### 8. Summary

Supercomputing at the ExaFLOP scale may be a challenge in high-performance computing, a challenge which is not likely to be met by conventional von Neumann architectures. To achieve ExaFLOPs, embodiments of a CSA provide a heterogeneous spatial array that targets direct execution of (e.g., compiler-produced) dataflow graphs. In addition to laying out the architectural principles of embodiments of a CSA, the above also describes and evaluates embodiments of a CSA which showed performance and energy of larger than 10× over existing products. Compiler-generated code may have significant performance and energy gains over roadmap architectures. As a heterogeneous, parametric architecture, embodiments of a CSA may be readily adapted to all computing uses. For example, a mobile version of CSA might be tuned to 32-bits, while a machine-learning focused array might feature significant numbers of vectorized 8-bit multiplication units. The main advantages of embodiments of a CSA are high performance and extreme energy efficiency, characteristics relevant to all forms of computing ranging from supercomputing and datacenter to the internet-of-things.

In one embodiment, a processor includes a plurality of processing elements; an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the interconnect network and the plurality of processing elements, and the plurality of processing elements is to perform an operation when an incoming operand set arrives at the plurality of processing elements; and a configuration controller coupled to the plurality of processing elements to configure the plurality of processing elements according to configuration information for the dataflow graph, and clock gate at least one clocked component of a processing element based on the configuration information. The at least one clocked component may be an input buffer of multiple parallel input buffers within the processing element. The at least one clocked component may be an output buffer of multiple parallel input buffers within the processing element. The at least one clocked component may be an operation configuration register within the processing element to store an operation configuration of the configuration information. The configuration controller may clock gate at least one clocked component of a second processing element based on the configuration information. The at least one clocked component may include multiple parallel input buffers within the processing element, multiple parallel output buffers within the processing element, and an operation configuration register within the processing element to store an operation configuration of the configuration information, and the configuration controller may independently clock gate each of those clocked components.

In another embodiment, a method includes configuring, with a configuration controller of a processor, a plurality of processing elements of the processor according to configuration information for a dataflow graph, wherein the processor comprises the plurality of processing elements and an interconnect network between the plurality of processing elements, and has the dataflow graph comprising a plurality of nodes overlaid into the plurality of processing elements of the processor and the interconnect network between the plurality of processing elements of the processor with each node represented as a dataflow operator in the interconnect network and the plurality of processing elements; clock gating, with the configuration controller of the processor, at least one clocked component of a processing element based on the configuration information for the dataflow graph; and performing an operation of the dataflow graph with the interconnect network and the plurality of processing elements when an incoming operand set arrives at the plurality of processing elements. The clock gating may include clock gating an input buffer of multiple parallel input buffers within the processing element. The clock gating may include clock gating an output buffer of multiple parallel input buffers within the processing element. The clock gating may include clock gating an operation configuration register within the processing element to store an operation configuration of the configuration information. The clock gating may include clock gating at least one clocked component of a second processing element based on the configuration information. The at least one clocked component may include multiple parallel input buffers within the processing element, multiple parallel output buffers within the processing element, and an operation configuration register within the processing element to store an operation configuration of the configuration information, and the configuration controller may independently perform clock gating each of those clocked components.

In yet another embodiment, a processor includes a plurality of processing elements; an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the interconnect network and the plurality of processing elements, and the plurality of processing elements is to perform an operation when an incoming operand set arrives at the plurality of processing elements; and means coupled to the plurality of processing elements to configure the plurality of processing elements according to configuration information for the dataflow graph, and clock gate at least one clocked component of a processing element based on the configuration information.

In another embodiment, a processor includes a plurality of processing elements; an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the interconnect network and the plurality of processing elements, and the plurality of processing elements is to perform an operation when an incoming operand set arrives at the plurality of processing elements; and a configuration controller, coupled to a first processing element and a second processing element of the plurality of processing elements and the first processing element having an output coupled to an input of the second processing element, to configure the second processing element to clock gate at least one clocked component of the second processing element, and configure the first processing element to send a reenable signal on the interconnect network to the second processing element to reenable the at least one clocked component of the second processing element when data is to be sent from the first processing element to the second processing element. The configuration controller may configure the first processing element to send the reenable signal and the data from the first processing element to the second processing element within a same clock cycle. The at least one clocked component of the second processing element may be multiple parallel input buffers within the second processing element. The configuration controller may configure the first processing element to clock gate multiple parallel output buffers within the first processing element, and reenable the multiple parallel output buffers when the data is to be sent from the multiple parallel output buffers within the first processing element to the multiple parallel input buffers within the second processing element. The configuration controller, coupled to a third processing element of the plurality of processing elements and the first processing element having an output coupled to an input of the third processing element, may configure the third processing element to not clock gate any clocked component of the third processing element. The configuration controller may configure the third processing element to not clock gate any clocked component of the third processing element when a distance on the interconnect network between the first processing element and the third processing element is greater than a threshold distance to communicate within a same clock cycle between the first processing element and the third processing element.

In yet another embodiment, a method includes configuring, with a configuration controller of a processor coupled to a first processing element and a second processing element of a plurality of processing elements and the first processing element having an output coupled to an input of the second processing element, the second processing element to clock gate at least one clocked component of the second processing element, wherein the processor comprises the plurality of processing elements and an interconnect network between the plurality of processing elements, and has a dataflow graph comprising a plurality of nodes overlaid into the plurality of processing elements of the processor and the interconnect network between the plurality of processing elements of the processor with each node represented as a dataflow operator in the interconnect network and the plurality of processing elements; configuring, with the configuration controller, the first processing element to send a reenable signal on the interconnect network to the second processing element to reenable the at least one clocked component of the second processing element when data is to be sent from the first processing element to the second processing element; clock gating, with the configuration controller of the processor, the at least one clocked component of the second processing element; sending, with the first processing element, a reenable signal on the interconnect network to the second processing element to reenable the at least one clocked component of the second processing element when data is sent from the first processing element to the second processing element; and performing an operation of the dataflow graph with the second processing element when an incoming operand set including the data arrives at the second processing element. The configuring of the first processing element may cause the first processing element to send the reenable signal and the data from the first processing element to the second processing element within a same clock cycle. The clock gating may include clock gating multiple parallel input buffers within the second processing element. The configuring of the first processing element may cause the first processing element to clock gate multiple parallel output buffers within the first processing element, and reenable the multiple parallel output buffers when the data is sent from the multiple parallel output buffers within the first processing element to the multiple parallel input buffers within the second processing element. The method may include configuring, with the configuration controller coupled to a third processing element of the plurality of processing elements and the first processing element having an output coupled to an input of the third processing element, the third processing element to not clock gate any clocked component of the third processing element. The configuring of the third processing element to not clock gate any clocked component of the third processing element may be based on a distance on the interconnect network between the first processing element and the third processing element being greater than a threshold distance to communicate within a same clock cycle between the first processing element and the third processing element.

In another embodiment, a processor includes a plurality of processing elements; an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the interconnect network and the plurality of processing elements, and the plurality of processing elements is to perform an operation when an incoming operand set arrives at the plurality of processing elements; and means, coupled to a first processing element and a second processing element of the plurality of processing elements and the first processing element having an output coupled to an input of the second processing element, to configure the second processing element to clock gate at least one clocked component of the second processing element, and configure the first processing element to send a reenable signal on the interconnect network to the second processing element to reenable the at least one clocked component of the second processing element when data is to be sent from the first processing element to the second processing element.

In one embodiment, a processor includes a plurality of processing elements; an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the interconnect network and the plurality of processing elements, and the plurality of processing elements is to perform an operation when an incoming operand set arrives at the plurality of processing elements; and a configuration controller coupled to a first subset and a second, different subset of the plurality of processing elements, the first subset having an output coupled to an input of the second, different subset, wherein the configuration controller is to configure the first subset and the second, different subset of the plurality of processing elements according to configuration information for a first context of a dataflow graph, and, for a requested context switch, configure the first subset of the plurality of processing elements according to configuration information for a second context of a dataflow graph after pending operations of the first context are completed (e.g., up to the point a backpressure signal is encountered and/or all the input data in consumed) (or are not completed, e.g., operations are stopped at a stopping point where state may be extracted) in the first subset and block second context dataflow into the input of the second, different subset from the output of the first subset until pending operations of the first context are completed (e.g., up to the point a backpressure signal is encountered and/or all the input data in consumed) in the second, different subset. The processor may include a first local configuration controller of the first subset and a second local configuration controller of the second, different subset, wherein the configuration controller is to send corresponding configuration information to each of the first local configuration controller and the second local configuration controller. Pending operations may be operations that are to (e.g., must) be completed to arrive at a (e.g., fully) saveable state, for example, see the discussion of FIGS. 6A-6B above. Configuration information may be stored somewhere and then read in, while extraction information may be written to some storage somewhere, for example, to virtual memory (e.g., via a RAF circuit). The configuration controller may include an extraction controller to cause state data from the first subset and the second, different subset of the plurality of processing elements to be saved to memory, and the extraction controller is to, for the requested context switch, extract first state data from the first subset after the pending operations of the first context are completed in the first subset. The plurality of processing elements may include a third, different subset of the plurality of processing elements between the output of the first subset and the input of the second, different subset, and the configuration controller is to, for the requested context switch, keep the third, different subset of the plurality of processing elements in an unconfigured state to block second context dataflow from the output of the first subset to the input of the second, different subset until the pending operations of the first context are completed in the second, different subset. The configuration controller may cause a backpressure signal of the third, different subset to be output for the unconfigured state to the first subset of the plurality of processing elements. The configuration controller may allow operations of the first context in the second, different subset (e.g., to occur) concurrently with operations of the second context in the first subset.

In another embodiment, a method includes receiving an input of a dataflow graph comprising a plurality of nodes; overlaying the dataflow graph into a plurality of processing elements of a processor and an interconnect network between the plurality of processing elements of the processor with each node represented as a dataflow operator in the interconnect network and the plurality of processing elements; performing an operation of the dataflow graph with the interconnect network and the plurality of processing elements when an incoming operand set arrives at the plurality of processing elements; configuring, with a configuration controller of the processor, a first subset and a second, different subset of the plurality of processing elements according to configuration information for a first context of a dataflow graph; and configuring, for a requested context switch with the configuration controller of the processor, the first subset of the plurality of processing elements according to configuration information for a second context of a dataflow graph after pending operations of the first context are completed in the first subset and blocking second context dataflow into an input of the second, different subset from an output of the first subset until pending operations of the first context are completed in the second, different subset. The method may include the configuration controller sending corresponding configuration information to each of a first local configuration controller of the first subset and a second local configuration controller of the second, different subset. The method may include, for the requested context switch, extracting first state data from the first subset after the pending operations of the first context are completed in the first subset. The method may include, for the requested context switch with the configuration controller, keeping a third, different subset of the plurality of processing elements between the output of the first subset and the input of the second, different subset in an unconfigured state to block second context dataflow from the output of the first subset to the input of the second, different subset until the pending operations of the first context are completed in the second, different subset. The keeping may include causing a backpressure signal of the third, different subset to be output for the unconfigured state to the first subset of the plurality of processing elements. The method may include allowing, with the configuration controller, operations of the first context in the second, different subset (e.g., to occur) concurrently with operations of the second context in the first subset.

In yet another embodiment, a processor includes a plurality of processing elements; an interconnect means between the plurality of processing elements to receive an input of a dataflow graph comprising a plurality of nodes, wherein the dataflow graph is to be overlaid into the interconnect means and the plurality of processing elements with each node represented as a dataflow operator in the interconnect means and the plurality of processing elements, and the plurality of processing elements is to perform an operation when an incoming operand set arrives at the plurality of processing elements; and means coupled to a first subset and a second, different subset of the plurality of processing elements, the first subset having an output coupled to an input of the second, different subset, wherein the means is to configure the first subset and the second, different subset of the plurality of processing elements according to configuration information for a first context of a dataflow graph, and, for a requested context switch, configure the first subset of the plurality of processing elements according to configuration information for a second context of a dataflow graph after pending operations of the first context are completed in the first subset and block second context dataflow into the input of the second, different subset from the output of the first subset until pending operations of the first context are completed in the second, different subset.

In another embodiment, a processor includes a plurality of processing elements; an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the interconnect network and the plurality of processing elements, and the plurality of processing elements is to perform an operation when an incoming operand set arrives at the plurality of processing elements; a first configuration controller coupled to a first subset of the plurality of processing elements; and a second configuration controller coupled to a second, different subset of the plurality of processing elements, and the first subset having an output coupled to an input of the second, different subset, wherein the first configuration controller and the second configuration controller are to configure the first subset and the second, different subset of the plurality of processing elements according to configuration information for a first context of a dataflow graph, and, for a requested context switch, the first configuration controller is to configure the first subset of the plurality of processing elements according to configuration information for a second context of a dataflow graph after pending operations of the first context are completed in the first subset and block second context dataflow into the input of the second, different subset from the output of the first subset until pending operations of the first context are completed in the second, different subset. The processor may include a higher-level configuration controller coupled to the first configuration controller and the second configuration controller, wherein the higher-level configuration controller is to send corresponding configuration information to each of the first configuration controller and the second configuration controller. The first configuration controller may include an extraction controller to cause state data from the first subset of the plurality of processing elements to be saved to memory, and the extraction controller is to, for the requested context switch, extract first state data from the first subset after the pending operations of the first context are completed in the first subset. The plurality of processing elements may include a third, different subset of the plurality of processing elements between the output of the first subset and the input of the second, different subset, and a third configuration controller is coupled to the third, different subset to, for the requested context switch, keep the third, different subset of the plurality of processing elements in an unconfigured state to block second context dataflow from the output of the first subset to the input of the second, different subset until the pending operations of the first context are completed in the second, different subset. The third configuration controller may cause a backpressure signal of the third, different subset to be output for the unconfigured state to the first subset of the plurality of processing elements. The first configuration controller and the second configuration controller may allow operations of the first context in the second, different subset (e.g., to occur) concurrently with operations of the second context in the first subset.

In yet another embodiment, a method includes receiving an input of a dataflow graph comprising a plurality of nodes; overlaying the dataflow graph into a plurality of processing elements of a processor and an interconnect network between the plurality of processing elements of the processor with each node represented as a dataflow operator in the interconnect network and the plurality of processing elements; performing an operation of the dataflow graph with the interconnect network and the plurality of processing elements when an incoming operand set arrives at the plurality of processing elements; configuring, with a first configuration controller and a second configuration controller of the processor, a first subset and a second, different subset of the plurality of processing elements according to corresponding configuration information for a first context of a dataflow graph; and configuring, for a requested context switch with the first configuration controller of the processor, the first subset of the plurality of processing elements according to configuration information for a second context of a dataflow graph after pending operations of the first context are completed in the first subset and blocking second context dataflow into an input of the second, different subset from an output of the first subset until pending operations of the first context are completed in the second, different subset. The method may include sending, with a higher-level configuration controller of the processor, the corresponding configuration information to each of the first configuration controller of the first subset and the second configuration controller of the second, different subset. The method may include, for the requested context switch, extracting first state data from the first subset after the pending operations of the first context are completed in the first subset. The method may include, for the requested context switch, keeping a third, different subset of the plurality of processing elements between the output of the first subset and the input of the second, different subset in an unconfigured state with a third configuration controller of the third, different subset to block second context dataflow from the output of the first subset to the input of the second, different subset until the pending operations of the first context are completed in the second, different subset. The keeping may include causing a backpressure signal of the third, different subset to be output for the unconfigured state to the first subset of the plurality of processing elements. The method may include allowing, with the first configuration controller and the second configuration controller, operations of the first context in the second, different subset (e.g., to occur) concurrently with operations of the second context in the first subset.

In yet another embodiment, a processor includes a plurality of processing elements; an interconnect means between the plurality of processing elements to receive an input of a dataflow graph comprising a plurality of nodes, wherein the dataflow graph is to be overlaid into the interconnect means and the plurality of processing elements with each node represented as a dataflow operator in the interconnect means and the plurality of processing elements, and the plurality of processing elements is to perform an operation when an incoming operand set arrives at the plurality of processing elements; a first means coupled to a first subset of the plurality of processing elements; and a second means coupled to a second, different subset of the plurality of processing elements, and the first subset having an output coupled to an input of the second, different subset, wherein the first means and the second means are to configure the first subset and the second, different subset of the plurality of processing elements according to configuration information for a first context of a dataflow graph, and, for a requested context switch, the first means is to configure the first subset of the plurality of processing elements according to configuration information for a second context of a dataflow graph after pending operations of the first context are completed in the first subset and block second context dataflow into the input of the second, different subset from the output of the first subset until pending operations of the first context are completed in the second, different subset.

In one embodiment, a processor includes a core with a decoder to decode an instruction into a decoded instruction and an execution unit to execute the decoded instruction to perform a first operation; a plurality of processing elements; and an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the plurality of processing elements, and the plurality of processing elements are to perform a second operation by a respective, incoming operand set arriving at each of the dataflow operators of the plurality of processing elements. A processing element of the plurality of processing elements may stall execution when a backpressure signal from a downstream processing element indicates that storage in the downstream processing element is not available for an output of the processing element. The processor may include a flow control path network to carry the backpressure signal according to the dataflow graph. A dataflow token may cause an output from a dataflow operator receiving the dataflow token to be sent to an input buffer of a particular processing element of the plurality of processing elements. The second operation may include a memory access and the plurality of processing elements comprises a memory-accessing dataflow operator that is not to perform the memory access until receiving a memory dependency token from a logically previous dataflow operator. The plurality of processing elements may include a first type of processing element and a second, different type of processing element.

In another embodiment, a method includes decoding an instruction with a decoder of a core of a processor into a decoded instruction; executing the decoded instruction with an execution unit of the core of the processor to perform a first operation; receiving an input of a dataflow graph comprising a plurality of nodes; overlaying the dataflow graph into a plurality of processing elements of the processor and an interconnect network between the plurality of processing elements of the processor with each node represented as a dataflow operator in the plurality of processing elements; and performing a second operation of the dataflow graph with the interconnect network and the plurality of processing elements by a respective, incoming operand set arriving at each of the dataflow operators of the plurality of processing elements. The method may include stalling execution by a processing element of the plurality of processing elements when a backpressure signal from a downstream processing element indicates that storage in the downstream processing element is not available for an output of the processing element. The method may include sending the backpressure signal on a flow control path network according to the dataflow graph. A dataflow token may cause an output from a dataflow operator receiving the dataflow token to be sent to an input buffer of a particular processing element of the plurality of processing elements. The method may include not performing a memory access until receiving a memory dependency token from a logically previous dataflow operator, wherein the second operation comprises the memory access and the plurality of processing elements comprises a memory-accessing dataflow operator. The method may include providing a first type of processing element and a second, different type of processing element of the plurality of processing elements.

In yet another embodiment, an apparatus includes a data path network between a plurality of processing elements; and a flow control path network between the plurality of processing elements, wherein the data path network and the flow control path network are to receive an input of a dataflow graph comprising a plurality of nodes, the dataflow graph is to be overlaid into the data path network, the flow control path network, and the plurality of processing elements with each node represented as a dataflow operator in the plurality of processing elements, and the plurality of processing elements are to perform a second operation by a respective, incoming operand set arriving at each of the dataflow operators of the plurality of processing elements. The flow control path network may carry backpressure signals to a plurality of dataflow operators according to the dataflow graph. A dataflow token sent on the data path network to a dataflow operator may cause an output from the dataflow operator to be sent to an input buffer of a particular processing element of the plurality of processing elements on the data path network. The data path network may be a static, circuit switched network to carry the respective, input operand set to each of the dataflow operators according to the dataflow graph. The flow control path network may transmit a backpressure signal according to the dataflow graph from a downstream processing element to indicate that storage in the downstream processing element is not available for an output of the processing element. At least one data path of the data path network and at least one flow control path of the flow control path network may form a channelized circuit with backpressure control. The flow control path network may pipeline at least two of the plurality of processing elements in series.

In another embodiment, a method includes receiving an input of a dataflow graph comprising a plurality of nodes; and overlaying the dataflow graph into a plurality of processing elements of a processor, a data path network between the plurality of processing elements, and a flow control path network between the plurality of processing elements with each node represented as a dataflow operator in the plurality of processing elements. The method may include carrying backpressure signals with the flow control path network to a plurality of dataflow operators according to the dataflow graph. The method may include sending a dataflow token on the data path network to a dataflow operator to cause an output from the dataflow operator to be sent to an input buffer of a particular processing element of the plurality of processing elements on the data path network. The method may include setting a plurality of switches of the data path network and/or a plurality of switches of the flow control path network to carry the respective, input operand set to each of the dataflow operators according to the dataflow graph, wherein the data path network is a static, circuit switched network. The method may include transmitting a backpressure signal with the flow control path network according to the dataflow graph from a downstream processing element to indicate that storage in the downstream processing element is not available for an output of the processing element. The method may include forming a channelized circuit with backpressure control with at least one data path of the data path network and at least one flow control path of the flow control path network.

In yet another embodiment, a processor includes a core with a decoder to decode an instruction into a decoded instruction and an execution unit to execute the decoded instruction to perform a first operation; a plurality of processing elements; and a network means between the plurality of processing elements to receive an input of a dataflow graph comprising a plurality of nodes, wherein the dataflow graph is to be overlaid into the network means and the plurality of processing elements with each node represented as a dataflow operator in the plurality of processing elements, and the plurality of processing elements are to perform a second operation by a respective, incoming operand set arriving at each of the dataflow operators of the plurality of processing elements.

In another embodiment, an apparatus includes a data path means between a plurality of processing elements; and a flow control path means between the plurality of processing elements, wherein the data path means and the flow control path means are to receive an input of a dataflow graph comprising a plurality of nodes, the dataflow graph is to be overlaid into the data path means, the flow control path means, and the plurality of processing elements with each node represented as a dataflow operator in the plurality of processing elements, and the plurality of processing elements are to perform a second operation by a respective, incoming operand set arriving at each of the dataflow operators of the plurality of processing elements.

In one embodiment, a processor includes a core with a decoder to decode an instruction into a decoded instruction and an execution unit to execute the decoded instruction to perform a first operation; and an array of processing elements to receive an input of a dataflow graph comprising a plurality of nodes, wherein the dataflow graph is to be overlaid into the array of processing elements with each node represented as a dataflow operator in the array of processing elements, and the array of processing elements is to perform a second operation when an incoming operand set arrives at the array of processing elements. The array of processing element may not perform the second operation until the incoming operand set arrives at the array of processing elements and storage in the array of processing elements is available for output of the second operation. The array of processing elements may include a network (or channel(s)) to carry dataflow tokens and control tokens to a plurality of dataflow operators. The second operation may include a memory access and the array of processing elements may include a memory-accessing dataflow operator that is not to perform the memory access until receiving a memory dependency token from a logically previous dataflow operator. Each processing element may perform only one or two operations of the dataflow graph.

In another embodiment, a method includes decoding an instruction with a decoder of a core of a processor into a decoded instruction; executing the decoded instruction with an execution unit of the core of the processor to perform a first operation; receiving an input of a dataflow graph comprising a plurality of nodes; overlaying the dataflow graph into an array of processing elements of the processor with each node represented as a dataflow operator in the array of processing elements; and performing a second operation of the dataflow graph with the array of processing elements when an incoming operand set arrives at the array of processing elements. The array of processing elements may not perform the second operation until the incoming operand set arrives at the array of processing elements and storage in the array of processing elements is available for output of the second operation. The array of processing elements may include a network carrying dataflow tokens and control tokens to a plurality of dataflow operators. The second operation may include a memory access and the array of processing elements comprises a memory-accessing dataflow operator that is not to perform the memory access until receiving a memory dependency token from a logically previous dataflow operator. Each processing element may performs only one or two operations of the dataflow graph.

In yet another embodiment, a non-transitory machine readable medium that stores code that when executed by a machine causes the machine to perform a method including decoding an instruction with a decoder of a core of a processor into a decoded instruction; executing the decoded instruction with an execution unit of the core of the processor to perform a first operation; receiving an input of a dataflow graph comprising a plurality of nodes; overlaying the dataflow graph into an array of processing elements of the processor with each node represented as a dataflow operator in the array of processing elements; and performing a second operation of the dataflow graph with the array of processing elements when an incoming operand set arrives at the array of processing elements. The array of processing element may not perform the second operation until the incoming operand set arrives at the array of processing elements and storage in the array of processing elements is available for output of the second operation. The array of processing elements may include a network carrying dataflow tokens and control tokens to a plurality of dataflow operators. The second operation may include a memory access and the array of processing elements comprises a memory-accessing dataflow operator that is not to perform the memory access until receiving a memory dependency token from a logically previous dataflow operator. Each processing element may performs only one or two operations of the dataflow graph.

In another embodiment, a processor includes a core with a decoder to decode an instruction into a decoded instruction and an execution unit to execute the decoded instruction to perform a first operation; and means to receive an input of a dataflow graph comprising a plurality of nodes, wherein the dataflow graph is to be overlaid into the means with each node represented as a dataflow operator in the means, and the means is to perform a second operation when an incoming operand set arrives at the means.

In one embodiment, a processor includes a core with a decoder to decode an instruction into a decoded instruction and an execution unit to execute the decoded instruction to perform a first operation; a plurality of processing elements; and an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the plurality of processing elements, and the plurality of processing elements is to perform a second operation when an incoming operand set arrives at the plurality of processing elements. The processor may further comprise a plurality of configuration controllers, each configuration controller is coupled to a respective subset of the plurality of processing elements, and each configuration controller is to load configuration information from storage and cause coupling of the respective subset of the plurality of processing elements according to the configuration information. The processor may include a plurality of configuration caches, and each configuration controller is coupled to a respective configuration cache to fetch the configuration information for the respective subset of the plurality of processing elements. The first operation performed by the execution unit may prefetch configuration information into each of the plurality of configuration caches. Each of the plurality of configuration controllers may include a reconfiguration circuit to cause a reconfiguration for at least one processing element of the respective subset of the plurality of processing elements on receipt of a configuration error message from the at least one processing element. Each of the plurality of configuration controllers may a reconfiguration circuit to cause a reconfiguration for the respective subset of the plurality of processing elements on receipt of a reconfiguration request message, and disable communication with the respective subset of the plurality of processing elements until the reconfiguration is complete. The processor may include a plurality of exception aggregators, and each exception aggregator is coupled to a respective subset of the plurality of processing elements to collect exceptions from the respective subset of the plurality of processing elements and forward the exceptions to the core for servicing. The processor may include a plurality of extraction controllers, each extraction controller is coupled to a respective subset of the plurality of processing elements, and each extraction controller is to cause state data from the respective subset of the plurality of processing elements to be saved to memory.

In another embodiment, a method includes decoding an instruction with a decoder of a core of a processor into a decoded instruction; executing the decoded instruction with an execution unit of the core of the processor to perform a first operation; receiving an input of a dataflow graph comprising a plurality of nodes; overlaying the dataflow graph into a plurality of processing elements of the processor and an interconnect network between the plurality of processing elements of the processor with each node represented as a dataflow operator in the plurality of processing elements; and performing a second operation of the dataflow graph with the interconnect network and the plurality of processing elements when an incoming operand set arrives at the plurality of processing elements. The method may include loading configuration information from storage for respective subsets of the plurality of processing elements and causing coupling for each respective subset of the plurality of processing elements according to the configuration information. The method may include fetching the configuration information for the respective subset of the plurality of processing elements from a respective configuration cache of a plurality of configuration caches. The first operation performed by the execution unit may be prefetching configuration information into each of the plurality of configuration caches. The method may include causing a reconfiguration for at least one processing element of the respective subset of the plurality of processing elements on receipt of a configuration error message from the at least one processing element. The method may include causing a reconfiguration for the respective subset of the plurality of processing elements on receipt of a reconfiguration request message; and disabling communication with the respective subset of the plurality of processing elements until the reconfiguration is complete. The method may include collecting exceptions from a respective subset of the plurality of processing elements; and forwarding the exceptions to the core for servicing. The method may include causing state data from a respective subset of the plurality of processing elements to be saved to memory.

In yet another embodiment, a non-transitory machine readable medium that stores code that when executed by a machine causes the machine to perform a method including decoding an instruction with a decoder of a core of a processor into a decoded instruction; executing the decoded instruction with an execution unit of the core of the processor to perform a first operation; receiving an input of a dataflow graph comprising a plurality of nodes; overlaying the dataflow graph into a plurality of processing elements of the processor and an interconnect network between the plurality of processing elements of the processor with each node represented as a dataflow operator in the plurality of processing elements; and performing a second operation of the dataflow graph with the interconnect network and the plurality of processing elements when an incoming operand set arrives at the plurality of processing elements. The method may include loading configuration information from storage for respective subsets of the plurality of processing elements and causing coupling for each respective subset of the plurality of processing elements according to the configuration information. The method may include fetching the configuration information for the respective subset of the plurality of processing elements from a respective configuration cache of a plurality of configuration caches. The first operation performed by the execution unit may be prefetching configuration information into each of the plurality of configuration caches. The method may include causing a reconfiguration for at least one processing element of the respective subset of the plurality of processing elements on receipt of a configuration error message from the at least one processing element. The method may include causing a reconfiguration for the respective subset of the plurality of processing elements on receipt of a reconfiguration request message; and disabling communication with the respective subset of the plurality of processing elements until the reconfiguration is complete. The method may include collecting exceptions from a respective subset of the plurality of processing elements; and forwarding the exceptions to the core for servicing. The method may include causing state data from a respective subset of the plurality of processing elements to be saved to memory.

In another embodiment, a processor includes a core with a decoder to decode an instruction into a decoded instruction and an execution unit to execute the decoded instruction to perform a first operation; a plurality of processing elements; and means between the plurality of processing elements to receive an input of a dataflow graph comprising a plurality of nodes, wherein the dataflow graph is to be overlaid into the m and the plurality of processing elements with each node represented as a dataflow operator in the plurality of processing elements, and the plurality of processing elements is to perform a second operation when an incoming operand set arrives at the plurality of processing elements.

In yet another embodiment, an apparatus comprises a data storage device that stores code that when executed by a hardware processor causes the hardware processor to perform any method disclosed herein. An apparatus may be as described in the detailed description. A method may be as described in the detailed description.

In another embodiment, a non-transitory machine readable medium that stores code that when executed by a machine causes the machine to perform a method comprising any method disclosed herein.

An instruction set (e.g., for execution by a core) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, July 2017; and see Intel® Architecture Instruction Set Extensions Programming Reference, April 2017; Intel is a trademark of Intel Corporation or its subsidiaries in the U.S. and/or other countries.).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### Generic Vector Friendly Instruction Format

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

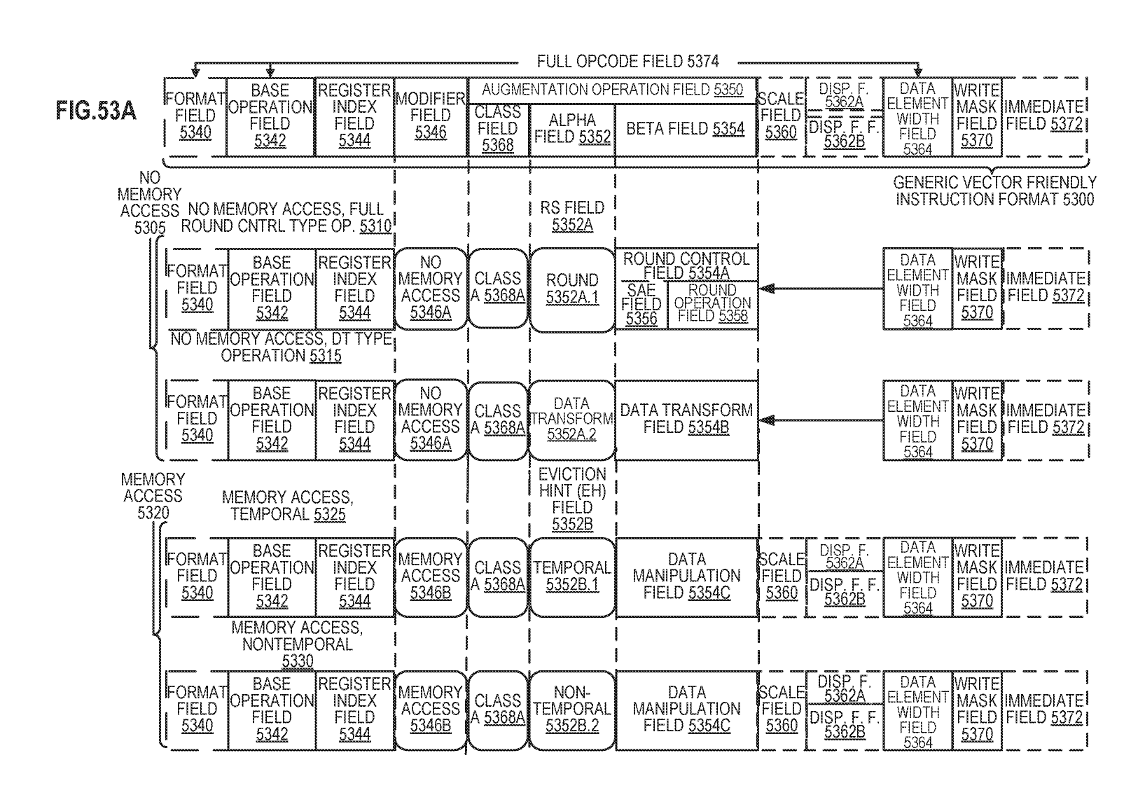

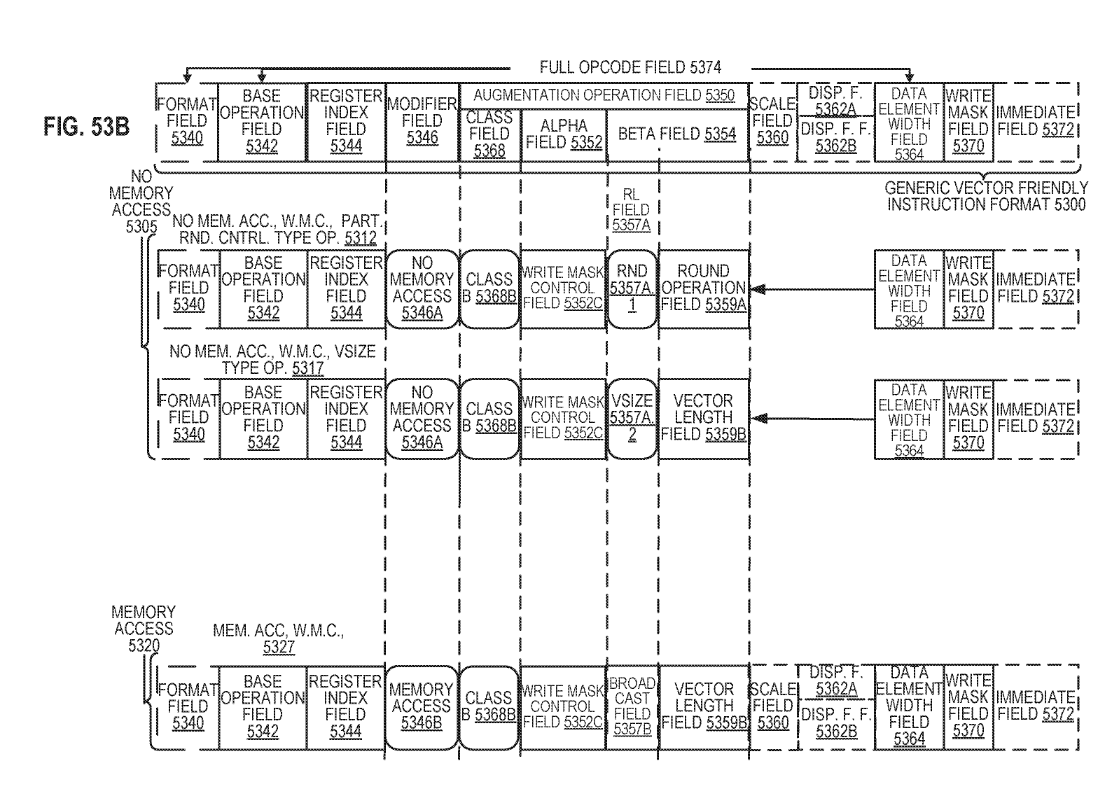

FIGS. 53A-53B are block diagrams illustrating a generic vector friendly instruction format and instruction templates thereof according to embodiments of the disclosure. FIG. 53A is a block diagram illustrating a generic vector friendly instruction format and class A instruction templates thereof according to embodiments of the disclosure; while FIG. 53B is a block diagram illustrating the generic vector friendly instruction format and class B instruction templates thereof according to embodiments of the disclosure. Specifically, a generic vector friendly instruction format 5300 for which are defined class A and class B instruction templates, both of which include no memory access 5305 instruction templates and memory access 5320 instruction templates. The term generic in the context of the vector friendly instruction format refers to the instruction format not being tied to any specific instruction set.

While embodiments of the disclosure will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

The class A instruction templates in FIG. 53A include: 1) within the no memory access 5305 instruction templates there is shown a no memory access, full round control type operation 5310 instruction template and a no memory access, data transform type operation 5315 instruction template; and 2) within the memory access 5320 instruction templates there is shown a memory access, temporal 5325 instruction template and a memory access, non-temporal 5330 instruction template. The class B instruction templates in FIG. 53B include: 1) within the no memory access 5305 instruction templates there is shown a no memory access, write mask control, partial round control type operation 5312 instruction template and a no memory access, write mask control, vsize type operation 5317 instruction template; and 2) within the memory access 5320 instruction templates there is shown a memory access, write mask control 5327 instruction template.

The generic vector friendly instruction format 5300 includes the following fields listed below in the order illustrated in FIGS. 53A-53B.

Format field 5340—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 5342—its content distinguishes different base operations.

Register index field 5344—its content, directly or through address generation, specifies the locations of the source and destination operands, be they in registers or in memory. These include a sufficient number of bits to select N registers from a P×Q (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 5346—its content distinguishes occurrences of instructions in the generic vector instruction format that specify memory access from those that do not; that is, between no memory access 5305 instruction templates and memory access 5320 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 5350—its content distinguishes which one of a variety of different operations to be performed in addition to the base operation. This field is context specific. In one embodiment of the disclosure, this field is divided into a class field 5368, an alpha field 5352, and a beta field 5354. The augmentation operation field 5350 allows common groups of operations to be performed in a single instruction rather than 2, 3, or 4 instructions.

Scale field 5360—its content allows for the scaling of the index field's content for memory address generation (e.g., for address generation that uses 2^{scale}*index+base).

Displacement Field 5362A—its content is used as part of memory address generation (e.g., for address generation that uses 2^{scale}*index+base+displacement).

Displacement Factor Field 5362B (note that the juxtaposition of displacement field 5362A directly over displacement factor field 5362B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 5374 (described later herein) and the data manipulation field 5354C. The displacement field 5362A and the displacement factor field 5362B are optional in the sense that they are not used for the no memory access 5305 instruction templates and/or different embodiments may implement only one or none of the two.

Data element width field 5364—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 5370—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 5370 allows for partial vector operations, including loads, stores, arithmetic, logical, etc. While embodiments of the disclosure are described in which the write mask field's 5370 content selects one of a number of write mask registers that contains the write mask to be used (and thus the write mask field's 5370 content indirectly identifies that masking to be performed), alternative embodiments instead or additional allow the mask write field's 5370 content to directly specify the masking to be performed.

Immediate field 5372—its content allows for the specification of an immediate. This field is optional in the sense that is it not present in an implementation of the generic vector friendly format that does not support immediate and it is not present in instructions that do not use an immediate.

Class field 5368—its content distinguishes between different classes of instructions. With reference to FIGS. 53A-B, the contents of this field select between class A and class B instructions. In FIGS. 53A-B, rounded corner squares are used to indicate a specific value is present in a field (e.g., class A 5368A and class B 5368B for the class field 5368 respectively in FIGS. 53A-B).

### Instruction Templates of Class A

In the case of the non-memory access 5305 instruction templates of class A, the alpha field 5352 is interpreted as an RS field 5352A, whose content distinguishes which one of the different augmentation operation types are to be performed (e.g., round 5352A.1 and data transform 5352A.2 are respectively specified for the no memory access, round type operation 5310 and the no memory access, data transform type operation 5315 instruction templates), while the beta field 5354 distinguishes which of the operations of the specified type is to be performed. In the no memory access 5305 instruction templates, the scale field 5360, the displacement field 5362A, and the displacement scale filed 5362B are not present.

### No-Memory Access Instruction Templates—Full Round Control Type Operation

In the no memory access full round control type operation 5310 instruction template, the beta field 5354 is interpreted as a round control field 5354A, whose content(s) provide static rounding. While in the described embodiments of the disclosure the round control field 5354A includes a suppress all floating point exceptions (SAE) field 5356 and a round operation control field 5358, alternative embodiments may support may encode both these concepts into the same field or only have one or the other of these concepts/fields (e.g., may have only the round operation control field 5358).

SAE field 5356—its content distinguishes whether or not to disable the exception event reporting; when the SAE field's 5356 content indicates suppression is enabled, a given instruction does not report any kind of floating-point exception flag and does not raise any floating point exception handler.

Round operation control field 5358—its content distinguishes which one of a group of rounding operations to perform (e.g., Round-up, Round-down, Round-towards-zero and Round-to-nearest). Thus, the round operation control field 5358 allows for the changing of the rounding mode on a per instruction basis. In one embodiment of the disclosure where a processor includes a control register for specifying rounding modes, the round operation control field's 5350 content overrides that register value.

### No Memory Access Instruction Templates—Data Transform Type Operation

In the no memory access data transform type operation 5315 instruction template, the beta field 5354 is interpreted as a data transform field 5354B, whose content distinguishes which one of a number of data transforms is to be performed (e.g., no data transform, swizzle, broadcast).

In the case of a memory access 5320 instruction template of class A, the alpha field 5352 is interpreted as an eviction hint field 5352B, whose content distinguishes which one of the eviction hints is to be used (in FIG. 53A, temporal 5352B.1 and non-temporal 5352B.2 are respectively specified for the memory access, temporal 5325 instruction template and the memory access, non-temporal 5330 instruction template), while the beta field 5354 is interpreted as a data manipulation field 5354C, whose content distinguishes which one of a number of data manipulation operations (also known as primitives) is to be performed (e.g., no manipulation; broadcast; up conversion of a source; and down conversion of a destination). The memory access 5320 instruction templates include the scale field 5360, and optionally the displacement field 5362A or the displacement scale field 5362B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 5352 is interpreted as a write mask control (Z) field 5352C, whose content distinguishes whether the write masking controlled by the write mask field 5370 should be a merging or a zeroing.

In the case of the non-memory access 5305 instruction templates of class B, part of the beta field 5354 is interpreted as an RL field 5357A, whose content distinguishes which one of the different augmentation operation types are to be performed (e.g., round 5357A.1 and vector length (VSIZE) 5357A.2 are respectively specified for the no memory access, write mask control, partial round control type operation 5312 instruction template and the no memory access, write mask control, VSIZE type operation 5317 instruction template), while the rest of the beta field 5354 distinguishes which of the operations of the specified type is to be performed. In the no memory access 5305 instruction templates, the scale field 5360, the displacement field 5362A, and the displacement scale filed 5362B are not present.

In the no memory access, write mask control, partial round control type operation 5310 instruction template, the rest of the beta field 5354 is interpreted as a round operation field 5359A and exception event reporting is disabled (a given instruction does not report any kind of floating-point exception flag and does not raise any floating point exception handler).

Round operation control field 5359A—just as round operation control field 5358, its content distinguishes which one of a group of rounding operations to perform (e.g., Round-up, Round-down, Round-towards-zero and Round-to-nearest). Thus, the round operation control field 5359A allows for the changing of the rounding mode on a per instruction basis. In one embodiment of the disclosure where a processor includes a control register for specifying rounding modes, the round operation control field's 5350 content overrides that register value.

In the no memory access, write mask control, VSIZE type operation 5317 instruction template, the rest of the beta field 5354 is interpreted as a vector length field 5359B, whose content distinguishes which one of a number of data vector lengths is to be performed on (e.g., 128, 256, or 512 byte).

In the case of a memory access 5320 instruction template of class B, part of the beta field 5354 is interpreted as a broadcast field 5357B, whose content distinguishes whether or not the broadcast type data manipulation operation is to be performed, while the rest of the beta field 5354 is interpreted the vector length field 5359B. The memory access 5320 instruction templates include the scale field 5360, and optionally the displacement field 5362A or the displacement scale field 5362B.

With regard to the generic vector friendly instruction format 5300, a full opcode field 5374 is shown including the format field 5340, the base operation field 5342, and the data element width field 5364. While one embodiment is shown where the full opcode field 5374 includes all of these fields, the full opcode field 5374 includes less than all of these fields in embodiments that do not support all of them. The full opcode field 5374 provides the operation code (opcode).

The augmentation operation field 5350, the data element width field 5364, and the write mask field 5370 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments of the disclosure, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the disclosure). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments of the disclosure. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

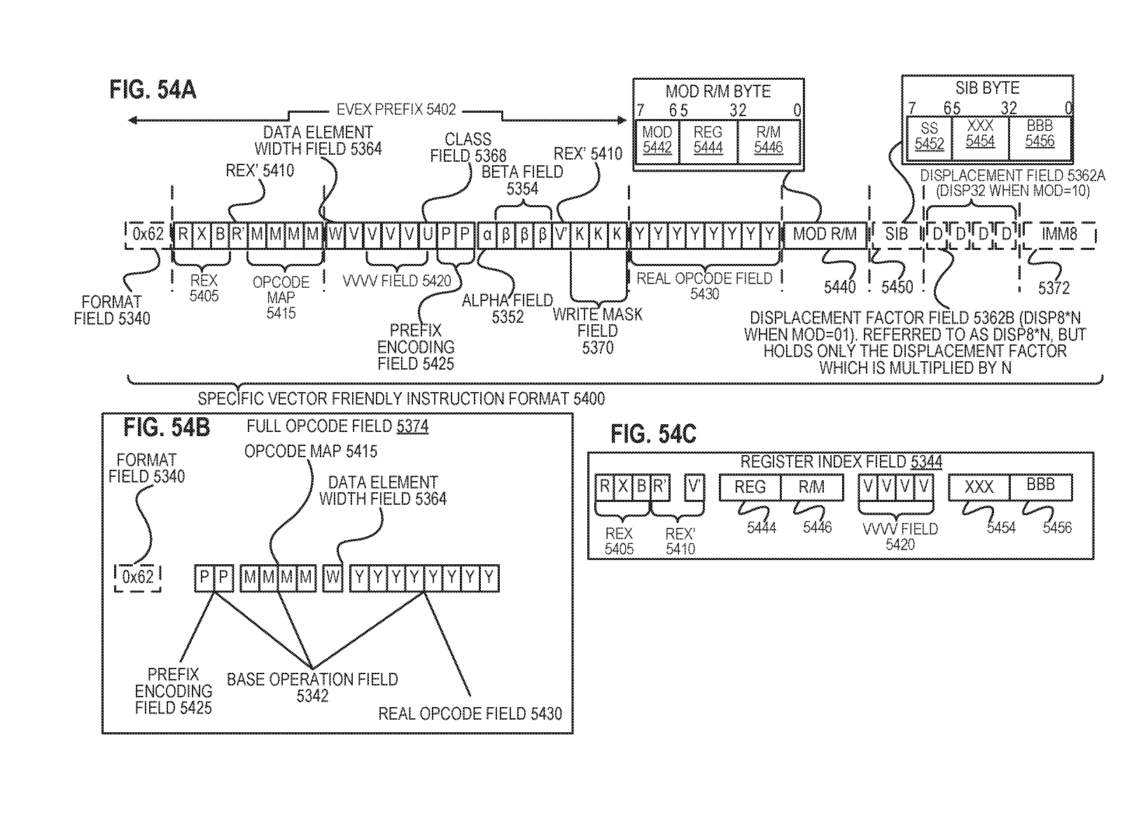

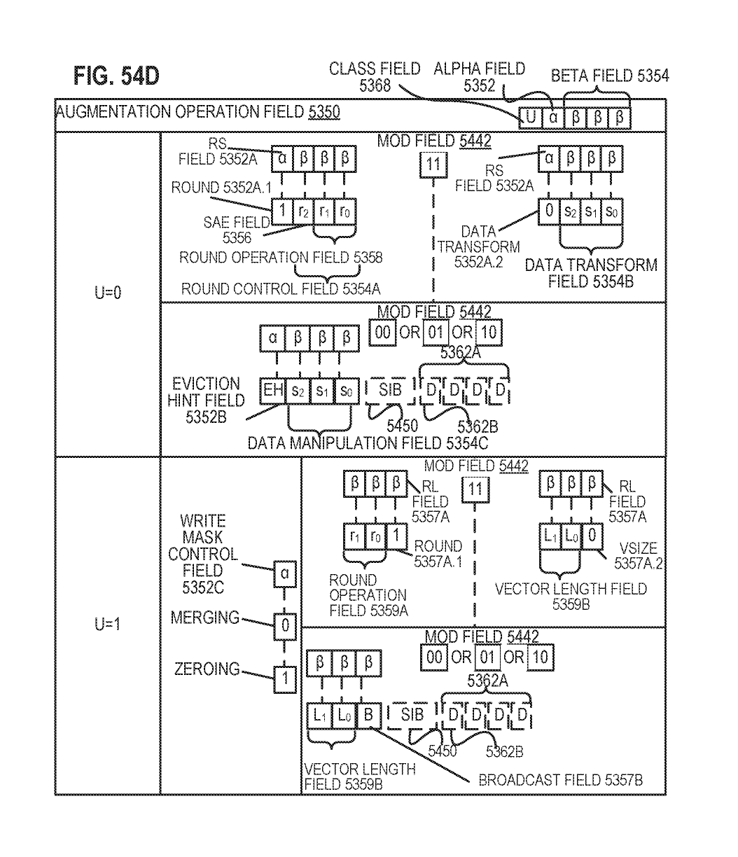

FIG. 54 is a block diagram illustrating an exemplary specific vector friendly instruction format according to embodiments of the disclosure. FIG. 54 shows a specific vector friendly instruction format 5400 that is specific in the sense that it specifies the location, size, interpretation, and order of the fields, as well as values for some of those fields. The specific vector friendly instruction format 5400 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 53 into which the fields from FIG. 54 map are illustrated.

It should be understood that, although embodiments of the disclosure are described with reference to the specific vector friendly instruction format 5400 in the context of the generic vector friendly instruction format 5300 for illustrative purposes, the disclosure is not limited to the specific vector friendly instruction format 5400 except where claimed. For example, the generic vector friendly instruction format 5300 contemplates a variety of possible sizes for the various fields, while the specific vector friendly instruction format 5400 is shown as having fields of specific sizes. By way of specific example, while the data element width field 5364 is illustrated as a one bit field in the specific vector friendly instruction format 5400, the disclosure is not so limited (that is, the generic vector friendly instruction format 5300 contemplates other sizes of the data element width field 5364).

The generic vector friendly instruction format 5300 includes the following fields listed below in the order illustrated in FIG. 54A.

EVEX Prefix (Bytes 0-3) 5402—is encoded in a four-byte form.

Format Field 5340 (EVEX Byte 0, bits [7:0])—the first byte (EVEX Byte 0) is the format field 5340 and it contains 0x62 (the unique value used for distinguishing the vector friendly instruction format in one embodiment of the disclosure).

The second-fourth bytes (EVEX Bytes 1-3) include a number of bit fields providing specific capability.

REX field 5405 (EVEX Byte 1, bits [7-5])—consists of a EVEX.R bit field (EVEX Byte 1, bit [7]—R), EVEX.X bit field (EVEX byte 1, bit [6]—X), and 5357 BEX byte 1, bit[5]—B). The EVEX.R, EVEX.X, and EVEX.B bit fields provide the same functionality as the corresponding VEX bit fields, and are encoded using is complement form, i.e. ZMM0 is encoded as 2611B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 5310—this is the first part of the REX′ field 5310 and is the EVEX.R′ bit field (EVEX Byte 1, bit [4]—R′) that is used to encode either the upper 16 or lower 16 of the extended 32 register set. In one embodiment of the disclosure, this bit, along with others as indicated below, is stored in bit inverted format to distinguish (in the well-known x86 32-bit mode) from the BOUND instruction, whose real opcode byte is 62, but does not accept in the MOD RIM field (described below) the value of 11 in the MOD field; alternative embodiments of the disclosure do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 5415 (EVEX byte 1, bits [3:0]—mmmm)—its content encodes an implied leading opcode byte (0F, 0F 38, or 0F 3).

Data element width field 5364 (EVEX byte 2, bit [7]—W)—is represented by the notation EVEX.W. EVEX.W is used to define the granularity (size) of the datatype (either 32-bit data elements or 64-bit data elements).

EVEX.vvvv 5420 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in is complement form for certain vector shifts; or 3) EVEX.vvvv does not encode any operand, the field is reserved and should contain 2611b. Thus, EVEX.vvvv field 5420 encodes the 4 low-order bits of the first source register specifier stored in inverted (1s complement) form. Depending on the instruction, an extra different EVEX bit field is used to extend the specifier size to 32 registers.

EVEX.U 5368 Class field (EVEX byte 2, bit [2]—U)—If EVEX.U=0, it indicates class A or EVEX.U0; if EVEX.U=1, it indicates class B or EVEX.U1.

Prefix encoding field 5425 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 5352 (EVEX byte 3, bit [7]—EH; also known as EVEX.EH, EVEX.rs, EVEX.RL, EVEX.write mask control, and EVEX.N; also illustrated with α)—as previously described, this field is context specific.

Beta field 5354 (EVEX byte 3, bits [6:4]—SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 5310—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 5370 (EVEX byte 3, bits [2:0]-kkk)—its content specifies the index of a register in the write mask registers as previously described. In one embodiment of the disclosure, the specific value EVEX kkk=000 has a special behavior implying no write mask is used for the particular instruction (this may be implemented in a variety of ways including the use of a write mask hardwired to all ones or hardware that bypasses the masking hardware).

Real Opcode Field 5430 (Byte 4) is also known as the opcode byte. Part of the opcode is specified in this field.

MOD R/M Field 5440 (Byte 5) includes MOD field 5442, Reg field 5444, and R/M field 5446. As previously described, the MOD field's 5442 content distinguishes between memory access and non-memory access operations. The role of Reg field 5444 can be summarized to two situations: encoding either the destination register operand or a source register operand, or be treated as an opcode extension and not used to encode any instruction operand. The role of R/M field 5446 may include the following: encoding the instruction operand that references a memory address, or encoding either the destination register operand or a source register operand.

Scale, Index, Base (SIB) Byte (Byte 6)—As previously described, the scale field's 5350 content is used for memory address generation. SIB.xxx 5454 and SIB.bbb 5456—the contents of these fields have been previously referred to with regard to the register indexes Xxxx and Bbbb.

Displacement field 5362A (Bytes 7-10)—when MOD field 5442 contains 10, bytes 7-10 are the displacement field 5362A, and it works the same as the legacy 32-bit displacement (disp32) and works at byte granularity.

Displacement factor field 5362B (Byte 7)—when MOD field 5442 contains 01, byte 7 is the displacement factor field 5362B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 5362B is a reinterpretation of disp8; when using displacement factor field 5362B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 5362B substitutes the legacy x86 instruction set 8-bit displacement. Thus, the displacement factor field 5362B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 5372 operates as previously described.

### Full Opcode Field

FIG. 54B is a block diagram illustrating the fields of the specific vector friendly instruction format 5400 that make up the full opcode field 5374 according to one embodiment of the disclosure. Specifically, the full opcode field 5374 includes the format field 5340, the base operation field 5342, and the data element width (W) field 5364. The base operation field 5342 includes the prefix encoding field 5425, the opcode map field 5415, and the real opcode field 5440.

### Register Index Field

FIG. 54C is a block diagram illustrating the fields of the specific vector friendly instruction format 5400 that make up the register index field 5344 according to one embodiment of the disclosure. Specifically, the register index field 5344 includes the REX field 5405, the REX′ field 5410, the MODR/M.reg field 5444, the MODR/M.r/m field 5446, the VVVV field 5420, xxx field 5454, and the bbb field 5456.

### Augmentation Operation Field

FIG. 54D is a block diagram illustrating the fields of the specific vector friendly instruction format 5400 that make up the augmentation operation field 5350 according to one embodiment of the disclosure. When the class (U) field 5368 contains 0, it signifies EVEX.U0 (class A 5368A); when it contains 1, it signifies EVEX.U1 (class B 5368B). When U=0 and the MOD field 5442 contains 11 (signifying a no memory access operation), the alpha field 5352 (EVEX byte 3, bit [7]—EH) is interpreted as the rs field 5352A. When the rs field 5352A contains a 1 (round 5352A.1), the beta field 5354 (EVEX byte 3, bits [6:4]—SSS) is interpreted as the round control field 5354A. The round control field 5354A includes a one bit SAE field 5356 and a two bit round operation field 5358. When the rs field 5352A contains a 0 (data transform 5352A.2), the beta field 5354 (EVEX byte 3, bits [6:4]—SSS) is interpreted as a three bit data transform field 5354B. When U=0 and the MOD field 5442 contains 00, 01, or 10 (signifying a memory access operation), the alpha field 5352 (EVEX byte 3, bit [7]—EH) is interpreted as the eviction hint (EH) field 5352B and the beta field 5354 (EVEX byte 3, bits [6:4]—SSS) is interpreted as a three bit data manipulation field 5354C.

When U=1, the alpha field 5352 (EVEX byte 3, bit [7]—EH) is interpreted as the write mask control (Z) field 5352C. When U=1 and the MOD field 5442 contains 11 (signifying a no memory access operation), part of the beta field 5354 (EVEX byte 3, bit [4]—S₀) is interpreted as the RL field 5357A; when it contains a 1 (round 5357A.1) the rest of the beta field 5354 (EVEX byte 3, bit [6-5]—S₂₋₁) is interpreted as the round operation field 5359A, while when the RL field 5357A contains a 0 (VSIZE 5357.A2) the rest of the beta field 5354 (EVEX byte 3, bit [6-5]—S₂₋₁) is interpreted as the vector length field 5359B (EVEX byte 3, bit [6-5]—L₁₋₀). When U=1 and the MOD field 5442 contains 00, 01, or 10 (signifying a memory access operation), the beta field 5354 (EVEX byte 3, bits [6:4]—SSS) is interpreted as the vector length field 5359B (EVEX byte 3, bit [6-5]—L₁₋₀) and the broadcast field 5357B (EVEX byte 3, bit [4]—B).

### Exemplary Register Architecture

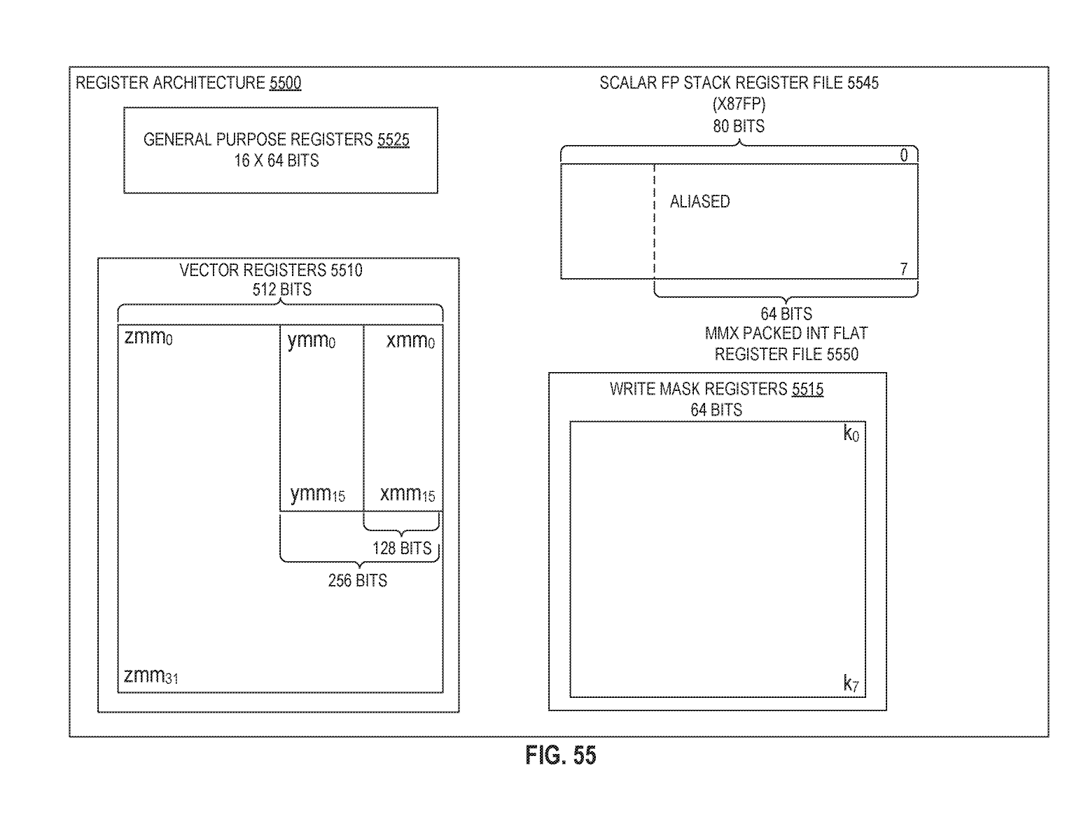

FIG. 55 is a block diagram of a register architecture 5500 according to one embodiment of the disclosure. In the embodiment illustrated, there are 32 vector registers 5510 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 5400 operates on these overlaid register file as illustrated in the below tables.

| Adjustable Vector | | | |
|---|---|---|---|
| Length | Class | Operations | Registers |
| Instruction | A (FIG. | 5310, 5315, | zmm registers (the vector |
| Templates that | 53A; | 5325, 5330 | length is 64 byte) |
| do not include the | U = 0) | | |
| vector length field | | | |
| 5359B | B (FIG. | 5312 | zmm registers (the vector |
| | 53B; | | length is 64 byte) |
| | U = 1) | | |
| Instruction | B (FIG. | 5317, 5327 | zmm, ymm, or xmm registers |
| templates that | 53B; | | (the vector length is |
| do include the | U = 1) | | 64 byte, 32 byte, or |
| vector length | | | 16 byte) depending on the |
| field 5359B | | | vector length field 5359B |

In other words, the vector length field 5359B selects between a maximum length and one or more other shorter lengths, where each such shorter length is half the length of the preceding length; and instructions templates without the vector length field 5359B operate on the maximum vector length. Further, in one embodiment, the class B instruction templates of the specific vector friendly instruction format 5400 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 5515—in the embodiment illustrated, there are 8 write mask registers (k0 through k7), each 64 bits in size. In an alternate embodiment, the write mask registers 5515 are 16 bits in size. As previously described, in one embodiment of the disclosure, the vector mask register k0 cannot be used as a write mask; when the encoding that would normally indicate k0 is used for a write mask, it selects a hardwired write mask of 0xFFFF, effectively disabling write masking for that instruction.

General-purpose registers 5525—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 5545, on which is aliased the MMX packed integer flat register file 5550—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the disclosure may use wider or narrower registers. Additionally, alternative embodiments of the disclosure may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

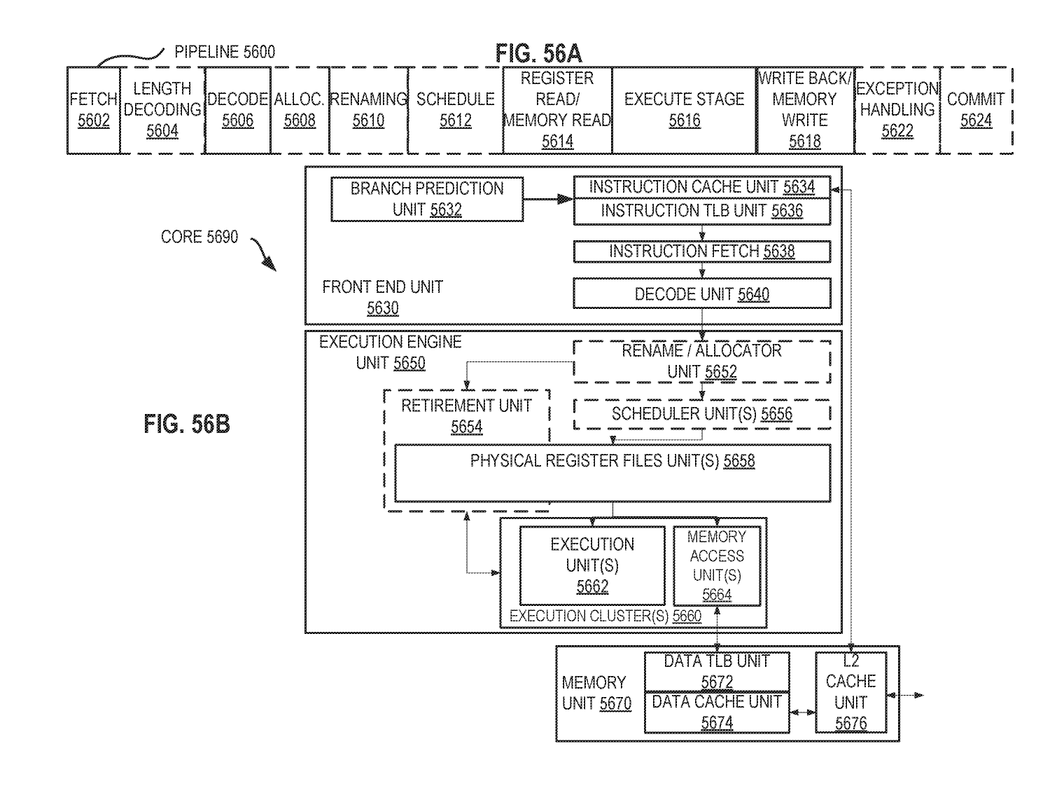

FIG. 56A is a block diagram illustrating both an exemplary in-order pipeline and an exemplary register renaming, out-of-order issue/execution pipeline according to embodiments of the disclosure. FIG. 56B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 56A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 56A, a processor pipeline 5600 includes a fetch stage 5602, a length decode stage 5604, a decode stage 5606, an allocation stage 5608, a renaming stage 5610, a scheduling (also known as a dispatch or issue) stage 5612, a register read/memory read stage 5614, an execute stage 5616, a write back/memory write stage 5618, an exception handling stage 5622, and a commit stage 5624.

FIG. 56B shows processor core 5690 including a front end unit 5630 coupled to an execution engine unit 5650, and both are coupled to a memory unit 5670. The core 5690 may be a reduced instruction set computing (RISC) core, a complex instruction set computing (CISC) core, a very long instruction word (VLIW) core, or a hybrid or alternative core type. As yet another option, the core 5690 may be a special-purpose core, such as, for example, a network or communication core, compression engine, coprocessor core, general purpose computing graphics processing unit (GPGPU) core, graphics core, or the like.

The front end unit 5630 includes a branch prediction unit 5632 coupled to an instruction cache unit 5634, which is coupled to an instruction translation lookaside buffer (TLB) 5636, which is coupled to an instruction fetch unit 5638, which is coupled to a decode unit 5640. The decode unit 5640 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 5640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 5690 includes a microcode ROM or other medium that stores microcode for certain macro-instructions (e.g., in decode unit 5640 or otherwise within the front end unit 5630). The decode unit 5640 is coupled to a rename/allocator unit 5652 in the execution engine unit 5650.

The execution engine unit 5650 includes the rename/allocator unit 5652 coupled to a retirement unit 5654 and a set of one or more scheduler unit(s) 5656. The scheduler unit(s) 5656 represents any number of different schedulers, including reservations stations, central instruction window, etc. The scheduler unit(s) 5656 is coupled to the physical register file(s) unit(s) 5658. Each of the physical register file(s) units 5658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 5658 comprises a vector registers unit, a write mask registers unit, and a scalar registers unit. These register units may provide architectural vector registers, vector mask registers, and general purpose registers. The physical register file(s) unit(s) 5658 is overlapped by the retirement unit 5654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 5654 and the physical register file(s) unit(s) 5658 are coupled to the execution cluster(s) 5660. The execution cluster(s) 5660 includes a set of one or more execution units 5662 and a set of one or more memory access units 5664. The execution units 5662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 5656, physical register file(s) unit(s) 5658, and execution cluster(s) 5660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 5664). It should also be understood that where separate pipelines are used, one or more of these pipelines may be out-of-order issue/execution and the rest in-order.

The set of memory access units 5664 is coupled to the memory unit 5670, which includes a data TLB unit 5672 coupled to a data cache unit 5674 coupled to a level 2 (L2) cache unit 5676. In one exemplary embodiment, the memory access units 5664 may include a load unit, a store address unit, and a store data unit, each of which is coupled to the data TLB unit 5672 in the memory unit 5670. The instruction cache unit 5634 is further coupled to a level 2 (L2) cache unit 5676 in the memory unit 5670. The L2 cache unit 5676 is coupled to one or more other levels of cache and eventually to a main memory.

By way of example, the exemplary register renaming, out-of-order issue/execution core architecture may implement the pipeline 5600 as follows: 1) the instruction fetch 5638 performs the fetch and length decoding stages 5602 and 5604; 2) the decode unit 5640 performs the decode stage 5606; 3) the rename/allocator unit 5652 performs the allocation stage 5608 and renaming stage 5610; 4) the scheduler unit(s) 5656 performs the schedule stage 5612; 5) the physical register file(s) unit(s) 5658 and the memory unit 5670 perform the register read/memory read stage 5614; the execution cluster 5660 perform the execute stage 5616; 6) the memory unit 5670 and the physical register file(s) unit(s) 5658 perform the write back/memory write stage 5618; 7) various units may be involved in the exception handling stage 5622; and 8) the retirement unit 5654 and the physical register file(s) unit(s) 5658 perform the commit stage 5624.

The core 5690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 5690 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 5634/5674 and a shared L2 cache unit 5676, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary in-Order Core Architecture

FIGS. 56A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

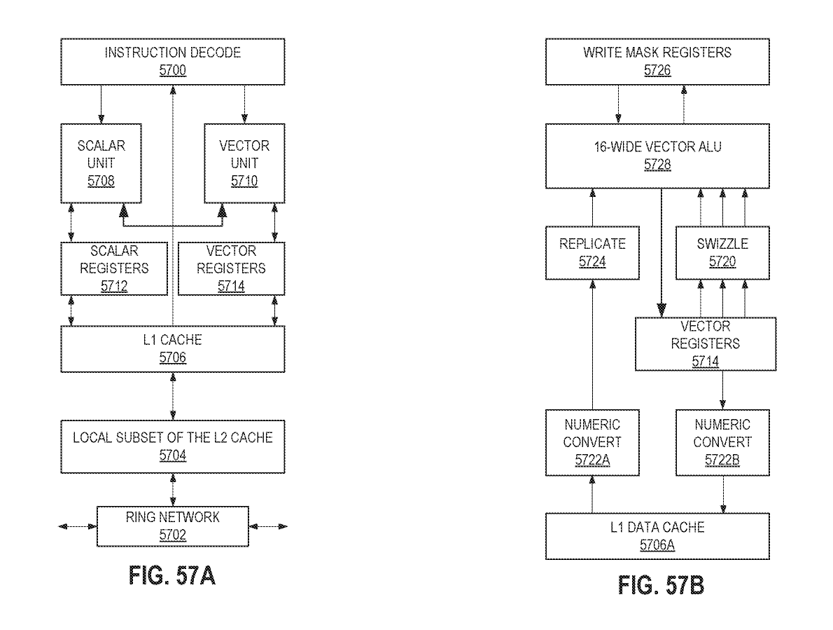

FIG. 57A is a block diagram of a single processor core, along with its connection to the on-die interconnect network 5702 and with its local subset of the Level 2 (L2) cache 5704, according to embodiments of the disclosure. In one embodiment, an instruction decode unit 5700 supports the x86 instruction set with a packed data instruction set extension. An L1 cache 5706 allows low-latency accesses to cache memory into the scalar and vector units. While in one embodiment (to simplify the design), a scalar unit 5708 and a vector unit 5710 use separate register sets (respectively, scalar registers 5712 and vector registers 5714) and data transferred between them is written to memory and then read back in from a level 1 (L1) cache 5706, alternative embodiments of the disclosure may use a different approach (e.g., use a single register set or include a communication path that allow data to be transferred between the two register files without being written and read back).

The local subset of the L2 cache 5704 is part of a global L2 cache that is divided into separate local subsets, one per processor core. Each processor core has a direct access path to its own local subset of the L2 cache 5704. Data read by a processor core is stored in its L2 cache subset 5704 and can be accessed quickly, in parallel with other processor cores accessing their own local L2 cache subsets. Data written by a processor core is stored in its own L2 cache subset 5704 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 57B is an expanded view of part of the processor core in FIG. 57A according to embodiments of the disclosure. FIG. 57B includes an L1 data cache 5706A part of the L1 cache 5704, as well as more detail regarding the vector unit 5710 and the vector registers 5714. Specifically, the vector unit 5710 is a 16-wide vector processing unit (VPU) (see the 16-wide ALU 5728), which executes one or more of integer, single-precision float, and double-precision float instructions. The VPU supports swizzling the register inputs with swizzle unit 5720, numeric conversion with numeric convert units 5722A-B, and replication with replication unit 5724 on the memory input. Write mask registers 5726 allow predicating resulting vector writes.

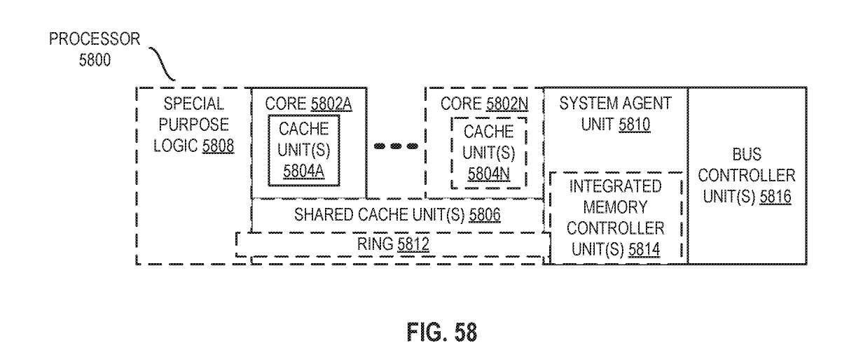

FIG. 58 is a block diagram of a processor 5800 that may have more than one core, may have an integrated memory controller, and may have integrated graphics according to embodiments of the disclosure. The solid lined boxes in FIG. 58 illustrate a processor 5800 with a single core 5802A, a system agent 5810, a set of one or more bus controller units 5816, while the optional addition of the dashed lined boxes illustrates an alternative processor 5800 with multiple cores 5802A-N, a set of one or more integrated memory controller unit(s) 5814 in the system agent unit 5810, and special purpose logic 5808.

Thus, different implementations of the processor 5800 may include: 1) a CPU with the special purpose logic 5808 being integrated graphics and/or scientific (throughput) logic (which may include one or more cores), and the cores 5802A-N being one or more general purpose cores (e.g., general purpose in-order cores, general purpose out-of-order cores, a combination of the two); 2) a coprocessor with the cores 5802A-N being a large number of special purpose cores intended primarily for graphics and/or scientific (throughput); and 3) a coprocessor with the cores 5802A-N being a large number of general purpose in-order cores. Thus, the processor 5800 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 5800 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 5806, and external memory (not shown) coupled to the set of integrated memory controller units 5814. The set of shared cache units 5806 may include one or more mid-level caches, such as level 2 (L2), level 3 (L3), level 4 (L4), or other levels of cache, a last level cache (LLC), and/or combinations thereof. While in one embodiment a ring based interconnect unit 5812 interconnects the integrated graphics logic 5808, the set of shared cache units 5806, and the system agent unit 5810/integrated memory controller unit(s) 5814, alternative embodiments may use any number of well-known techniques for interconnecting such units. In one embodiment, coherency is maintained between one or more cache units 5406 and cores 5802-A-N.

In some embodiments, one or more of the cores 5802A-N are capable of multi-threading. The system agent 5810 includes those components coordinating and operating cores 5802A-N. The system agent unit 5810 may include for example a power control unit (PCU) and a display unit. The PCU may be or include logic and components needed for regulating the power state of the cores 5802A-N and the integrated graphics logic 5808. The display unit is for driving one or more externally connected displays.

The cores 5802A-N may be homogenous or heterogeneous in terms of architecture instruction set; that is, two or more of the cores 5802A-N may be capable of execution the same instruction set, while others may be capable of executing only a subset of that instruction set or a different instruction set.

### Exemplary Computer Architectures

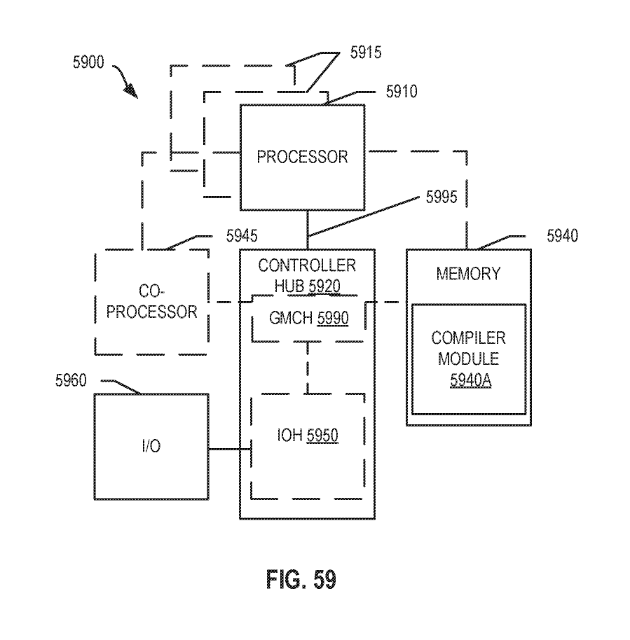

FIGS. 59-62 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 59, shown is a block diagram of a system 5900 in accordance with one embodiment of the present disclosure. The system 5900 may include one or more processors 5910, 5915, which are coupled to a controller hub 5920. In one embodiment the controller hub 5920 includes a graphics memory controller hub (GMCH) 5990 and an Input/Output Hub (IOH) 5950 (which may be on separate chips); the GMCH 5990 includes memory and graphics controllers to which are coupled memory 5940 and a coprocessor 5945; the IOH 5950 is couples input/output (I/O) devices 5960 to the GMCH 5990. Alternatively, one or both of the memory and graphics controllers are integrated within the processor (as described herein), the memory 5940 and the coprocessor 5945 are coupled directly to the processor 5910, and the controller hub 5920 in a single chip with the IOH 5950. Memory 5940 may include a compiler module 5940A, for example, to store code that when executed causes a processor to perform any method of this disclosure.

The optional nature of additional processors 5915 is denoted in FIG. 59 with broken lines. Each processor 5910, 5915 may include one or more of the processing cores described herein and may be some version of the processor 5800.

The memory 5940 may be, for example, dynamic random access memory (DRAM), phase change memory (PCM), or a combination of the two. For at least one embodiment, the controller hub 5920 communicates with the processor(s) 5910, 5915 via a multi-drop bus, such as a frontside bus (FSB), point-to-point interface such as QuickPath Interconnect (QPI), or similar connection 5995.

In one embodiment, the coprocessor 5945 is a special-purpose processor, such as, for example, a high-throughput MIC processor, a network or communication processor, compression engine, graphics processor, GPGPU, embedded processor, or the like. In one embodiment, controller hub 5920 may include an integrated graphics accelerator.

There can be a variety of differences between the physical resources 5910, 5915 in terms of a spectrum of metrics of merit including architectural, microarchitectural, thermal, power consumption characteristics, and the like.

In one embodiment, the processor 5910 executes instructions that control data processing operations of a general type. Embedded within the instructions may be coprocessor instructions. The processor 5910 recognizes these coprocessor instructions as being of a type that should be executed by the attached coprocessor 5945. Accordingly, the processor 5910 issues these coprocessor instructions (or control signals representing coprocessor instructions) on a coprocessor bus or other interconnect, to coprocessor 5945. Coprocessor(s) 5945 accept and execute the received coprocessor instructions.

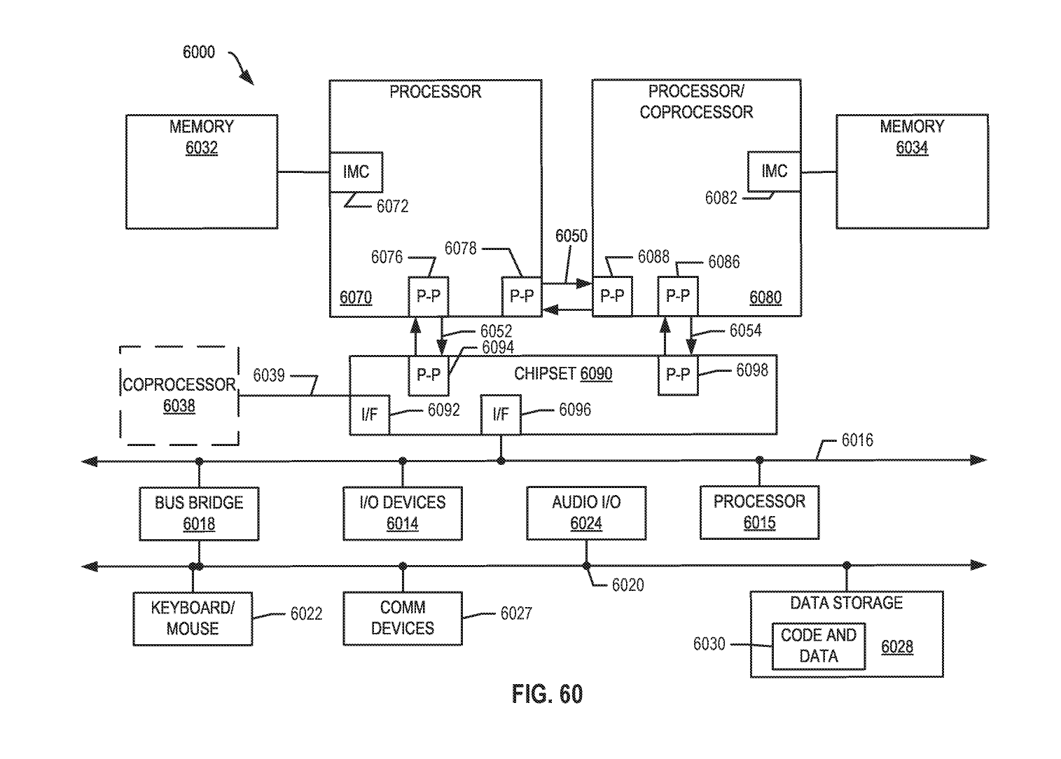

Referring now to FIG. 60, shown is a block diagram of a first more specific exemplary system 6000 in accordance with an embodiment of the present disclosure. As shown in FIG. 60, multiprocessor system 6000 is a point-to-point interconnect system, and includes a first processor 6070 and a second processor 6080 coupled via a point-to-point interconnect 6050. Each of processors 6070 and 6080 may be some version of the processor 5800. In one embodiment of the disclosure, processors 6070 and 6080 are respectively processors 5910 and 5915, while coprocessor 6038 is coprocessor 5945. In another embodiment, processors 6070 and 6080 are respectively processor 5910 coprocessor 5945.

Processors 6070 and 6080 are shown including integrated memory controller (IMC) units 6072 and 6082, respectively. Processor 6070 also includes as part of its bus controller units point-to-point (P-P) interfaces 6076 and 6078; similarly, second processor 6080 includes P-P interfaces 6086 and 6088. Processors 6070, 6080 may exchange information via a point-to-point (P-P) interface 6050 using P-P interface circuits 6078, 6088. As shown in FIG. 60, IMCs 6072 and 6082 couple the processors to respective memories, namely a memory 6032 and a memory 6034, which may be portions of main memory locally attached to the respective processors.

Processors 6070, 6080 may each exchange information with a chipset 6090 via individual P-P interfaces 6052, 6054 using point to point interface circuits 6076, 6094, 6086, 6098. Chipset 6090 may optionally exchange information with the coprocessor 6038 via a high-performance interface 6039. In one embodiment, the coprocessor 6038 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 6090 may be coupled to a first bus 6016 via an interface 6096. In one embodiment, first bus 6016 may be a Peripheral Component Interconnect (PCI) bus, or a bus such as a PCI Express bus or another third generation I/O interconnect bus, although the scope of the present disclosure is not so limited.

As shown in FIG. 60, various I/O devices 6014 may be coupled to first bus 6016, along with a bus bridge 6018 which couples first bus 6016 to a second bus 6020. In one embodiment, one or more additional processor(s) 6015, such as coprocessors, high-throughput MIC processors, GPGPU's, accelerators (such as, e.g., graphics accelerators or digital signal processing (DSP) units), field programmable gate arrays, or any other processor, are coupled to first bus 6016. In one embodiment, second bus 6020 may be a low pin count (LPC) bus. Various devices may be coupled to a second bus 6020 including, for example, a keyboard and/or mouse 6022, communication devices 6027 and a storage unit 6028 such as a disk drive or other mass storage device which may include instructions/code and data 6030, in one embodiment. Further, an audio I/O 6024 may be coupled to the second bus 6020. Note that other architectures are possible. For example, instead of the point-to-point architecture of FIG. 60, a system may implement a multi-drop bus or other such architecture.

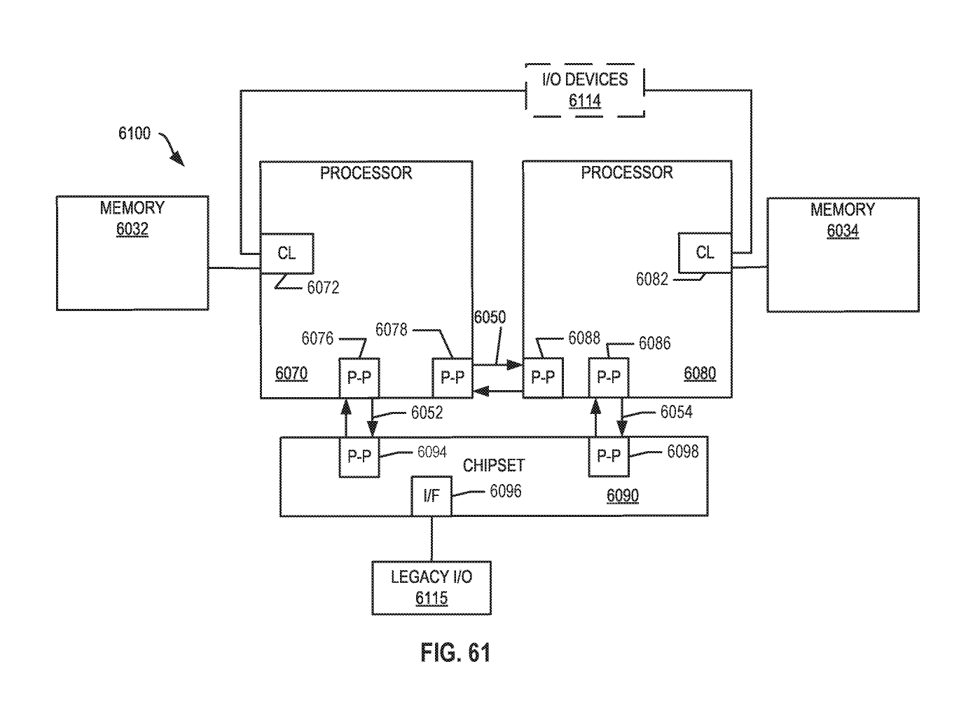

Referring now to FIG. 61, shown is a block diagram of a second more specific exemplary system 6100 in accordance with an embodiment of the present disclosure Like elements in FIGS. 60 and 61 bear like reference numerals, and certain aspects of FIG. 60 have been omitted from FIG. 61 in order to avoid obscuring other aspects of FIG. 61.

FIG. 61 illustrates that the processors 6070, 6080 may include integrated memory and I/O control logic (“CL”) 6072 and 6082, respectively. Thus, the CL 6072, 6082 include integrated memory controller units and include I/O control logic. FIG. 61 illustrates that not only are the memories 6032, 6034 coupled to the CL 6072, 6082, but also that I/O devices 6114 are also coupled to the control logic 6072, 6082. Legacy I/O devices 6115 are coupled to the chipset 6090.

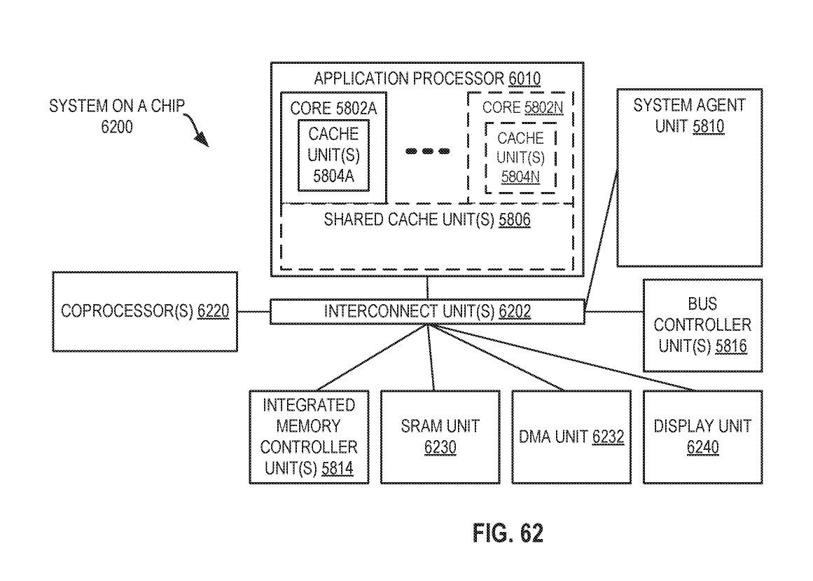

Referring now to FIG. 62, shown is a block diagram of a SoC 6200 in accordance with an embodiment of the present disclosure. Similar elements in FIG. 58 bear like reference numerals. Also, dashed lined boxes are optional features on more advanced SoCs. In FIG. 62, an interconnect unit(s) 6202 is coupled to: an application processor 6210 which includes a set of one or more cores 202A-N and shared cache unit(s) 5806; a system agent unit 5810; a bus controller unit(s) 5816; an integrated memory controller unit(s) 5814; a set or one or more coprocessors 6220 which may include integrated graphics logic, an image processor, an audio processor, and a video processor; an static random access memory (SRAM) unit 6230; a direct memory access (DMA) unit 6232; and a display unit 6240 for coupling to one or more external displays. In one embodiment, the coprocessor(s) 6220 include a special-purpose processor, such as, for example, a network or communication processor, compression engine, GPGPU, a high-throughput MIC processor, embedded processor, or the like.

Embodiments (e.g., of the mechanisms) disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 6030 illustrated in FIG. 60, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

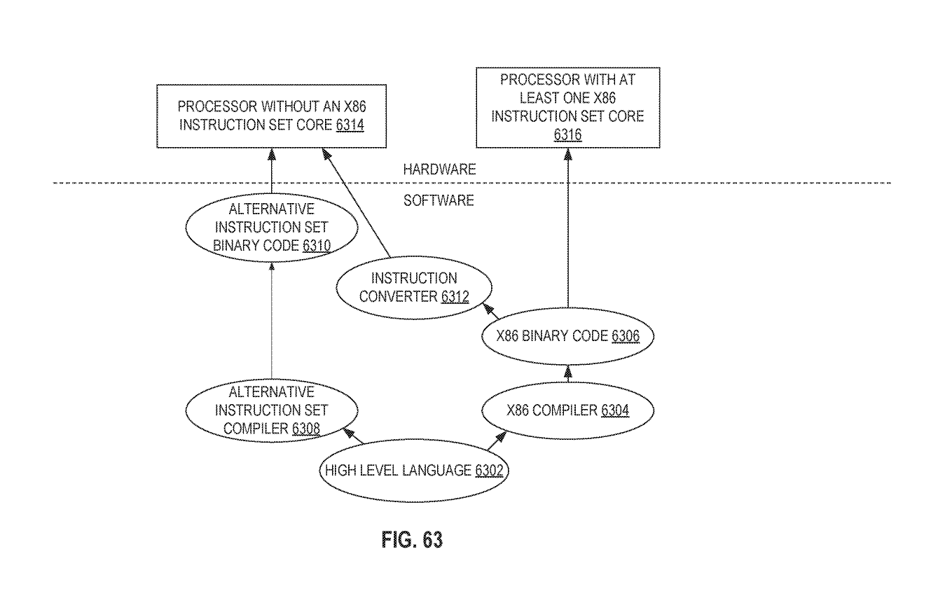

FIG. 63 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 63 shows a program in a high level language 6302 may be compiled using an x86 compiler 6304 to generate x86 binary code 6306 that may be natively executed by a processor with at least one x86 instruction set core 6316. The processor with at least one x86 instruction set core 6316 represents any processor that can perform substantially the same functions as an Intel® processor with at least one x86 instruction set core by compatibly executing or otherwise processing (1) a substantial portion of the instruction set of the Intel® x86 instruction set core or (2) object code versions of applications or other software targeted to run on an Intel® processor with at least one x86 instruction set core, in order to achieve substantially the same result as an Intel® processor with at least one x86 instruction set core. The x86 compiler 6304 represents a compiler that is operable to generate x86 binary code 6306 (e.g., object code) that can, with or without additional linkage processing, be executed on the processor with at least one x86 instruction set core 6316. Similarly, FIG. 63 shows the program in the high level language 6302 may be compiled using an alternative instruction set compiler 6308 to generate alternative instruction set binary code 6310 that may be natively executed by a processor without at least one x86 instruction set core 6314 (e.g., a processor with cores that execute the MIPS instruction set of MIPS Technologies of Sunnyvale, Calif. and/or that execute the ARM instruction set of ARM Holdings of Sunnyvale, Calif.). The instruction converter 6312 is used to convert the x86 binary code 6306 into code that may be natively executed by the processor without an x86 instruction set core 6314. This converted code is not likely to be the same as the alternative instruction set binary code 6310 because an instruction converter capable of this is difficult to make; however, the converted code will accomplish the general operation and be made up of instructions from the alternative instruction set. Thus, the instruction converter 6312 represents software, firmware, hardware, or a combination thereof that, through emulation, simulation or any other process, allows a processor or other electronic device that does not have an x86 instruction set processor or core to execute the x86 binary code 6306.

1. A processor comprising:
a plurality of processing elements;
an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the interconnect network and the plurality of processing elements, and the plurality of processing elements is to perform an operation when an incoming operand set arrives at the plurality of processing elements; and
a configuration controller coupled to the plurality of processing elements to configure the plurality of processing elements according to configuration information for the dataflow graph, and clock gate at least one clocked component of a processing element based on the configuration information.

2. The processor of claim 1, wherein the at least one clocked component is an input buffer of multiple parallel input buffers within the processing element.

3. The processor of claim 1, wherein the at least one clocked component is an output buffer of multiple parallel input buffers within the processing element.

4. The processor of claim 1, wherein the at least one clocked component is an operation configuration register within the processing element to store an operation configuration of the configuration information.

5. The processor of claim 1, wherein the configuration controller is to clock gate at least one clocked component of a second processing element based on the configuration information.

6. The processor of claim 1, wherein the at least one clocked component comprises multiple parallel input buffers within the processing element, multiple parallel output buffers within the processing element, and an operation configuration register within the processing element to store an operation configuration of the configuration information, and the configuration controller is to independently clock gate each of those clocked components.

7. A method comprising:
configuring, with a configuration controller of a processor, a plurality of processing elements of the processor according to configuration information for a dataflow graph, wherein the processor comprises the plurality of processing elements and an interconnect network between the plurality of processing elements, and has the dataflow graph comprising a plurality of nodes overlaid into the plurality of processing elements of the processor and the interconnect network between the plurality of processing elements of the processor with each node represented as a dataflow operator in the interconnect network and the plurality of processing elements;
clock gating, with the configuration controller of the processor, at least one clocked component of a processing element based on the configuration information for the dataflow graph; and
performing an operation of the dataflow graph with the interconnect network and the plurality of processing elements when an incoming operand set arrives at the plurality of processing elements.

8. The method of claim 7, wherein the clock gating comprises clock gating an input buffer of multiple parallel input buffers within the processing element.

9. The method of claim 7, wherein the clock gating comprises clock gating an output buffer of multiple parallel input buffers within the processing element.

10. The method of claim 7, wherein the clock gating comprises clock gating an operation configuration register within the processing element to store an operation configuration of the configuration information.

11. The method of claim 7, wherein the clock gating comprises clock gating at least one clocked component of a second processing element based on the configuration information.

12. The method of claim 7, wherein the at least one clocked component comprises multiple parallel input buffers within the processing element, multiple parallel output buffers within the processing element, and an operation configuration register within the processing element to store an operation configuration of the configuration information, and the configuration controller is independently clock gating each of those clocked components.

13. A processor comprising:
a plurality of processing elements;
an interconnect network between the plurality of processing elements to receive an input of a dataflow graph comprising a plurality of nodes, wherein the dataflow graph is to be overlaid into the interconnect network and the plurality of processing elements with each node represented as a dataflow operator in the interconnect network and the plurality of processing elements, and the plurality of processing elements is to perform an operation when an incoming operand set arrives at the plurality of processing elements; and
a configuration controller, coupled to a first processing element and a second processing element of the plurality of processing elements and the first processing element having an output coupled to an input of the second processing element, to configure the second processing element to clock gate at least one clocked component of the second processing element, and configure the first processing element to send a reenable signal on the interconnect network to the second processing element to reenable the at least one clocked component of the second processing element when data is to be sent from the first processing element to the second processing element.

14. The processor of claim 13, wherein the configuration controller is to configure the first processing element to send the reenable signal and the data from the first processing element to the second processing element within a same clock cycle.

15. The processor of claim 13, wherein the at least one clocked component of the second processing element comprises multiple parallel input buffers within the second processing element.

16. The processor of claim 15, wherein the configuration controller is to configure the first processing element to clock gate multiple parallel output buffers within the first processing element, and reenable the multiple parallel output buffers when the data is to be sent from the multiple parallel output buffers within the first processing element to the multiple parallel input buffers within the second processing element.

17. The processor of claim 13, wherein the configuration controller, coupled to a third processing element of the plurality of processing elements and the first processing element having an output coupled to an input of the third processing element, to configure the third processing element to not clock gate any clocked component of the third processing element.

18. The processor of claim 17, wherein the configuration controller is to configure the third processing element to not clock gate any clocked component of the third processing element when a distance on the interconnect network between the first processing element and the third processing element is greater than a threshold distance to communicate within a same clock cycle between the first processing element and the third processing element.

19. A method comprising:
configuring, with a configuration controller of a processor coupled to a first processing element and a second processing element of a plurality of processing elements and the first processing element having an output coupled to an input of the second processing element, the second processing element to clock gate at least one clocked component of the second processing element, wherein the processor comprises the plurality of processing elements and an interconnect network between the plurality of processing elements, and has a dataflow graph comprising a plurality of nodes overlaid into the plurality of processing elements of the processor and the interconnect network between the plurality of processing elements of the processor with each node represented as a dataflow operator in the interconnect network and the plurality of processing elements;
configuring, with the configuration controller, the first processing element to send a reenable signal on the interconnect network to the second processing element to reenable the at least one clocked component of the second processing element when data is to be sent from the first processing element to the second processing element;
clock gating, with the configuration controller of the processor, the at least one clocked component of the second processing element;
sending, with the first processing element, a reenable signal on the interconnect network to the second processing element to reenable the at least one clocked component of the second processing element when the data is sent from the first processing element to the second processing element; and
performing an operation of the dataflow graph with the second processing element when an incoming operand set including the data arrives at the second processing element.

20. The method of claim 19, wherein the configuring of the first processing element causes the first processing element to send the reenable signal and the data from the first processing element to the second processing element within a same clock cycle.

21. The method of claim 19, wherein the clock gating comprises clock gating multiple parallel input buffers within the second processing element.

22. The method of claim 21, wherein the configuring of the first processing element causes the first processing element to clock gate multiple parallel output buffers within the first processing element, and reenable the multiple parallel output buffers when the data is sent from the multiple parallel output buffers within the first processing element to the multiple parallel input buffers within the second processing element.

23. The method of claim 19, further comprising configuring, with the configuration controller coupled to a third processing element of the plurality of processing elements and the first processing element having an output coupled to an input of the third processing element, the third processing element to not clock gate any clocked component of the third processing element.

24. The method of claim 23, wherein the configuring of the third processing element to not clock gate any clocked component of the third processing element is based on a distance on the interconnect network between the first processing element and the third processing element being greater than a threshold distance to communicate within a same clock cycle between the first processing element and the third processing element.
